(19) United States
(12) Patent Application Publication
(10) Pub. No.: US 2012/0041684 A1
(43) Pub. Date: Feb. 16, 2012

(54) Method of evaluating obesity, obesity-evaluating apparatus, obesity-evaluating method, obesity-evaluating system, obesity-evaluating program product, recording medium, and information communication terminal apparatus

(75) Inventors: Takayuki Tanaka, Kanagawa (JP); Hiroshi Yamamoto, Tokyo (JP); Toshihiko Ando, Kanagawa (JP); Minoru Yamakado, Tokyo (JP)

(73) Assignee: Ajinomoto Co., Inc.

(21) Appl. No.: 13/137,373

(22) Filed: Aug. 9, 2011

Related U.S. Application Data
(63) Continuation of application No. PCT/JP2010/052443, filed on Feb. 18, 2010.

(30) Foreign Application Priority Data
Feb. 19, 2009 (JP) 2009-037116

(51) Int. Cl. G06F 19/00

(52) U.S. Cl. 702/19

(57) ABSTRACT

According to the method of evaluating obesity of the present invention, amino acid concentration data on concentration values of amino acids in blood collected from a subject to be evaluated is measured, and the state of at least one of the apparent obesity, the non-apparent obesity and the obesity which are defined by the BMI and the VFA in the subject is evaluated based on the concentration value of at least one of Glu, Ser, Pro, Gly, Ala, Cys2, Tyr, Val, Orn, Met, Lys, Ile, Leu, Phe, and Trp contained in the measured amino acid concentration data of the subject.

This application is a Continuation of PCT/JP2010/052443, filed Feb. 18, 2010, which claims priority from Japanese patent application JP 2009-037116 filed Feb. 19, 2009. The contents of each of the aforementioned application are incorporated herein by reference in their entirety.

### BACKGROUND OF THE INVENTION

1. Field of the Invention

The present invention relates to a method of evaluating obesity, which utilizes a concentration of an amino acid in blood (plasma).

2. Description of the Related Art

According to “Results from 2006 National Health and Nutrition Survey” carried out by the Ministry of Health, Labour and Welfare in 2006, the number of obese subjects in Japan is increasing, and especially, a ratio of male obese subjects increases as compared to that in twenty years ago (1986) and ten years ago (1996) in all age groups. If obesity is left untreated, risk for disease such as diabetes, hyperlipemia, cardiac infarction, angina, cerebral infarct, cerebral thrombosis, gout, fatty liver, sleep apnea syndrome, arthritis deformans, and low back pain increases, so that it is necessary to perform screening for the obese subjects at an early stage to encourage them to improve lifestyle habit. In order to this, an index for quantitative, simple and rapid screening of a state of obesity is required.

A present index for evaluating the state of obesity includes a body mass index (BMI), a body fat percentage, and a visceral fat area (VFA). However, there is a problem that although the BMI may be applied to a subject of standard proportions, this cannot be applied to a large-boned subject, a long-legged subject, a small-boned subject, a well-muscled subject and the like. There is a problem of a large measurement error in the body fat percentage. There is a problem of a high measurement cost and high frequency of exposure in the visceral fat area. Therefore, an alternative index is required.

It is known that blood amino acid concentration changes in the obese subject. For example, Chevalier et al. (“Chevalier, S., Burgess, S C., et. al., “The greater contribution of gluconeogenesis to glucose production in obesity is related to increased whole-body protein catabolism.”, Diabetes, 2006, 55, p 675-681”) and She et al. (“She, P., Van, H C., et. al., “Obesity-related elevations in plasma leucine are associated with alterations in enzymes involved in branched-chain amino acid metabolism.”, American journal of physiology, Endocrinology and metabolism, 2007, 293, 6, p 1552-1563”) report that branched-chain amino acids (valine, leucine, and isoleucine) in blood plasma increase in the obese subject than in a healthy subject. Breum et al. (“Breum, L., Rasmussen, M H., et. al., “Twenty-four-hour plasma tryptophan concentrations and ratios are below normal in obese subjects and are not normalized by substantial weight reduction.”, The American journal of clinical nutrition, 2003, 77, 5, p 1122-1128”) and Jeevanandam et al. (“Jeevanandam, M., Ramias, L., et. al., “Altered plasma free amino acid levels in obese traumatized man.”, Metabolism:clinical and experimental, 1991, 40, 4, p 385-390”) report that percentage of tryptophane to a sum of the branched-chain amino-acids and aromatic amino acids (tyrosine and phenylalanine) in the blood plasma decreases in the obese subject than in the healthy subject. Caballero et al. (“Caballero, B., Finer, N., Wurtman, R J., et. al., “Plasma amino acids and insulin levels in obesity: response to carbohydrate intake and tryptophan supplements.”, Metabolism:clinical and experimental, 1988, 37, 7, p 672-676”) reports that the branched-chain amino-acids and glutamic acid in the blood plasma increase in the obese subject than in the healthy subject and that glycine, tryptophane, threonine, histidine, taurine, citrulline, and cystine decrease in the obese subject than in the healthy subject. Dorner et al. (“Dorner, G., Bewer, G., et. al., Changes of the plasma tryptophan to neutral amino acids ratio in formula-fed infants: possible effects on brain development., Experimental and clinical endocrinology, 1983, 82, 3, p 368-371”) reports that the branched-chain amino-acids and the aromatic amino acids in the blood plasma increase in the obese subject than in the healthy subject.

WO 2004/052191 and WO 2006/098192 related to a method of relating the amino acid concentration and a biological state are disclosed as previous patents. WO 2008/015929 related to a method of evaluating a state of metabolic syndrome using the amino acid concentration and WO 2009/001862 related to a method of evaluating visceral fat accumulation using the amino acid concentration are disclosed.

However, there is a problem that a method of evaluating a state of obesity, which uses a plurality of amino acids as explanatory variables, has not developed, and has not been practically used. In addition, there is a problem that even when the state of obesity is evaluated by an index formula group disclosed in WO 2004/052191, WO 2006/098192, WO 2008/015929 and WO 2009/001862, sufficient accuracy cannot be obtained.

### SUMMARY OF THE INVENTION

It is an object of the present invention to at least partially solve the problems in the conventional technology. The present invention has been made in view of the problems described above, and an object of the present invention is to provide a method of evaluating obesity, which can evaluate accurately a state of an apparent obesity, a non-apparent obesity or an obesity defined by the BMI and the VFA (Visceral Fat Area), by using, of blood amino acid concentrations, the amino acid concentration associated with the state of the apparent obesity, the non-apparent obesity or the obesity.

The present inventors have earnestly studied the problems to solve them, have searched and identified amino acid explanatory variables more specific for evaluating the state of the apparent obesity, the non-apparent obesity or the obesity defined by the BMI and the VFA, have found that multivariate discriminants (index formulae or correlation equations) containing the concentrations of the identified amino acids as explanatory variables, significantly correlate with the state of the above obesity, and have completed the present invention.

To solve the problem and achieve the object described above, a method of evaluating obesity according to one aspect of the present invention includes (i) an obtaining step of obtaining amino acid concentration data on a concentration value of an amino acid in blood collected from a subject to be evaluated, and (ii) a concentration value criterion evaluating step of evaluating a state of at least one of an apparent obesity, a non-apparent obesity, and an obesity that are defined by BMI (Body Mass Index) and VFA (Visceral Fat Area) in the subject, based on the concentration value of at least one of Glu, Ser, Pro, Gly, Ala, Cys2, Tyr, Val, Orn, Met, Lys, Ile, Leu, Phe, and Trp contained in the amino acid concentration data of the subject obtained at the obtaining step.

Another aspect of the present invention is the method of evaluating obesity, wherein the concentration value criterion evaluating step further includes a concentration value criterion discriminating step of discriminating between a healthy state defined by the BMI and the VFA and the apparent obesity, between the healthy state and the non-apparent obesity, between the healthy state and the obesity, between the apparent obesity and the non-apparent obesity, between the apparent obesity and the obesity, between the non-apparent obesity and the obesity, or between the healthy state or the apparent obesity and the non-apparent obesity or the obesity in the subject, based on the concentration value of at least one of Glu, Ser, Pro, Gly, Ala, Cys2, Tyr, Val, Orn, Met, Lys, Ile, Leu, Phe, and Trp contained in the amino acid concentration data of the subject obtained at the obtaining step.

Still another aspect of the present invention is the method of evaluating obesity, wherein the concentration value criterion evaluating step further includes (I) a discriminant value calculating step of calculating a discriminant value that is a value of a multivariate discriminant with a concentration of the amino acid as an explanatory variable, based on both (i) the concentration value of at least one of Glu, Ser, Pro, Gly, Ala, Cys2, Tyr, Val, Orn, Met, Lys, Ile, Leu, Phe, and Trp contained in the amino acid concentration data of the subject obtained at the obtaining step and (ii) the previously established multivariate discriminant, and (II) a discriminant value criterion evaluating step of evaluating the state of at least one of the apparent obesity, the non-apparent obesity, and the obesity in the subject based on the discriminant value calculated at the discriminant value calculating step. The multivariate discriminant contains at least one of Glu, Ser, Pro, Gly, Ala, Cys2, Tyr, Val, Orn, Met, Lys, Ile, Leu, Phe, and Trp as the explanatory variable.

Still another aspect of the present invention is the method of evaluating obesity, wherein the discriminant value criterion evaluating step further includes a discriminant value criterion discriminating step of discriminating between a healthy state defined by the BMI and the VFA and the apparent obesity, between the healthy state and the non-apparent obesity, between the healthy state and the obesity, between the apparent obesity and the non-apparent obesity, between the apparent obesity and the obesity, between the non-apparent obesity and the obesity, or between the healthy state or the apparent obesity and the non-apparent obesity or the obesity in the subject, based on the discriminant value calculated at the discriminant value calculating step.

Still another aspect of the present invention is the method of evaluating obesity, wherein the multivariate discriminant is any one of a fractional expression, the sum of a plurality of the fractional expressions, a logistic regression equation, a linear discriminant, a multiple regression equation, a discriminant prepared by a support vector machine, a discriminant prepared by a Mahalanobis' generalized distance method, a discriminant prepared by canonical discriminant analysis, and a discriminant prepared by a decision tree.

Still another aspect of the present invention is the method of evaluating obesity, wherein when discriminating between the healthy state and the apparent obesity at the discriminant value criterion discriminating step, the multivariate discriminant is a formula 1, a formula 2, the logistic regression equation with Glu, Thr, and Phe as the explanatory variables, the logistic regression equation with Pro, Asn, Thr, Arg, Tyr, and Orn as the explanatory variables, the linear discriminant with His, Thr, Val, Orn, and Trp as the explanatory variables, or the linear discriminant with Ser, Pro, Asn, Orn, Phe, Val, Leu, and Ile as the explanatory variables:

a₁(Glu/Gly)+b₁(His/Ile)+c₁(Thr/Phe)+d₁ (formula 1)

a₂(Pro/Ser)+b₂(Thr/Asn)+c₂(Arg/Tyr)+d₂(Orn/Gln)+e₂ (formula 2)

wherein in the formula 1, a₁, b₁, and c₁ are arbitrary non-zero real numbers and d₁ is an arbitrary real number and in the formula 2, a₂, b₂, c₂, and d₂ are arbitrary non-zero real numbers and e₂ is an arbitrary real number.

Still another aspect of the present invention is the method of evaluating obesity, wherein when discriminating between the healthy state and the non-apparent obesity at the discriminant value criterion discriminating step, the multivariate discriminant is a formula 3, a formula 4, the logistic regression equation with Glu, Ser, Ala, Orn, Leu, and Trp as the explanatory variables, the logistic regression equation with Glu, Ser, Gly, Cit, Ala, Val, Leu, and Ile as the explanatory variables, the linear discriminant with Glu, Ser, His, Thr, Lys, and Phe as the explanatory variables, or the linear discriminant with Glu, His, ABA, Tyr, Met, and Lys as the explanatory variables:

a₃(Ser/Ala)+b₃(Gly/Tyr)+c₃(Trp/Glu)+d₃ (formula 3)

a₄(Ser/Cit)+b₄(Gly/(Val+Leu+Ile))+c₄(Gln/Ala)+d₄(Thr/Glu)+e₄ (formula 4)

wherein in the formula 3, a₃, b₃, and c₃ are arbitrary non-zero real numbers and d₃ is an arbitrary real number and in the formula 4, a₄, b₄, c₄, and d₄ are arbitrary non-zero real numbers and e₄ is an arbitrary real number.

Still another aspect of the present invention is the method of evaluating obesity, wherein when discriminating between the healthy state and the obesity at the discriminant value criterion discriminating step, the multivariate discriminant is a formula 5, a formula 6, the logistic regression equation with Glu, Ser, Cit, Ala, Tyr, and Trp as the explanatory variables, the logistic regression equation with Glu, Ser, Ala, Tyr, Trp, Val, Leu, and Ile as the explanatory variables, the linear discriminant with Glu, Thr, Ala, Tyr, Orn, and Lys as the explanatory variables, or the linear discriminant with Glu, Pro, His, Cit, Orn, and Lys as the explanatory variables:

a₅(Glu/Ser)+b₅(Cit/Ala)+c₅(Trp/Tyr)+d₅ (formula 5)

a₆(Glu/Gly)+b₆(Ser/Ala)+c₆(Trp/Tyr)+d₆((Val+Leu+Ile)/Asn)+e₆ (formula 6)

wherein in the formula 5, a₅, b₅, and c₅ are arbitrary non-zero real numbers and d₅ is an arbitrary real number and in the formula 6, a₆, b₆, c₆, and d₆ are arbitrary non-zero real numbers and e₆ is an arbitrary real number.

Still another aspect of the present invention is the method of evaluating obesity, wherein when discriminating between the apparent obesity and the non-apparent obesity at the discriminant value criterion discriminating step, the multivariate discriminant is a formula 7, a formula 8, the logistic regression equation with Glu, Thr, Ala, Arg, Tyr, and Lys as the explanatory variables, the logistic regression equation with Pro, Gly, Gln, Ala, Orn, Val, Leu, and Ile as the explanatory variables, the linear discriminant with His, Thr, Ala, Tyr, Orn, and Phe as the explanatory variables, or the linear discriminant with Ser, Pro, Gly, Cit, Lys, and Phe as the explanatory variables:

a₇(Thr/Tyr)+b₇(Ala/Ile)+c₇(Arg/Gln)+d₇ (formula 7)

a₈(Pro/(Val+Leu+Ile))+b₈(Gly/Orn)+c₈(Gln/Ala)+d₈(ABA/Thr)+e₈ (formula 8)

wherein in the formula 7, a₇, b₇, and c₇ are arbitrary non-zero real numbers and d₇ is an arbitrary real number and in the formula 8, a₈, b₈, c₈, and d₈ are arbitrary non-zero real numbers and e₈ is an arbitrary real number.

Still another aspect of the present invention is the method of evaluating obesity, wherein when discriminating between the apparent obesity and the obesity at the discriminant value criterion discriminating step, the multivariate discriminant is a formula 9, a formula 10, the logistic regression equation with Glu, Asn, Gly, His, Leu, and Trp as the explanatory variables, the logistic regression equation with Glu, Ala, ABA, Met, Lys, Val, Leu, and Ile as the explanatory variables, the linear discriminant with Glu, Gly, His, Ala, and Lys as the explanatory variables, or the linear discriminant with Glu, Thr, Ala, ABA, Lys, Val, Leu, and Ile as the explanatory variables:

a₉(Gly/Glu)+b₉(His/Trp)+c₉(Leu/Gln)+d₉ (formula 9)

a₁₀(Glu/Asn)+b₁₀(ABA/Ser)+c₁₀(Lys/Gln)+d₁₀((Val+Leu+Ile)/Trp))+e₁₀ (formula 10)

wherein in the formula 9, a₉, b₉, and c₉ are arbitrary non-zero real numbers and d₉ is an arbitrary real number and in the formula 10, a₁₀, b₁₀, c₁₀, and d₁₀ are arbitrary non-zero real numbers and e₁₀ is an arbitrary real number.

Still another aspect of the present invention is the method of evaluating obesity, wherein when discriminating between the non-apparent obesity and the obesity at the discriminant value criterion discriminating step, the multivariate discriminant is a formula 11, a formula 12, the logistic regression equation with Glu, Gly, Cit, Tyr, Val, and Phe as the explanatory variables, the logistic regression equation with Glu, Pro, Cit, Tyr, Phe, and Trp as the explanatory variables, the linear discriminant with Glu, Cit, Tyr, Orn, Met, and Trp as the explanatory variables, or the linear discriminant with Glu, Pro, His, Met, and Phe as the explanatory variables:

a₁₁(Glu/Gln)+b₁₁(Tyr/Gly)+c₁₁(Lys/Trp)+d₁₁ (formula 11)

a₁₂(Glu/Asn)+b₁₂(His/Thr)+c₁₂(Phe/Cit)+d₁₂(Trp/Tyr)+e₁₂ (formula 12)

wherein in the formula 11, a₁₁, b₁₁, and c₁₁ are arbitrary non-zero real numbers and d₁₁ is an arbitrary real number and in the formula 12, a₁₂, b₁₂, c₁₂, and d₁₂ are arbitrary non-zero real numbers and e₁₂ is an arbitrary real number.

Still another aspect of the present invention is the method of evaluating obesity, wherein when discriminating between the healthy state or the apparent obesity and the non-apparent obesity or the obesity at the discriminant value criterion discriminating step, the multivariate discriminant is a formula 13, the logistic regression equation with Glu, Gly, Ala, Tyr, Trp, Val, Leu, and Ile as the explanatory variables, or the linear discriminant with Glu, Ala, Arg, Tyr, Orn, Val, Leu, and Ile as the explanatory variables:

a₁₃(Glu/Asn)+b₁₃(Ser/Ala)+c₁₃(Cit/Phe)+d₁₃(Tyr/Trp)+e₁₃ (formula 13)

wherein in the formula 13, a₁₃, b₁₃, c₁₃, and d₁₃ are arbitrary non-zero real numbers and e₁₃ is an arbitrary real number.

An obesity-evaluating apparatus according to one aspect of the present invention includes a control unit and a memory unit to evaluate a state of at least one of an apparent obesity, a non-apparent obesity, and an obesity that are defined by BMI (Body Mass Index) and VFA (Visceral Fat Area) in a subject to be evaluated. The control unit includes (I) a discriminant value-calculating unit that calculates a discriminant value that is a value of a multivariate discriminant with a concentration of an amino acid as an explanatory variable, based on both (i) a concentration value of at least one of Glu, Ser, Pro, Gly, Ala, Cys2, Tyr, Val, Orn, Met, Lys, Ile, Leu, Phe, and Trp contained in previously obtained amino acid concentration data of the subject on the concentration value of the amino acid and (ii) the multivariate discriminant stored in the memory unit, and (II) a discriminant value criterion-evaluating unit that evaluates the state of at least one of the apparent obesity, the non-apparent obesity, and the obesity in the subject based on the discriminant value calculated by the discriminant value-calculating unit. The multivariate discriminant contains at least one of Glu, Ser, Pro, Gly, Ala, Cys2, Tyr, Val, Orn, Met, Lys, Ile, Leu, Phe, and Trp as the explanatory variable.

Another aspect of the present invention is the obesity-evaluating apparatus, wherein the discriminant value criterion-evaluating unit further includes a discriminant value criterion-discriminating unit that discriminates between a healthy state defined by the BMI and the VFA and the apparent obesity, between the healthy state and the non-apparent obesity, between the healthy state and the obesity, between the apparent obesity and the non-apparent obesity, between the apparent obesity and the obesity, between the non-apparent obesity and the obesity, or between the healthy state or the apparent obesity and the non-apparent obesity or the obesity in the subject, based on the discriminant value calculated by the discriminant value-calculating unit.

Still another aspect of the present invention is the obesity-evaluating apparatus, wherein the multivariate discriminant is any one of a fractional expression, the sum of a plurality of the fractional expressions, a logistic regression equation, a linear discriminant, a multiple regression equation, a discriminant prepared by a support vector machine, a discriminant prepared by a Mahalanobis' generalized distance method, a discriminant prepared by canonical discriminant analysis, and a discriminant prepared by a decision tree.

Still another aspect of the present invention is the obesity-evaluating apparatus, wherein when discriminating between the healthy state and the apparent obesity by the discriminant value criterion discriminating unit, the multivariate discriminant is a formula 1, a formula 2, the logistic regression equation with Glu, Thr, and Phe as the explanatory variables, the logistic regression equation with Pro, Asn, Thr, Arg, Tyr, and Orn as the explanatory variables, the linear discriminant with His, Thr, Val, Orn, and Trp as the explanatory variables, or the linear discriminant with Ser, Pro, Asn, Orn, Phe, Val, Leu, and Ile as the explanatory variables:

a₁(Glu/Gly)+b₁(His/Ile)+c₁(Thr/Phe)+d₁ (formula 1)

a₂(Pro/Ser)+b₂(Thr/Asn)+c₂(Arg/Tyr)+d₂(Orn/Gln)+e₂ (formula 2)

wherein in the formula 1, a₁, b₁, and c₁ are arbitrary non-zero real numbers and d₁ is an arbitrary real number and in the formula 2, a₂, b₂, c₂, and d₂ are arbitrary non-zero real numbers and e₂ is an arbitrary real number.

Still another aspect of the present invention is the obesity-evaluating apparatus, wherein when discriminating between the healthy state and the non-apparent obesity by the discriminant value criterion discriminating unit, the multivariate discriminant is a formula 3, a formula 4, the logistic regression equation with Glu, Ser, Ala, Orn, Leu, and Trp as the explanatory variables, the logistic regression equation with Glu, Ser, Gly, Cit, Ala, Val, Leu, and Ile as the explanatory variables, the linear discriminant with Glu, Ser, His, Thr, Lys, and Phe as the explanatory variables, or the linear discriminant with Glu, His, ABA, Tyr, Met, and Lys as the explanatory variables:

a₃(Ser/Ala)+b₃(Gly/Tyr)+c₃(Trp/Glu)+d₃ (formula 3)

a₄(Ser/Cit)+b₄(Gly/(Val+Leu+Ile))+c₄(Gln/Ala)+d₄(Thr/Glu)+e₄ (formula 4)

wherein in the formula 3, a₃, b₃, and c₃ are arbitrary non-zero real numbers and d₃ is an arbitrary real number and in the formula 4, a₄, b₄, c₄, and d₄ are arbitrary non-zero real numbers and e₄ is an arbitrary real number.

Still another aspect of the present invention is the obesity-evaluating apparatus, wherein when discriminating between the healthy state and the obesity by the discriminant value criterion discriminating unit, the multivariate discriminant is a formula 5, a formula 6, the logistic regression equation with Glu, Ser, Cit, Ala, Tyr, and Trp as the explanatory variables, the logistic regression equation with Glu, Ser, Ala, Tyr, Trp, Val, Leu, and Ile as the explanatory variables, the linear discriminant with Glu, Thr, Ala, Tyr, Orn, and Lys as the explanatory variables, or the linear discriminant with Glu, Pro, His, Cit, Orn, and Lys as the explanatory variables:

a₅(Glu/Ser)+b₅(Cit/Ala)+c₅(Trp/Tyr)+d₅ (formula 5)

a₆(Glu/Gly)+b₆(Ser/Ala)+c₆(Trp/Tyr)+d₆((Val+Leu+Ile)/Asn)+e₆ (formula 6)

wherein in the formula 5, a₅, b₅, and c₅ are arbitrary non-zero real numbers and d₅ is an arbitrary real number and in the formula 6, a₆, b₆, c₆, and d₆ are arbitrary non-zero real numbers and e₆ is an arbitrary real number.

Still another aspect of the present invention is the obesity-evaluating apparatus, wherein when discriminating between the apparent obesity and the non-apparent obesity by the discriminant value criterion discriminating unit, the multivariate discriminant is a formula 7, a formula 8, the logistic regression equation with Glu, Thr, Ala, Arg, Tyr, and Lys as the explanatory variables, the logistic regression equation with Pro, Gly, Gln, Ala, Orn, Val, Leu, and Ile as the explanatory variables, the linear discriminant with His, Thr, Ala, Tyr, Orn, and Phe as the explanatory variables, or the linear discriminant with Ser, Pro, Gly, Cit, Lys, and Phe as the explanatory variables:

a₇(Thr/Tyr)+b₇(Ala/Ile)+c₇(Arg/Gln)+d₇ (formula 7)

a₈(Pro/(Val+Leu+Ile))+b₈(Gly/Orn)+c₈(Gln/Ala)+d₈(ABA/Thr)+e₈ (formula 8)

wherein in the formula 7, a₇, b₇, and c₇ are arbitrary non-zero real numbers and d₇ is an arbitrary real number and in the formula 8, a₈, b₈, c₈, and d₈ are arbitrary non-zero real numbers and e₈ is an arbitrary real number.

Still another aspect of the present invention is the obesity-evaluating apparatus, wherein when discriminating between the apparent obesity and the obesity by the discriminant value criterion discriminating unit, the multivariate discriminant is a formula 9, a formula 10, the logistic regression equation with Glu, Asn, Gly, His, Leu, and Trp as the explanatory variables, the logistic regression equation with Glu, Ala, ABA, Met, Lys, Val, Leu, and Ile as the explanatory variables, the linear discriminant with Glu, Gly, His, Ala, and Lys as the explanatory variables, or the linear discriminant with Glu, Thr, Ala, ABA, Lys, Val, Leu, and Ile as the explanatory variables:

a₉(Gly/Glu)+b₉(His/Trp)+c₉(Leu/Gln)+d₉ (formula 9)

a₁₀(Glu/Asn)+b₁₀(ABA/Ser)+c₁₀(Lys/Gln)+d₁₀((Val+Leu+Ile)/Trp))+e₁₀ (formula 10)

wherein in the formula 9, a₉, b₉, and c₉ are arbitrary non-zero real numbers and d₉ is an arbitrary real number and in the formula 10, a₁₀, b₁₀, c₁₀, and d₁₀ are arbitrary non-zero real numbers and e₁₀ is an arbitrary real number.

Still another aspect of the present invention is the obesity-evaluating apparatus, wherein when discriminating between the non-apparent obesity and the obesity by the discriminant value criterion discriminating unit, the multivariate discriminant is a formula 11, a formula 12, the logistic regression equation with Glu, Gly, Cit, Tyr, Val, and Phe as the explanatory variables, the logistic regression equation with Glu, Pro, Cit, Tyr, Phe, and Trp as the explanatory variables, the linear discriminant with Glu, Cit, Tyr, Orn, Met, and Trp as the explanatory variables, or the linear discriminant with Glu, Pro, His, Met, and Phe as the explanatory variables:

a₁₁(Glu/Gln)+b₁₁(Tyr/Gly)+c₁₁(Lys/Trp)+d₁₁ (formula 11)

a₁₂(Glu/Asn)+b₁₂(His/Thr)+c₁₂(Phe/Cit)+d₁₂(Trp/Tyr)+e₁₂ (formula 12)

wherein in the formula 11, a₁₁, b₁₁, and c₁₁ are arbitrary non-zero real numbers and d₁₁ is an arbitrary real number and in the formula 12, a₁₂, b₁₂, c₁₂, and d₁₂ are arbitrary non-zero real numbers and e₁₂ is an arbitrary real number.

Still another aspect of the present invention is the obesity-evaluating apparatus, wherein when discriminating between the healthy state or the apparent obesity and the non-apparent obesity or the obesity by the discriminant value criterion discriminating unit, the multivariate discriminant is a formula 13, the logistic regression equation with Glu, Gly, Ala, Tyr, Trp, Val, Leu, and Ile as the explanatory variables, or the linear discriminant with Glu, Ala, Arg, Tyr, Orn, Val, Leu, and Ile as the explanatory variables:

a₁₃(Glu/Asn)+b₁₃(Ser/Ala)+c₁₃(Cit/Phe)+d₁₃(Tyr/Trp)+e₁₃ (formula 13)

wherein in the formula 13, a₁₃, b₁₃, c₁₃, and d₁₃ are arbitrary non-zero real numbers and e₁₃ is an arbitrary real number.

Still another aspect of the present invention is the obesity-evaluating apparatus, wherein the control unit further includes a multivariate discriminant-preparing unit that prepares the multivariate discriminant stored in the memory unit, based on obesity state information containing the amino acid concentration data and obesity state index data on an index for indicating the state of at least one of the apparent obesity, the non-apparent obesity, and the obesity, stored in the memory unit. The multivariate discriminant-preparing unit further includes (i) a candidate multivariate discriminant-preparing unit that prepares a candidate multivariate discriminant that is a candidate of the multivariate discriminant, based on a predetermined discriminant-preparing method from the obesity state information, (ii) a candidate multivariate discriminant-verifying unit that verifies the candidate multivariate discriminant prepared by the candidate multivariate discriminant-preparing unit, based on a predetermined verifying method, and (iii) an explanatory variable-selecting unit that selects the explanatory variable of the candidate multivariate discriminant based on a predetermined explanatory variable-selecting method from a verification result obtained by the candidate multivariate discriminant-verifying unit, thereby selecting a combination of the amino acid concentration data contained in the obesity state information used in preparing the candidate multivariate discriminant. The multivariate discriminant-preparing unit prepares the multivariate discriminant by selecting the candidate multivariate discriminant used as the multivariate discriminant, from a plurality of the candidate multivariate discriminants, based on the verification results accumulated by repeatedly executing the candidate multivariate discriminant-preparing unit, the candidate multivariate discriminant-verifying unit, and the explanatory variable-selecting unit.

An obesity-evaluating method according to one aspect of the present invention is a method of evaluating a state of at least one of an apparent obesity, a non-apparent obesity, and an obesity that are defined by BMI (Body Mass Index) and VFA (Visceral Fat Area) in a subject to be evaluated. The method is carried out with an information processing apparatus including a control unit and a memory unit. The method includes (I) a discriminant value calculating step of calculating a discriminant value that is a value of a multivariate discriminant with a concentration of an amino acid as an explanatory variable, based on both (i) a concentration value of at least one of Glu, Ser, Pro, Gly, Ala, Cys2, Tyr, Val, Orn, Met, Lys, Ile, Leu, Phe, and Trp contained in previously obtained amino acid concentration data of the subject on the concentration value of the amino acid and (ii) the multivariate discriminant stored in the memory unit, and (II) a discriminant value criterion evaluating step of evaluating the state of at least one of the apparent obesity, the non-apparent obesity, and the obesity in the subject based on the discriminant value calculated at the discriminant value calculating step. The multivariate discriminant contains at least one of Glu, Ser, Pro, Gly, Ala, Cys2, Tyr, Val, Orn, Met, Lys, Ile, Leu, Phe, and Trp as the explanatory variable. The steps (I) and (II) are executed by the control unit.

Another aspect of the present invention is the obesity-evaluating method, wherein the discriminant value criterion evaluating step further includes a discriminant value criterion discriminating step of discriminating between a healthy state defined by the BMI and the VFA and the apparent obesity, between the healthy state and the non-apparent obesity, between the healthy state and the obesity, between the apparent obesity and the non-apparent obesity, between the apparent obesity and the obesity, between the non-apparent obesity and the obesity, or between the healthy state or the apparent obesity and the non-apparent obesity or the obesity in the subject, based on the discriminant value calculated at the discriminant value calculating step.

Still another aspect of the present invention is the obesity-evaluating method, wherein the multivariate discriminant is any one of a fractional expression, the sum of a plurality of the fractional expressions, a logistic regression equation, a linear discriminant, a multiple regression equation, a discriminant prepared by a support vector machine, a discriminant prepared by a Mahalanobis' generalized distance method, a discriminant prepared by canonical discriminant analysis, and a discriminant prepared by a decision tree.

Still another aspect of the present invention is the obesity-evaluating method, wherein when discriminating between the healthy state and the apparent obesity at the discriminant value criterion discriminating step, the multivariate discriminant is a formula 1, a formula 2, the logistic regression equation with Glu, Thr, and Phe as the explanatory variables, the logistic regression equation with Pro, Asn, Thr, Arg, Tyr, and Orn as the explanatory variables, the linear discriminant with His, Thr, Val, Orn, and Trp as the explanatory variables, or the linear discriminant with Ser, Pro, Asn, Orn, Phe, Val, Leu, and Ile as the explanatory variables:

a₁(Glu/Gly)+b₁(His/Ile)+c₁(Thr/Phe)+d₁ (formula 1)

a₂(Pro/Ser)+b₂(Thr/Asn)+c₂(Arg/Tyr)+d₂(Orn/Gln)+e₂ (formula 2)

wherein in the formula 1, a₁, b₁, and c₁ are arbitrary non-zero real numbers and d₁ is an arbitrary real number and in the formula 2, a₂, b₂, c₂, and d₂ are arbitrary non-zero real numbers and e₂ is an arbitrary real number.

Still another aspect of the present invention is the obesity-evaluating method, wherein when discriminating between the healthy state and the non-apparent obesity at the discriminant value criterion discriminating step, the multivariate discriminant is a formula 3, a formula 4, the logistic regression equation with Glu, Ser, Ala, Orn, Leu, and Trp as the explanatory variables, the logistic regression equation with Glu, Ser, Gly, Cit, Ala, Val, Leu, and Ile as the explanatory variables, the linear discriminant with Glu, Ser, His, Thr, Lys, and Phe as the explanatory variables, or the linear discriminant with Glu, His, ABA, Tyr, Met, and Lys as the explanatory variables:

a₃(Ser/Ala)+b₃(Gly/Tyr)+c₃(Trp/Glu)+d₃ (formula 3)

a₄(Ser/Cit)+b₄(Gly/(Val+Leu+Ile))+c₄(Gln/Ala)+d₄(Thr/Glu)+e₄ (formula 4)

wherein in the formula 3, a₃, b₃, and c₃ are arbitrary non-zero real numbers and d₃ is an arbitrary real number and in the formula 4, a₄, b₄, c₄, and d₄ are arbitrary non-zero real numbers and e₄ is an arbitrary real number.

Still another aspect of the present invention is the obesity-evaluating method, wherein when discriminating between the healthy state and the obesity at the discriminant value criterion discriminating step, the multivariate discriminant is a formula 5, a formula 6, the logistic regression equation with Glu, Ser, Cit, Ala, Tyr, and Trp as the explanatory variables, the logistic regression equation with Glu, Ser, Ala, Tyr, Trp, Val, Leu, and Ile as the explanatory variables, the linear discriminant with Glu, Thr, Ala, Tyr, Orn, and Lys as the explanatory variables, or the linear discriminant with Glu, Pro, His, Cit, Orn, and Lys as the explanatory variables:

a₅(Glu/Ser)+b₅(Cit/Ala)+c₅(Trp/Tyr)+d₅ (formula 5)

a₆(Glu/Gly)+b₆(Ser/Ala)+c₆(Trp/Tyr)+d₆((Val+Leu+Ile)/Asn)+e₆ (formula 6)

wherein in the formula 5, a₅, b₅, and c₅ are arbitrary non-zero real numbers and d₅ is an arbitrary real number and in the formula 6, a₆, b₆, c₆, and d₆ are arbitrary non-zero real numbers and e₆ is an arbitrary real number.

Still another aspect of the present invention is the obesity-evaluating method, wherein when discriminating between the apparent obesity and the non-apparent obesity at the discriminant value criterion discriminating step, the multivariate discriminant is a formula 7, a formula 8, the logistic regression equation with Glu, Thr, Ala, Arg, Tyr, and Lys as the explanatory variables, the logistic regression equation with Pro, Gly, Gln, Ala, Orn, Val, Leu, and Ile as the explanatory variables, the linear discriminant with His, Thr, Ala, Tyr, Orn, and Phe as the explanatory variables, or the linear discriminant with Ser, Pro, Gly, Cit, Lys, and Phe as the explanatory variables:

a₇(Thr/Tyr)+b₇(Ala/Ile)+c₇(Arg/Gln)+d₇ (formula 7)

a₈(Pro/(Val+Leu+Ile))+b₈(Gly/Orn)+c₈(Gln/Ala)+d₈(ABA/Thr)+e₈ (formula 8)

wherein in the formula 7, a₇, b₇, and c₇ are arbitrary non-zero real numbers and d₇ is an arbitrary real number and in the formula 8, a₈, b₈, c₈, and d₈ are arbitrary non-zero real numbers and e₈ is an arbitrary real number.

Still another aspect of the present invention is the obesity-evaluating method, wherein when discriminating between the apparent obesity and the obesity at the discriminant value criterion discriminating step, the multivariate discriminant is a formula 9, a formula 10, the logistic regression equation with Glu, Asn, Gly, His, Leu, and Trp as the explanatory variables, the logistic regression equation with Glu, Ala, ABA, Met, Lys, Val, Leu, and Ile as the explanatory variables, the linear discriminant with Glu, Gly, His, Ala, and Lys as the explanatory variables, or the linear discriminant with Glu, Thr, Ala, ABA, Lys, Val, Leu, and Ile as the explanatory variables:

a₉(Gly/Glu)+b₉(His/Trp)+c₉(Leu/Gln)+d₉ (formula 9)

a₁₀(Glu/Asn)+b₁₀(ABA/Ser)+c₁₀(Lys/Gln)+d₁₀((Val+Leu+Ile)/Trp))+e₁₀ (formula 10)

wherein in the formula 9, a₉, b₉, and c₉ are arbitrary non-zero real numbers and d₉ is an arbitrary real number and in the formula 10, a₁₀, b₁₀, c₁₀, and d₁₀ are arbitrary non-zero real numbers and e₁₀ is an arbitrary real number.

Still another aspect of the present invention is the obesity-evaluating method, wherein when discriminating between the non-apparent obesity and the obesity at the discriminant value criterion discriminating step, the multivariate discriminant is a formula 11, a formula 12, the logistic regression equation with Glu, Gly, Cit, Tyr, Val, and Phe as the explanatory variables, the logistic regression equation with Glu, Pro, Cit, Tyr, Phe, and Trp as the explanatory variables, the linear discriminant with Glu, Cit, Tyr, Orn, Met, and Trp as the explanatory variables, or the linear discriminant with Glu, Pro, His, Met, and Phe as the explanatory variables:

a₁₁(Glu/Gln)+b₁₁(Tyr/Gly)+c₁₁(Lys/Trp)+d₁₁ (formula 11)

a₁₂(Glu/Asn)+b₁₂(His/Thr)+c₁₂(Phe/Cit)+d₁₂(Trp/Tyr)+e₁₂ (formula 12)

wherein in the formula 11, a₁₁, b₁₁, and c₁₁ are arbitrary non-zero real numbers and d₁₁ is an arbitrary real number and in the formula 12, a₁₂, b₁₂, c₁₂, and d₁₂ are arbitrary non-zero real numbers and e₁₂ is an arbitrary real number.

Still another aspect of the present invention is the obesity-evaluating method, wherein when discriminating between the healthy state or the apparent obesity and the non-apparent obesity or the obesity at the discriminant value criterion discriminating step, the multivariate discriminant is a formula 13, the logistic regression equation with Glu, Gly, Ala, Tyr, Trp, Val, Leu, and Ile as the explanatory variables, or the linear discriminant with Glu, Ala, Arg, Tyr, Orn, Val, Leu, and Ile as the explanatory variables:

a₁₃(Glu/Asn)+b₁₃(Ser/Ala)+c₁₃(Cit/Phe)+d₁₃(Tyr/Trp)+e₁₃ (formula 13)

wherein in the formula 13, a₁₃, b₁₃, c₁₃, and d₁₃ are arbitrary non-zero real numbers and e₁₃ is an arbitrary real number.

Still another aspect of the present invention is the obesity-evaluating method, wherein the method further includes a multivariate discriminant preparing step of preparing the multivariate discriminant stored in the memory unit, based on obesity state information containing the amino acid concentration data and obesity state index date on an index for indicating the state of at least one of the apparent obesity, the non-apparent obesity, and the obesity, stored in the memory unit. The multivariate discriminant preparing step is executed by the control unit. The multivariate discriminant preparing step further includes (i) a candidate multivariate discriminant preparing step of preparing a candidate multivariate discriminant that is a candidate of the multivariate discriminant, based on a predetermined discriminant-preparing method from the obesity state information, (ii) a candidate multivariate discriminant verifying step of verifying the candidate multivariate discriminant prepared at the candidate multivariate preparing step, based on a predetermined verifying method, and (iii) an explanatory variable selecting step of selecting the explanatory variable of the candidate multivariate discriminant based on a predetermined explanatory variable-selecting method from a verification result obtained at the candidate multivariate discriminant verifying step, thereby selecting a combination of the amino acid concentration data contained in the obesity state information used in preparing the candidate multivariate discriminant. At the multivariate discriminant preparing step, the multivariate discriminant is prepared by selecting the candidate multivariate discriminant used as the multivariate discriminant, from a plurality of the candidate multivariate discriminants, based on the verification results accumulated by repeatedly executing the candidate multivariate discriminant preparing step, the candidate multivariate discriminant verifying step, and the explanatory variable selecting step.

An obesity-evaluating system according to one aspect of the present invention includes (i) an obesity-evaluating apparatus including a control unit and a memory unit to evaluate a state of at least one of an apparent obesity, a non-apparent obesity, and an obesity that are defined by BMI (Body Mass Index) and VFA (Visceral Fat Area) in a subject to be evaluated, and (ii) an information communication terminal apparatus that provides amino acid concentration data of the subject on a concentration value of an amino acid. The apparatuses are connected to each other communicatively via a network. The information communication terminal apparatus includes an amino acid concentration data-sending unit that transmits the amino acid concentration data of the subject to the obesity-evaluating apparatus, and an evaluation result-receiving unit that receives an evaluation result of the subject on the state of at least one of the apparent obesity, the non-apparent obesity, and the obesity transmitted from the obesity-evaluating apparatus. The control unit of the obesity-evaluating apparatus includes (I) an amino acid concentration data-receiving unit that receives the amino acid concentration data of the subject transmitted from the information communication terminal apparatus, (II) a discriminant value-calculating unit that calculates a discriminant value that is a value of a multivariate discriminant with a concentration of the amino acid as an explanatory variable, based on both (i) the concentration value of at least one of Glu, Ser, Pro, Gly, Ala, Cys2, Tyr, Val, Orn, Met, Lys, Ile, Leu, Phe, and Trp contained in the amino acid concentration data of the subject received by the amino acid concentration data-receiving unit and (ii) the multivariate discriminant stored in the memory unit, (III) a discriminant value criterion-evaluating unit that evaluates the state of at least one of the apparent obesity, the non-apparent obesity, and the obesity in the subject based on the discriminant value calculated by the discriminant value-calculating unit, and (IV) an evaluation result-sending unit that transmits the evaluation result of the subject obtained by the discriminant value criterion-evaluating unit to the information communication terminal apparatus. The multivariate discriminant contains at least one of Glu, Ser, Pro, Gly, Ala, Cys2, Tyr, Val, Orn, Met, Lys, Ile, Leu, Phe, and Trp as the explanatory variable.

An obesity-evaluating program product according to one aspect of the present invention has a non-transitory computer readable medium including programmed instructions for making an information processing apparatus including a control unit and a memory unit execute a method of evaluating a state of at least one of an apparent obesity, a non-apparent obesity, and an obesity that are defined by BMI (Body Mass Index) and VFA (Visceral Fat Area) in a subject to be evaluated. The method includes (I) a discriminant value calculating step of calculating a discriminant value that is a value of a multivariate discriminant with a concentration of an amino acid as an explanatory variable, based on both (i) a concentration value of at least one of Glu, Ser, Pro, Gly, Ala, Cys2, Tyr, Val, Orn, Met, Lys, Ile, Leu, Phe, and Trp contained in previously obtained amino acid concentration data of the subject on the concentration value of the amino acid and (ii) the multivariate discriminant stored in the memory unit, and (II) a discriminant value criterion evaluating step of evaluating the state of at least one of the apparent obesity, the non-apparent obesity, and the obesity in the subject based on the discriminant value calculated at the discriminant value calculating step. The multivariate discriminant contains at least one of Glu, Ser, Pro, Gly, Ala, Cys2, Tyr, Val, Orn, Met, Lys, Ile, Leu, Phe, and Trp as the explanatory variable. The steps (I) and (II) are executed by the control unit.

The present invention also relates to a non-transitory computer-readable recording medium, the recording medium according to one aspect of the present invention includes the obesity-evaluating program product described above.

The present invention also relates to an information communication terminal apparatus. The information communication terminal apparatus provides amino acid concentration data of a subject to be evaluated on a concentration value of an amino acid, being communicatively via a network to an obesity-evaluating apparatus including a control unit and a memory unit to evaluate a state of at least one of an apparent obesity, a non-apparent obesity, and an obesity that are defined by BMI (Body Mass Index) and VFA (Visceral Fat Area) in the subject. The information communication terminal apparatus includes an amino acid concentration data-sending unit that transmits the amino acid concentration data of the subject to the obesity-evaluating apparatus, and an evaluation result-receiving unit that receives the evaluation result of the subject on the state of at least one of the apparent obesity, the non-apparent obesity, and the obesity transmitted from the obesity-evaluating apparatus. The evaluation result is the result of (I) receiving the amino acid concentration data of the subject transmitted from the information communication terminal apparatus, (II) calculating a discriminant value that is a value of a multivariate discriminant with a concentration of the amino acid as an explanatory variable, based on both (i) the concentration value of at least one of Glu, Ser, Pro, Gly, Ala, Cys2, Tyr, Val, Orn, Met, Lys, Ile, Leu, Phe, and Trp contained in the received amino acid concentration data of the subject and (ii) the multivariate discriminant stored in the memory unit, and (III) evaluating the state of at least one of the apparent obesity, the non-apparent obesity, and the obesity in the subject based on the calculated discriminant value. The multivariate discriminant contains at least one of Glu, Ser, Pro, Gly, Ala, Cys2, Tyr, Val, Orn, Met, Lys, Ile, Leu, Phe, and Trp as the explanatory variable.

The present invention also relates to an obesity-evaluating apparatus including a control unit and a memory unit to evaluate a state of at least one of an apparent obesity, a non-apparent obesity, and an obesity that are defined by BMI (Body Mass Index) and VFA (Visceral Fat Area) in a subject to be evaluated, being communicatively via a network to an information communication terminal apparatus that provides amino acid concentration data of the subject on a concentration value of an amino acid. The control unit includes (I) an amino acid concentration data-receiving unit that receives the amino acid concentration data of the subject transmitted from the information communication terminal apparatus, (II) a discriminant value-calculating unit that calculates a discriminant value that is a value of a multivariate discriminant with a concentration of the amino acid as an explanatory variable, based on both (i) the concentration value of at least one of Glu, Ser, Pro, Gly, Ala, Cys2, Tyr, Val, Orn, Met, Lys, Ile, Leu, Phe, and Trp contained in the amino acid concentration data of the subject received by the amino acid concentration data-receiving unit and (ii) the multivariate discriminant stored in the memory unit, (III) a discriminant value criterion-evaluating unit that evaluates the state of at least one of the apparent obesity, the non-apparent obesity, and the obesity in the subject based on the discriminant value calculated by the discriminant value-calculating unit, and (IV) an evaluation result-sending unit that transmits the evaluation result of the subject obtained by the discriminant value criterion-evaluating unit to the information communication terminal apparatus. The multivariate discriminant contains at least one of Glu, Ser, Pro, Gly, Ala, Cys2, Tyr, Val, Orn, Met, Lys, Ile, Leu, Phe, and Trp as the explanatory variable.

According to the present invention, (i) the amino acid concentration data on the concentration value of the amino acid in blood collected from the subject is obtained, and (ii) the state of at least one of the apparent obesity, the non-apparent obesity, and the obesity that are defined by the BMI and the VFA in the subject is evaluated based on the concentration value of at least one of Glu, Ser, Pro, Gly, Ala, Cys2, Tyr, Val, Orn, Met, Lys, Ile, Leu, Phe, and Trp contained in the obtained amino acid concentration data of the subject. Thus, the concentrations of the amino acids which among amino acids in blood, are related to the state of the apparent obesity, the non-apparent obesity, or the obesity defined by the BMI and the VFA can be utilized to bring about the effect of enabling an accurate evaluation of the state of the apparent obesity, the non-apparent obesity, or the obesity.

According to the present invention, the discrimination between the healthy state defined by the BMI and the VFA and the apparent obesity, between the healthy state and the non-apparent obesity, between the healthy state and the obesity, between the apparent obesity and the non-apparent obesity, between the apparent obesity and the obesity, between the non-apparent obesity and the obesity, or between the healthy state or the apparent obesity and the non-apparent obesity or the obesity in the subject is conducted based on the concentration value of at least one of Glu, Ser, Pro, Gly, Ala, Cys2, Tyr, Val, Orn, Met, Lys, Ile, Leu, Phe, and Trp contained in the obtained amino acid concentration data of the subject. Thus, the concentrations of the amino acids which among amino acids in blood, are useful for the 2-group discrimination of the healthy state and the apparent obesity, the 2-group discrimination of the healthy state and the non-apparent obesity, the 2-group discrimination of the healthy state and the obesity, the 2-group discrimination of the apparent obesity and the non-apparent obesity, the 2-group discrimination of the apparent obesity and the obesity, the 2-group discrimination of the non-apparent obesity and the obesity, or the 2-group discrimination of the healthy state or the apparent obesity and the non-apparent obesity or the obesity, can be utilized to bring about the effect of enabling accurately these 2-group discriminations.

According to the present invention, (I) the discriminant value that is the value of the multivariate discriminant with the concentration of the amino acid as the explanatory variable is calculated based on both (i) the concentration value of at least one of Glu, Ser, Pro, Gly, Ala, Cys2, Tyr, Val, Orn, Met, Lys, Ile, Leu, Phe, and Trp contained in the amino acid concentration data of the subject and (ii) the multivariate discriminant containing at least one of Glu, Ser, Pro, Gly, Ala, Cys2, Tyr, Val, Orn, Met, Lys, Ile, Leu, Phe, and Trp as the explanatory variable, and (II) the state of at least one of the apparent obesity, the non-apparent obesity, and the obesity in the subject is evaluated based on the calculated discriminant value. Thus, the discriminant values obtained in the multivariate discriminants correlated significantly with the state of the apparent obesity, the non-apparent obesity, or the obesity can be utilized to bring about the effect of enabling an accurate evaluation of the state of the apparent obesity, the non-apparent obesity, or the obesity.

According to the present invention, the discrimination between the healthy state defined by the BMI and the VFA and the apparent obesity, between the healthy state and the non-apparent obesity, between the healthy state and the obesity, between the apparent obesity and the non-apparent obesity, between the apparent obesity and the obesity, between the non-apparent obesity and the obesity, or between the healthy state or the apparent obesity and the non-apparent obesity or the obesity in the subject is conducted based on the calculated discriminant value. Thus, the discriminant values obtained in the multivariate discriminants useful for the 2-group discrimination of the healthy state and the apparent obesity, the 2-group discrimination of the healthy state and the non-apparent obesity, the 2-group discrimination of the healthy state and the obesity, the 2-group discrimination of the apparent obesity and the non-apparent obesity, the 2-group discrimination of the apparent obesity and the obesity, the 2-group discrimination of the non-apparent obesity and the obesity, or the 2-group discrimination of the healthy state or the apparent obesity and the non-apparent obesity or the obesity, can be utilized to bring about the effect of enabling accurately these 2-group discriminations.

According to the present invention, the multivariate discriminant is any one of a fractional expression, the sum of a plurality of the fractional expressions, a logistic regression equation, a linear discriminant, a multiple regression equation, a discriminant prepared by a support vector machine, a discriminant prepared by a Mahalanobis' generalized distance method, a discriminant prepared by canonical discriminant analysis, and a discriminant prepared by a decision tree. Thus, the discriminant values obtained in the multivariate discriminants useful for the 2-group discrimination of the healthy state and the apparent obesity, the 2-group discrimination of the healthy state and the non-apparent obesity, the 2-group discrimination of the healthy state and the obesity, the 2-group discrimination of the apparent obesity and the non-apparent obesity, the 2-group discrimination of the apparent obesity and the obesity, the 2-group discrimination of the non-apparent obesity and the obesity, or the 2-group discrimination of the healthy state or the apparent obesity and the non-apparent obesity or the obesity, can be utilized to bring about the effect of enabling more accurately these 2-group discriminations.

According to the present invention, when discriminating between the healthy state and the apparent obesity, the multivariate discriminant is a formula 1, a formula 2, the logistic regression equation with Glu, Thr, and Phe as the explanatory variables, the logistic regression equation with Pro, Asn, Thr, Arg, Tyr, and Orn as the explanatory variables, the linear discriminant with His, Thr, Val, Orn, and Trp as the explanatory variables, or the linear discriminant with Ser, Pro, Asn, Orn, Phe, Val, Leu, and Ile as the explanatory variables:

a₁(Glu/Gly)+b₁(His/Ile)+c₁(Thr/Phe)+d₁ (formula 1)

a₂(Pro/Ser)+b₂(Thr/Asn)+c₂(Arg/Tyr)+d₂(Orn/Gln)+e₂ (formula 2)

wherein in the formula 1, a₁, b₁, and c₁ are arbitrary non-zero real numbers and d₁ is an arbitrary real number and in the formula 2, a₂, b₂, c₂, and d₂ are arbitrary non-zero real numbers and e₂ is an arbitrary real number. Thus, the discriminant values obtained in the multivariate discriminants useful particularly for the 2-group discrimination of the healthy state and the apparent obesity, can be utilized to bring about the effect of enabling more accurately the 2-group discrimination.

According to the present invention, when discriminating between the healthy state and the non-apparent obesity, the multivariate discriminant is a formula 3, a formula 4, the logistic regression equation with Glu, Ser, Ala, Orn, Leu, and Trp as the explanatory variables, the logistic regression equation with Glu, Ser, Gly, Cit, Ala, Val, Leu, and Ile as the explanatory variables, the linear discriminant with Glu, Ser, His, Thr, Lys, and Phe as the explanatory variables, or the linear discriminant with Glu, His, ABA, Tyr, Met, and Lys as the explanatory variables:

a₃(Ser/Ala)+b₃(Gly/Tyr)+c₃(Trp/Glu)+d₃ (formula 3)

a₄(Ser/Cit)+b₄(Gly/(Val+Leu+Ile))+c₄(Gln/Ala)+d₄(Thr/Glu)+e₄ (formula 4)

wherein in the formula 3, a₃, b₃, and c₃ are arbitrary non-zero real numbers and d₃ is an arbitrary real number and in the formula 4, a₄, b₄, c₄, and d₄ are arbitrary non-zero real numbers and e₄ is an arbitrary real number. Thus, the discriminant values obtained in the multivariate discriminants useful particularly for the 2-group discrimination of the healthy state and the non-apparent obesity, can be utilized to bring about the effect of enabling more accurately the 2-group discrimination.

According to the present invention, when discriminating between the healthy state and the obesity, the multivariate discriminant is a formula 5, a formula 6, the logistic regression equation with Glu, Ser, Cit, Ala, Tyr, and Trp as the explanatory variables, the logistic regression equation with Glu, Ser, Ala, Tyr, Trp, Val, Leu, and Ile as the explanatory variables, the linear discriminant with Glu, Thr, Ala, Tyr, Orn, and Lys as the explanatory variables, or the linear discriminant with Glu, Pro, His, Cit, Orn, and Lys as the explanatory variables:

a₅(Glu/Ser)+b₅(Cit/Ala)+c₅(Trp/Tyr)+d₅ (formula 5)

a₆(Glu/Gly)+b₆(Ser/Ala)+c₆(Trp/Tyr)+d₆((Val+Leu+Ile)/Asn)+e₆ (formula 6)

wherein in the formula 5, a₅, b₅, and c₅ are arbitrary non-zero real numbers and d₅ is an arbitrary real number and in the formula 6, a₆, b₆, c₆, and d₆ are arbitrary non-zero real numbers and e₆ is an arbitrary real number. Thus, the discriminant values obtained in the multivariate discriminants useful particularly for the 2-group discrimination of the healthy state and the obesity, can be utilized to bring about the effect of enabling more accurately the 2-group discrimination.

According to the present invention, when discriminating between the apparent obesity and the non-apparent obesity, the multivariate discriminant is a formula 7, a formula 8, the logistic regression equation with Glu, Thr, Ala, Arg, Tyr, and Lys as the explanatory variables, the logistic regression equation with Pro, Gly, Gln, Ala, Orn, Val, Leu, and Ile as the explanatory variables, the linear discriminant with His, Thr, Ala, Tyr, Orn, and Phe as the explanatory variables, or the linear discriminant with Ser, Pro, Gly, Cit, Lys, and Phe as the explanatory variables:

a₇(Thr/Tyr)+b₇(Ala/Ile)+c₇(Arg/Gln)+d₇ (formula 7)

a₈(Pro/(Val+Leu+Ile))+b₈(Gly/Orn)+c₈(Gln/Ala)+d₈(ABA/Thr)+e₈ (formula 8)

wherein in the formula 7, a₇, b₇, and c₇ are arbitrary non-zero real numbers and d₇ is an arbitrary real number and in the formula 8, a₈, b₈, c₈, and d₈ are arbitrary non-zero real numbers and e₈ is an arbitrary real number. Thus, the discriminant values obtained in the multivariate discriminants useful particularly for the 2-group discrimination of the apparent obesity and the non-apparent obesity, can be utilized to bring about the effect of enabling more accurately the 2-group discrimination.

According to the present invention, when discriminating between the apparent obesity and the obesity, the multivariate discriminant is a formula 9, a formula 10, the logistic regression equation with Glu, Asn, Gly, His, Leu, and Trp as the explanatory variables, the logistic regression equation with Glu, Ala, ABA, Met, Lys, Val, Leu, and Ile as the explanatory variables, the linear discriminant with Glu, Gly, His, Ala, and Lys as the explanatory variables, or the linear discriminant with Glu, Thr, Ala, ABA, Lys, Val, Leu, and Ile as the explanatory variables:

a₉(Gly/Glu)+b₉(His/Trp)+c₉(Leu/Gln)+d₉ (formula 9)

a₁₀(Glu/Asn)+b₁₀(ABA/Ser)+c₁₀(Lys/Gin)+d₁₀((Val+Leu+Ile)/Trp))+e₁₀ (formula 10)

wherein in the formula 9, a₉, b₉, and c₉ are arbitrary non-zero real numbers and d₉ is an arbitrary real number and in the formula 10, a₁₀, b₁₀, c₁₀, and d₁₀ are arbitrary non-zero real numbers and e₁₀ is an arbitrary real number. Thus, the discriminant values obtained in the multivariate discriminants useful particularly for the 2-group discrimination of the apparent obesity and the obesity, can be utilized to bring about the effect of enabling more accurately the 2-group discrimination.

According to the present invention, when discriminating between the non-apparent obesity and the obesity, the multivariate discriminant is a formula 11, a formula 12, the logistic regression equation with Glu, Gly, Cit, Tyr, Val, and Phe as the explanatory variables, the logistic regression equation with Glu, Pro, Cit, Tyr, Phe, and Trp as the explanatory variables, the linear discriminant with Glu, Cit, Tyr, Orn, Met, and Trp as the explanatory variables, or the linear discriminant with Glu, Pro, His, Met, and Phe as the explanatory variables:

a₁₁(Glu/Gln)+b₁₁(Tyr/Gly)+c₁₁(Lys/Trp)+d₁₁ (formula 11)

a₁₂(Glu/Asn)+b₁₂(His/Thr)+c₁₂(Phe/Cit)+d₁₂(Trp/Tyr)+e₁₂ (formula 12)

wherein in the formula 11, a₁₁, b₁₁, and c₁₁ are arbitrary non-zero real numbers and d₁₁ is an arbitrary real number and in the formula 12, a₁₂, b₁₂, c₁₂, and d₁₂ are arbitrary non-zero real numbers and e₁₂ is an arbitrary real number. Thus, the discriminant values obtained in the multivariate discriminants useful particularly for the 2-group discrimination of the non-apparent obesity and the obesity, can be utilized to bring about the effect of enabling more accurately the 2-group discrimination.

According to the present invention, when discriminating between the healthy state or the apparent obesity and the non-apparent obesity or the obesity, the multivariate discriminant is a formula 13, the logistic regression equation with Glu, Gly, Ala, Tyr, Trp, Val, Leu, and Ile as the explanatory variables, or the linear discriminant with Glu, Ala, Arg, Tyr, Orn, Val, Leu, and Ile as the explanatory variables:

a₁₃(Glu/Asn)+b₁₃(Ser/Ala)+c₁₃(Cit/Phe)+d₁₃(Tyr/Trp)+e₁₃ (formula 13)

wherein in the formula 13, a₁₃, b₁₃, c₁₃, and d₁₃ are arbitrary non-zero real numbers and e₁₃ is an arbitrary real number. Thus, the discriminant values obtained in the multivariate discriminants useful particularly for the 2-group discrimination of the healthy state or the apparent obesity and the non-apparent obesity or the obesity, can be utilized to bring about the effect of enabling more accurately the 2-group discrimination.

According to the present invention, the multivariate discriminant stored in the memory unit is prepared based on the obesity state information containing the amino acid concentration data and the obesity state index data on the index for indicating the state of at least one of the apparent obesity, the non-apparent obesity, and the obesity, stored in the memory unit. Specifically, (1) the candidate multivariate discriminant is prepared based on the predetermined discriminant-preparing method from the obesity state information, (2) the prepared candidate multivariate discriminant is verified based on the predetermined verifying method, (3) the explanatory variables of the candidate multivariate discriminant are selected based on the predetermined explanatory variable-selecting method from the verification results, thereby selecting the combination of the amino acid concentration data contained in the obesity state information used in preparing of the candidate multivariate discriminant, and (4) the candidate multivariate discriminant used as the multivariate discriminant is selected from a plurality of the candidate multivariate discriminants based on the verification results accumulated by repeatedly executing (1), (2) and (3), thereby preparing the multivariate discriminant. Thus, the effect of being able to prepare the multivariate discriminant most appropriate for evaluating the state of the apparent obesity, the non-apparent obesity, or the obesity is brought about.

According to the present invention, the obesity-evaluating program recorded on the recording medium is read and executed by the computer, thereby allowing the computer to execute the obesity-evaluating program, thus bringing about the effect of obtaining the same effect as in the obesity-evaluating program.

When the state of the apparent obesity, the non-apparent obesity, or the obesity is evaluated in the present invention, another biological information (e.g., biological metabolites such as glucose, lipid, protein, peptide, mineral and hormone, and biological indices such as blood glucose level, blood pressure level, sex, age, hepatic disease index, dietary habit, drinking habit, exercise habit, obesity level and disease history) may be used in addition to the amino acid concentration. When the state of the apparent obesity, the non-apparent obesity, or the obesity is evaluated in the present invention, another biological information (e.g., biological metabolites such as glucose, lipid, protein, peptide, mineral and hormone, and biological indices such as blood glucose level, blood pressure level, sex, age, hepatic disease index, dietary habit, drinking habit, exercise habit, obesity level and disease history) may be used as the explanatory variables in the multivariate discriminant in addition to the amino acid concentration.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a principle configurational diagram showing a basic principle of the present invention;

FIG. 2 is a flowchart showing one example of a method of evaluating obesity according to a first embodiment;

FIG. 3 is a principle configurational diagram showing a basic principle of the present invention;

FIG. 4 is a diagram showing an example of an entire configuration of a present system;

FIG. 5 is a diagram showing another example of an entire configuration of the present system;

FIG. 6 is a block diagram showing an example of a configuration of an obesity-evaluating apparatus 100 in the present system;

FIG. 7 is a chart showing an example of information stored in a user information file 106a;

FIG. 8 is a chart showing an example of information stored in an amino acid concentration data file 106b;

FIG. 9 is a chart showing an example of information stored in an obesity state information file 106c;

FIG. 10 is a chart showing an example of information stored in a designated obesity state information file 106d;

FIG. 11 is a chart showing an example of information stored in a candidate multivariable discriminant file 106e1;

FIG. 12 is a chart showing an example of information stored in a verification result file 106e2;

FIG. 13 is a chart showing an example of information stored in a selected obesity state information file 106e3;

FIG. 14 is a chart showing an example of information stored in a multivariable discriminant file 106e4;

FIG. 15 is a chart showing an example of information stored in a discriminant value file 106f;

FIG. 16 is a chart showing an example of information stored in an evaluation result file 106g;

FIG. 17 is a block diagram showing a configuration of a multivariable discriminant-preparing part 102h;

FIG. 18 is a block diagram showing a configuration of a discriminant value criterion-evaluating part 102j;

FIG. 19 is a block diagram showing an example of a configuration of a client apparatus 200 in the present system;

FIG. 20 is a block diagram showing an example of a configuration of a database apparatus 400 in the present system;

FIG. 21 is a flowchart showing an example of an obesity evaluation service processing performed in the present system;

FIG. 22 is a flowchart showing an example of a multivariate discriminant-preparing processing performed in the obesity-evaluating apparatus 100 in the present system;

FIG. 23 is boxplots showing distributions of amino acid explanatory variables in a healthy group, an apparent obesity group, a non-apparent obesity group, and an obesity group;

FIG. 24 is a chart showing a list of discriminants having the same discrimination performance as that of an index formula 1;

FIG. 25 is a chart showing a list of discriminants having the same discrimination performance as that of the index formula 1;

FIG. 26 is a graph showing area under the ROC curve in the 2-group discrimination between the healthy group and the apparent obesity group;

FIG. 27 is a chart showing a list of discriminants having the same discrimination performance as that of an index formula 2;

FIG. 28 is a chart showing a list of discriminants having the same discrimination performance as that of the index formula 2;

FIG. 29 is a graph showing area under the ROC curve in the 2-group discrimination between the healthy group and the apparent obesity group;

FIG. 30 is a chart showing a list of discriminants having the same discrimination performance as that of an index formula 3;

FIG. 31 is a chart showing a list of discriminants having the same discrimination performance as that of the index formula 3;

FIG. 32 is a graph showing area under the ROC curve in the 2-group discrimination between the healthy group and the apparent obesity group;

FIG. 33 is a chart showing a list of discriminants having the same discrimination performance as that of an index formula 4;

FIG. 34 is a chart showing a list of discriminants having the same discrimination performance as that of the index formula 4;

FIG. 35 is a graph showing area under the ROC curve in the 2-group discrimination between the healthy group and the non-apparent obesity group;

FIG. 36 is a chart showing a list of discriminants having the same discrimination performance as that of an index formula 5;

FIG. 37 is a chart showing a list of discriminants having the same discrimination performance as that of the index formula 5;

FIG. 38 is a graph showing area under the ROC curve in the 2-group discrimination between the healthy group and the non-apparent obesity group;

FIG. 39 is a chart showing a list of discriminants having the same discrimination performance as that of an index formula 6;

FIG. 40 is a chart showing a list of discriminants having the same discrimination performance as that of the index formula 6;

FIG. 41 is a graph showing area under the ROC curve in the 2-group discrimination between the healthy group and the non-apparent obesity group;

FIG. 42 is a chart showing a list of discriminants having the same discrimination performance as that of an index formula 7;

FIG. 43 is a chart showing a list of discriminants having the same discrimination performance as that of the index formula 7;

FIG. 44 is a graph showing area under the ROC curve in the 2-group discrimination between the healthy group and the obesity group;

FIG. 45 is a chart showing a list of discriminants having the same discrimination performance as that of an index formula 8;

FIG. 46 is a chart showing a list of discriminants having the same discrimination performance as that of the index formula 8;

FIG. 47 is a graph showing area under the ROC curve in the 2-group discrimination between the healthy group and the obesity group;

FIG. 48 is a chart showing a list of discriminants having the same discrimination performance as that of an index formula 9;

FIG. 49 is a chart showing a list of discriminants having the same discrimination performance as that of the index formula 9;

FIG. 50 is a graph showing area under the ROC curve in the 2-group discrimination between the healthy group and the obesity group;

FIG. 51 is a chart showing a list of discriminants having the same discrimination performance as that of an index formula 10;

FIG. 52 is a chart showing a list of discriminants having the same discrimination performance as that of the index formula 10;

FIG. 53 is a graph showing area under the ROC curve in the 2-group discrimination between the apparent obesity group and the non-apparent obesity group;

FIG. 54 is a chart showing a list of discriminants having the same discrimination performance as that of an index formula 11;

FIG. 55 is a chart showing a list of discriminants having the same discrimination performance as that of the index formula 11;

FIG. 56 is a graph showing area under the ROC curve in the 2-group discrimination between the apparent obesity group and the non-apparent obesity group;

FIG. 57 is a chart showing a list of discriminants having the same discrimination performance as that of an index formula 12;

FIG. 58 is a chart showing a list of discriminants having the same discrimination performance as that of the index formula 12;

FIG. 59 is a graph showing area under the ROC curve in the 2-group discrimination between the apparent obesity group and the non-apparent obesity group;

FIG. 60 is a chart showing a list of discriminants having the same discrimination performance as that of an index formula 13;

FIG. 61 is a chart showing a list of discriminants having the same discrimination performance as that of the index formula 13;

FIG. 62 is a graph showing area under the ROC curve in the 2-group discrimination between the apparent obesity group and the non-apparent obesity group;

FIG. 63 is a chart showing a list of discriminants having the same discrimination performance as that of an index formula 14;

FIG. 64 is a chart showing a list of discriminants having the same discrimination performance as that of the index formula 14;

FIG. 65 is a graph showing area under the ROC curve in the 2-group discrimination between the apparent obesity group and the obesity group;

FIG. 66 is a chart showing a list of discriminants having the same discrimination performance as that of an index formula 15;

FIG. 67 is a chart showing a list of discriminants having the same discrimination performance as that of the index formula 15;

FIG. 68 is a graph showing area under the ROC curve in the 2-group discrimination between the apparent obesity group and the obesity group;

FIG. 69 is a chart showing a list of discriminants having the same discrimination performance as that of an index formula 16;

FIG. 70 is a chart showing a list of discriminants having the same discrimination performance as that of the index formula 16;

FIG. 71 is a graph showing area under the ROC curve in the 2-group discrimination between the non-apparent obesity group and the obesity group;

FIG. 72 is a chart showing a list of discriminants having the same discrimination performance as that of an index formula 17;

FIG. 73 is a chart showing a list of discriminants having the same discrimination performance as that of the index formula 17;

FIG. 74 is a graph showing area under the ROC curve in the 2-group discrimination between the non-apparent obesity group and the obesity group;

FIG. 75 is a chart showing a list of discriminants having the same discrimination performance as that of an index formula 18;

FIG. 76 is a chart showing a list of discriminants having the same discrimination performance as that of the index formula 18;

FIG. 77 is a graph showing area under the ROC curve in the 2-group discrimination between the non-apparent obesity group and the obesity group;

FIG. 78 is a chart showing verification results of the performances of 2-group discriminations between the healthy group and the apparent obesity group, between the healthy group and the non-apparent obesity group, between the healthy group and the obesity group, between the apparent obesity group and the non-apparent obesity group, between the apparent obesity group and the obesity group, and between the non-apparent obesity group and the obesity group;

FIG. 79 is a chart showing verification results of the performances of 2-group discriminations between the healthy group and the apparent obesity group, between the healthy group and the non-apparent obesity group, between the healthy group and the obesity group, between the apparent obesity group and the non-apparent obesity group, between the apparent obesity group and the obesity group, and between the non-apparent obesity group and the obesity group;

FIG. 80 is a chart showing a list of discriminants having the same discrimination performance as that of an index formula 19;

FIG. 81 is a chart showing a list of discriminants having the same discrimination performance as that of the index formula 19;

FIG. 82 is a chart showing a list of discriminants having the same discrimination performance as that of an index formula 20;

FIG. 83 is a chart showing a list of discriminants having the same discrimination performance as that of the index formula 20;

FIG. 84 is a chart showing a list of discriminants having the same discrimination performance as that of an index formula 21;

FIG. 85 is a chart showing a list of discriminants having the same discrimination performance as that of the index formula 21;

FIG. 86 is a chart showing a list of discriminants having the same discrimination performance as that of an index formula 22;

FIG. 87 is a chart showing a list of discriminants having the same discrimination performance as that of the index formula 22;

FIG. 88 is a chart showing a list of discriminants having the same discrimination performance as that of an index formula 23;

FIG. 89 is a chart showing a list of discriminants having the same discrimination performance as that of the index formula 23;

FIG. 90 is a chart showing a list of discriminants having the same discrimination performance as that of an index formula 24;

FIG. 91 is a chart showing a list of discriminants having the same discrimination performance as that of the index formula 24;

FIG. 92 is a chart showing a list of discriminants having the same discrimination performance as that of an index formula 25;

FIG. 93 is a chart showing a list of discriminants having the same discrimination performance as that of the index formula 25;

FIG. 94 is a chart showing a list of discriminants having the same discrimination performance as that of an index formula 26;

FIG. 95 is a chart showing a list of discriminants having the same discrimination performance as that of the index formula 26;

FIG. 96 is a chart showing a list of discriminants having the same discrimination performance as that of an index formula 27;

FIG. 97 is a chart showing a list of discriminants having the same discrimination performance as that of the index formula 27;

FIG. 98 is a chart showing a list of discriminants having the same discrimination performance as that of an index formula 28;

FIG. 99 is a chart showing a list of discriminants having the same discrimination performance as that of the index formula 28;

FIG. 100 is a chart showing a list of discriminants having the same discrimination performance as that of an index formula 29;

FIG. 101 is a chart showing a list of discriminants having the same discrimination performance as that of the index formula 29;

FIG. 102 is a chart showing a list of discriminants having the same discrimination performance as that of an index formula 30;

FIG. 103 is a chart showing a list of discriminants having the same discrimination performance as that of the index formula 30;

FIG. 104 is a chart showing a list of discriminants having the same discrimination performance as that of an index formula 31;

FIG. 105 is a chart showing a list of discriminants having the same discrimination performance as that of the index formula 31;

FIG. 106 is a chart showing a list of discriminants having the same discrimination performance as that of an index formula 32;

FIG. 107 is a chart showing a list of discriminants having the same discrimination performance as that of the index formula 32;

FIG. 108 is a chart showing a list of discriminants having the same discrimination performance as that of an index formula 33;

FIG. 109 is a chart showing a list of discriminants having the same discrimination performance as that of the index formula 33;

FIG. 110 is a chart showing a list of discriminants having the same discrimination performance as that of an index formula 34;

FIG. 111 is a chart showing a list of discriminants having the same discrimination performance as that of the index formula 34;

FIG. 112 is a chart showing a list of discriminants having the same discrimination performance as that of an index formula 35;

FIG. 113 is a chart showing a list of discriminants having the same discrimination performance as that of the index formula 35;

FIG. 114 is a chart showing a list of discriminants having the same discrimination performance as that of an index formula 36;

FIG. 115 is a chart showing a list of discriminants having the same discrimination performance as that of the index formula 36;

FIG. 116 is a chart showing a list of discriminants having the same discrimination performance as that of an index formula 37;

FIG. 117 is a chart showing a list of discriminants having the same discrimination performance as that of the index formula 37;

FIG. 118 is a graph showing area under the ROC curve in the 2-group discrimination between healthy group/apparent obesity group and non-apparent obesity group/obesity group;

FIG. 119 is a chart showing a list of discriminants having the same discrimination performance as that of an index formula 38;

FIG. 120 is a chart showing a list of discriminants having the same discrimination performance as that of the index formula 38;

FIG. 121 is a graph showing area under the ROC curve in the 2-group discrimination between healthy group/apparent obesity group and non-apparent obesity group/obesity group;

FIG. 122 is a chart showing a list of discriminants having the same discrimination performance as that of an index formula 39;

FIG. 123 is a chart showing a list of discriminants having the same discrimination performance as that of the index formula 39; and

FIG. 124 is a graph showing area under the ROC curve in the 2-group discrimination between healthy group/apparent obesity group and non-apparent obesity group/obesity group.

### DETAILED DESCRIPTION OF THE PREFERRED EMBODIMENTS

Hereinafter, an embodiment (first embodiment) of the method of evaluating obesity of the present invention and an embodiment (second embodiment) of the obesity-evaluating apparatus, the obesity-evaluating method, the obesity-evaluating system, the obesity-evaluating program and the recording medium of the present invention are described in detail with reference to the drawings. The present invention is not limited to these embodiments.

### First Embodiment

### 1-1. Outline of the Invention

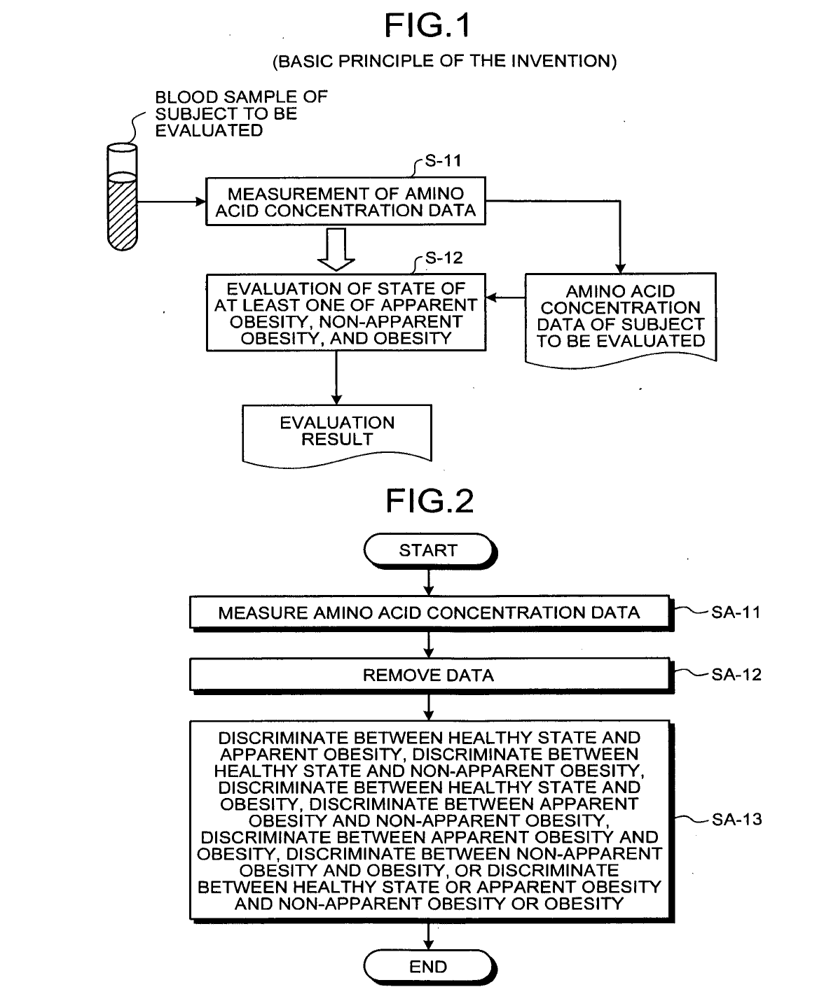

Here, an outline of the method of evaluating obesity of the present invention will be described with reference to FIG. 1. FIG. 1 is a principle configurational diagram showing a basic principle of the present invention.

In the present invention, amino acid concentration data on a concentration value of an amino acid in blood collected from a subject (for example, an individual such as animal or human) to be evaluated is first measured (step S-11). Concentrations of amino acids in blood are analyzed in the following manner. A blood sample is collected in a heparin-treated tube, and then the blood plasma is separated by centrifugation of the collected blood sample. All blood plasma samples separated are frozen and stored at −70° C. before a measurement of amino acid concentrations. Before the measurement of amino acid concentrations, the blood plasma samples are deproteinized by adding sulfosalicylic acid to a concentration of 3%. An amino acid analyzer by high-performance liquid chromatography (HPLC) by using ninhydrin reaction in the post column is used for the measurement of amino acid concentrations. The unit of the amino acid concentration may be for example molar concentration, weight concentration, or these concentrations which are subjected to addition, subtraction, multiplication or division by an arbitrary constant.

In the present invention, a state of at least one of an apparent obesity, a non-apparent obesity, and an obesity that are defined by BMI (Body Mass Index) and VFA (Visceral Fat Area) in the subject is evaluated based on the concentration value of at least one of Glu, Ser, Pro, Gly, Ala, Cys2, Tyr, Val, Orn, Met, Lys, Ile, Leu, Phe, and Trp contained in the amino acid concentration data of the subject measured in step S-11 (step S-12).

According to the present invention described above, (i) the amino acid concentration data on the concentration value of the amino acid in blood collected from the subject is measured, and (ii) the state of at least one of the apparent obesity, the non-apparent obesity, and the obesity that are defined by the BMI and the VFA in the subject is evaluated based on the concentration value of at least one of Glu, Ser, Pro, Gly, Ala, Cys2, Tyr, Val, Orn, Met, Lys, Ile, Leu, Phe, and Trp contained in the measured amino acid concentration data of the subject. Thus, the concentrations of the amino acids which among amino acids in blood, are related to the state of the apparent obesity, the non-apparent obesity, or the obesity defined by the BMI and the VFA can be utilized to bring about the effect of enabling an accurate evaluation of the state of the apparent obesity, the non-apparent obesity, or the obesity.

Before step S-12 is executed, data such as defective and outliers may be removed from the amino acid concentration data of the subject measured in step S-11. Thus, the state of the apparent obesity, the non-apparent obesity, or the obesity can be more accurately evaluated.

In step S-12, the discrimination between the healthy state defined by the BMI and the VFA and the apparent obesity, between the healthy state and the non-apparent obesity, between the healthy state and the obesity, between the apparent obesity and the non-apparent obesity, between the apparent obesity and the obesity, between the non-apparent obesity and the obesity, or between “the healthy state or the apparent obesity” and “the non-apparent obesity or the obesity” in the subject may be conducted based on the concentration value of at least one of Glu, Ser, Pro, Gly, Ala, Cys2, Tyr, Val, Orn, Met, Lys, Ile, Leu, Phe, and Trp contained in the amino acid concentration data of the subject measured in step S-11. Specifically, the concentration value of at least one of Glu, Ser, Pro, Gly, Ala, Cys2, Tyr, Val, Orn, Met, Lys, Ile, Leu, Phe, and Trp may be compared with a previously established threshold (cutoff value), thereby discriminating between the healthy state and the apparent obesity, between the healthy state and the non-apparent obesity, between the healthy state and the obesity, between the apparent obesity and the non-apparent obesity, between the apparent obesity and the obesity, between the non-apparent obesity and the obesity, or between “the healthy state or the apparent obesity” and “the non-apparent obesity or the obesity” in the subject. Thus, the concentrations of the amino acids which among amino acids in blood, are useful for the 2-group discrimination of the healthy state and the apparent obesity, the 2-group discrimination of the healthy state and the non-apparent obesity, the 2-group discrimination of the healthy state and the obesity, the 2-group discrimination of the apparent obesity and the non-apparent obesity, the 2-group discrimination of the apparent obesity and the obesity, the 2-group discrimination of the non-apparent obesity and the obesity, or the 2-group discrimination of the healthy state or the apparent obesity and the non-apparent obesity or the obesity, can be utilized to bring about the effect of enabling accurately these 2-group discriminations.

In step S-12, (I) a discriminant value that is a value of a multivariate discriminant with a concentration of the amino acid as an explanatory variable may be calculated based on both (i) the concentration value of at least one of Glu, Ser, Pro, Gly, Ala, Cys2, Tyr, Val, Orn, Met, Lys, Ile, Leu, Phe, and Trp contained in the amino acid concentration data of the subject measured in step S-11 and (ii) the previously established multivariate discriminant containing at least one of Glu, Ser, Pro, Gly, Ala, Cys2, Tyr, Val, Orn, Met, Lys, Ile, Leu, Phe, and Trp as the explanatory variable, and (II) the state of at least one of the apparent obesity, the non-apparent obesity, and the obesity in the subject may be evaluated based on the calculated discriminant value. Thus, the discriminant values obtained in the multivariate discriminants correlated significantly with the state of the apparent obesity, the non-apparent obesity, or the obesity can be utilized to bring about the effect of enabling an accurate evaluation of the state of the apparent obesity, the non-apparent obesity, or the obesity.

In step S-12, the discrimination between the healthy state defined by the BMI and the VFA and the apparent obesity, between the healthy state and the non-apparent obesity, between the healthy state and the obesity, between the apparent obesity and the non-apparent obesity, between the apparent obesity and the obesity, between the non-apparent obesity and the obesity, or between “the healthy state or the apparent obesity” and “the non-apparent obesity or the obesity” in the subject may be conducted based on the calculated discriminant value. Specifically, the discriminant value may be compared with a previously established threshold (cutoff value), thereby discriminating between the healthy state and the apparent obesity, between the healthy state and the non-apparent obesity, between the healthy state and the obesity, between the apparent obesity and the non-apparent obesity, between the apparent obesity and the obesity, between the non-apparent obesity and the obesity, or between “the healthy state or the apparent obesity” and “the non-apparent obesity or the obesity” in the subject. Thus, the discriminant values obtained in the multivariate discriminants useful for the 2-group discrimination of the healthy state and the apparent obesity, the 2-group discrimination of the healthy state and the non-apparent obesity, the 2-group discrimination of the healthy state and the obesity, the 2-group discrimination of the apparent obesity and the non-apparent obesity, the 2-group discrimination of the apparent obesity and the obesity, the 2-group discrimination of the non-apparent obesity and the obesity, or the 2-group discrimination of the healthy state or the apparent obesity and the non-apparent obesity or the obesity, can be utilized to bring about the effect of enabling accurately these 2-group discriminations.

The multivariate discriminant may be any one of a fractional expression, the sum of a plurality of the fractional expressions, a logistic regression equation, a linear discriminant, a multiple regression equation, a discriminant prepared by a support vector machine, a discriminant prepared by a Mahalanobis' generalized distance method, a discriminant prepared by canonical discriminant analysis, and a discriminant prepared by a decision tree. Thus, the discriminant values obtained in the multivariate discriminants useful for the 2-group discrimination of the healthy state and the apparent obesity, the 2-group discrimination of the healthy state and the non-apparent obesity, the 2-group discrimination of the healthy state and the obesity, the 2-group discrimination of the apparent obesity and the non-apparent obesity, the 2-group discrimination of the apparent obesity and the obesity, the 2-group discrimination of the non-apparent obesity and the obesity, or the 2-group discrimination of the healthy state or the apparent obesity and the non-apparent obesity or the obesity, can be utilized to bring about the effect of enabling more accurately these 2-group discriminations.

Specifically, when discriminating between the healthy state and the apparent obesity, the multivariate discriminant may be a formula 1, a formula 2, the logistic regression equation with Glu, Thr, and Phe as the explanatory variables, the logistic regression equation with Pro, Asn, Thr, Arg, Tyr, and Orn as the explanatory variables, the linear discriminant with His, Thr, Val, Orn, and Trp as the explanatory variables, or the linear discriminant with Ser, Pro, Asn, Orn, Phe, Val, Leu, and Ile as the explanatory variables:

a₁(Glu/Gly)+b₁(His/Ile)+c₁(Thr/Phe)+d₁ (formula 1)

a₂(Pro/Ser)+b₂(Thr/Asn)+c₂(Arg/Tyr)+d₂(Orn/Gln)+e₂ (formula 2)

wherein in the formula 1, a₁, b₁, and c₁ are arbitrary non-zero real numbers and d₁ is an arbitrary real number and in the formula 2, a₂, b₂, c₂, and d₂ are arbitrary non-zero real numbers and e₂ is an arbitrary real number. Thus, the discriminant values obtained in the multivariate discriminants useful particularly for the 2-group discrimination of the healthy state and the apparent obesity, can be utilized to bring about the effect of enabling more accurately the 2-group discrimination.

When discriminating between the healthy state and the non-apparent obesity, the multivariate discriminant may be a formula 3, a formula 4, the logistic regression equation with Glu, Ser, Ala, Orn, Leu, and Trp as the explanatory variables, the logistic regression equation with Glu, Ser, Gly, Cit, Ala, Val, Leu, and Ile as the explanatory variables, the linear discriminant with Glu, Ser, His, Thr, Lys, and Phe as the explanatory variables, or the linear discriminant with Glu, His, ABA, Tyr, Met, and Lys as the explanatory variables:

a₃(Ser/Ala)+b₃(Gly/Tyr)+c₃(Trp/Glu)+d₃ (formula 3)

a₄(Ser/Cit)+b₄(Gly/(Val+Leu+Ile))+c₄(Gln/Ala)+d₄(Thr/Glu)+e₄ (formula 4)

wherein in the formula 3, a₃, b₃, and c₃ are arbitrary non-zero real numbers and d₃ is an arbitrary real number and in the formula 4, a₄, b₄, c₄, and d₄ are arbitrary non-zero real numbers and e₄ is an arbitrary real number. Thus, the discriminant values obtained in the multivariate discriminants useful particularly for the 2-group discrimination of the healthy state and the non-apparent obesity, can be utilized to bring about the effect of enabling more accurately the 2-group discrimination.

When discriminating between the healthy state and the obesity, the multivariate discriminant may be a formula 5, a formula 6, the logistic regression equation with Glu, Ser, Cit, Ala, Tyr, and Trp as the explanatory variables, the logistic regression equation with Glu, Ser, Ala, Tyr, Trp, Val, Leu, and Ile as the explanatory variables, the linear discriminant with Glu, Thr, Ala, Tyr, Orn, and Lys as the explanatory variables, or the linear discriminant with Glu, Pro, His, Cit, Orn, and Lys as the explanatory variables:

a₅(Glu/Ser)+b₅(Cit/Ala)+c₅(Trp/Tyr)+d₅ (formula 5)

a₆(Glu/Gly)+b₆(Ser/Ala)+c₆(Trp/Tyr)+d₆((Val+Leu+Ile)/Asn)+e₆ (formula 6)

wherein in the formula 5, a₅, b₅, and c₅ are arbitrary non-zero real numbers and d₅ is an arbitrary real number and in the formula 6, a₆, b₆, c₆, and d₆ are arbitrary non-zero real numbers and e₆ is an arbitrary real number. Thus, the discriminant values obtained in the multivariate discriminants useful particularly for the 2-group discrimination of the healthy state and the obesity, can be utilized to bring about the effect of enabling more accurately the 2-group discrimination.

When discriminating between the apparent obesity and the non-apparent obesity, the multivariate discriminant may be a formula 7, a formula 8, the logistic regression equation with Glu, Thr, Ala, Arg, Tyr, and Lys as the explanatory variables, the logistic regression equation with Pro, Gly, Gln, Ala, Orn, Val, Leu, and Ile as the explanatory variables, the linear discriminant with His, Thr, Ala, Tyr, Orn, and Phe as the explanatory variables, or the linear discriminant with Ser, Pro, Gly, Cit, Lys, and Phe as the explanatory variables:

a₇(Thr/Tyr)+b₇(Ala/Ile)+c₇(Arg/Gln)+d₇ (formula 7)

a₈(Pro/(Val+Leu+Ile))+b₈(Gly/Orn)+c₈(Gln/Ala)+d₈(ABA/Thr)+e₈ (formula 8)

wherein in the formula 7, a₇, b₇, and c₇ are arbitrary non-zero real numbers and d₇ is an arbitrary real number and in the formula 8, a₈, b₈, c₈, and d₈ are arbitrary non-zero real numbers and e₈ is an arbitrary real number. Thus, the discriminant values obtained in the multivariate discriminants useful particularly for the 2-group discrimination of the apparent obesity and the non-apparent obesity, can be utilized to bring about the effect of enabling more accurately the 2-group discrimination.

When discriminating between the apparent obesity and the obesity, the multivariate discriminant may be a formula 9, a formula 10, the logistic regression equation with Glu, Asn, Gly, His, Leu, and Trp as the explanatory variables, the logistic regression equation with Glu, Ala, ABA, Met, Lys, Val, Leu, and Ile as the explanatory variables, the linear discriminant with Glu, Gly, His, Ala, and Lys as the explanatory variables, or the linear discriminant with Glu, Thr, Ala, ABA, Lys, Val, Leu, and Ile as the explanatory variables:

a₉(Gly/Glu)+b₉(His/Trp)+c₉(Leu/Gln)+d₉ (formula 9)

a₁₀(Glu/Asn)+b₁₀(ABA/Ser)+c₁₀(Lys/Gln)+d₁₀((Val+Leu+Ile)/Trp))+e₁₀ (formula 10)

wherein in the formula 9, a₉, b₉, and c₉ are arbitrary non-zero real numbers and d₉ is an arbitrary real number and in the formula 10, a₁₀, b₁₀, c₁₀, and d₁₀ are arbitrary non-zero real numbers and e₁₀ is an arbitrary real number. Thus, the discriminant values obtained in the multivariate discriminants useful particularly for the 2-group discrimination of the apparent obesity and the obesity, can be utilized to bring about the effect of enabling more accurately the 2-group discrimination.

When discriminating between the non-apparent obesity and the obesity, the multivariate discriminant may be a formula 11, a formula 12, the logistic regression equation with Glu, Gly, Cit, Tyr, Val, and Phe as the explanatory variables, the logistic regression equation with Glu, Pro, Cit, Tyr, Phe, and Trp as the explanatory variables, the linear discriminant with Glu, Cit, Tyr, Orn, Met, and Trp as the explanatory variables, or the linear discriminant with Glu, Pro, His, Met, and Phe as the explanatory variables:

a₁₁(Glu/Gln)+b₁₁(Tyr/Gly)+c₁₁(Lys/Trp)+d₁₁ (formula 11)

a₁₂(Glu/Asn)+b₁₂(His/Thr)+c₁₂(Phe/Cit)+d₁₂(Trp/Tyr)+e₁₂ (formula 12)

wherein in the formula 11, a₁₁, b₁₁, and c₁₁ are arbitrary non-zero real numbers and d₁₁ is an arbitrary real number and in the formula 12, a₁₂, b₁₂, c₁₂, and d₁₂ are arbitrary non-zero real numbers and e₁₂ is an arbitrary real number. Thus, the discriminant values obtained in the multivariate discriminants useful particularly for the 2-group discrimination of the non-apparent obesity and the obesity, can be utilized to bring about the effect of enabling more accurately the 2-group discrimination.

When discriminating between “the healthy state or the apparent obesity” and “the non-apparent obesity or the obesity”, the multivariate discriminant may be a formula 13, the logistic regression equation with Glu, Gly, Ala, Tyr, Trp, Val, Leu, and Ile as the explanatory variables, or the linear discriminant with Glu, Ala, Arg, Tyr, Orn, Val, Leu, and Ile as the explanatory variables:

a₁₃(Glu/Asn)+b₁₃(Ser/Ala)+c₁₃(Cit/Phe)+d₁₃(Tyr/Trp)+e₁₃ (formula 13)

wherein in the formula 13, a₁₃, b₁₃, c₁₃, and d₁₃ are arbitrary non-zero real numbers and e₁₃ is an arbitrary real number. Thus, the discriminant values obtained in the multivariate discriminants useful particularly for the 2-group discrimination of the healthy state or the apparent obesity and the non-apparent obesity or the obesity, can be utilized to bring about the effect of enabling more accurately the 2-group discrimination.

The multivariate discriminant described above can be prepared by a method described in International Publication WO 2004/052191 that is an international application filed by the present applicant or by a method (multivariate discriminant-preparing processing described in the second embodiment described later) described in International Publication WO 2006/098192 that is an international application filed by the present applicant. Any multivariate discriminants obtained by these methods can be preferably used in the evaluation of the state of the apparent obesity, the non-apparent obesity or the obesity defined by the BMI and the VFA, regardless of the unit of the amino acid concentration in the amino acid concentration data as input data.

In the fractional expression, the numerator of the fractional expression is expressed by the sum of the amino acids A, B, C etc. and the denominator of the fractional expression is expressed by the sum of the amino acids a, b, c etc. The fractional expression also includes the sum of the fractional expressions α, β, γ etc. (for example, α+β) having such constitution. The fractional expression also includes divided fractional expressions. The amino acids used in the numerator or denominator may have suitable coefficients respectively. The amino acids used in the numerator or denominator may appear repeatedly. Each fractional expression may have a suitable coefficient. A value of a coefficient for each explanatory variable and a value for a constant term may be any real numbers. In combinations where explanatory variables in the numerator and explanatory variables in the denominator in the fractional expression are switched with each other, the positive (or negative) sign is generally reversed in correlation with objective explanatory variables, but because their correlation is maintained, such combinations can be assumed to be equivalent to one another in discrimination, and thus the fractional expression also includes combinations where explanatory variables in the numerator and explanatory variables in the denominator in the fractional expression are switched with each other.

The multivariate discriminant refers to a form of equation used generally in multivariate analysis and includes, for example, multiple regression equation, multiple logistic regression equation, linear discriminant function, Mahalanobis' generalized distance, canonical discriminant function, support vector machine, and decision tree. The multivariate discriminant also includes an equation shown by the sum of different forms of multivariate discriminants. In the multiple regression equation, multiple logistic regression equation and canonical discriminant function, a coefficient and constant term are added to each explanatory variable, and the coefficient and constant term in this case are preferably real numbers, more preferably values in the range of 99% confidence interval for the coefficient and constant term obtained from data for discrimination, more preferably in the range of 95% confidence interval for the coefficient and constant term obtained from data for discrimination. The value of each coefficient and the confidence interval thereof may be those multiplied by a real number, and the value of each constant term and the confidence interval thereof may be those having an arbitrary actual constant added or subtracted or those multiplied or divided by an arbitrary actual constant. When an expression such as a logistic regression, a linear discriminant, and a multiple regression analysis is used as an index, a linear transformation of the expression (addition of a constant and multiplication by a constant) and a monotonic increasing (decreasing) transformation (for example, a logit transformation) of the expression do not alter discrimination capability, and thus are equivalent. Therefore, the expression includes an expression that is subjected to a linear transformation and a monotonic increasing (decreasing) transformation.

When the state of the apparent obesity, the non-apparent obesity, or the obesity is evaluated in the present invention, another biological information (e.g., biological metabolites such as glucose, lipid, protein, peptide, mineral and hormone, and biological indices such as blood glucose level, blood pressure level, sex, age, hepatic disease index, dietary habit, drinking habit, exercise habit, obesity level and disease history) may be used in addition to the amino acid concentration. When the state of the apparent obesity, the non-apparent obesity, or the obesity is evaluated in the present invention, another biological information (e.g., biological metabolites such as glucose, lipid, protein, peptide, mineral and hormone, and biological indices such as blood glucose level, blood pressure level, sex, age, hepatic disease index, dietary habit, drinking habit, exercise habit, obesity level and disease history) may be used as the explanatory variables in the multivariate discriminant in addition to the amino acid concentration.

### 1-2. Method of Evaluating Obesity in Accordance with the First Embodiment

Herein, the method of evaluating obesity according to the first embodiment is described with reference to FIG. 2. FIG. 2 is a flowchart showing one example of the method of evaluating obesity according to the first embodiment.

The amino acid concentration data on the concentration values of the amino acids is measured from blood collected from an individual such as animal or human (step SA-11). The measurement of the concentration values of the amino acids is conducted by the method described above.

Data such as defective and outliers is then removed from the amino acid concentration data of the individual measured in step SA-11 (step SA-12).

Then, the concentration value of at least one of Glu, Ser, Pro, Gly, Ala, Cys2, Tyr, Val, Orn, Met, Lys, Ile, Leu, Phe, and Trp contained in the amino acid concentration data of the individual from which the data such as the defective and the outliers have been removed in step SA-12 is compared with a previously established threshold (cutoff value), thereby discriminating between the healthy state and the apparent obesity, between the healthy state and the non-apparent obesity, between the healthy state and the obesity, between the apparent obesity and the non-apparent obesity, between the apparent obesity and the obesity, between the non-apparent obesity and the obesity, or between the healthy state or the apparent obesity and the non-apparent obesity or the obesity in the individual (step SA-13).

### 1-3. Summary of the First Embodiment and Other Embodiments

In the method of evaluating obesity as described above in detail, (1) the amino acid concentration data is measured from blood collected from the individual, (2) the data such as the defective and the outliers is removed from the measured amino acid concentration data of the individual, and (3) the concentration value of at least one of Glu, Ser, Pro, Gly, Ala, Cys2, Tyr, Val, Orn, Met, Lys, Ile, Leu, Phe, and Trp contained in the amino acid concentration data of the individual from which the data such as the defective and the outliers have been removed is compared with the previously established threshold (cutoff value), thereby discriminating between the healthy state and the apparent obesity, between the healthy state and the non-apparent obesity, between the healthy state and the obesity, between the apparent obesity and the non-apparent obesity, between the apparent obesity and the obesity, between the non-apparent obesity and the obesity, or between the healthy state or the apparent obesity and the non-apparent obesity or the obesity in the individual. Thus, the concentrations of the amino acids which among amino acids in blood, are useful for the 2-group discrimination of the healthy state and the apparent obesity, the 2-group discrimination of the healthy state and the non-apparent obesity, the 2-group discrimination of the healthy state and the obesity, the 2-group discrimination of the apparent obesity and the non-apparent obesity, the 2-group discrimination of the apparent obesity and the obesity, the 2-group discrimination of the non-apparent obesity and the obesity, or the 2-group discrimination of the healthy state or the apparent obesity and the non-apparent obesity or the obesity, can be utilized to bring about the effect of enabling accurately these 2-group discriminations.

In the step SA-13, (I) the discriminant value may be calculated based on both (i) the concentration value of at least one of Glu, Ser, Pro, Gly, Ala, Cys2, Tyr, Val, Orn, Met, Lys, Ile, Leu, Phe, and Trp contained in the amino acid concentration data of the individual from which the data such as the defective and the outliers have been removed in the step SA-12 and (ii) the multivariate discriminant containing at least one of Glu, Ser, Pro, Gly, Ala, Cys2, Tyr, Val, Orn, Met, Lys, Ile, Leu, Phe, and Trp as the explanatory variable, and (II) the calculated discriminant value may be compared with the previously established threshold (cutoff value), thereby discriminating between the healthy state and the apparent obesity, between the healthy state and the non-apparent obesity, between the healthy state and the obesity, between the apparent obesity and the non-apparent obesity, between the apparent obesity and the obesity, between the non-apparent obesity and the obesity, or between the healthy state or the apparent obesity and the non-apparent obesity or the obesity in the individual. Thus, the discriminant values obtained in the multivariate discriminants useful for the 2-group discrimination of the healthy state and the apparent obesity, the 2-group discrimination of the healthy state and the non-apparent obesity, the 2-group discrimination of the healthy state and the obesity, the 2-group discrimination of the apparent obesity and the non-apparent obesity, the 2-group discrimination of the apparent obesity and the obesity, the 2-group discrimination of the non-apparent obesity and the obesity, or the 2-group discrimination of the healthy state or the apparent obesity and the non-apparent obesity or the obesity, can be utilized to bring about the effect of enabling accurately these 2-group discriminations.

In the step SA-13, the multivariate discriminant may be any one of a fractional expression, the sum of a plurality of the fractional expressions, a logistic regression equation, a linear discriminant, a multiple regression equation, a discriminant prepared by a support vector machine, a discriminant prepared by a Mahalanobis' generalized distance method, a discriminant prepared by canonical discriminant analysis, and a discriminant prepared by a decision tree. Thus, the discriminant values obtained in the multivariate discriminants useful for the 2-group discrimination of the healthy state and the apparent obesity, the 2-group discrimination of the healthy state and the non-apparent obesity, the 2-group discrimination of the healthy state and the obesity, the 2-group discrimination of the apparent obesity and the non-apparent obesity, the 2-group discrimination of the apparent obesity and the obesity, the 2-group discrimination of the non-apparent obesity and the obesity, or the 2-group discrimination of the healthy state or the apparent obesity and the non-apparent obesity or the obesity, can be utilized to bring about the effect of enabling more accurately these 2-group discriminations.

Specifically, when discriminating between the healthy state and the apparent obesity, the multivariate discriminant may be a formula 1, a formula 2, the logistic regression equation with Glu, Thr, and Phe as the explanatory variables, the logistic regression equation with Pro, Asn, Thr, Arg, Tyr, and Orn as the explanatory variables, the linear discriminant with His, Thr, Val, Orn, and Trp as the explanatory variables, or the linear discriminant with Ser, Pro, Asn, Orn, Phe, Val, Leu, and Ile as the explanatory variables:

a₁(Glu/Gly)+b₁(His/Ile)+c₁(Thr/Phe)+d₁ (formula 1)

a₂(Pro/Ser)+b₂(Thr/Asn)+c₂(Arg/Tyr)+d₂(Orn/Gln)+e₂ (formula 2)

wherein in the formula 1, a₁, b₁, and c₁ are arbitrary non-zero real numbers and d₁ is an arbitrary real number and in the formula 2, a₂, b₂, c₂, and d₂ are arbitrary non-zero real numbers and e₂ is an arbitrary real number. Thus, the discriminant values obtained in the multivariate discriminants useful particularly for the 2-group discrimination of the healthy state and the apparent obesity, can be utilized to bring about the effect of enabling more accurately the 2-group discrimination.

When discriminating between the healthy state and the non-apparent obesity, the multivariate discriminant may be a formula 3, a formula 4, the logistic regression equation with Glu, Ser, Ala, Orn, Leu, and Trp as the explanatory variables, the logistic regression equation with Glu, Ser, Gly, Cit, Ala, Val, Leu, and Ile as the explanatory variables, the linear discriminant with Glu, Ser, His, Thr, Lys, and Phe as the explanatory variables, or the linear discriminant with Glu, His, ABA, Tyr, Met, and Lys as the explanatory variables:

a₃(Ser/Ala)+b₃(Gly/Tyr)+c₃(Trp/Glu)+d₃ (formula 3)

a₄(Ser/Cit)+b₄(Gly/(Val+Leu+Ile))+c₄(Gln/Ala)+d₄(Thr/Glu)+e₄ (formula 4)

wherein in the formula 3, a₃, b₃, and c₃ are arbitrary non-zero real numbers and d₃ is an arbitrary real number and in the formula 4, a₄, b₄, c₄, and d₄ are arbitrary non-zero real numbers and e₄ is an arbitrary real number. Thus, the discriminant values obtained in the multivariate discriminants useful particularly for the 2-group discrimination of the healthy state and the non-apparent obesity, can be utilized to bring about the effect of enabling more accurately the 2-group discrimination.

When discriminating between the healthy state and the obesity, the multivariate discriminant may be a formula 5, a formula 6, the logistic regression equation with Glu, Ser, Cit, Ala, Tyr, and Trp as the explanatory variables, the logistic regression equation with Glu, Ser, Ala, Tyr, Trp, Val, Leu, and Ile as the explanatory variables, the linear discriminant with Glu, Thr, Ala, Tyr, Orn, and Lys as the explanatory variables, or the linear discriminant with Glu, Pro, His, Cit, Orn, and Lys as the explanatory variables:

a₅(Glu/Ser)+b₅(Cit/Ala)+c₅(Trp/Tyr)+d₅ (formula 5)

a₆(Glu/Gly)+b₆(Ser/Ala)+c₆(Trp/Tyr)+d₆((Val+Leu+Ile)/Asn)+e₆ (formula 6)

wherein in the formula 5, a₅, b₅, and c₅ are arbitrary non-zero real numbers and d₅ is an arbitrary real number and in the formula 6, a₆, b₆, c₆, and d₆ are arbitrary non-zero real numbers and e₆ is an arbitrary real number. Thus, the discriminant values obtained in the multivariate discriminants useful particularly for the 2-group discrimination of the healthy state and the obesity, can be utilized to bring about the effect of enabling more accurately the 2-group discrimination.

When discriminating between the apparent obesity and the non-apparent obesity, the multivariate discriminant may be a formula 7, a formula 8, the logistic regression equation with Glu, Thr, Ala, Arg, Tyr, and Lys as the explanatory variables, the logistic regression equation with Pro, Gly, Gln, Ala, Orn, Val, Leu, and Ile as the explanatory variables, the linear discriminant with His, Thr, Ala, Tyr, Orn, and Phe as the explanatory variables, or the linear discriminant with Ser, Pro, Gly, Cit, Lys, and Phe as the explanatory variables:

a₇(Thr/Tyr)+b₇(Ala/Ile)+c₇(Arg/Gln)+d₇ (formula 7)

a₈(Pro/(Val+Leu+Ile))+b₈(Gly/Orn)+c₈(Gln/Ala)+d₈(ABA/Thr)+e₈ (formula 8)

wherein in the formula 7, a₇, b₇, and c₇ are arbitrary non-zero real numbers and d₇ is an arbitrary real number and in the formula 8, a₈, b₈, c₈, and d₈ are arbitrary non-zero real numbers and e₈ is an arbitrary real number. Thus, the discriminant values obtained in the multivariate discriminants useful particularly for the 2-group discrimination of the apparent obesity and the non-apparent obesity, can be utilized to bring about the effect of enabling more accurately the 2-group discrimination.

When discriminating between the apparent obesity and the obesity, the multivariate discriminant may be a formula 9, a formula 10, the logistic regression equation with Glu, Asn, Gly, His, Leu, and Trp as the explanatory variables, the logistic regression equation with Glu, Ala, ABA, Met, Lys, Val, Leu, and Ile as the explanatory variables, the linear discriminant with Glu, Gly, His, Ala, and Lys as the explanatory variables, or the linear discriminant with Glu, Thr, Ala, ABA, Lys, Val, Leu, and Ile as the explanatory variables:

a₉(Gly/Glu)+b₉(His/Trp)+c₉(Leu/Gln)+d₉ (formula 9)

a₁₀(Glu/Asn)+b₁₀(ABA/Ser)+c₁₀(Lys/Gln)+d₁₀((Val+Leu+Ile)/Trp))+e₁₀ (formula 10)

wherein in the formula 9, a₉, b₉, and c₉ are arbitrary non-zero real numbers and d₉ is an arbitrary real number and in the formula 10, a₁₀, b₁₀, c₁₀, and d₁₀ are arbitrary non-zero real numbers and e₁₀ is an arbitrary real number. Thus, the discriminant values obtained in the multivariate discriminants useful particularly for the 2-group discrimination of the apparent obesity and the obesity, can be utilized to bring about the effect of enabling more accurately the 2-group discrimination.

When discriminating between the non-apparent obesity and the obesity, the multivariate discriminant may be a formula 11, a formula 12, the logistic regression equation with Glu, Gly, Cit, Tyr, Val, and Phe as the explanatory variables, the logistic regression equation with Glu, Pro, Cit, Tyr, Phe, and Trp as the explanatory variables, the linear discriminant with Glu, Cit, Tyr, Orn, Met, and Trp as the explanatory variables, or the linear discriminant with Glu, Pro, His, Met, and Phe as the explanatory variables:

a₁₁(Glu/Gln)+b₁₁(Tyr/Gly)+c₁₁(Lys/Trp)+d₁₁ (formula 11)

a₁₂(Glu/Asn)+b₁₂(His/Thr)+c₁₂(Phe/Cit)+d₁₂(Trp/Tyr)+e₁₂ (formula 12)

wherein in the formula 11, a₁₁, b₁₁, and c₁₁ are arbitrary non-zero real numbers and d₁₁ is an arbitrary real number and in the formula 12, a₁₂, b₁₂, c₁₂, and d₁₂ are arbitrary non-zero real numbers and e₁₂ is an arbitrary real number. Thus, the discriminant values obtained in the multivariate discriminants useful particularly for the 2-group discrimination of the non-apparent obesity and the obesity, can be utilized to bring about the effect of enabling more accurately the 2-group discrimination.

When discriminating between the healthy state or the apparent obesity and the non-apparent obesity or the obesity, the multivariate discriminant may be a formula 13, the logistic regression equation with Glu, Gly, Ala, Tyr, Trp, Val, Leu, and Ile as the explanatory variables, or the linear discriminant with Glu, Ala, Arg, Tyr, Orn, Val, Leu, and Ile as the explanatory variables:

a₁₃(Glu/Asn)+b₁₃(Ser/Ala)+c₁₃(Cit/Phe)+d₁₃(Tyr/Trp)+e₁₃ (formula 13)

wherein in the formula 13, a₁₃, b₁₃, c₁₃, and d₁₃ are arbitrary non-zero real numbers and e₁₃ is an arbitrary real number. Thus, the discriminant values obtained in the multivariate discriminants useful particularly for the 2-group discrimination of the healthy state or the apparent obesity and the non-apparent obesity or the obesity, can be utilized to bring about the effect of enabling more accurately the 2-group discrimination.

The multivariate discriminant described above can be prepared by a method described in International Publication WO 2004/052191 that is an international application filed by the present applicant or by a method (multivariate discriminant-preparing processing described in the second embodiment described later) described in International Publication WO 2006/098192 that is an international application filed by the present applicant. Any multivariate discriminants obtained by these methods can be preferably used in the evaluation of the state of the apparent obesity, the non-apparent obesity or the obesity, regardless of the unit of the amino acid concentration in the amino acid concentration data as input data.

### Second Embodiment

### 2-1. Outline of the Invention

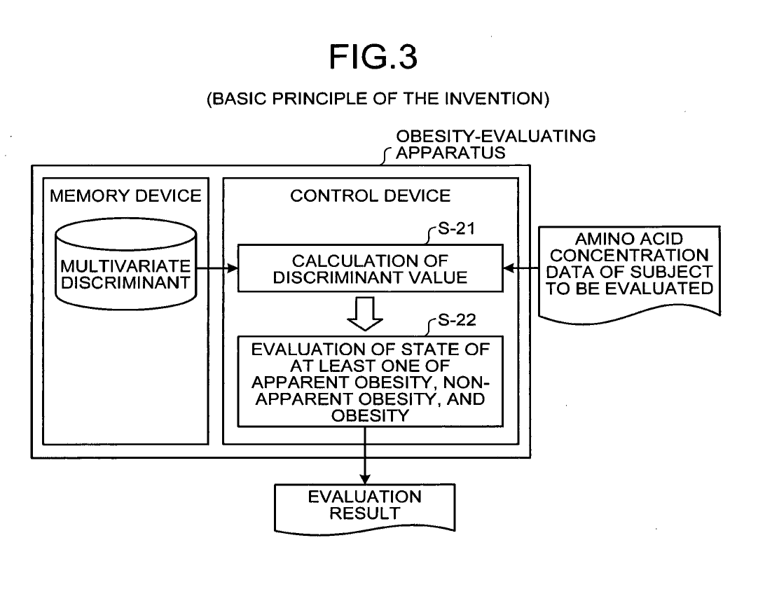

Herein, an outline of the obesity-evaluating apparatus, the obesity-evaluating method, the obesity-evaluating system, the obesity-evaluating program and the recording medium of the present invention are described in detail with reference to FIG. 3. FIG. 3 is a principle configurational diagram showing a basic principle of the present invention.

In the present invention, a discriminant value that is a value of a multivariate discriminant with a concentration of an amino acid as an explanatory variable is calculated in a control device, based on both (i) a concentration value of at least one of Glu, Ser, Pro, Gly, Ala, Cys2, Tyr, Val, Orn, Met, Lys, Ile, Leu, Phe, and Trp contained in previously obtained amino acid concentration data on the concentration value of the amino acid of a subject (for example, an individual such as animal or human) to be evaluated and (ii) the multivariate discriminant containing at least one of Glu, Ser, Pro, Gly, Ala, Cys2, Tyr, Val, Orn, Met, Lys, Ile, Leu, Phe, and Trp as the explanatory variable, stored in a memory device (step S-21).

In the present invention, a state of at least one of an apparent obesity, a non-apparent obesity, and an obesity that are defined by BMI (Body Mass Index) and VFA (Visceral Fat Area) in the subject is evaluated in the control device based on the discriminant value calculated in step S-21 (step S-22).

According to the present invention described above, (I) the discriminant value that is the value of the multivariate discriminant with the concentration of the amino acid as the explanatory variable is calculated based on both (i) the concentration value of at least one of Glu, Ser, Pro, Gly, Ala, Cys2, Tyr, Val, Orn, Met, Lys, Ile, Leu, Phe, and Trp contained in the amino acid concentration data of the subject and (ii) the multivariate discriminant containing at least one of Glu, Ser, Pro, Gly, Ala, Cys2, Tyr, Val, Orn, Met, Lys, Ile, Leu, Phe, and Trp as the explanatory variable, and (II) the state of at least one of the apparent obesity, the non-apparent obesity, and the obesity that are defined by the BMI and the VFA in the subject is evaluated based on the calculated discriminant value. Thus, the discriminant values obtained in the multivariate discriminants correlated significantly with the state of the apparent obesity, the non-apparent obesity, or the obesity can be utilized to bring about the effect of enabling an accurate evaluation of the state of the apparent obesity, the non-apparent obesity, or the obesity.

In step S-22, the discrimination between the healthy state defined by the BMI and the VFA and the apparent obesity, between the healthy state and the non-apparent obesity, between the healthy state and the obesity, between the apparent obesity and the non-apparent obesity, between the apparent obesity and the obesity, between the non-apparent obesity and the obesity, or between “the healthy state or the apparent obesity” and “the non-apparent obesity or the obesity” in the subject may be conducted based on the discriminant value calculated in step S-21. Specifically, the discriminant value may be compared with a previously established threshold (cutoff value), thereby discriminating between the healthy state and the apparent obesity, between the healthy state and the non-apparent obesity, between the healthy state and the obesity, between the apparent obesity and the non-apparent obesity, between the apparent obesity and the obesity, between the non-apparent obesity and the obesity, or between “the healthy state or the apparent obesity” and “the non-apparent obesity or the obesity” in the subject. Thus, the discriminant values obtained in the multivariate discriminants useful for the 2-group discrimination of the healthy state and the apparent obesity, the 2-group discrimination of the healthy state and the non-apparent obesity, the 2-group discrimination of the healthy state and the obesity, the 2-group discrimination of the apparent obesity and the non-apparent obesity, the 2-group discrimination of the apparent obesity and the obesity, the 2-group discrimination of the non-apparent obesity and the obesity, or the 2-group discrimination of the healthy state or the apparent obesity and the non-apparent obesity or the obesity, can be utilized to bring about the effect of enabling accurately these 2-group discriminations.

The multivariate discriminant may be any one of a fractional expression, the sum of a plurality of the fractional expressions, a logistic regression equation, a linear discriminant, a multiple regression equation, a discriminant prepared by a support vector machine, a discriminant prepared by a Mahalanobis' generalized distance method, a discriminant prepared by canonical discriminant analysis, and a discriminant prepared by a decision tree. Thus, the discriminant values obtained in the multivariate discriminants useful for the 2-group discrimination of the healthy state and the apparent obesity, the 2-group discrimination of the healthy state and the non-apparent obesity, the 2-group discrimination of the healthy state and the obesity, the 2-group discrimination of the apparent obesity and the non-apparent obesity, the 2-group discrimination of the apparent obesity and the obesity, the 2-group discrimination of the non-apparent obesity and the obesity, or the 2-group discrimination of the healthy state or the apparent obesity and the non-apparent obesity or the obesity, can be utilized to bring about the effect of enabling more accurately these 2-group discriminations.

Specifically, when discriminating between the healthy state and the apparent obesity, the multivariate discriminant may be a formula 1, a formula 2, the logistic regression equation with Glu, Thr, and Phe as the explanatory variables, the logistic regression equation with Pro, Asn, Thr, Arg, Tyr, and Orn as the explanatory variables, the linear discriminant with His, Thr, Val, Orn, and Trp as the explanatory variables, or the linear discriminant with Ser, Pro, Asn, Orn, Phe, Val, Leu, and Ile as the explanatory variables:

a₁(Glu/Gly)+b₁(His/Ile)+c₁(Thr/Phe)+d₁ (formula 1)

a₂(Pro/Ser)+b₂(Thr/Asn)+c₂(Arg/Tyr)+d₂(Orn/Gln)+e₂ (formula 2)

wherein in the formula 1, a₁, b₁, and c₁ are arbitrary non-zero real numbers and d₁ is an arbitrary real number and in the formula 2, a₂, b₂, c₂, and d₂ are arbitrary non-zero real numbers and e₂ is an arbitrary real number. Thus, the discriminant values obtained in the multivariate discriminants useful particularly for the 2-group discrimination of the healthy state and the apparent obesity, can be utilized to bring about the effect of enabling more accurately the 2-group discrimination.

When discriminating between the healthy state and the non-apparent obesity, the multivariate discriminant may be a formula 3, a formula 4, the logistic regression equation with Glu, Ser, Ala, Orn, Leu, and Trp as the explanatory variables, the logistic regression equation with Glu, Ser, Gly, Cit, Ala, Val, Leu, and Ile as the explanatory variables, the linear discriminant with Glu, Ser, His, Thr, Lys, and Phe as the explanatory variables, or the linear discriminant with Glu, His, ABA, Tyr, Met, and Lys as the explanatory variables:

a₃(Ser/Ala)+b₃(Gly/Tyr)+c₃(Trp/Glu)+d₃ (formula 3)

a₄(Ser/Cit)+b₄(Gly/(Val+Leu+Ile))+c₄(Gln/Ala)+d₄(Thr/Glu)+e₄ (formula 4)

wherein in the formula 3, a₃, b₃, and c₃ are arbitrary non-zero real numbers and d₃ is an arbitrary real number and in the formula 4, a₄, b₄, c₄, and d₄ are arbitrary non-zero real numbers and e₄ is an arbitrary real number. Thus, the discriminant values obtained in the multivariate discriminants useful particularly for the 2-group discrimination of the healthy state and the non-apparent obesity, can be utilized to bring about the effect of enabling more accurately the 2-group discrimination.

When discriminating between the healthy state and the obesity, the multivariate discriminant may be a formula 5, a formula 6, the logistic regression equation with Glu, Ser, Cit, Ala, Tyr, and Trp as the explanatory variables, the logistic regression equation with Glu, Ser, Ala, Tyr, Trp, Val, Leu, and Ile as the explanatory variables, the linear discriminant with Glu, Thr, Ala, Tyr, Orn, and Lys as the explanatory variables, or the linear discriminant with Glu, Pro, His, Cit, Orn, and Lys as the explanatory variables:

a₅(Glu/Ser)+b₅(Cit/Ala)+c₅(Trp/Tyr)+d₅ (formula 5)

a₆(Glu/Gly)+b₆(Ser/Ala)+c₆(Trp/Tyr)+d₆((Val+Leu+Ile)/Asn)+e₆ (formula 6)

wherein in the formula 5, a₅, b₅, and c₅ are arbitrary non-zero real numbers and d₅ is an arbitrary real number and in the formula 6, a₆, b₆, c₆, and d₆ are arbitrary non-zero real numbers and e₆ is an arbitrary real number. Thus, the discriminant values obtained in the multivariate discriminants useful particularly for the 2-group discrimination of the healthy state and the obesity, can be utilized to bring about the effect of enabling more accurately the 2-group discrimination.

When discriminating between the apparent obesity and the non-apparent obesity, the multivariate discriminant may be a formula 7, a formula 8, the logistic regression equation with Glu, Thr, Ala, Arg, Tyr, and Lys as the explanatory variables, the logistic regression equation with Pro, Gly, Gln, Ala, Orn, Val, Leu, and Ile as the explanatory variables, the linear discriminant with His, Thr, Ala, Tyr, Orn, and Phe as the explanatory variables, or the linear discriminant with Ser, Pro, Gly, Cit, Lys, and Phe as the explanatory variables:

a₇(Thr/Tyr)+b₇(Ala/Ile)+c₇(Arg/Gln)+d₇ (formula 7)

a₈(Pro/(Val+Leu+Ile))+b₈(Gly/Orn)+c₈(Gln/Ala)+d₈(ABA/Thr)+e₈ (formula 8)

wherein in the formula 7, a₇, b₇, and c₇ are arbitrary non-zero real numbers and d₇ is an arbitrary real number and in the formula 8, a₈, b₈, c₈, and d₈ are arbitrary non-zero real numbers and e₈ is an arbitrary real number. Thus, the discriminant values obtained in the multivariate discriminants useful particularly for the 2-group discrimination of the apparent obesity and the non-apparent obesity, can be utilized to bring about the effect of enabling more accurately the 2-group discrimination.

When discriminating between the apparent obesity and the obesity, the multivariate discriminant may be a formula 9, a formula 10, the logistic regression equation with Glu, Asn, Gly, His, Leu, and Trp as the explanatory variables, the logistic regression equation with Glu, Ala, ABA, Met, Lys, Val, Leu, and Ile as the explanatory variables, the linear discriminant with Glu, Gly, His, Ala, and Lys as the explanatory variables, or the linear discriminant with Glu, Thr, Ala, ABA, Lys, Val, Leu, and Ile as the explanatory variables:

a₉(Gly/Glu)+b₉(His/Trp)+c₉(Leu/Gln)+d₉ (formula 9)

a₁₀(Glu/Asn)+b₁₀(ABA/Ser)+C₁₀(Lys/Gln)+d₁₀((Val+Leu+Ile)/Trp))+e₁₀ (formula 10)

wherein in the formula 9, a₉, b₉, and c₉ are arbitrary non-zero real numbers and d₉ is an arbitrary real number and in the formula 10, a₁₀, b₁₀, c₁₀, and d₁₀ are arbitrary non-zero real numbers and e₁₀ is an arbitrary real number. Thus, the discriminant values obtained in the multivariate discriminants useful particularly for the 2-group discrimination of the apparent obesity and the obesity, can be utilized to bring about the effect of enabling more accurately the 2-group discrimination.

When discriminating between the non-apparent obesity and the obesity, the multivariate discriminant may be a formula 11, a formula 12, the logistic regression equation with Glu, Gly, Cit, Tyr, Val, and Phe as the explanatory variables, the logistic regression equation with Glu, Pro, Cit, Tyr, Phe, and Trp as the explanatory variables, the linear discriminant with Glu, Cit, Tyr, Orn, Met, and Trp as the explanatory variables, or the linear discriminant with Glu, Pro, His, Met, and Phe as the explanatory variables:

a₁₁(Glu/Gln)+b₁₁(Tyr/Gly)+c₁₁(Lys/Trp)+d₁₁ (formula 11)

a₁₂(Glu/Asn)+b₁₂(His/Thr)+c₁₂(Phe/Cit)+d₁₂(Trp/Tyr)+e₁₂ (formula 12)

wherein in the formula 11, a₁₁, b₁₁, and c₁₁ are arbitrary non-zero real numbers and d₁₁ is an arbitrary real number and in the formula 12, a₁₂, b₁₂, c₁₂, and d₁₂ are arbitrary non-zero real numbers and e₁₂ is an arbitrary real number. Thus, the discriminant values obtained in the multivariate discriminants useful particularly for the 2-group discrimination of the non-apparent obesity and the obesity, can be utilized to bring about the effect of enabling more accurately the 2-group discrimination.

When discriminating between “the healthy state or the apparent obesity” and “the non-apparent obesity or the obesity”, the multivariate discriminant may be a formula 13, the logistic regression equation with Glu, Gly, Ala, Tyr, Trp, Val, Leu, and Ile as the explanatory variables, or the linear discriminant with Glu, Ala, Arg, Tyr, Orn, Val, Leu, and Ile as the explanatory variables:

a₁₃(Glu/Asn)+b₁₃(Ser/Ala)+c₁₃(Cit/Phe)+d₁₃(Tyr/Trp)+e₁₃ (formula 13)

wherein in the formula 13, a₁₃, b₁₃, c₁₃, and d₁₃ are arbitrary non-zero real numbers and e₁₃ is an arbitrary real number. Thus, the discriminant values obtained in the multivariate discriminants useful particularly for the 2-group discrimination of the healthy state or the apparent obesity and the non-apparent obesity or the obesity, can be utilized to bring about the effect of enabling more accurately the 2-group discrimination.

The multivariate discriminant described above can be prepared by a method described in International Publication WO 2004/052191 that is an international application filed by the present applicant or by a method (multivariate discriminant-preparing processing described later) described in International Publication WO 2006/098192 that is an international application filed by the present applicant. Any multivariate discriminants obtained by these methods can be preferably used in the evaluation of the state of the apparent obesity, the non-apparent obesity or the obesity defined by the BMI and the VFA, regardless of the unit of the amino acid concentration in the amino acid concentration data as input data.

In the fractional expression, the numerator of the fractional expression is expressed by the sum of the amino acids A, B, C etc. and the denominator of the fractional expression is expressed by the sum of the amino acids a, b, c etc. The fractional expression also includes the sum of the fractional expressions α, β, γ etc. (for example, α+β) having such constitution. The fractional expression also includes divided fractional expressions. The amino acids used in the numerator or denominator may have suitable coefficients respectively. The amino acids used in the numerator or denominator may appear repeatedly. Each fractional expression may have a suitable coefficient. A value of a coefficient for each explanatory variable and a value for a constant term may be any real numbers. In combinations where explanatory variables in the numerator and explanatory variables in the denominator in the fractional expression are switched with each other, the positive (or negative) sign is generally reversed in correlation with objective explanatory variables, but because their correlation is maintained, such combinations can be assumed to be equivalent to one another in discrimination, and thus the fractional expression also includes combinations where explanatory variables in the numerator and explanatory variables in the denominator in the fractional expression are switched with each other.

The multivariate discriminant refers to a form of equation used generally in multivariate analysis and includes, for example, multiple regression equation, multiple logistic regression equation, linear discriminant function, Mahalanobis' generalized distance, canonical discriminant function, support vector machine, and decision tree. The multivariate discriminant also includes an equation shown by the sum of different forms of the multivariate discriminants. In the multiple regression equation, multiple logistic regression equation and canonical discriminant function, a coefficient and constant term are added to each explanatory variable, and the coefficient and constant term in this case are preferably real numbers, more preferably values in the range of 99% confidence interval for the coefficient and constant term obtained from data for discrimination, more preferably in the range of 95% confidence interval for the coefficient and constant term obtained from data for discrimination. The value of each coefficient and the confidence interval thereof may be those multiplied by a real number, and the value of each constant term and the confidence interval thereof may be those having an arbitrary actual constant added or subtracted or those multiplied or divided by an arbitrary actual constant. When an expression such as a logistic regression, a linear discriminant, and a multiple regression analysis is used as an index, a linear transformation of the expression (addition of a constant and multiplication by a constant) and a monotonic increasing (decreasing) transformation (for example, a logit transformation) of the expression do not alter discrimination capability, and thus are equivalent. Therefore, the expression includes an expression that is subjected to a linear transformation and a monotonic increasing (decreasing) transformation.

When the state of the apparent obesity, the non-apparent obesity, or the obesity is evaluated in the present invention, another biological information (e.g., biological metabolites such as glucose, lipid, protein, peptide, mineral and hormone, and biological indices such as blood glucose level, blood pressure level, sex, age, hepatic disease index, dietary habit, drinking habit, exercise habit, obesity level and disease history) may be used in addition to the amino acid concentration. When the state of the apparent obesity, the non-apparent obesity, or the obesity is evaluated in the present invention, another biological information (e.g., biological metabolites such as glucose, lipid, protein, peptide, mineral and hormone, and biological indices such as blood glucose level, blood pressure level, sex, age, hepatic disease index, dietary habit, drinking habit, exercise habit, obesity level and disease history) may be used as the explanatory variables in the multivariate discriminant in addition to the amino acid concentration.

Here, the summary of the multivariate discriminant-preparing processing (steps 1 to 4) is described in detail.

First, a candidate multivariate discriminant (e.g., y=a₁x₁+a₂x₂+ . . . +aₙxₙ, y: obesity state index data, xᵢ: amino acid concentration data, aᵢ: constant, i=1, 2, . . . , n) that is a candidate for the multivariate discriminant is prepared in the control device based on a predetermined discriminant-preparing method from obesity state information stored in the memory device containing the amino acid concentration data and obesity state index data on an index for indicating the state of at least one of the apparent obesity, the non-apparent obesity and the obesity (step 1). Data containing defective and outliers may be removed in advance from the obesity state information.

In step 1, a plurality of the candidate multivariate discriminants may be prepared from the obesity state information by using a plurality of the different discriminant-preparing methods (including those for multivariate analysis such as principal component analysis, discriminant analysis, support vector machine, multiple regression analysis, logistic regression analysis, k-means method, cluster analysis, and decision tree). Specifically, a plurality of the candidate multivariate discriminants may be prepared simultaneously and concurrently by using a plurality of different algorithms with the obesity state information which is multivariate data composed of the amino acid concentration data and the obesity state index data obtained by analyzing blood samples from a large number of healthy groups and obesity groups. For example, the two different candidate multivariate discriminants may be formed by performing discriminant analysis and logistic regression analysis simultaneously with the different algorithms. Alternatively, the candidate multivariate discriminant may be formed by converting the obesity state information with the candidate multivariate discriminant prepared by performing principal component analysis and then performing discriminant analysis of the converted obesity state information. In this way, it is possible to finally prepare the multivariate discriminant suitable for diagnostic condition.

The candidate multivariate discriminant prepared by principal component analysis is a linear expression consisting of amino acid explanatory variables maximizing the variance of all amino acid concentration data. The candidate multivariate discriminant prepared by discriminant analysis is a high-powered expression (including exponential and logarithmic expressions) consisting of amino acid explanatory variables minimizing the ratio of the sum of the variances in respective groups to the variance of all amino acid concentration data. The candidate multivariate discriminant prepared by using support vector machine is a high-powered expression (including kernel function) consisting of amino acid explanatory variables maximizing the boundary between groups. The candidate multivariate discriminant prepared by multiple regression analysis is a high-powered expression consisting of amino acid explanatory variables minimizing the sum of the distances from all amino acid concentration data. The candidate multivariate discriminant prepared by logistic regression analysis is a fraction expression having, as a component, the natural logarithm having a linear expression consisting of amino acid explanatory variables maximizing the likelihood as the exponent. The k-means method is a method of searching k pieces of neighboring amino acid concentration data in various groups, designating the group containing the greatest number of the neighboring points as its data-belonging group, and selecting the amino acid explanatory variable that makes the group to which input amino acid concentration data belong agree well with the designated group. The cluster analysis is a method of clustering (grouping) the points closest in entire amino acid concentration data. The decision tree is a method of ordering amino acid explanatory variables and predicting the group of amino acid concentration data from the pattern possibly held by the higher-ordered amino acid explanatory variable.

Returning to the description of the multivariate discriminant-preparing processing, the candidate multivariate discriminant prepared in step 1 is verified (mutually verified) in the control device based on a particular verifying method (step 2). The verification of the candidate multivariate discriminant is performed on each other to each candidate multivariate discriminant prepared in step 1.

In step 2, at least one of discrimination rate, sensitivity, specificity, information criterion, and the like of the candidate multivariate discriminant may be verified by at least one of the bootstrap method, holdout method, leave-one-out method, and the like. In this way, it is possible to prepare the candidate multivariate discriminant higher in predictability or reliability, by taking the obesity state information and the diagnostic condition into consideration.

The discrimination rate is the rate of the obesity states judged correct according to the present invention in all input data. The sensitivity is the rate of the obesity states judged correct according to the present invention in the obesity states declared obesity in the input data. The specificity is the rate of the obesity states judged correct according to the present invention in the obesity states declared healthy in the input data. The information criterion is the sum of the number of the amino acid explanatory variables in the candidate multivariate discriminant prepared in step 1 and the difference in number between the obesity states evaluated according to the present invention and those declared in input data. The predictability is the average of the discrimination rate, sensitivity, or specificity obtained by repeating verification of the candidate multivariate discriminant. Alternatively, the reliability is the variance of the discrimination rate, sensitivity, or specificity obtained by repeating verification of the candidate multivariate discriminant.

Returning to the description of the multivariate discriminant-preparing processing, a combination of the amino acid concentration data contained in the obesity state information used in preparing the candidate multivariate discriminant is selected by selecting the explanatory variable of the candidate multivariate discriminant in the control device based on a predetermined explanatory variable-selecting method from the verification result obtained in step 2 (step 3). The selection of the amino acid explanatory variable is performed on each candidate multivariate discriminant prepared in step 1. In this way, it is possible to select the amino acid explanatory variable of the candidate multivariate discriminant properly. The step 1 is executed once again by using the obesity state information including the amino acid concentration data selected in step 3.

In step 3, the amino acid explanatory variable of the candidate multivariate discriminant may be selected based on at least one of the stepwise method, best path method, local search method, and genetic algorithm from the verification result obtained in step 2.

The best path method is a method of selecting an amino acid explanatory variable by optimizing an evaluation index of the candidate multivariate discriminant while eliminating the amino acid explanatory variables contained in the candidate multivariate discriminant one by one.

Returning to the description of the multivariate discriminant-preparing processing, the steps 1, 2 and 3 are repeatedly performed in the control device, and based on verification results thus accumulated, the candidate multivariate discriminant used as the multivariate discriminant is selected from a plurality of the candidate multivariate discriminants, thereby preparing the multivariate discriminant (step 4). In the selection of the candidate multivariate discriminant, there are cases where the optimum multivariate discriminant is selected from the candidate multivariate discriminants prepared in the same discriminant-preparing method or the optimum multivariate discriminant is selected from all candidate multivariate discriminants.

As described above, in the multivariate discriminant-preparing processing, the processing for the preparation of the candidate multivariate discriminants, the verification of the candidate multivariate discriminants, and the selection of the explanatory variables in the candidate multivariate discriminants are performed based on the obesity state information in a series of operations in a systematized manner, whereby the multivariate discriminant most appropriate for evaluating the state of the apparent obesity, the non-apparent obesity and the obesity can be prepared. In other words, in the multivariate discriminant-preparing processing, the amino acid concentration is used in multivariate statistical analysis, and for selecting the optimum and robust combination of the explanatory variables, the explanatory variable-selecting method is combined with cross-validation to extract the multivariate discriminant having high diagnosis performance. Logistic regression equation, linear discriminant, discriminant prepared by support vector machine, discriminant prepared by Mahalanobis' generalized distance method, equation prepared by multiple regression analysis, discriminant prepared by cluster analysis, and the like can be used in the multivariate discriminant.

### 2-2. System Configuration

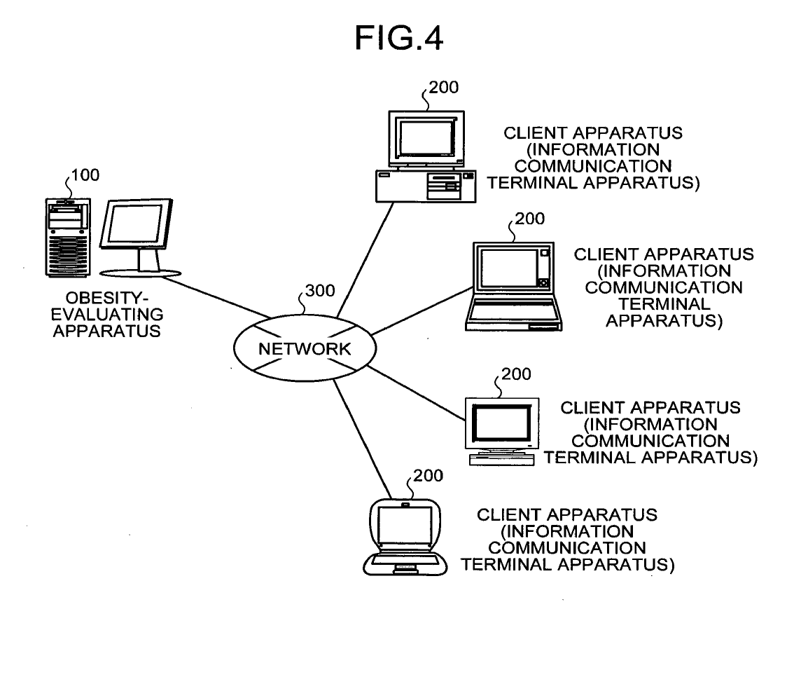

Hereinafter, the configuration of the obesity-evaluating system according to the second embodiment (hereinafter referred to sometimes as the present system) will be described with reference to FIGS. 4 to 20. This system is merely one example, and the present invention is not limited thereto.

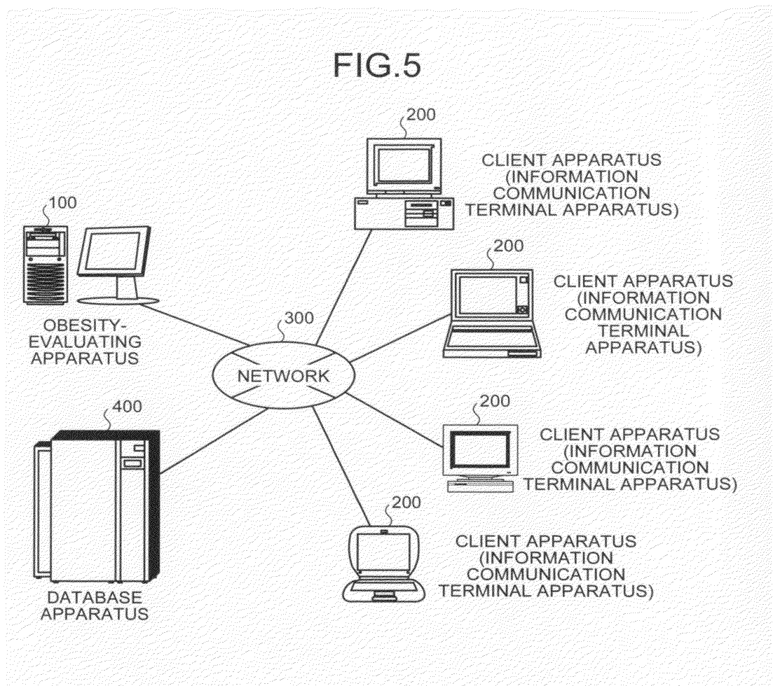

First, an entire configuration of the present system will be described with reference to FIGS. 4 and 5. FIG. 4 is a diagram showing an example of the entire configuration of the present system. FIG. 5 is a diagram showing another example of the entire configuration of the present system. As shown in FIG. 4, the present system is constituted in which the obesity-evaluating apparatus 100 that evaluates the state of at least one of the apparent obesity, the non-apparent obesity and the obesity that are defined by the BMI and the VFA in the subject, and the client apparatus 200 (corresponding to the information communication terminal apparatus of the present invention) that provides the amino acid concentration data of the subject on the concentration values of the amino acids, are communicatively connected to each other via a network 300.

In the present system as shown in FIG. 5, in addition to the obesity-evaluating apparatus 100 and the client apparatus 200, the database apparatus 400 storing, for example, the obesity state information used in preparing the multivariate discriminant and the multivariate discriminant used in evaluating the state of the apparent obesity, the non-apparent obesity or the obesity in the obesity-evaluating apparatus 100, may be communicatively connected via the network 300. In this configuration, the information on the state of the apparent obesity, the non-apparent obesity or the obesity etc. are provided via the network 300 from the obesity-evaluating apparatus 100 to the client apparatuses 200 and the database apparatus 400, or from the client apparatuses 200 and the database apparatus 400 to the obesity-evaluating apparatus 100. The “information on the state of the apparent obesity, the non-apparent obesity or the obesity” is information on the measured values of particular items of the state of the apparent obesity, the non-apparent obesity or the obesity of organisms including human. The information on the state of the apparent obesity, the non-apparent obesity or the obesity is generated in the obesity-evaluating apparatus 100, client apparatus 200, or other apparatuses (e.g., various measuring apparatuses) and stored mainly in the database apparatus 400.

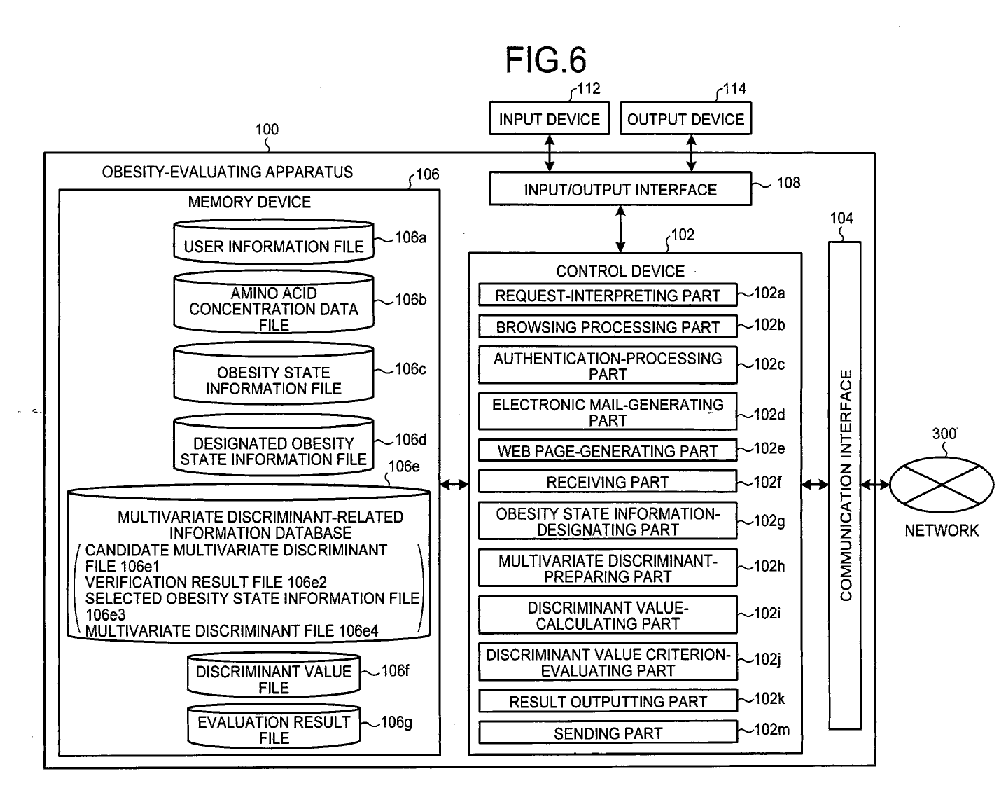

Now, the configuration of the obesity-evaluating apparatus 100 in the present system will be described with reference to FIGS. 6 to 18. FIG. 6 is a block diagram showing an example of the configuration of the obesity-evaluating apparatus 100 in the present system, showing conceptually only the region relevant to the present invention.

The obesity-evaluating apparatus 100 includes (a) a control device 102, such as CPU (Central Processing Unit), that integrally controls the obesity-evaluating apparatus 100, (b) a communication interface 104 that connects the obesity-evaluating apparatus 100 to the network 300 communicatively via communication apparatuses such as a router and wired or wireless communication lines such as a private line, (c) a memory device 106 that stores various databases, tables, files and others, and (d) an input/output interface 108 connected to an input device 112 and an output device 114, and these parts are connected to each other communicatively via any communication channel. The obesity-evaluating apparatus 100 may be present together with various analyzers (e.g., amino acid analyzer) in a same housing. A typical configuration of disintegration/integration of the obesity-evaluating apparatus 100 is not limited to that shown in the figure, and all or a part of it may be disintegrated or integrated functionally or physically in any unit, for example, according to various loads applied. For example, a part of the processing may be performed via CGI (Common Gateway Interface).

The memory device 106 is a storage means, and examples thereof include memory apparatuses such as RAM (Random Access Memory) and ROM (Read Only Memory), fixed disk drives such as a hard disk, a flexible disk, an optical disk, and the like. The memory device 106 stores computer programs giving instructions to the CPU for various processings, together with OS (Operating System). As shown in the figure, the memory device 106 stores the user information file 106a, the amino acid concentration data file 106b, the obesity state information file 106c, the designated obesity state information file 106d, a multivariate discriminant-related information database 106e, the discriminant value file 106f and the evaluation result file 106g.

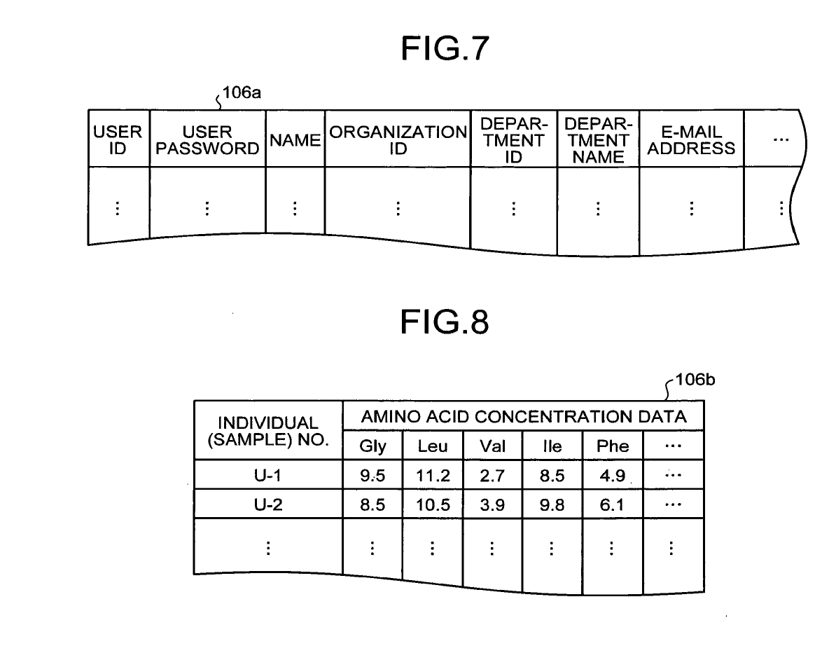

The user information file 106a stores user information on users. FIG. 7 is a chart showing an example of information stored in the user information file 106a. As shown in FIG. 7, the information stored in the user information file 106a includes user ID (identification) for identifying a user uniquely, user password for authentication of the user, user name, organization ID for uniquely identifying an organization of the user, department ID for uniquely identifying a department of the user organization, department name, and electronic mail address of the user that are correlated to one another.

Returning to FIG. 6, the amino acid concentration data file 106b stores the amino acid concentration data on the concentration values of the amino acids. FIG. 8 is a chart showing an example of information stored in the amino acid concentration data file 106b. As shown in FIG. 8, the information stored in the amino acid concentration data file 106b includes individual number for uniquely identifying an individual (sample) as a subject to be evaluated and amino acid concentration data that are correlated to one another. In FIG. 8, the amino acid concentration data is assumed to be numerical values, i.e., on a continuous scale, but the amino acid concentration data may be expressed on a nominal scale or an ordinal scale. In the case of the nominal or ordinal scale, any number may be allocated to each state for analysis. The amino acid concentration data may be combined with other biological information (e.g., biological metabolites such as glucose, lipid, protein, peptide, mineral and hormone, and biological indices such as blood glucose level, blood pressure level, sex, age, hepatic disease index, dietary habit, drinking habit, exercise habit, obesity level and disease history).

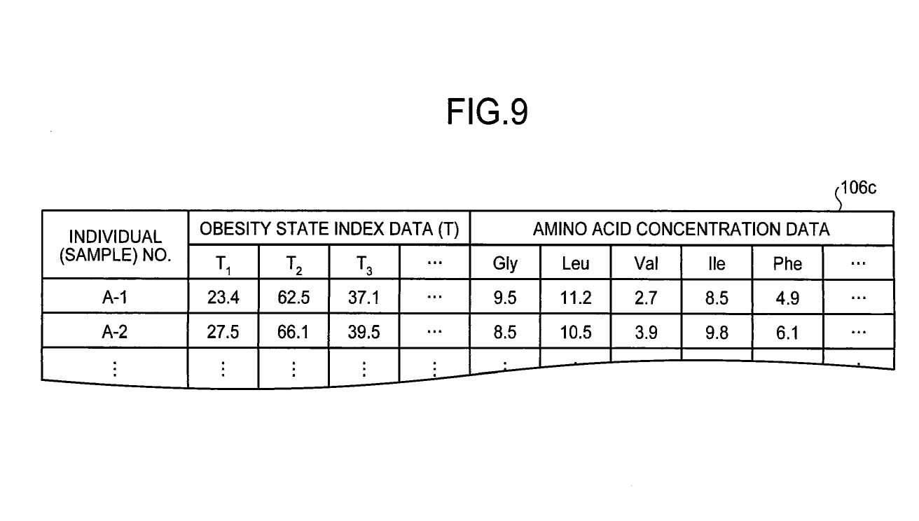

Returning to FIG. 6, the obesity state information file 106c stores the obesity state information used in preparing the multivariate discriminant. FIG. 9 is a chart showing an example of information stored in the obesity state information file 106c. As shown in FIG. 9, the information stored in the obesity state information file 106c includes individual (sample) number, obesity state index data (T) on index (index T₁, index T₂, index T₃ . . . ) for indicating the state of the apparent obesity, the non-apparent obesity or the obesity, and amino acid concentration data that are correlated to one another. In FIG. 9, the obesity state index data and the amino acid concentration data are assumed to be numerical values, i.e., on a continuous scale, but the obesity state index data and the amino acid concentration data may be expressed on a nominal scale or an ordinal scale. In the case of the nominal or ordinal scale, any number may be allocated to each state for analysis. The obesity state index data is a single known condition index serving as a marker of the state of the apparent obesity, the non-apparent obesity or the obesity, and numerical data may be used.

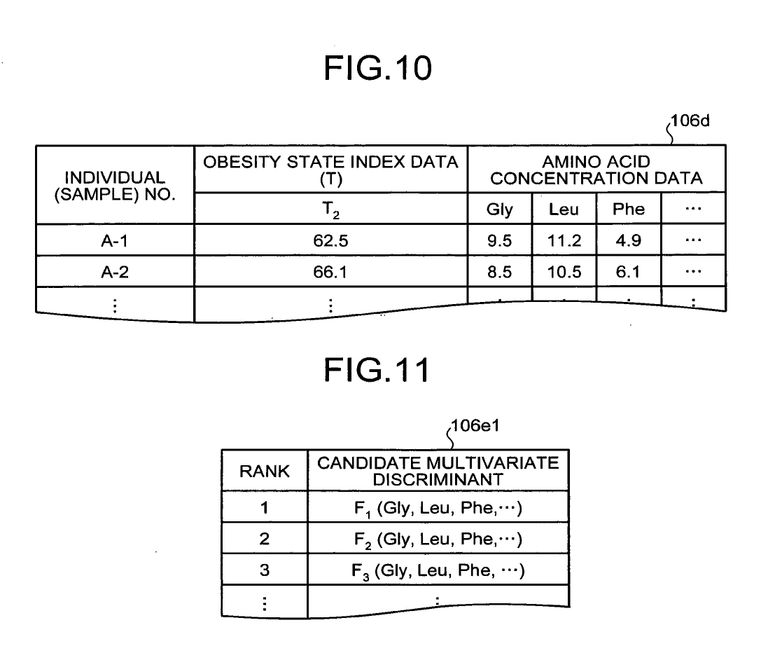

Returning to FIG. 6, the designated obesity state information file 106d stores the obesity state information designated in an obesity state information-designating part 102g described below. FIG. 10 is a chart showing an example of information stored in the designated obesity state information file 106d. As shown in FIG. 10, the information stored in the designated obesity state information file 106d includes individual number, designated obesity state index data, and designated amino acid concentration data that are correlated to one another.

Returning to FIG. 6, the multivariate discriminant-related information database 106e is composed of (i) the candidate multivariate discriminant file 106e1 storing the candidate multivariate discriminant prepared in a candidate multivariate discriminant-preparing part 102h1 described below, (ii) the verification result file 106e2 storing the verification results obtained in a candidate multivariate discriminant-verifying part 102h2 described below, (iii) the selected obesity state information file 106e3 storing the obesity state information containing the combination of the amino acid concentration data selected in an explanatory variable-selecting part 102h3 described below, and (iv) the multivariate discriminant file 106e4 storing the multivariate discriminant prepared in the multivariate discriminant-preparing part 102h described below.

The candidate multivariate discriminant file 106e1 stores the candidate multivariate discriminants prepared in the candidate multivariate discriminant-preparing part 102h1 described below. FIG. 11 is a chart showing an example of information stored in the candidate multivariate discriminant file 106e1. As shown in FIG. 11, the information stored in the candidate multivariate discriminant file 106e1 includes rank, and candidate multivariate discriminant (e.g., F₁ (Gly, Leu, Phe, . . . ), F₂ (Gly, Leu, Phe, . . . ), or F₃ (Gly, Leu, Phe, . . . ) in FIG. 11) that are correlated to each other.

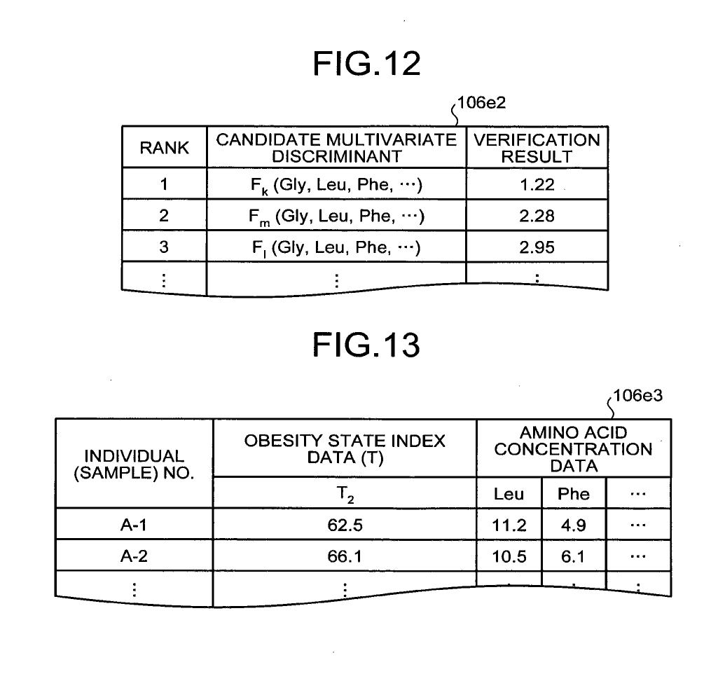

Returning to FIG. 6, the verification result file 106e2 stores the verification results obtained in the candidate multivariate discriminant-verifying part 102h2 described below. FIG. 12 is a chart showing an example of information stored in the verification result file 106e2. As shown in FIG. 12, the information stored in the verification result file 106e2 includes rank, candidate multivariate discriminant (e.g., Fₖ (Gly, Leu, Phe, . . . ), Fₘ (Gly, Leu, Phe, . . . ), F₁ (Gly, Leu, Phe, . . . ) in FIG. 12), and verification result of each candidate multivariate discriminant (e.g., evaluation value of each candidate multivariate discriminant) that are correlated to one another.

Returning to FIG. 6, the selected obesity state information file 106e3 stores the obesity state information including the combination of the amino acid concentration data corresponding to the explanatory variables selected in the explanatory variable-selecting part 102h3 described below. FIG. 13 is a chart showing an example of information stored in the selected obesity state information file 106e3. As shown in FIG. 13, the information stored in the selected obesity state information file 106e3 includes individual number, obesity state index data designated in the obesity state information-designating part 102g described below, and amino acid concentration data selected in the explanatory variable-selecting part 102h3 described below that are correlated to one another.

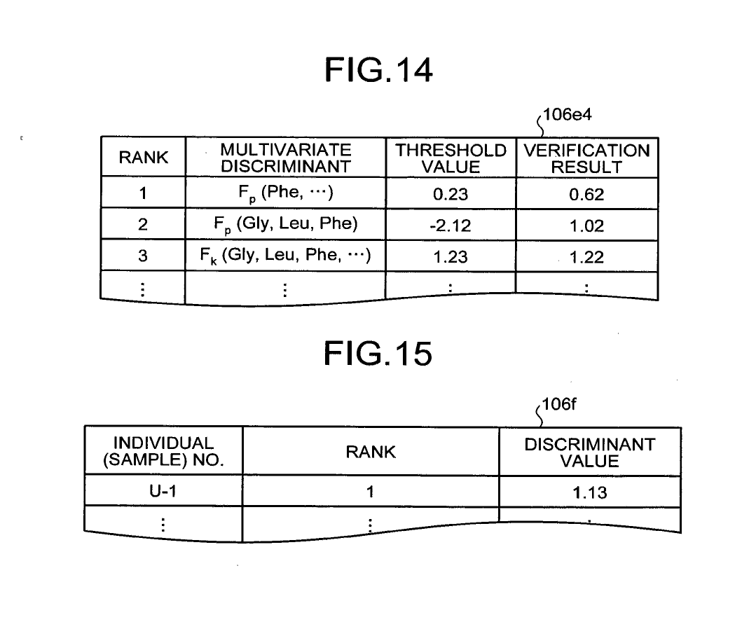

Returning to FIG. 6, the multivariate discriminant file 106e4 stores the multivariate discriminants prepared in the multivariate discriminant-preparing part 102h described below. FIG. 14 is a chart showing an example of information stored in the multivariate discriminant file 106e4. As shown in FIG. 14, the information stored in the multivariate discriminant file 106e4 includes rank, multivariate discriminant (e.g., Fₚ (Phe, . . . ), Fₚ (Gly, Leu, Phe), Fₖ (Gly, Leu, Phe, . . . ) in FIG. 14), a threshold corresponding to each discriminant-preparing method, and verification result of each multivariate discriminant (e.g., evaluation value of each multivariate discriminant) that are correlated to one another.

Returning to FIG. 6, the discriminant value file 106f stores the discriminant value calculated in a discriminant value-calculating part 102i described below. FIG. 15 is a chart showing an example of information stored in the discriminant value file 106f. As shown in FIG. 15, the information stored in the discriminant value file 106f includes individual number for uniquely identifying the individual (sample) as the subject, rank (number for uniquely identifying the multivariate discriminant), and discriminant value that are correlated to one another.

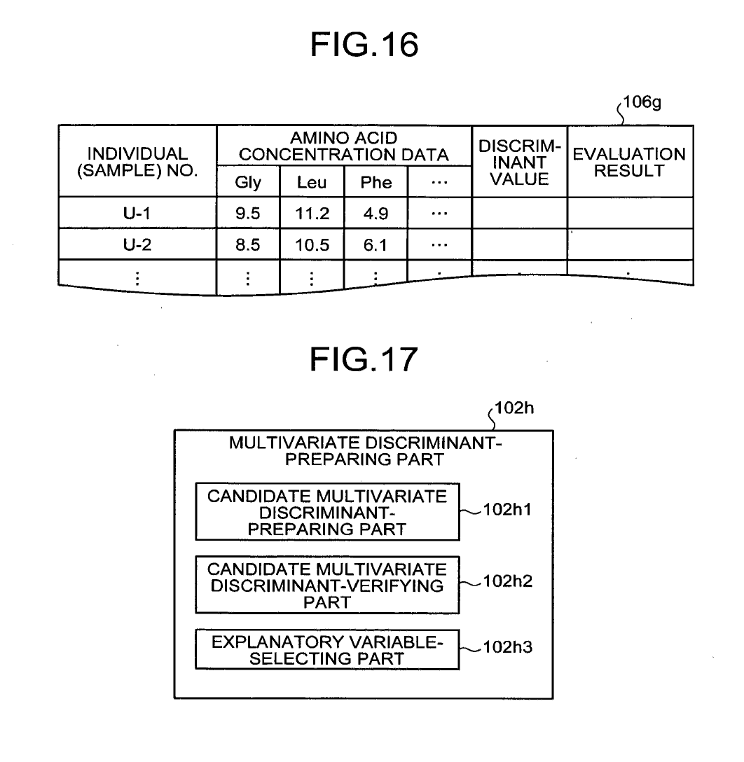

Returning to FIG. 6, the evaluation result file 106g stores the evaluation results obtained in the discriminant value criterion-evaluating part 102j described below (specifically the discrimination results obtained in a discriminant value criterion-discriminating part 102j1 described below). FIG. 16 is a chart showing an example of information stored in the evaluation result file 106g. The information stored in the evaluation result file 106g includes individual number for uniquely identifying the individual (sample) as the subject, previously obtained amino acid concentration data of the subject, discriminant value calculated by multivariate discriminant, and evaluation result on the state of the apparent obesity, the non-apparent obesity or the obesity, that are correlated to one another.

Returning to FIG. 6, the memory device 106 stores various Web data for providing the client apparatuses 200 with web site information, CGI programs, and others as information other than the information described above. The Web data include data for displaying the Web pages described below and others, and the data are generated as, for example, a HTML (HyperText Markup Language) or XML (Extensible Markup Language) text file. Files for components and files for operation for generation of the Web data, and other temporary files, and the like are also stored in the memory device 106. In addition, the memory device 106 may store as needed sound files of sounds for transmission to the client apparatuses 200 in WAVE format or AIFF (Audio Interchange File Format) format and image files of still images or motion pictures in JPEG (Joint Photographic Experts Group) format or MPEG2 (Moving Picture Experts Group phase 2) format.

The communication interface 104 allows communication between the obesity-evaluating apparatus 100 and the network 300 (or communication apparatus such as a router). Thus, the communication interface 104 has a function to communicate data via a communication line with other terminals.

The input/output interface 108 is connected to the input device 112 and the output device 114. A monitor (including a home television), a speaker, or a printer may be used as the output device 114 (hereinafter, the output device 114 may be described as a monitor 114). A keyboard, a mouse, a microphone, or a monitor functioning as a pointing device together with a mouse may be used as the input device 112.

The control device 102 has an internal memory storing control programs such as OS (Operating System), programs for various processing procedures, and other needed data, and performs various information processings according to these programs. As shown in the figure, the control device 102 includes mainly a request-interpreting part 102a, a browsing processing part 102b, an authentication-processing part 102c, an electronic mail-generating part 102d, a Web page-generating part 102e, a receiving part 102f, the obesity state information-designating part 102g, the multivariate discriminant-preparing part 102h, the discriminant value-calculating part 102i, the discriminant value criterion-evaluating part 102j, a result outputting part 102k and a sending part 102m. The control device 102 performs data processings such as removal of data including defective, removal of data including many outliers, and removal of explanatory variables for the defective-including data in the obesity state information transmitted from the database apparatus 400 and in the amino acid concentration data transmitted from the client apparatus 200.

The request-interpreting part 102a interprets the requests transmitted from the client apparatus 200 or the database apparatus 400 and sends the requests to other parts in the control device 102 according to results of interpreting the requests. Upon receiving browsing requests for various screens transmitted from the client apparatus 200, the browsing processing part 102b generates and transmits web data for these screens. Upon receiving authentication requests transmitted from the client apparatus 200 or the database apparatus 400, the authentication-processing part 102c performs authentication. The electronic mail-generating part 102d generates electronic mails including various kinds of information. The Web page-generating part 102e generates Web pages for users to browse with the client apparatus 200.

The receiving part 102f receives, via the network 300, information (specifically, the amino acid concentration data, the obesity state information, the multivariate discriminant etc.) transmitted from the client apparatus 200 and the database apparatus 400. The obesity state information-designating part 102g designates objective obesity state index data and objective amino acid concentration data in preparing the multivariate discriminant.

The multivariate discriminant-preparing part 102h generates the multivariate discriminants based on the obesity state information received in the receiving part 102f and the obesity state information designated in the obesity state information-designating part 102g. Specifically, the multivariate discriminant-preparing part 102h generates the multivariate discriminant by selecting the candidate multivariate discriminant used as the multivariate discriminant from a plurality of the candidate multivariate discriminants, based on verification results accumulated by repeating processings in the candidate multivariate discriminant-preparing part 102h1, the candidate multivariate discriminant-verifying part 102h2, and the explanatory variable-selecting part 102h3 from the obesity state information.

If the multivariate discriminants are stored previously in a predetermined region of the memory device 106, the multivariate discriminant-preparing part 102h may generate the multivariate discriminant by selecting the desired multivariate discriminant out of the memory device 106. Alternatively, the multivariate discriminant-preparing part 102h may generate the multivariate discriminant by selecting and downloading the desired multivariate discriminant from the multivariate discriminants previously stored in another computer apparatus (e.g., the database apparatus 400).

Hereinafter, a configuration of the multivariate discriminant-preparing part 102h will be described with reference to FIG. 17. FIG. 17 is a block diagram showing the configuration of the multivariate discriminant-preparing part 102h, and only a part in the configuration related to the present invention is shown conceptually. The multivariate discriminant-preparing part 102h has the candidate multivariate discriminant-preparing part 102h1, the candidate multivariate discriminant-verifying part 102h2, and the explanatory variable-selecting part 102h3, additionally. The candidate multivariate discriminant-preparing part 102h1 generates the candidate multivariate discriminant that is a candidate of the multivariate discriminant, from the obesity state information based on a predetermined discriminant-preparing method. The candidate multivariate discriminant-preparing part 102h1 may generate a plurality of the candidate multivariate discriminants from the obesity state information, by using a plurality of the different discriminant-preparing methods. The candidate multivariate discriminant-verifying part 102h2 verifies the candidate multivariate discriminant prepared in the candidate multivariate discriminant-preparing part 102h1 based on a particular verifying method. The candidate multivariate discriminant-verifying part 102h2 may verify at least one of the discrimination rate, sensitivity, specificity, and information criterion of the candidate multivariate discriminants based on at least one of the bootstrap method, holdout method, and leave-one-out method. The explanatory variable-selecting part 102h3 selects the combination of the amino acid concentration data contained in the obesity state information used in preparing the candidate multivariate discriminant, by selecting the explanatory variables of the candidate multivariate discriminant based on a particular explanatory variable-selecting method from the verification results obtained in the candidate multivariate discriminant-verifying part 102h2. The explanatory variable-selecting part 102h3 may select the explanatory variables of the candidate multivariate discriminant based on at least one of the stepwise method, best path method, local search method, and genetic algorithm from the verification results.

Returning to FIG. 6, the discriminant value-calculating part 102i calculates the discriminant value that is the value of the multivariate discriminant, based on both (i) the amino acid concentration data (for example, the concentration value of at least one of Glu, Ser, Pro, Gly, Ala, Cys2, Tyr, Val, Orn, Met, Lys, Ile, Leu, Phe, and Trp) of the subject received in the receiving part 102f and (ii) the multivariate discriminant (for example, the multivariate discriminant containing at least one of Glu, Ser, Pro, Gly, Ala, Cys2, Tyr, Val, Orn, Met, Lys, Ile, Leu, Phe, and Trp as the explanatory variable) prepared in the multivariate discriminant-preparing part 102h.

The multivariate discriminant may be any one of a fractional expression, the sum of a plurality of the fractional expressions, a logistic regression equation, a linear discriminant, a multiple regression equation, a discriminant prepared by a support vector machine, a discriminant prepared by a Mahalanobis' generalized distance method, a discriminant prepared by canonical discriminant analysis, and a discriminant prepared by a decision tree.

Specifically, when discriminating between the healthy state and the apparent obesity by the discriminant value criterion-discriminating part 102j1, the multivariate discriminant may be a formula 1, a formula 2, the logistic regression equation with Glu, Thr, and Phe as the explanatory variables, the logistic regression equation with Pro, Asn, Thr, Arg, Tyr, and Orn as the explanatory variables, the linear discriminant with His, Thr, Val, Orn, and Trp as the explanatory variables, or the linear discriminant with Ser, Pro, Asn, Orn, Phe, Val, Leu, and Ile as the explanatory variables:

a₁(Glu/Gly)+b₁(His/Ile)+c₁(Thr/Phe)+d₁ (formula 1)

a₂(Pro/Ser)+b₂(Thr/Asn)+c₂(Arg/Tyr)+d₂(Orn/Gln)+e₂ (formula 2)

wherein in the formula 1, a₁, b₁, and c₁ are arbitrary non-zero real numbers and d₁ is an arbitrary real number and in the formula 2, a₂, b₂, c₂, and d₂ are arbitrary non-zero real numbers and e₂ is an arbitrary real number.

When discriminating between the healthy state and the non-apparent obesity by the discriminant value criterion-discriminating part 102j1, the multivariate discriminant may be a formula 3, a formula 4, the logistic regression equation with Glu, Ser, Ala, Orn, Leu, and Trp as the explanatory variables, the logistic regression equation with Glu, Ser, Gly, Cit, Ala, Val, Leu, and Ile as the explanatory variables, the linear discriminant with Glu, Ser, His, Thr, Lys, and Phe as the explanatory variables, or the linear discriminant with Glu, His, ABA, Tyr, Met, and Lys as the explanatory variables:

a₃(Ser/Ala)+b₃(Gly/Tyr)+c₃(Trp/Glu)+d₃ (formula 3)

a₄(Ser/Cit)+b₄(Gly/(Val+Leu+Ile))+c₄(Gln/Ala)+d₄(Thr/Glu)+e₄ (formula 4)

wherein in the formula 3, a₃, b₃, and c₃ are arbitrary non-zero real numbers and d₃ is an arbitrary real number and in the formula 4, a₄, b₄, c₄, and d₄ are arbitrary non-zero real numbers and e₄ is an arbitrary real number.

When discriminating between the healthy state and the obesity by the discriminant value criterion-discriminating part 102j1, the multivariate discriminant may be a formula 5, a formula 6, the logistic regression equation with Glu, Ser, Cit, Ala, Tyr, and Trp as the explanatory variables, the logistic regression equation with Glu, Ser, Ala, Tyr, Trp, Val, Leu, and Ile as the explanatory variables, the linear discriminant with Glu, Thr, Ala, Tyr, Orn, and Lys as the explanatory variables, or the linear discriminant with Glu, Pro, His, Cit, Orn, and Lys as the explanatory variables:

a₅(Glu/Ser)+b₅(Cit/Ala)+c₅(Trp/Tyr)+d₅ (formula 5)

a₆(Glu/Gly)+b₆(Ser/Ala)+c₆(Trp/Tyr)+d₆((Val+Leu+Ile)/Asn)+e₆ (formula 6)

wherein in the formula 5, a₅, b₅, and c₅ are arbitrary non-zero real numbers and d₅ is an arbitrary real number and in the formula 6, a₆, b₆, c₆, and d₆ are arbitrary non-zero real numbers and e₆ is an arbitrary real number.

When discriminating between the apparent obesity and the non-apparent obesity by the discriminant value criterion-discriminating part 102j1, the multivariate discriminant may be a formula 7, a formula 8, the logistic regression equation with Glu, Thr, Ala, Arg, Tyr, and Lys as the explanatory variables, the logistic regression equation with Pro, Gly, Gln, Ala, Orn, Val, Leu, and Ile as the explanatory variables, the linear discriminant with His, Thr, Ala, Tyr, Orn, and Phe as the explanatory variables, or the linear discriminant with Ser, Pro, Gly, Cit, Lys, and Phe as the explanatory variables:

a₇(Thr/Tyr)+b₇(Ala/Ile)+c₇(Arg/Gln)+d₇ (formula 7)

a₈(Pro/(Val+Leu+Ile))+b₈(Gly/Orn)+c₈(Gln/Ala)+d₈(ABA/Thr)+e₈ (formula 8)

wherein in the formula 7, a₇, b₇, and c₇ are arbitrary non-zero real numbers and d₇ is an arbitrary real number and in the formula 8, a₈, b₈, c₈, and d₈ are arbitrary non-zero real numbers and e₈ is an arbitrary real number.

When discriminating between the apparent obesity and the obesity by the discriminant value criterion-discriminating part 102j1, the multivariate discriminant may be a formula 9, a formula 10, the logistic regression equation with Glu, Asn, Gly, His, Leu, and Trp as the explanatory variables, the logistic regression equation with Glu, Ala, ABA, Met, Lys, Val, Leu, and Ile as the explanatory variables, the linear discriminant with Glu, Gly, His, Ala, and Lys as the explanatory variables, or the linear discriminant with Glu, Thr, Ala, ABA, Lys, Val, Leu, and Ile as the explanatory variables:

a₉(Gly/Glu)+b₉(His/Trp)+c₉(Leu/Gln)+d₉ (formula 9)

a₁₀(Glu/Asn)+b₁₀(ABA/Ser)+c₁₀(Lys/Gln)+d₁₀((Val+Leu+Ile)/Trp))+e₁₀ (formula 10)

wherein in the formula 9, a₉, b₉, and c₉ are arbitrary non-zero real numbers and d₉ is an arbitrary real number and in the formula 10, a₁₀, b₁₀, c₁₀, and d₁₀ are arbitrary non-zero real numbers and e₁₀ is an arbitrary real number.

When discriminating between the non-apparent obesity and the obesity by the discriminant value criterion-discriminating part 102j1, the multivariate discriminant may be a formula 11, a formula 12, the logistic regression equation with Glu, Gly, Cit, Tyr, Val, and Phe as the explanatory variables, the logistic regression equation with Glu, Pro, Cit, Tyr, Phe, and Trp as the explanatory variables, the linear discriminant with Glu, Cit, Tyr, Orn, Met, and Trp as the explanatory variables, or the linear discriminant with Glu, Pro, His, Met, and Phe as the explanatory variables:

a₁₁(Glu/Gln)+b₁₁(Tyr/Gly)+c₁₁(Lys/Trp)+d₁₁ (formula 11)

a₁₂(Glu/Asn)+b₁₂(His/Thr)+c₁₂(Phe/Cit)+d₁₂(Trp/Tyr)+e₁₂ (formula 12)

wherein in the formula 11, a₁₁, b₁₁, and c₁₁ are arbitrary non-zero real numbers and d₁₁ is an arbitrary real number and in the formula 12, a₁₂, b₁₂, c_{c12}, and d₁₂ are arbitrary non-zero real numbers and e₁₂ is an arbitrary real number.

When discriminating between the healthy state or the apparent obesity and the non-apparent obesity or the obesity by the discriminant value criterion-discriminating part 102j1, the multivariate discriminant may be a formula 13, the logistic regression equation with Glu, Gly, Ala, Tyr, Trp, Val, Leu, and Ile as the explanatory variables, or the linear discriminant with Glu, Ala, Arg, Tyr, Orn, Val, Leu, and Ile as the explanatory variables:

a₁₃(Glu/Asn)+b₁₃(Ser/Ala)+c₁₃(Cit/Phe)+d₁₃(Tyr/Trp)+e₁₃ (formula 13)

wherein in the formula 13, a₁₃, b₁₃, c₁₃, and d₁₃ are arbitrary non-zero real numbers and e₁₃ is an arbitrary real number.

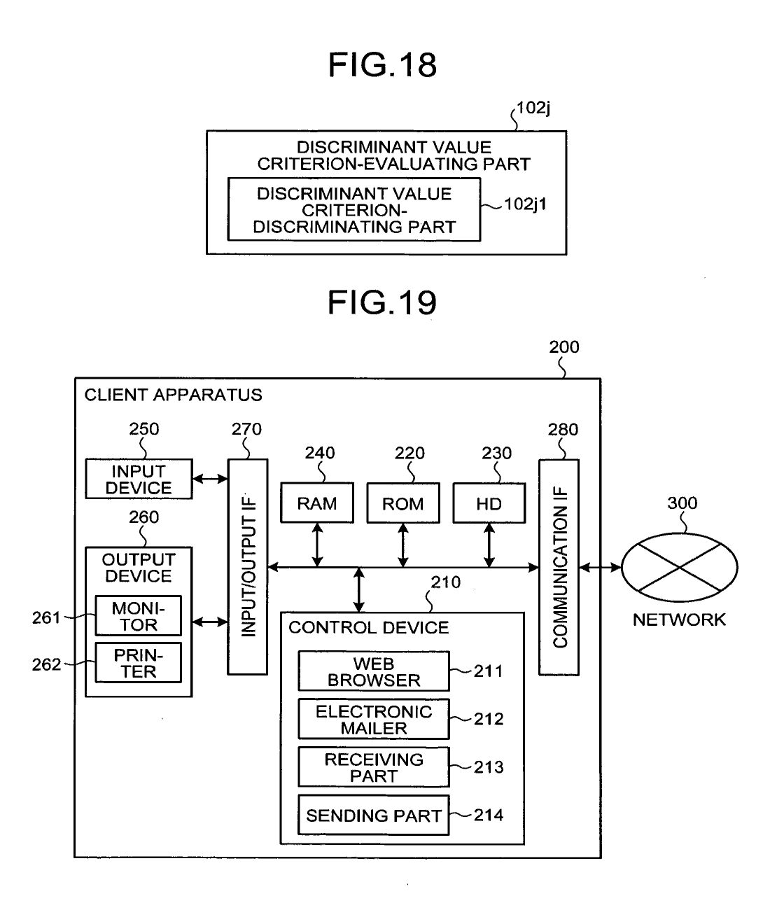

The discriminant value criterion-evaluating part 102j evaluates the state of at least one of the apparent obesity, the non-apparent obesity, and the obesity in the subject based on the discriminant value calculated in the discriminant value-calculating part 102i. The discriminant value criterion-evaluating part 102j further includes the discriminant value criterion-discriminating part 102j1. Now, the configuration of the discriminant value criterion-evaluating part 102j will be described with reference to FIG. 18. FIG. 18 is a block diagram showing the configuration of the discriminant value criterion-evaluating part 102j, and only a part in the configuration related to the present invention is shown conceptually. The discriminant value criterion-discriminating part 102j1 conducts the discrimination between the healthy state defined by the BMI and the VFA and the apparent obesity, between the healthy state and the non-apparent obesity, between the healthy state and the obesity, between the apparent obesity and the non-apparent obesity, between the apparent obesity and the obesity, between the non-apparent obesity and the obesity, or between the healthy state or the apparent obesity and the non-apparent obesity or the obesity in the subject, based on the discriminant value. Specifically, the discriminant value criterion-discriminating part 102j1 compares the discriminant value with a previously established threshold (cutoff value), thereby discriminating between the healthy state and the apparent obesity, between the healthy state and the non-apparent obesity, between the healthy state and the obesity, between the apparent obesity and the non-apparent obesity, between the apparent obesity and the obesity, between the non-apparent obesity and the obesity, or between the healthy state or the apparent obesity and the non-apparent obesity or the obesity in the subject.

Returning to FIG. 6, the result outputting part 102k outputs, into the output device 114, the processing results in each processing part in the control device 102 (the evaluation results obtained in the discriminant value criterion-evaluating part 102j (specifically, the discrimination results obtained in the discriminant value criterion-discriminating part 102j1)) etc.

The sending part 102m transmits the evaluation results to the client apparatus 200 that is a sender of the amino acid concentration data of the subject, and transmits the multivariate discriminant prepared in the obesity-evaluating apparatus 100 and the evaluation results to the database apparatus 400.

Hereinafter, a configuration of the client apparatus 200 in the present system will be described with reference to FIG. 19. FIG. 19 is a block diagram showing an example of the configuration of the client apparatus 200 in the present system, and only the part in the configuration relevant to the present invention is shown conceptually.

The client apparatus 200 includes a control device 210, ROM 220, HD (Hard Disk) 230, RAM 240, an input device 250, an output device 260, an input/output IF 270, and a communication IF 280 that are connected communicatively to one another through a communication channel.

The control device 210 has a Web browser 211, an electronic mailer 212, a receiving part 213, and a sending part 214. The Web browser 211 performs browsing processings of interpreting Web data and displaying the interpreted Web data on a monitor 261 described below. The Web browser 211 may have various plug-in softwares, such as stream player, having functions to receive, display and feedback streaming screen images. The electronic mailer 212 sends and receives electronic mails using a particular protocol (e.g., SMTP (Simple Mail Transfer Protocol) or POPS (Post Office Protocol version 3)). The receiving part 213 receives various kinds of information, such as the evaluation results transmitted from the obesity-evaluating apparatus 100, via the communication IF 280. The sending part 214 sends various kinds of information such as the amino acid concentration data of the subject, via the communication IF 280, to the obesity-evaluating apparatus 100.

The input device 250 is for example a keyboard, a mouse or a microphone. The monitor 261 described below also functions as a pointing device together with a mouse. The output device 260 is an output means for outputting information received via the communication IF 280, and includes the monitor 261 (including home television) and a printer 262. In addition, the output device 260 may have a speaker or the like additionally. The input/output IF 270 is connected to the input device 250 and the output device 260.

The communication IF 280 connects the client apparatus 200 to the network 300 (or communication apparatus such as a router) communicatively. In other words, the client apparatuses 200 are connected to the network 300 via a communication apparatus such as a modem, TA (Terminal Adapter) or a router, and a telephone line, or a private line. In this way, the client apparatuses 200 can access to the obesity-evaluating apparatus 100 by using a particular protocol.

The client apparatus 200 may be realized by installing softwares (including programs, data and others) for a Web data-browsing function and an electronic mail-processing function to an information processing apparatus (for example, an information processing terminal such as a known personal computer, a workstation, a family computer, Internet TV (Television), PHS (Personal Handyphone System) terminal, a mobile phone terminal, a mobile unit communication terminal or PDA (Personal Digital Assistants)) connected as needed with peripheral devices such as a printer, a monitor, and an image scanner.

All or a part of processings of the control device 210 in the client apparatus 200 may be performed by CPU and programs read and executed by the CPU. Computer programs for giving instructions to the CPU and executing various processings together with the OS (Operating System) are recorded in the ROM 220 or HD 230. The computer programs, which are executed as they are loaded in the RAM 240, constitute the control device 210 with the CPU. The computer programs may be stored in application program servers connected via any network to the client apparatus 200, and the client apparatus 200 may download all or a part of them as needed. All or any part of processings of the control device 210 may be realized by hardware such as wired-logic.

Hereinafter, the network 300 in the present system will be described with reference to FIGS. 4 and 5. The network 300 has a function to connect the obesity-evaluating apparatus 100, the client apparatuses 200, and the database apparatus 400 mutually, communicatively to one another, and is for example the Internet, an intranet, or LAN (Local Area Network (both wired/wireless)). The network 300 may be VAN (Value Added Network), a personal computer communication network, a public telephone network (including both analog and digital), a leased line network (including both analog and digital), CATV (Community Antenna Television) network, a portable switched network or a portable packet-switched network (including IMT2000 (International Mobile Telecommunication 2000) system, GSM (Global System for Mobile Communications) system, or PDC (Personal Digital Cellular)/PDC-P system), a wireless calling network, a local wireless network such as Bluetooth (registered trademark), PHS network, a satellite communication network (including CS (Communication Satellite), BS (Broadcasting Satellite), ISDB (Integrated Services Digital Broadcasting), and the like), or the like.

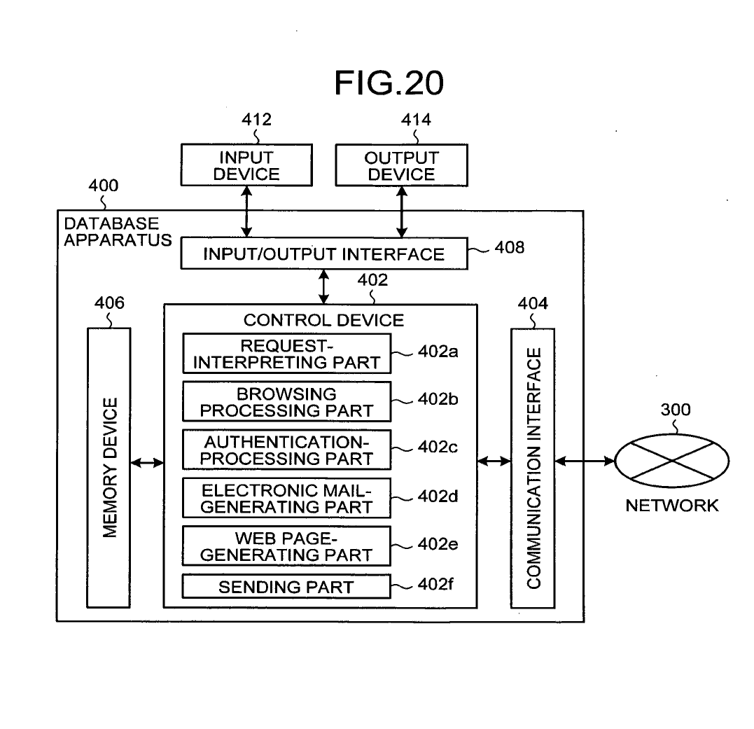

Hereinafter, the configuration of the database apparatus 400 in the present system will be described with reference to FIG. 20. FIG. 20 is a block diagram showing an example of the configuration of the database apparatus 400 in the present system, showing conceptually only the region relevant to the present invention.

The database apparatus 400 has functions to store, for example, the obesity state information used in preparing the multivariate discriminants in the obesity-evaluating apparatus 100 or in the database apparatus 400, the multivariate discriminants prepared in the obesity-evaluating apparatus 100, and the evaluation results obtained in the obesity-evaluating apparatus 100. As shown in FIG. 20, the database apparatus 400 includes (a) a control device 402, such as CPU, which integrally controls the entire database apparatus 400, (b) a communication interface 404 connecting the database apparatus to the network 300 communicatively via a communication apparatus such as a router and via wired or wireless communication circuits such as a private line, (c) a memory device 406 storing various databases, tables and files (for example, files for Web pages), and (d) an input/output interface 408 connected to an input device 412 and an output device 414, and these parts are connected communicatively to each other via any communication channel.

The memory device 406 is a storage means, and may be, for example, memory apparatus such as RAM or ROM, a fixed disk drive such as a hard disk, a flexible disk, an optical disk, and the like. The memory device 406 stores, for example, various programs used in various processings. The communication interface 404 allows communication between the database apparatus 400 and the network 300 (or a communication apparatus such as a router). Thus, the communication interface 404 has a function to communicate data via a communication line with other terminals. The input/output interface 408 is connected to the input device 412 and the output device 414. A monitor (including a home television), a speaker, or a printer may be used as the output device 414 (hereinafter, the output device 414 may be described as a monitor 414). A keyboard, a mouse, a microphone, or a monitor functioning as a pointing device together with a mouse may be used as the input device 412.

The control device 402 has an internal memory storing control programs such as OS (Operating System), programs for various processing procedures, and other needed data, and performs various information processings according to these programs. As shown in the figure, the control device 402 includes mainly a request-interpreting part 402a, a browsing processing part 402b, an authentication-processing part 402c, an electronic mail-generating part 402d, a Web page-generating part 402e, and a sending part 402f.

The request-interpreting part 402a interprets the requests transmitted from the obesity-evaluating apparatus 100 and sends the requests to other parts in the control device 402 according to results of interpreting the requests. Upon receiving browsing requests for various screens transmitted from the obesity-evaluating apparatus 100, the browsing processing part 402b generates and transmits web data for these screens. Upon receiving authentication requests transmitted from the obesity-evaluating apparatus 100, the authentication-processing part 402c performs authentication. The electronic mail-generating part 402d generates electronic mails including various kinds of information. The Web page-generating part 402e generates Web pages for users to browse with the client apparatus 200. The sending part 402f transmits various kinds of information such as the obesity state information and the multivariate discriminants to the obesity-evaluating apparatus 100.

### 2-3. Processing in the Present System

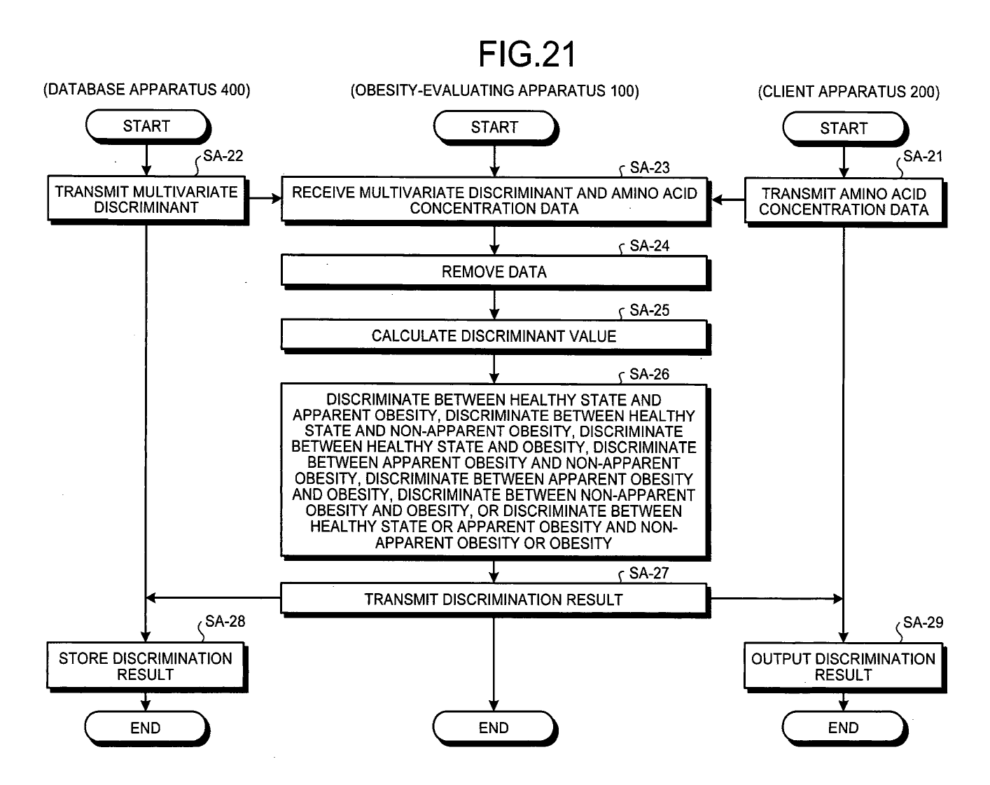

Here, an example of an obesity evaluation service processing performed in the present system constituted as described above will be described with reference to FIG. 21. FIG. 21 is a flowchart showing the example of the obesity evaluation service processing.

The amino acid concentration data used in the present processing is data concerning the concentration values of amino acids obtained by analyzing blood previously collected from an individual. Hereinafter, the method of analyzing blood amino acid will be described briefly. First, a blood sample is collected in a heparin-treated tube, and then the blood plasma is separated by centrifugation of the tube. All blood plasma samples separated are frozen and stored at −70° C. before a measurement of an amino acid concentration. Before the measurement of the amino acid concentration, the blood plasma samples are deproteinized by adding sulfosalicylic acid to a concentration of 3%. An amino acid analyzer by high-performance liquid chromatography (HPLC) by using ninhydrin reaction in the post column is used for the measurement of the amino acid concentration.

First, the client apparatus 200 accesses the obesity-evaluating apparatus 100 when the user specifies the Web site address (such as URL) provided from the obesity-evaluating apparatus 100, via the input device 250 on the screen displaying the Web browser 211. Specifically, when the user instructs update of the Web browser 211 screen on the client apparatus 200, the Web browser 211 sends the Web site address provided from the obesity-evaluating apparatus 100 by a particular protocol to the obesity-evaluating apparatus 100, thereby transmitting requests demanding a transmission of Web page corresponding to an amino acid concentration data transmission screen to the obesity-evaluating apparatus 100 based on a routing of the address.

Then, upon receipt of the request transmitted from the client apparatus 200, the request-interpreting part 102a in the obesity-evaluating apparatus 100 analyzes the transmitted requests and sends the requests to other parts in the control device 102 according to analytical results. Specifically, when the transmitted requests are requests to send the Web page corresponding to the amino acid concentration data transmission screen, mainly the browsing processing part 102b in the obesity-evaluating apparatus 100 obtains the Web data for display of the Web page stored in a predetermined region of the memory device 106 and sends the obtained Web data to the client apparatus 200. More specifically, upon receiving the requests to transmit the Web page corresponding to the amino acid concentration data transmission screen by the user, the control device 102 in the obesity-evaluating apparatus 100 demands inputs of user ID and user password from the user. If the user ID and password are input, the authentication-processing part 102c in the obesity-evaluating apparatus 100 examines the input user ID and password by comparing them with the user ID and user password stored in the user information file 106a for authentication. Only when the user is authenticated, the browsing processing part 102b in the obesity-evaluating apparatus 100 sends the Web data for displaying the Web page corresponding to the amino acid concentration data transmission screen to the client apparatus 200. The client apparatus 200 is identified with the IP (Internet Protocol) address transmitted from the client apparatus 200 together with the transmission requests.

Then, the client apparatus 200 receives, in the receiving part 213, the Web data (for displaying the Web page corresponding to the amino acid concentration data transmission screen) transmitted from the obesity-evaluating apparatus 100, interprets the received Web data with the Web browser 211, and displays the amino acid concentration data transmission screen on the monitor 261.

When the user inputs and selects, via the input device 250, for example the amino acid concentration data of the individual on the amino acid concentration data transmission screen displayed on the monitor 261, the sending part 214 of the client apparatus 200 transmits an identifier for identifying input information and selected items to the obesity-evaluating apparatus 100, thereby transmitting the amino acid concentration data of the individual as the subject to the obesity-evaluating apparatus 100 (step SA-21). In step SA-21, the transmission of the amino acid concentration data may be realized for example by using an existing file transfer technology such as FTP (File Transfer Protocol).

Then, the request-interpreting part 102a of the obesity-evaluating apparatus 100 interprets the identifier transmitted from the client apparatus 200 thereby interpreting the requests from the client apparatus 200, and requests the database apparatus 400 to send the multivariate discriminant for the evaluation of the state of the apparent obesity, the non-apparent obesity, or the obesity (specifically, the multivariate discriminant for the discrimination between the healthy state and the apparent obesity, between the healthy state and the non-apparent obesity, between the healthy state and the obesity, between the apparent obesity and the non-apparent obesity, between the apparent obesity and the obesity, between the non-apparent obesity and the obesity, or between the healthy state or the apparent obesity and the non-apparent obesity or the obesity) containing at least one of Glu, Ser, Pro, Gly, Ala, Cys2, Tyr, Val, Orn, Met, Lys, Ile, Leu, Phe, and Trp as the explanatory variable.

Then, the request-interpreting part 402a in the database apparatus 400 interprets the transmission requests from the obesity-evaluating apparatus 100 and transmits, to the obesity-evaluating apparatus 100, the multivariate discriminant stored in a predetermined region of the memory device 406 (for example, the updated newest multivariate discriminant) containing at least one of Glu, Ser, Pro, Gly, Ala, Cys2, Tyr, Val, Orn, Met, Lys, Ile, Leu, Phe, and Trp as the explanatory variable (step SA-22).

In step SA-22, the multivariate discriminant transmitted to the obesity-evaluating apparatus 100 may be any one of a fractional expression, the sum of a plurality of the fractional expressions, a logistic regression equation, a linear discriminant, a multiple regression equation, a discriminant prepared by a support vector machine, a discriminant prepared by a Mahalanobis' generalized distance method, a discriminant prepared by canonical discriminant analysis, and a discriminant prepared by a decision tree.

Specifically, when discriminating between the healthy state and the apparent obesity in step SA-26, the multivariate discriminant may be a formula 1, a formula 2, the logistic regression equation with Glu, Thr, and Phe as the explanatory variables, the logistic regression equation with Pro, Asn, Thr, Arg, Tyr, and Orn as the explanatory variables, the linear discriminant with His, Thr, Val, Orn, and Trp as the explanatory variables, or the linear discriminant with Ser, Pro, Asn, Orn, Phe, Val, Leu, and Ile as the explanatory variables:

a₁(Glu/Gly)+b₁(His/Ile)+c₁(Thr/Phe)+d₁ (formula 1)

a₂(Pro/Ser)+b₂(Thr/Asn)+c₂(Arg/Tyr)+d₂(Orn/Gln)+e₂ (formula 2)

wherein in the formula 1, a₁, b₁, and c₁ are arbitrary non-zero real numbers and d₁ is an arbitrary real number and in the formula 2, a₂, b₂, c₂, and d₂ are arbitrary non-zero real numbers and e₂ is an arbitrary real number.

When discriminating between the healthy state and the non-apparent obesity in step SA-26, the multivariate discriminant may be a formula 3, a formula 4, the logistic regression equation with Glu, Ser, Ala, Orn, Leu, and Trp as the explanatory variables, the logistic regression equation with Glu, Ser, Gly, Cit, Ala, Val, Leu, and Ile as the explanatory variables, the linear discriminant with Glu, Ser, His, Thr, Lys, and Phe as the explanatory variables, or the linear discriminant with Glu, His, ABA, Tyr, Met, and Lys as the explanatory variables:

a₃(Ser/Ala)+b₃(Gly/Tyr)+c₃(Trp/Glu)+d₃ (formula 3)

a₄(Ser/Cit)+b₄(Gly/(Val+Leu+Ile))+c₄(Gln/Ala)+d₄(Thr/Glu)+e₄ (formula 4)

wherein in the formula 3, a₃, b₃, and c₃ are arbitrary non-zero real numbers and d₃ is an arbitrary real number and in the formula 4, a₄, b₄, c₄, and d₄ are arbitrary non-zero real numbers and e₄ is an arbitrary real number.

When discriminating between the healthy state and the obesity in step SA-26, the multivariate discriminant may be a formula 5, a formula 6, the logistic regression equation with Glu, Ser, Cit, Ala, Tyr, and Trp as the explanatory variables, the logistic regression equation with Glu, Ser, Ala, Tyr, Trp, Val, Leu, and Ile as the explanatory variables, the linear discriminant with Glu, Thr, Ala, Tyr, Orn, and Lys as the explanatory variables, or the linear discriminant with Glu, Pro, His, Cit, Orn, and Lys as the explanatory variables:

a₅(Glu/Ser)+b₅(Cit/Ala)+c₅(Trp/Tyr)+d₅ (formula 5)

a₆(Glu/Gly)+b₆(Ser/Ala)+c₆(Trp/Tyr)+d₆((Val+Leu+Ile)/Asn)+e₆ (formula 6)

wherein in the formula 5, a₅, b₅, and c₅ are arbitrary non-zero real numbers and d₅ is an arbitrary real number and in the formula 6, a₆, b₆, c₆, and d₆ are arbitrary non-zero real numbers and e₆ is an arbitrary real number.

When discriminating between the apparent obesity and the non-apparent obesity in step SA-26, the multivariate discriminant may be a formula 7, a formula 8, the logistic regression equation with Glu, Thr, Ala, Arg, Tyr, and Lys as the explanatory variables, the logistic regression equation with Pro, Gly, Gln, Ala, Orn, Val, Leu, and Ile as the explanatory variables, the linear discriminant with His, Thr, Ala, Tyr, Orn, and Phe as the explanatory variables, or the linear discriminant with Ser, Pro, Gly, Cit, Lys, and Phe as the explanatory variables:

a₇(Thr/Tyr)+b₇(Ala/Ile)+c₇(Arg/Gln)+d₇ (formula 7)

a₈(Pro/(Val+Leu+Ile))+b₈(Gly/Orn)+c₈(Gln/Ala)+d₈(ABA/Thr)+e₈ (formula 8)

wherein in the formula 7, a₇, b₇, and c₇ are arbitrary non-zero real numbers and d₇ is an arbitrary real number and in the formula 8, a₈, b₈, c₈, and d₈ are arbitrary non-zero real numbers and e₈ is an arbitrary real number.

When discriminating between the apparent obesity and the obesity in step SA-26, the multivariate discriminant may be a formula 9, a formula 10, the logistic regression equation with Glu, Asn, Gly, His, Leu, and Trp as the explanatory variables, the logistic regression equation with Glu, Ala, ABA, Met, Lys, Val, Leu, and Ile as the explanatory variables, the linear discriminant with Glu, Gly, His, Ala, and Lys as the explanatory variables, or the linear discriminant with Glu, Thr, Ala, ABA, Lys, Val, Leu, and Ile as the explanatory variables:

a₉(Gly/Glu)+b₉(His/Trp)+c₉(Leu/Gln)+d₉ (formula 9)

a₁₀(Glu/Asn)+b₁₀(ABA/Ser)+c₁₀(Lys/Gln)+d₁₀((Val+Leu+Ile)/Trp))+e₁₀ (formula 10)

wherein in the formula 9, a₉, b₉, and c₉ are arbitrary non-zero real numbers and d₉ is an arbitrary real number and in the formula 10, a₁₀, b₁₀, c₁₀, and d₁₀ are arbitrary non-zero real numbers and e₁₀ is an arbitrary real number.

When discriminating between the non-apparent obesity and the obesity in step SA-26, the multivariate discriminant may be a formula 11, a formula 12, the logistic regression equation with Glu, Gly, Cit, Tyr, Val, and Phe as the explanatory variables, the logistic regression equation with Glu, Pro, Cit, Tyr, Phe, and Trp as the explanatory variables, the linear discriminant with Glu, Cit, Tyr, Orn, Met, and Trp as the explanatory variables, or the linear discriminant with Glu, Pro, His, Met, and Phe as the explanatory variables:

a₁₁(Glu/Gln)+b₁₁(Tyr/Gly)+c₁₁(Lys/Trp)+d₁₁ (formula 11)

a₁₂(Glu/Asn)+b₁₂(His/Thr)+c₁₂(Phe/Cit)+d₁₂(Trp/Tyr)+e₁₂ (formula 12)

wherein in the formula 11, a₁₁, b₁₁, and c₁₁ are arbitrary non-zero real numbers and d₁₁ is an arbitrary real number and in the formula 12, a₁₂, b₁₂, c₁₂, and d₁₂ are arbitrary non-zero real numbers and e₁₂ is an arbitrary real number.

When discriminating between the healthy state or the apparent obesity and the non-apparent obesity or the obesity in step SA-26, the multivariate discriminant may be a formula 13, the logistic regression equation with Glu, Gly, Ala, Tyr, Trp, Val, Leu, and Ile as the explanatory variables, or the linear discriminant with Glu, Ala, Arg, Tyr, Orn, Val, Leu, and Ile as the explanatory variables:

a₁₃(Glu/Asn)+b₁₃(Ser/Ala)+c₁₃(Cit/Phe)+d₁₃(Tyr/Trp)+e₁₃ (formula 13)

wherein in the formula 13, a₁₃, b₁₃, c₁₃, and d₁₃ are arbitrary non-zero real numbers and e₁₃ is an arbitrary real number.

Then, The obesity-evaluating apparatus 100 receives, in the receiving part 102f, the amino acid concentration data of the individual transmitted from the client apparatuses 200 and the multivariate discriminant transmitted from the database apparatus 400, and stores the received amino acid concentration data in a predetermined memory region of the amino acid concentration data file 106b and the received multivariate discriminant in a predetermined memory region of the multivariate discriminant file 106e4 (step SA-23).

Then, the control device 102 in the obesity-evaluating apparatus 100 removes data such as defective and outliers from the amino acid concentration data of the individual received in step SA-23 (step SA-24).

Then, the obesity-evaluating apparatus 100 calculates, in the discriminant value-calculating part 102i, the discriminant value based on both (i) the multivariate discriminant received in step SA-23 and (ii) the concentration value of at least one of Glu, Ser, Pro, Gly, Ala, Cys2, Tyr, Val, Orn, Met, Lys, Ile, Leu, Phe, and Trp contained in the amino acid concentration data of the individual from which the data such as the defective and outliers have been removed in step SA-24 (step SA-25).

Then, the obesity-evaluating apparatus 100 (i) compares, in the discriminant value criterion-discriminating part 102j1, the discriminant value calculated in step SA-25 with a previously established threshold (cutoff value), thereby discriminating between the healthy state and the apparent obesity, between the healthy state and the non-apparent obesity, between the healthy state and the obesity, between the apparent obesity and the non-apparent obesity, between the apparent obesity and the obesity, between the non-apparent obesity and the obesity, or between the healthy state or the apparent obesity and the non-apparent obesity or the obesity in the individual, and (ii) stores the discrimination results in a predetermined memory region of the evaluation result file 106g (step SA-26).

Then, the sending part 102m in the obesity-evaluating apparatus 100 sends, to the client apparatus 200 that has sent the amino acid concentration data and to the database apparatus 400, the discrimination results obtained in step SA-26 (step SA-27). Specifically, the obesity-evaluating apparatus 100 first generates a Web page for displaying the discrimination results in the Web page-generating part 102e and stores the Web data corresponding to the generated Web page in a predetermined memory region of the memory device 106. Then, the user is authenticated as described above by inputting a predetermined URL (Uniform Resource Locator) into the Web browser 211 of the client apparatus 200 via the input device 250, and the client apparatus 200 sends a Web page browsing request to the obesity-evaluating apparatus 100. The obesity-evaluating apparatus 100 then interprets the browsing request transmitted from the client apparatus 200 in the browsing processing part 102b and reads the Web data corresponding to the Web page for displaying the discrimination results, out of the predetermined memory region of the memory device 106. The sending part 102m in the obesity-evaluating apparatus 100 then sends the read-out Web data to the client apparatus 200 and simultaneously sends the Web data or the discrimination results to the database apparatus 400.

In step SA-27, the control device 102 in the obesity-evaluating apparatus 100 may notify the discrimination results to the user client apparatus 200 by electronic mail. Specifically, the electronic mail-generating part 102d in the obesity-evaluating apparatus 100 first acquires the user electronic mail address by referencing the user information stored in the user information file 106a based on the user ID and the like at the transmission timing. The electronic mail-generating part 102d in the obesity-evaluating apparatus 100 then generates electronic mail data with the acquired electronic mail address as its mail address, including the user name and the discrimination results. The sending part 102m in the obesity-evaluating apparatus 100 then sends the generated electronic mail data to the user client apparatus 200.

Also in step SA-27, the obesity-evaluating apparatus 100 may send the discrimination results to the user client apparatus 200 by using, for example, an existing file transfer technology such as FTP.

Returning to FIG. 21, the control device 402 in the database apparatus 400 receives the discrimination results or the Web data transmitted from the obesity-evaluating apparatus 100 and stores (accumulates) the received discrimination results or the received Web data in a predetermined memory region of the memory device 406 (step SA-28).

The receiving part 213 of the client apparatus 200 receives the Web data transmitted from the obesity-evaluating apparatus 100, and the received Web data is interpreted with the Web browser 211, to display on the monitor 261 the Web page screen displaying the discrimination result of the individual (step SA-29). When the discrimination results are sent from the obesity-evaluating apparatus 100 by electronic mail, the electronic mail transmitted from the obesity-evaluating apparatus 100 is received at any timing, and the received electronic mail is displayed on the monitor 261 with the known function of the electronic mailer 212 in the client apparatus 200.

In this way, the user can confirm the discrimination results of the individual on the discrimination between the healthy state and the apparent obesity, between the healthy state and the non-apparent obesity, between the healthy state and the obesity, between the apparent obesity and the non-apparent obesity, between the apparent obesity and the obesity, between the non-apparent obesity and the obesity, or between the healthy state or the apparent obesity and the non-apparent obesity or the obesity, by browsing the Web page displayed on the monitor 261. The user may print out the content of the Web page displayed on the monitor 261 by the printer 262.

When the discrimination results are transmitted by electronic mail from the obesity-evaluating apparatus 100, the user reads the electronic mail displayed on the monitor 261, whereby the user can confirm the discrimination results of the individual on the discrimination between the healthy state and the apparent obesity, between the healthy state and the non-apparent obesity, between the healthy state and the obesity, between the apparent obesity and the non-apparent obesity, between the apparent obesity and the obesity, between the non-apparent obesity and the obesity, or between the healthy state or the apparent obesity and the non-apparent obesity or the obesity. The user may print out the content of the electronic mail displayed on the monitor 261 by the printer 262.

Given the foregoing description, the explanation of the obesity evaluation service processing is finished.

### 2-4. Summary of the Second Embodiment and Other Embodiments

According to the obesity-evaluating system described above in detail, the client apparatus 200 sends the amino acid concentration data of the individual to the obesity-evaluating apparatus 100. Upon receiving the requests from the obesity-evaluating apparatus 100, the database apparatus 400 transmits the multivariate discriminant for the discrimination between the healthy state and the apparent obesity, between the healthy state and the non-apparent obesity, between the healthy state and the obesity, between the apparent obesity and the non-apparent obesity, between the apparent obesity and the obesity, between the non-apparent obesity and the obesity, or between the healthy state or the apparent obesity and the non-apparent obesity or the obesity, to the obesity-evaluating apparatus 100. By the obesity-evaluating apparatus 100, (1) the amino acid concentration data is received from the client apparatus 200, and the multivariate discriminant is received from the database apparatus 400 simultaneously, (2) the discriminant value is calculated based on both the received amino acid concentration data and the received multivariate discriminant, (3) the calculated discriminant value is compared with the previously established threshold, thereby discriminating between the healthy state and the apparent obesity, between the healthy state and the non-apparent obesity, between the healthy state and the obesity, between the apparent obesity and the non-apparent obesity, between the apparent obesity and the obesity, between the non-apparent obesity and the obesity, or between the healthy state or the apparent obesity and the non-apparent obesity or the obesity in the individual, and (4) the discrimination results are transmitted to the client apparatus 200 and database apparatus 400. Then, the client apparatus 200 receives and displays the discrimination results transmitted from the obesity-evaluating apparatus 100, and the database apparatus 400 receives and stores the discrimination results transmitted from the obesity-evaluating apparatus 100. Thus, the discriminant values obtained in the multivariate discriminants useful for the 2-group discrimination of the healthy state and the apparent obesity, the 2-group discrimination of the healthy state and the non-apparent obesity, the 2-group discrimination of the healthy state and the obesity, the 2-group discrimination of the apparent obesity and the non-apparent obesity, the 2-group discrimination of the apparent obesity and the obesity, the 2-group discrimination of the non-apparent obesity and the obesity, or the 2-group discrimination of the healthy state or the apparent obesity and the non-apparent obesity or the obesity, can be utilized to bring about the effect of enabling accurately these 2-group discriminations.

According to the obesity-evaluating system, the multivariate discriminant may be any one of a fractional expression, the sum of a plurality of the fractional expressions, a logistic regression equation, a linear discriminant, a multiple regression equation, a discriminant prepared by a support vector machine, a discriminant prepared by a Mahalanobis' generalized distance method, a discriminant prepared by canonical discriminant analysis, and a discriminant prepared by a decision tree. Thus, the discriminant values obtained in the multivariate discriminants useful for the 2-group discrimination of the healthy state and the apparent obesity, the 2-group discrimination of the healthy state and the non-apparent obesity, the 2-group discrimination of the healthy state and the obesity, the 2-group discrimination of the apparent obesity and the non-apparent obesity, the 2-group discrimination of the apparent obesity and the obesity, the 2-group discrimination of the non-apparent obesity and the obesity, or the 2-group discrimination of the healthy state or the apparent obesity and the non-apparent obesity or the obesity, can be utilized to bring about the effect of enabling more accurately these 2-group discriminations.

Specifically, when discriminating between the healthy state and the apparent obesity in step SA-26, the multivariate discriminant may be a formula 1, a formula 2, the logistic regression equation with Glu, Thr, and Phe as the explanatory variables, the logistic regression equation with Pro, Asn, Thr, Arg, Tyr, and Orn as the explanatory variables, the linear discriminant with His, Thr, Val, Orn, and Trp as the explanatory variables, or the linear discriminant with Ser, Pro, Asn, Orn, Phe, Val, Leu, and Ile as the explanatory variables:

a₁(Glu/Gly)+b₁(His/Ile)+c₁(Thr/Phe)+d₁ (formula 1)

a₂(Pro/Ser)+b₂(Thr/Asn)+c₂(Arg/Tyr)+d₂(Orn/Gln)+e₂ (formula 2)

wherein in the formula 1, a₁, b₁, and c₁ are arbitrary non-zero real numbers and d₁ is an arbitrary real number and in the formula 2, a₂, b₂, c₂, and d₂ are arbitrary non-zero real numbers and e₂ is an arbitrary real number. Thus, the discriminant values obtained in the multivariate discriminants useful particularly for the 2-group discrimination of the healthy state and the apparent obesity, can be utilized to bring about the effect of enabling more accurately the 2-group discrimination.

When discriminating between the healthy state and the non-apparent obesity in step SA-26, the multivariate discriminant may be a formula 3, a formula 4, the logistic regression equation with Glu, Ser, Ala, Orn, Leu, and Trp as the explanatory variables, the logistic regression equation with Glu, Ser, Gly, Cit, Ala, Val, Leu, and Ile as the explanatory variables, the linear discriminant with Glu, Ser, His, Thr, Lys, and Phe as the explanatory variables, or the linear discriminant with Glu, His, ABA, Tyr, Met, and Lys as the explanatory variables:

a₃(Ser/Ala)+b₃(Gly/Tyr)+c₃(Trp/Glu)+d₃ (formula 3)

a₄(Ser/Cit)+b₄(Gly/(Val+Leu+Ile))+c₄(Gln/Ala)+d₄(Thr/Glu)+e₄ (formula 4)

wherein in the formula 3, a₃, b₃, and c₃ are arbitrary non-zero real numbers and d₃ is an arbitrary real number and in the formula 4, a₄, b₄, c₄, and d₄ are arbitrary non-zero real numbers and e₄ is an arbitrary real number. Thus, the discriminant values obtained in the multivariate discriminants useful particularly for the 2-group discrimination of the healthy state and the non-apparent obesity, can be utilized to bring about the effect of enabling more accurately the 2-group discrimination.

When discriminating between the healthy state and the obesity in step SA-26, the multivariate discriminant may be a formula 5, a formula 6, the logistic regression equation with Glu, Ser, Cit, Ala, Tyr, and Trp as the explanatory variables, the logistic regression equation with Glu, Ser, Ala, Tyr, Trp, Val, Leu, and Ile as the explanatory variables, the linear discriminant with Glu, Thr, Ala, Tyr, Orn, and Lys as the explanatory variables, or the linear discriminant with Glu, Pro, His, Cit, Orn, and Lys as the explanatory variables:

a₅(Glu/Ser)+b₅(Cit/Ala)+c₅(Trp/Tyr)+d₅ (formula 5)

a₆(Glu/Gly)+b₆(Ser/Ala)+c₆(Trp/Tyr)+d₆((Val+Leu+Ile)/Asn)+e₆ (formula 6)

wherein in the formula 5, a₅, b₅, and c₅ are arbitrary non-zero real numbers and d₅ is an arbitrary real number and in the formula 6, a₆, b₆, c₆, and d₆ are arbitrary non-zero real numbers and e₆ is an arbitrary real number. Thus, the discriminant values obtained in the multivariate discriminants useful particularly for the 2-group discrimination of the healthy state and the obesity, can be utilized to bring about the effect of enabling more accurately the 2-group discrimination.

When discriminating between the apparent obesity and the non-apparent obesity in step SA-26, the multivariate discriminant may be a formula 7, a formula 8, the logistic regression equation with Glu, Thr, Ala, Arg, Tyr, and Lys as the explanatory variables, the logistic regression equation with Pro, Gly, Gln, Ala, Orn, Val, Leu, and Ile as the explanatory variables, the linear discriminant with His, Thr, Ala, Tyr, Orn, and Phe as the explanatory variables, or the linear discriminant with Ser, Pro, Gly, Cit, Lys, and Phe as the explanatory variables:

a₇(Thr/Tyr)+b₇(Ala/Ile)+c₇(Arg/Gln)+d₇ (formula 7)

a₈(Pro/(Val+Leu+Ile))+b₈(Gly/Orn)+c₈(Gln/Ala)+d₈(ABA/Thr)+e₈ (formula 8)

wherein in the formula 7, a₇, b₇, and c₇ are arbitrary non-zero real numbers and d₇ is an arbitrary real number and in the formula 8, a₈, b₈, c₈, and d₈ are arbitrary non-zero real numbers and e₈ is an arbitrary real number. Thus, the discriminant values obtained in the multivariate discriminants useful particularly for the 2-group discrimination of the apparent obesity and the non-apparent obesity, can be utilized to bring about the effect of enabling more accurately the 2-group discrimination.

When discriminating between the apparent obesity and the obesity in step SA-26, the multivariate discriminant may be a formula 9, a formula 10, the logistic regression equation with Glu, Asn, Gly, His, Leu, and Trp as the explanatory variables, the logistic regression equation with Glu, Ala, ABA, Met, Lys, Val, Leu, and Ile as the explanatory variables, the linear discriminant with Glu, Gly, His, Ala, and Lys as the explanatory variables, or the linear discriminant with Glu, Thr, Ala, ABA, Lys, Val, Leu, and Ile as the explanatory variables:

a₉(Gly/Glu)+b₉(His/Trp)+c₉(Leu/Gln)+d₉ (formula 9)

a₁₀(Glu/Asn)+b₁₀(ABA/Ser)+c₁₀(Lys/Gln)+d₁₀((Val+Leu+Ile)/Trp))+e₁₀ (formula 10)

wherein in the formula 9, a₉, b₉, and c₉ are arbitrary non-zero real numbers and d₉ is an arbitrary real number and in the formula 10, a₁₀, b₁₀, c₁₀, and d₁₀ are arbitrary non-zero real numbers and e₁₀ is an arbitrary real number. Thus, the discriminant values obtained in the multivariate discriminants useful particularly for the 2-group discrimination of the apparent obesity and the obesity, can be utilized to bring about the effect of enabling more accurately the 2-group discrimination.

When discriminating between the non-apparent obesity and the obesity in step SA-26, the multivariate discriminant may be a formula 11, a formula 12, the logistic regression equation with Glu, Gly, Cit, Tyr, Val, and Phe as the explanatory variables, the logistic regression equation with Glu, Pro, Cit, Tyr, Phe, and Trp as the explanatory variables, the linear discriminant with Glu, Cit, Tyr, Orn, Met, and Trp as the explanatory variables, or the linear discriminant with Glu, Pro, His, Met, and Phe as the explanatory variables:

a₁₁(Glu/Gln)+b₁₁(Tyr/Gly)+c₁₁(Lys/Trp)+d₁₁ (formula 11)

a₁₂(Glu/Asn)+b₁₂(His/Thr)+c₁₂(Phe/Cit)+d₁₂(Trp/Tyr)+e₁₂ (formula 12)

wherein in the formula 11, a₁₁, b₁₁, and c₁₁ are arbitrary non-zero real numbers and d₁₁ is an arbitrary real number and in the formula 12, a₁₂, b₁₂, c₁₂, and d₁₂ are arbitrary non-zero real numbers and e₁₂ is an arbitrary real number. Thus, the discriminant values obtained in the multivariate discriminants useful particularly for the 2-group discrimination of the non-apparent obesity and the obesity, can be utilized to bring about the effect of enabling more accurately the 2-group discrimination.

When discriminating between the healthy state or the apparent obesity and the non-apparent obesity or the obesity in step SA-26, the multivariate discriminant may be a formula 13, the logistic regression equation with Glu, Gly, Ala, Tyr, Trp, Val, Leu, and Ile as the explanatory variables, or the linear discriminant with Glu, Ala, Arg, Tyr, Orn, Val, Leu, and Ile as the explanatory variables:

a₁₃(Glu/Asn)+b₁₃(Ser/Ala)+c₁₃(Cit/Phe)+d₁₃(Tyr/Trp)+e₁₃ (formula 13)

wherein in the formula 13, a₁₃, b₁₃, c₁₃, and d₁₃ are arbitrary non-zero real numbers and e₁₃ is an arbitrary real number. Thus, the discriminant values obtained in the multivariate discriminants useful particularly for the 2-group discrimination of the healthy state or the apparent obesity and the non-apparent obesity or the obesity, can be utilized to bring about the effect of enabling more accurately the 2-group discrimination.

The multivariate discriminant described above can be prepared by a method described in International Publication WO 2004/052191 that is an international application filed by the present applicant or by a method (multivariate discriminant-preparing processing described later) described in International Publication WO 2006/098192 that is an international application filed by the present applicant. Any multivariate discriminants obtained by these methods can be preferably used in the evaluation of the state of the apparent obesity, the non-apparent obesity or the obesity, regardless of the unit of the amino acid concentration in the amino acid concentration data as input data.

In addition to the second embodiment described above, the obesity-evaluating apparatus, the obesity-evaluating method, the obesity-evaluating system, the obesity-evaluating program product and the recording medium according to the present invention can be practiced in various different embodiments within the technological scope of the claims. For example, among the processings described in the second embodiment above, all or a part of the processings described above as performed automatically may be performed manually, and all or a part of the manually conducted processings may be performed automatically by known methods. In addition, the processing procedure, control procedure, specific name, various registered data, information including parameters such as retrieval condition, screen, and database configuration shown in the description above or drawings may be modified arbitrarily, unless specified otherwise. For example, the components of the obesity-evaluating apparatus 100 shown in the figures are conceptual and functional and may not be the same physically as those shown in the figure. In addition, all or an arbitrary part of the operational function of each component and each device in the obesity-evaluating apparatus 100 (in particular, the operational functions executed in the control device 102) may be executed by the CPU (Central Processing Unit) or the programs executed by the CPU, and may be realized as wired-logic hardware.

The “program” is a data processing method written in any language or by any description method and may be of any format such as source code or binary code. The “program” may not be limited to a program configured singly, and may include a program configured decentrally as a plurality of modules or libraries, and a program to achieve the function together with a different program such as OS (Operating System). The program is stored on a non-transitory computer-readable recording medium including programmed instructions for making a computer execute the method according to the present invention and read mechanically as needed by the obesity-evaluating apparatus 100. Any well-known configuration or procedure may be used as specific configuration, reading procedure, installation procedure after reading, and the like for reading the programs recorded on the recording medium in each apparatus.

The “recording media” includes any “portable physical media”, “fixed physical media”, and “communication media”. Examples of the “portable physical media” include flexible disk, magnetic optical disk, ROM, EPROM (Erasable Programmable Read Only Memory), EEPROM (Electronically Erasable and Programmable Read Only Memory), CD-ROM (Compact Disk Read Only Memory), MO (Magneto-Optical disk), DVD (Digital Versatile Disk), and the like. Examples of the “fixed physical media” include ROM, RAM, HD, and the like which are installed in various computer systems. The “communication media” for example stores the program for a short period of time such as communication line and carrier wave when the program is transmitted via a network such as LAN (Local Area Network), WAN (Wide Area Network), or the Internet.

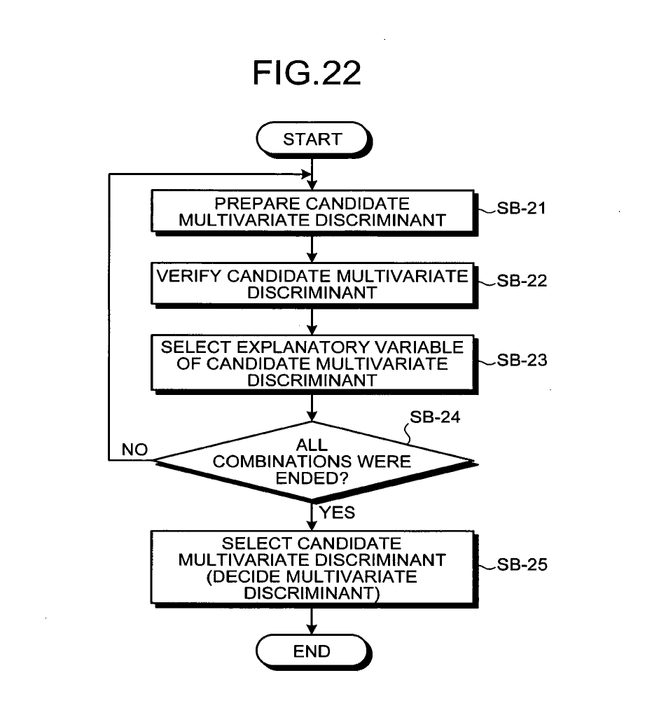

Finally, an example of the multivariate discriminant-preparing processing performed in the obesity-evaluating apparatus 100 is described in detail with reference to FIG. 22. FIG. 22 is a flowchart showing an example of the multivariate discriminant-preparing processing. The multivariate discriminant-preparing processing may be performed in the database apparatus 400 handling the obesity state information.

In the present description, the obesity-evaluating apparatus 100 stores the obesity state information previously obtained from the database apparatus 400 in a predetermined memory region of the obesity state information file 106c. The obesity-evaluating apparatus 100 shall store, in a predetermined memory region of the designated obesity state information file 106d, the obesity state information including the obesity state index data and amino acid concentration data designated previously in the obesity state information-designating part 102g.

The candidate multivariate discriminant-preparing part 102h1 in the multivariate discriminant-preparing part 102h first prepares the candidate multivariate discriminants according to a predetermined discriminant-preparing method from the obesity state information stored in a predetermine memory region of the designated obesity state information file 106d, and stores the prepared candidate multivariate discriminants in a predetermined memory region of the candidate multivariate discriminant file 106e1 (step SB-21). Specifically, the candidate multivariate discriminant-preparing part 102h1 in the multivariate discriminant-preparing part 102h first selects a desired method out of a plurality of different discriminant-preparing methods (including those for multivariate analysis such as principal component analysis, discriminant analysis, support vector machine, multiple regression analysis, logistic regression analysis, k-means method, cluster analysis, and decision tree) and determines the form of the candidate multivariate discriminant to be prepared based on the selected discriminant-preparing method. The candidate multivariate discriminant-preparing part 102h1 in the multivariate discriminant-preparing part 102h then performs various calculation corresponding to the selected function-selecting method (e.g., average or variance), based on the obesity state information. The candidate multivariate discriminant-preparing part 102h1 in the multivariate discriminant-preparing part 102h then determines the parameters for the calculation result and the determined candidate multivariate discriminant. In this way, the candidate multivariate discriminant is generated based on the selected discriminant-preparing method. When the candidate multivariate discriminants are generated simultaneously and concurrently (in parallel) by using a plurality of different discriminant-preparing methods in combination, the processings described above may be executed concurrently for each selected discriminant-preparing method. Alternatively when the candidate multivariate discriminants are generated in series by using a plurality of different discriminant-preparing methods in combination, for example, the candidate multivariate discriminants may be generated by converting the obesity state information with the candidate multivariate discriminants prepared by performing principal component analysis and performing discriminant analysis of the converted obesity state information.

The candidate multivariate discriminant-verifying part 102h2 in the multivariate discriminant-preparing part 102h verifies (mutually verifies) the candidate multivariate discriminant prepared in step SB-21 according to a particular verifying method and stores the verification result in a predetermined memory region of the verification result file 106e2 (step SB-22). Specifically, the candidate multivariate discriminant-verifying part 102h2 in the multivariate discriminant-preparing part 102h first generates the verification data to be used in verification of the candidate multivariate discriminant, based on the obesity state information stored in a predetermined memory region of the designated obesity state information file 106d, and verifies the candidate multivariate discriminant according to the generated verification data. If a plurality of the candidate multivariate discriminants is generated by using a plurality of different discriminant-preparing methods in step SB-21, the candidate multivariate discriminant-verifying part 102h2 in the multivariate discriminant-preparing part 102h verifies each candidate multivariate discriminant corresponding to each discriminant-preparing method according to a particular verifying method. Here in step SB-22, at least one of the discrimination rate, sensitivity, specificity, information criterion, and the like of the candidate multivariate discriminant may be verified based on at least one method of the bootstrap method, holdout method, leave-one-out method, and the like. Thus, it is possible to select the candidate multivariate discriminant higher in predictability or reliability, by taking the obesity state information and diagnostic condition into consideration.

Then, the explanatory variable-selecting part 102h3 in the multivariate discriminant-preparing part 102h selects the combination of the amino acid concentration data contained in the obesity state information used in preparing the candidate multivariate discriminant by selecting the explanatory variable of the candidate multivariate discriminant from the verification result obtained in step SB-22 according to a predetermined explanatory variable-selecting method, and stores the obesity state information including the selected combination of the amino acid concentration data in a predetermined memory region of the selected obesity state information file 106e3 (step SB-23). When a plurality of the candidate multivariate discriminants is generated by using a plurality of different discriminant-preparing methods in step SB-21 and each candidate multivariate discriminant corresponding to each discriminant-preparing method is verified according to a predetermined verifying method in step SB-22, the explanatory variable-selecting part 102h3 in the multivariate discriminant-preparing part 102h selects the explanatory variable of the candidate multivariate discriminant for each candidate multivariate discriminant corresponding to the verification result obtained in step SB-22, according to a predetermined explanatory variable-selecting method in step SB-23. Here in step SB-23, the explanatory variable of the candidate multivariate discriminant may be selected from the verification results according to at least one of the stepwise method, best path method, local search method, and genetic algorithm. The best path method is a method of selecting an explanatory variable by optimizing an evaluation index of the candidate multivariate discriminant while eliminating the explanatory variables contained in the candidate multivariate discriminant one by one. In step SB-23, the explanatory variable-selecting part 102h3 in the multivariate discriminant-preparing part 102h may select the combination of the amino acid concentration data based on the obesity state information stored in a predetermined memory region of the designated obesity state information file 106d.

The multivariate discriminant-preparing part 102h then judges whether all combinations of the amino acid concentration data contained in the obesity state information stored in a predetermined memory region of the designated obesity state information file 106d are processed, and if the judgment result is “End” (Yes in step SB-24), the processing advances to the next step (step SB-25), and if the judgment result is not “End” (No in step SB-24), it returns to step SB-21. The multivariate discriminant-preparing part 102h may judge whether the processing is performed a predetermined number of times, and if the judgment result is “End” (Yes in step SB-24), the processing may advance to the next step (step SB-25), and if the judgment result is not “End” (No in step SB-24), it may return to step SB-21. The multivariate discriminant-preparing part 102h may judge whether the combination of the amino acid concentration data selected in step SB-23 is the same as the combination of the amino acid concentration data contained in the obesity state information stored in a predetermined memory region of the designated obesity state information file 106d or the combination of the amino acid concentration data selected in the previous step SB-23, and if the judgment result is “the same” (Yes in step SB-24), the processing may advance to the next step (step SB-25) and if the judgment result is not “the same” (No in step SB-24), it may return to step SB-21. If the verification result is specifically the evaluation value for each multivariate discriminant, the multivariate discriminant-preparing part 102h may advance to step SB-25 or return to step SB-21, based on the comparison of the evaluation value with a particular threshold corresponding to each discriminant-preparing method.

Then, the multivariate discriminant-preparing part 102h determines the multivariate discriminant by selecting the candidate multivariate discriminant used as the multivariate discriminant based on the verification results from a plurality of the candidate multivariate discriminants, and stores the determined multivariate discriminant (the selected candidate multivariate discriminant) in particular memory region of the multivariate discriminant file 106e4 (step SB-25). Here, in step SB-25, for example, there are cases where the optimal multivariate discriminant is selected from the candidate multivariate discriminants prepared in the same discriminant-preparing method or the optimal multivariate discriminant is selected from all candidate multivariate discriminants.

Given the foregoing description, the explanation of the multivariate discriminant-preparing processing is finished.

### Example 1

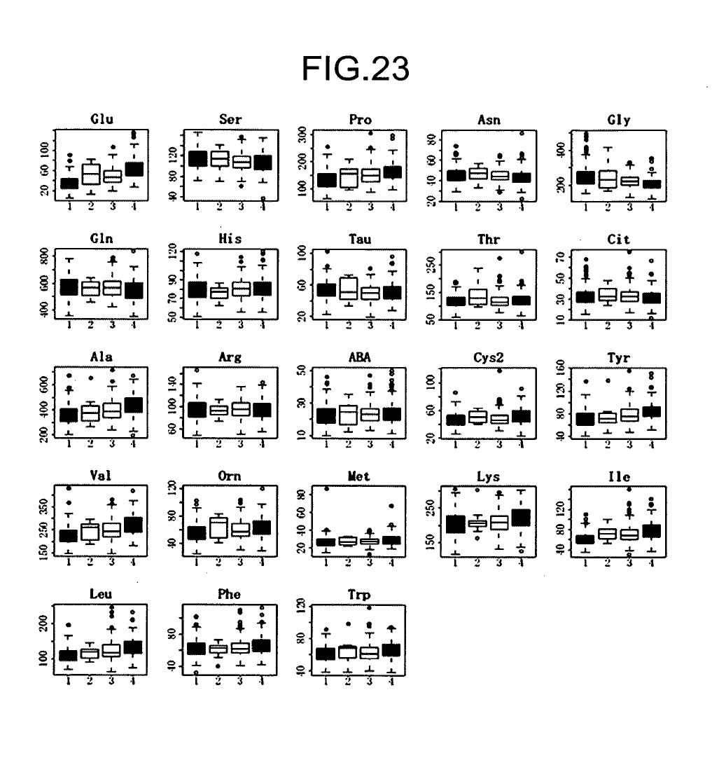

The blood amino acid concentrations are measured by the above-described method of analyzing amino acid from the blood samples of subjects who receive a comprehensive medical examination. The subjects are classified into four groups: a healthy group (BMI<25, VFA (visceral fat area)<100 cm²), an apparent obesity group (BMI≧25, VFA<100 cm²), a non-apparent obesity group (BMI<25, VFA≧100 cm²), and an obesity group (BMI≧25, VFA≧100 cm²). Distribution of amino acid explanatory variables among the four groups is illustrated in FIG. 23. In this drawing, “1” indicates the distribution of the amino acid explanatory variables of the healthy group, “2” indicates that of the apparent obesity group, “3” indicates that of the non-apparent obesity group, and “4” indicates that of the obesity group. In order to evaluate an obesity state, the Kruskal Wallis test is performed among the four groups.

Glu, Ser, Pro, Gly, Ala, Cys2, Tyr, Val, Orn, Met, Lys, Ile, Leu, Phe, and Trp significantly change among the four groups and it was found that they have discriminative ability among the four groups.

### Example 2

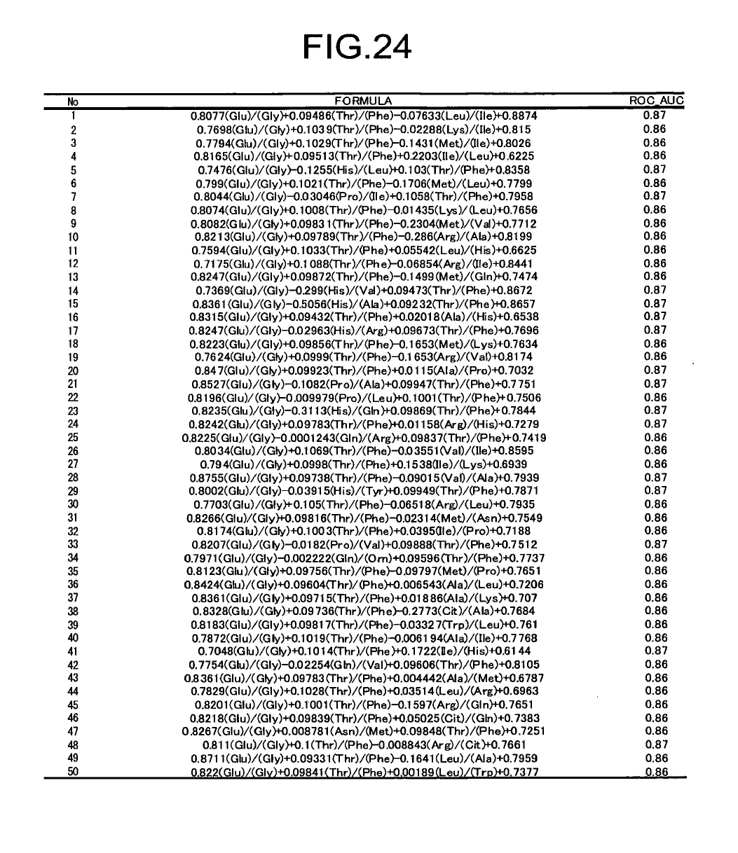

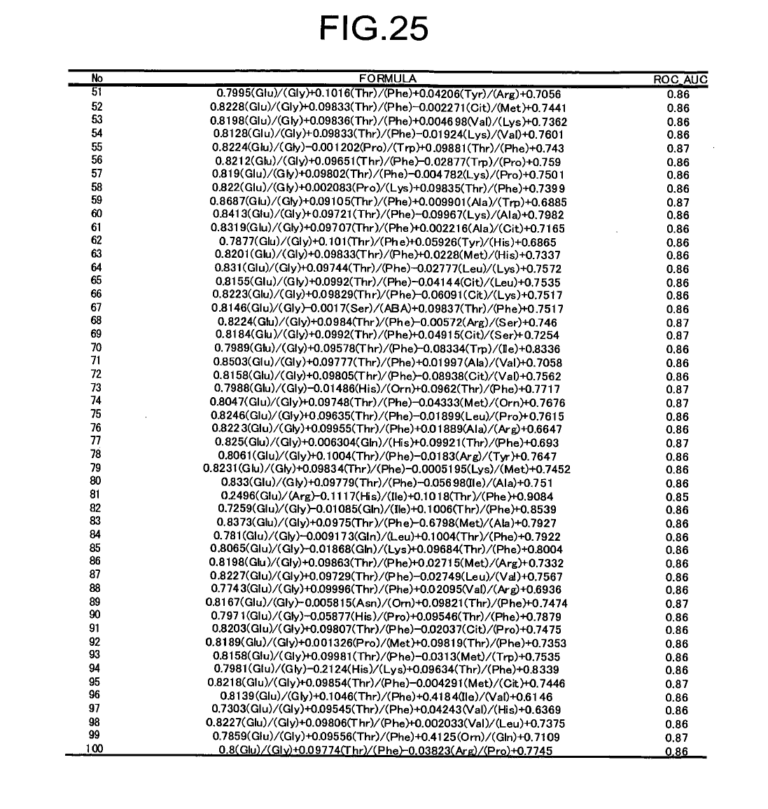

The sample data used in Example 1 is used. Indices which maximize 2-group discriminative ability between the healthy group and the apparent obesity group are earnestly searched for, by using the method described in International publication WO 2004/052191 which is an international application by the present applicant. As a result, index formula 1 is obtained among a plurality of index formulae having equivalent ability. Other than this, a plurality of multivariate discriminants having discriminative ability equivalent to the index formula 1 are obtained. They are shown in FIGS. 24 and 25. The value of each coefficient in the formulae shown in FIGS. 24 and 25 may be multiplied by a real number or by adding an arbitrary constant term thereto.

0.707(Glu)/(Gly)−0.09557(His)/(Ile)+0.1031(Thr)/(Phe)+0.875 Index formula 1:

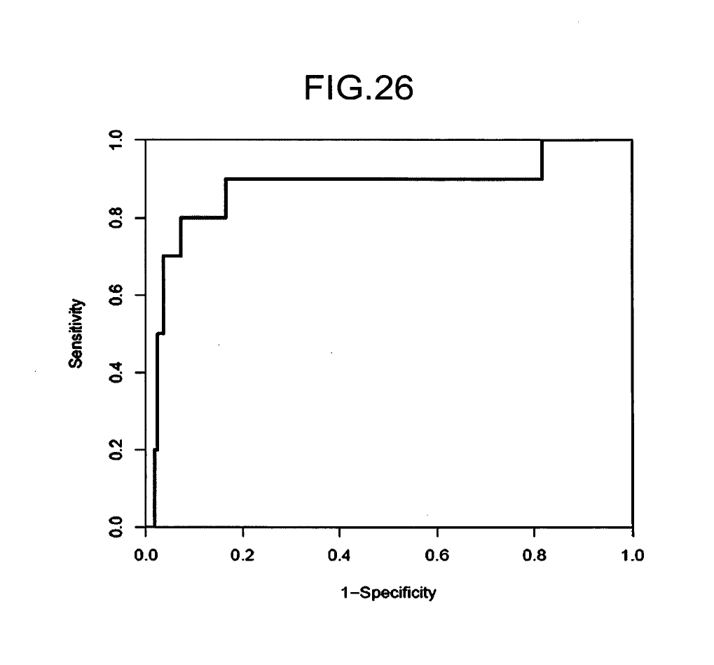

The 2-group discrimination between the healthy group and the apparent obesity group using the index formula 1 is evaluated by the area under the ROC curve (see FIG. 26). As a result, an AUC of 0.876±0.039 (in 95% confidence interval, 0.800 to 0.953) is obtained. In addition, the optimum cutoff value of the 2-group discrimination between the healthy group and the apparent obesity group using the index formula 1 is calculated with the symptom prevalence of the apparent obesity of 6%. As a result, the cutoff value is 1.151, and 80.00% sensitivity, 92.68% specificity, 41.10% positive predictive value, 98.64% negative predictive value, and 91.92% correct diagnosis rate are obtained. From these results, it is found that the index formula 1 is useful, with high diagnostic ability.

### Example 3

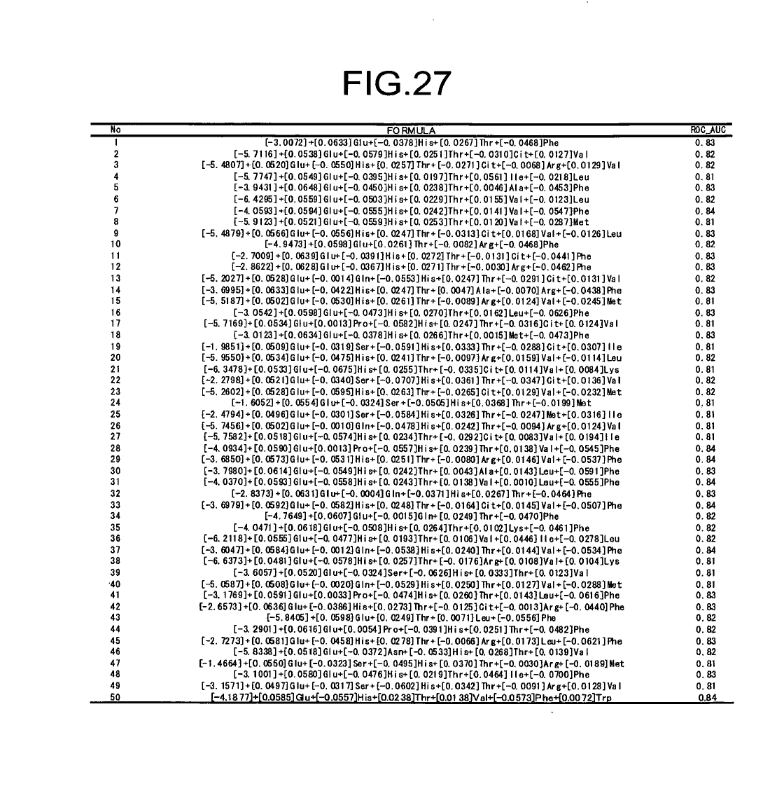

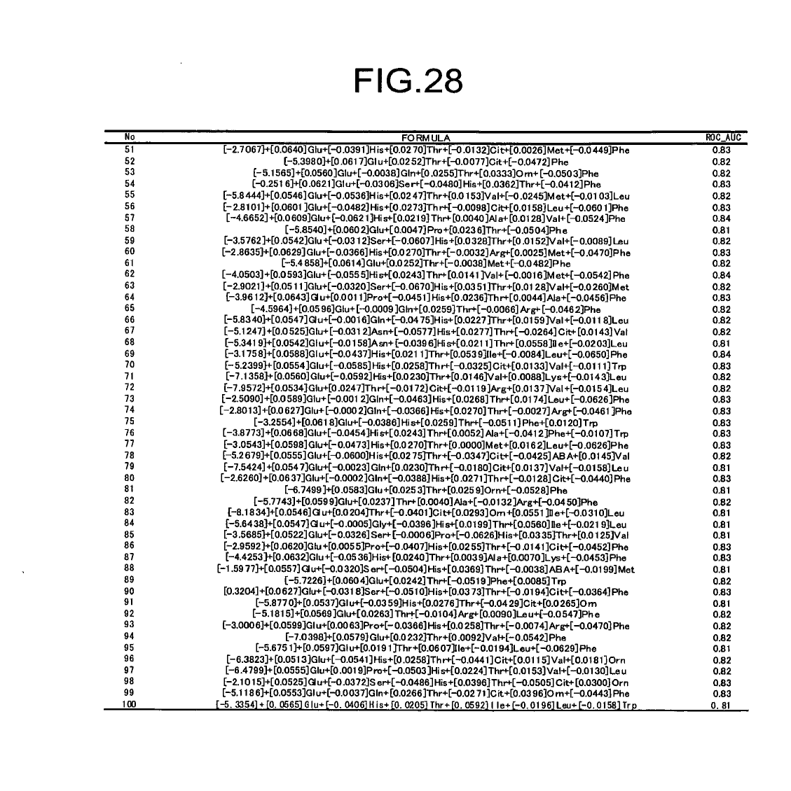

The sample data used in Example 1 is used. Indices which maximize 2-group discriminative ability between the healthy group and the apparent obesity group are searched for, by logistic analysis (explanatory variable coverage method according to the ROC maximum criterion). As a result, as index formula 2, a logistic regression equation having Glu, Thr, and Phe (the numeral coefficients of the amino acid explanatory variables Glu, Thr, and Phe, and the constant term are 0.0616, 0.0250, −0.0488, and −5.5278 in order) is obtained. Other than this, a plurality of logistic regression equations having discriminative ability equivalent to the index formula 2 are obtained. They are shown in FIGS. 27 and 28. The value of each coefficient in the equations shown in FIGS. 27 and 28 may be multiplied by a real number.

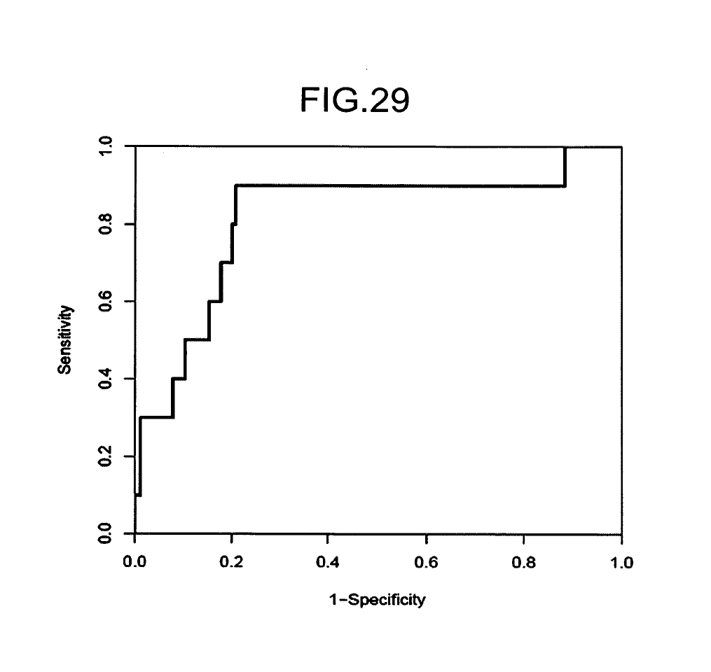

The 2-group discrimination between the healthy group and the apparent obesity group using the index formula 2 is evaluated by the area under the ROC curve (see FIG. 29). As a result, an AUC of 0.817±0.053 (in 95% confidence interval, 0.714 to 0.920) is obtained. In addition, the optimum cutoff value of the 2-group discrimination between the healthy group and the apparent obesity group using the index formula 2 is calculated with the symptom prevalence of the apparent obesity of 6%. As a result, the cutoff value is 0.061, and 90.00% sensitivity, 79.27% specificity, 21.70% positive predictive value, 99.20% negative predictive value, and 79.91% correct diagnosis rate are obtained. From these results, it is found that the index formula 2 is useful, with high diagnostic ability.

### Example 4

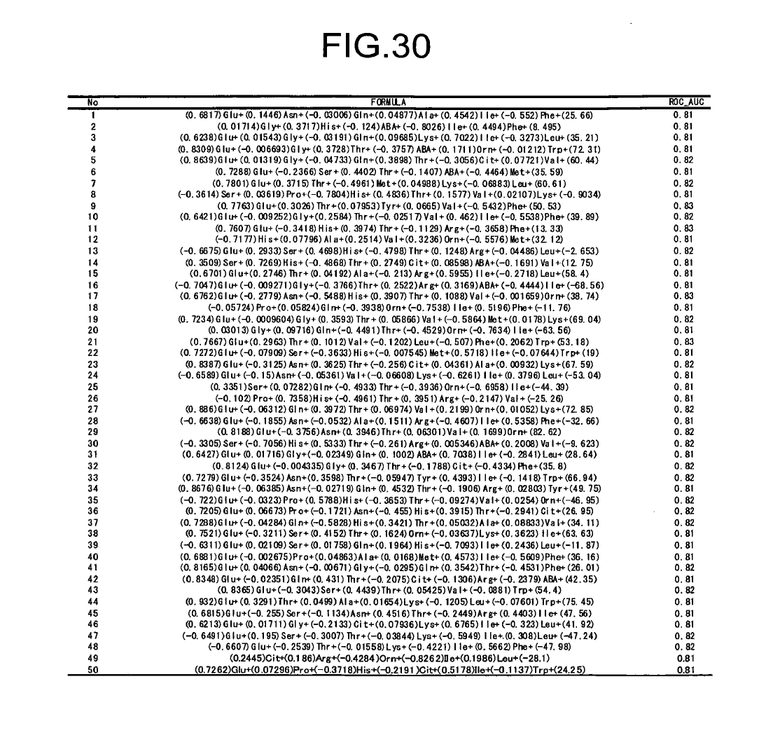

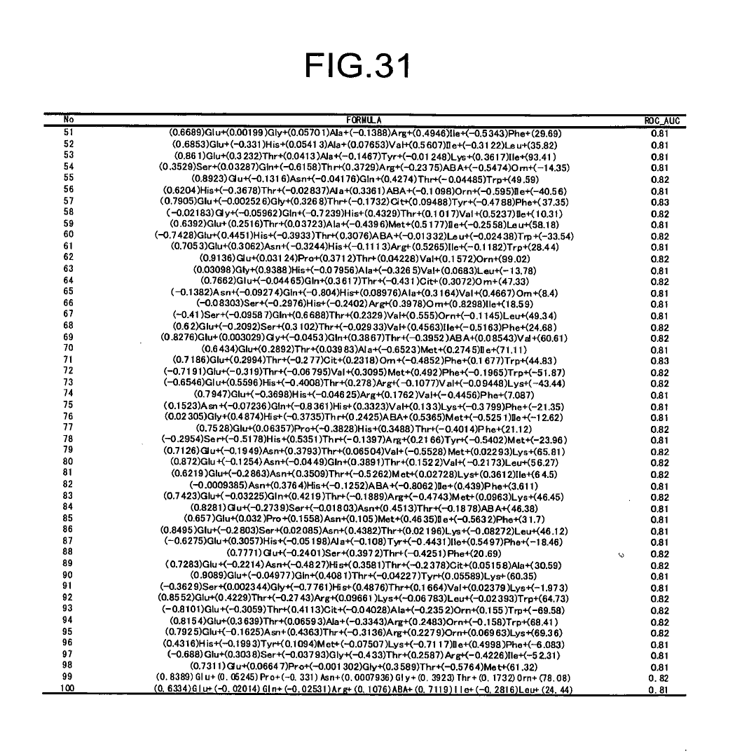

The sample data used in Example 1 is used. Indices which maximize 2-group discriminative ability between the healthy group and the apparent obesity group are searched for, by linear discriminant analysis (explanatory variable coverage method). As a result, as index formula 3, a linear discriminant function having His, Thr, Val, Orn, and Trp (the numeral coefficients of the amino acid explanatory variables His, Thr, Val, Orn, and Trp, and the constant term are 0.8411, −0.457, −0.1973, −0.1053, −0.1838, and −49.56 in order) is obtained. Other than this, a plurality of linear discriminant functions having discriminative ability equivalent to the index formula 3 are obtained. They are shown in FIGS. 30 and 31. The value of each coefficient in the functions shown in FIGS. 30 and 31 may be multiplied by a real number or by adding an arbitrary constant term thereto.

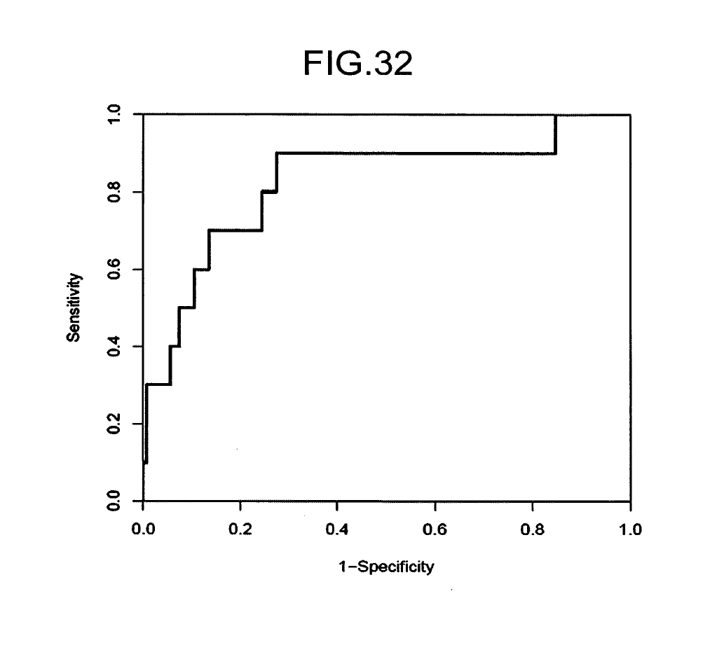

The 2-group discrimination between the healthy group and the apparent obesity group using the index formula 3 is evaluated by the area under the ROC curve (see FIG. 32). As a result, an AUC of 0.826±0.051 (in 95% confidence interval, 0.726 to 0.925) is obtained. In addition, the optimum cutoff value of the 2-group discrimination between the healthy group and the apparent obesity group using the index formula 3 is calculated with the symptom prevalence of the apparent obesity of 6%. As a result, the cutoff value is 6.29, and 80.00% sensitivity, 75.61% specificity, 17.31% positive predictive value, 98.34% negative predictive value, and 75.87% correct diagnosis rate are obtained. From these results, it is found that the index formula 3 is useful, with high diagnostic ability.

### Example 5

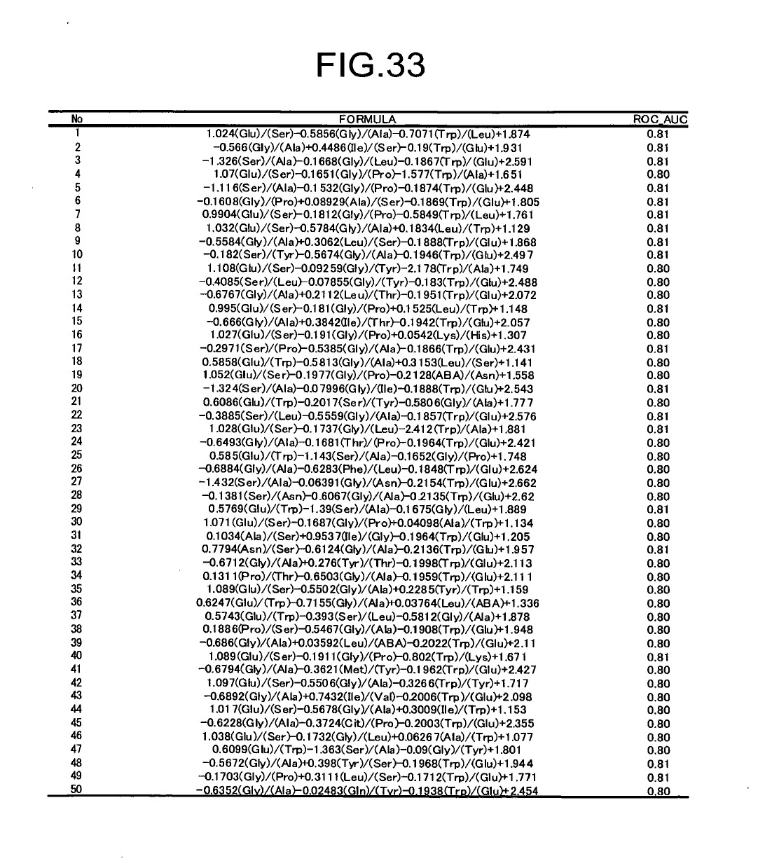

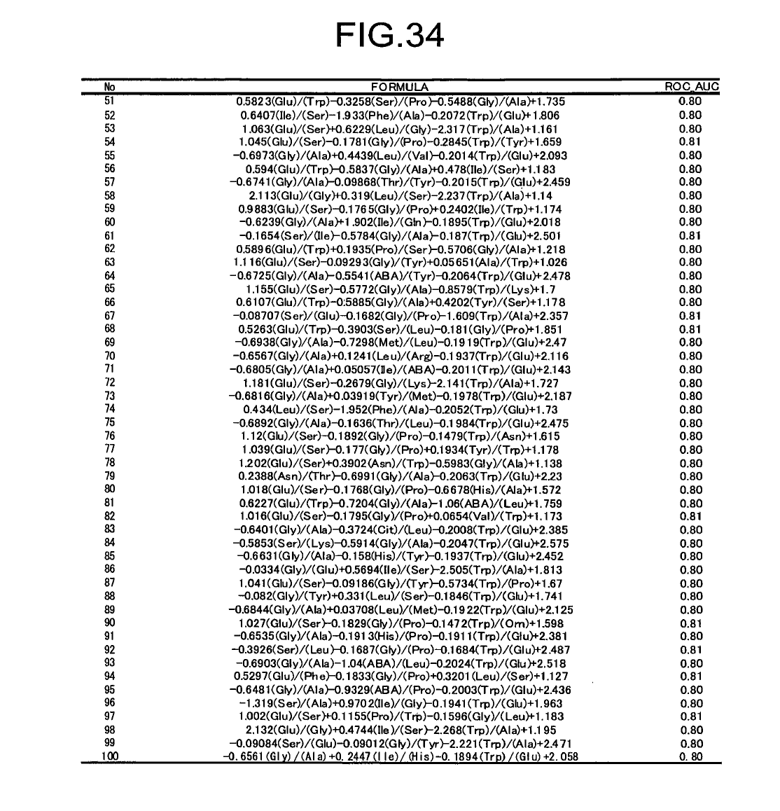

The sample data used in Example 1 is used. Indices which maximize 2-group discriminative ability between the healthy group and the non-apparent obesity group are earnestly searched for, by using the method described in International publication WO 2004/052191 which is an international application by the present applicant. As a result, index formula 4 is obtained among a plurality of index formulae having equivalent ability. Other than this, a plurality of multivariate discriminants having discriminative ability equivalent to the index formula 4 are obtained. They are shown in FIGS. 33 and 34. The value of each coefficient in the formulae shown in FIGS. 33 and 34 may be multiplied by a real number or by adding an arbitrary constant term thereto.

−1.314(Ser)/(Ala)−0.08432(Gly)/(Tyr)−0.1957(Trp)/(Glu)+2.529 Index formula 4:

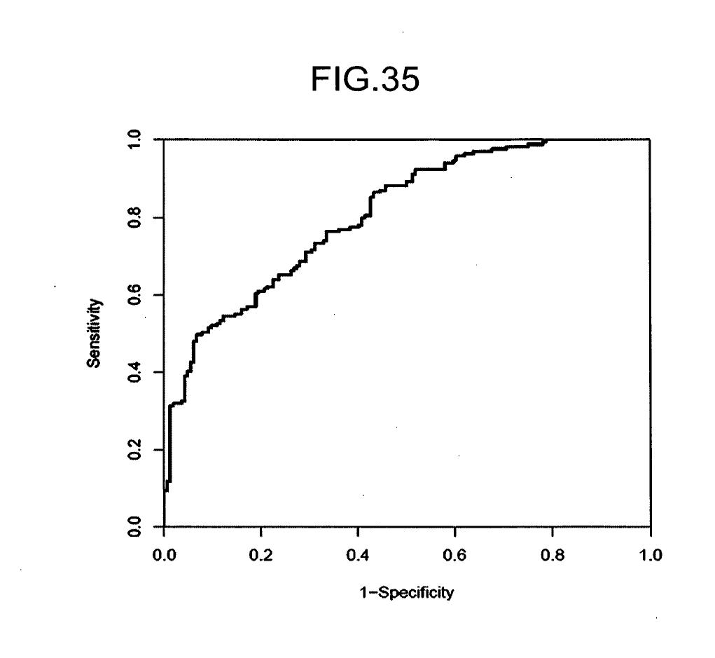

The 2-group discrimination between the healthy group and the non-apparent obesity group using the index formula 4 is evaluated by the area under the ROC curve (see FIG. 35). As a result, an AUC of 0.807±0.024 (in 95% confidence interval, 0.760 to 0.854) is obtained. In addition, the optimum cutoff value of the 2-group discrimination between the healthy group and the non-apparent obesity group using the index formula 4 is calculated with the symptom prevalence of the non-apparent obesity of 50%. As a result, the cutoff value is 1.534, and 71.01% sensitivity, 70.12% specificity, 70.38% positive predictive value, 70.75% negative predictive value, and 70.56% correct diagnosis rate are obtained. From these results, it is found that the index formula 4 is useful, with high diagnostic ability.

### Example 6

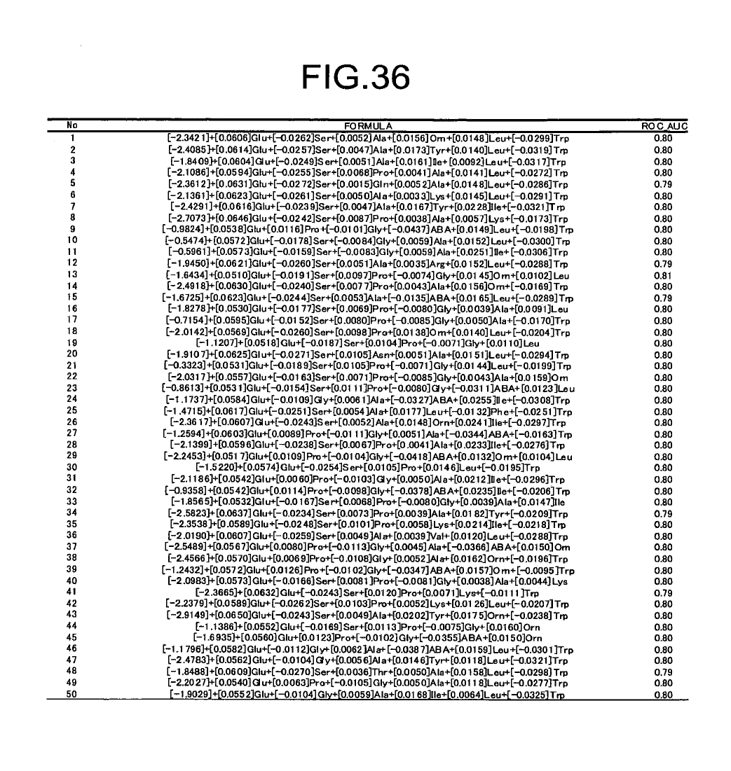

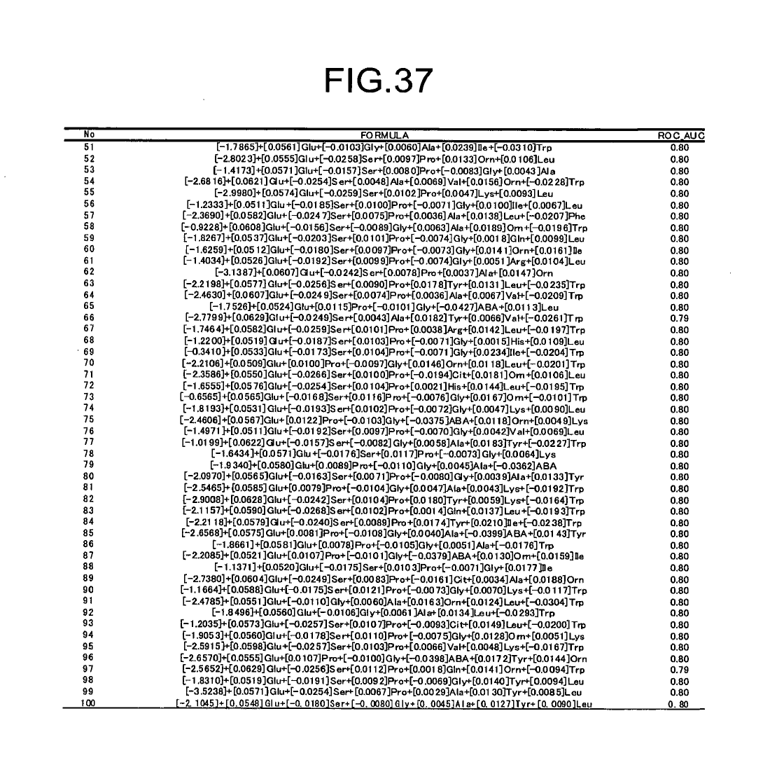

The sample data used in Example 1 is used. Indices which maximize 2-group discriminative ability between the healthy group and the non-apparent obesity group are searched for, by logistic analysis (explanatory variable coverage method according to the ROC maximum criterion). As a result, as index formula 5, a logistic regression equation having Glu, Ser, Ala, Orn, Leu, and Trp (the numeral coefficients of the amino acid explanatory variables Glu, Ser, Ala, Orn, Leu, and Trp, and the constant term are 0.0606, −0.0262, −0.0052, 0.0156, 0.0148, −0.0299, and −2.3421 in order) is obtained. Other than this, a plurality of logistic regression equations having discriminative ability equivalent to the index formula 5 are obtained. They are shown in FIGS. 36 and 37. The value of each coefficient in the equations shown in FIGS. 36 and 37 may be multiplied by a real number.

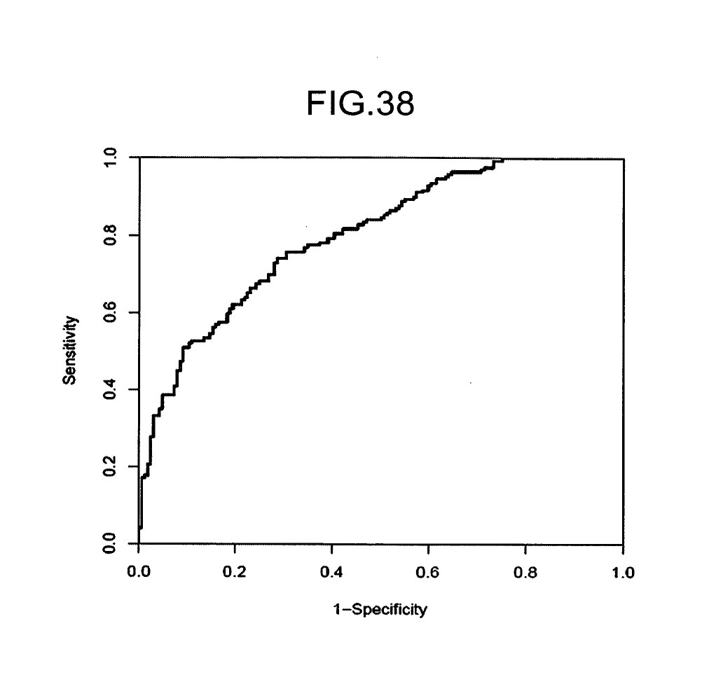

The 2-group discrimination between the healthy group and the non-apparent obesity group using the index formula 5 is evaluated by the area under the ROC curve (see FIG. 38). As a result, an AUC of 0.799±0.024 (in 95% confidence interval, 0.751 to 0.847) is obtained. In addition, the optimum cutoff value of the 2-group discrimination between the healthy group and the non-apparent obesity group using the index formula 5 is calculated with the symptom prevalence of the non-apparent obesity of 50%. As a result, the cutoff value is 0.485, and 73.96% sensitivity, 71.34% specificity, 72.07% positive predictive value, 73.26% negative predictive value, and 72.65% correct diagnosis rate are obtained. From these results, it is found that the index formula 5 is useful, with high diagnostic ability.

### Example 7

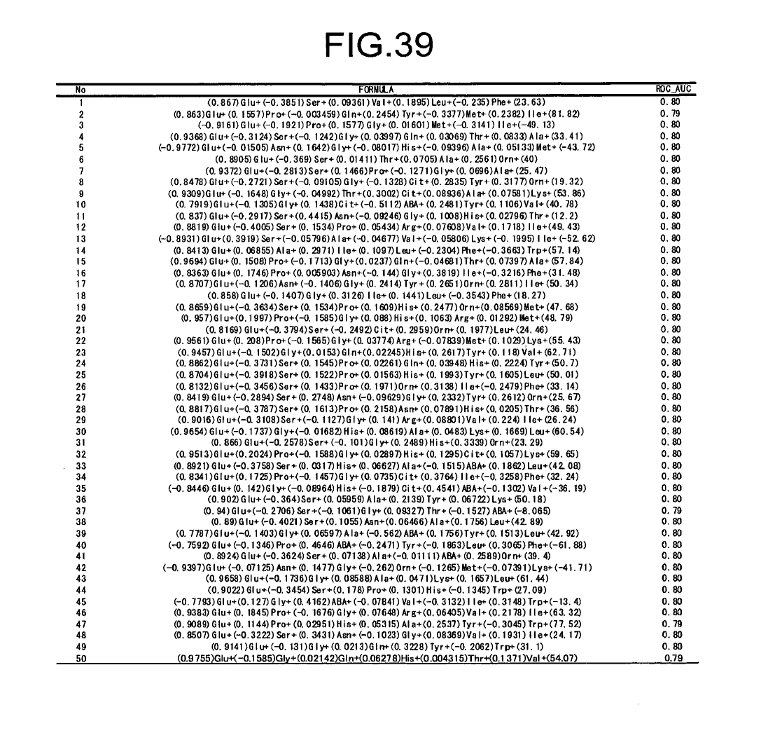

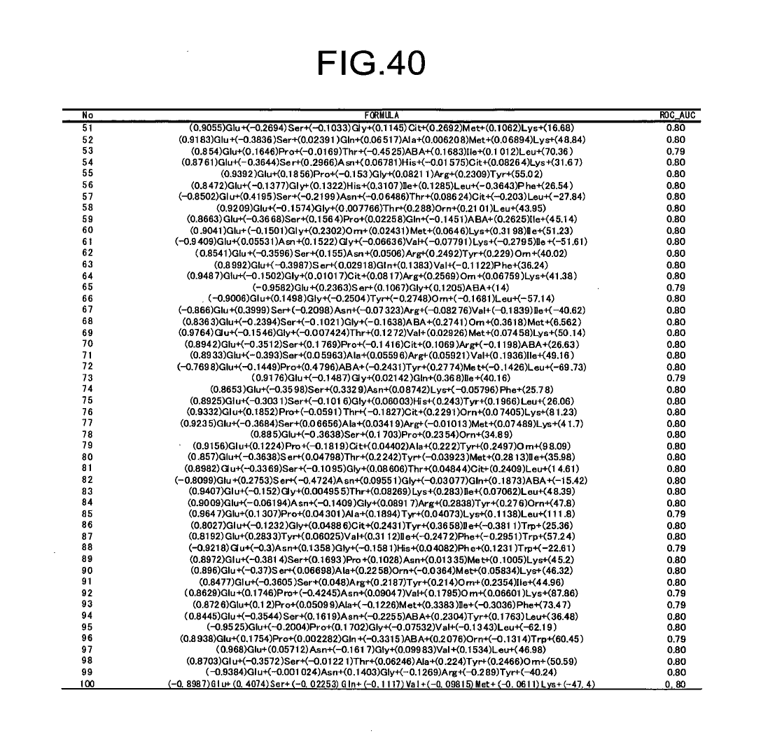

The sample data used in Example 1 is used. Indices which maximize 2-group discriminative ability between the healthy group and the non-apparent obesity group are searched for, by linear discriminant analysis (explanatory variable coverage method). As a result, as index formula 6, a linear discriminant function having Glu, Ser, His, Thr, Lys, and Phe (the numeral coefficients of the amino acid explanatory variables Glu, Ser, His, Thr, Lys, and Phe, and the constant term are 0.9185, −0.3667, 0.08611, 0.05409, 0.1007, −0.0387, and 29.51 in order) is obtained. Other than this, a plurality of linear discriminant functions having discriminative ability equivalent to the index formula 6 are obtained. They are shown in FIGS. 39 and 40. The value of each coefficient in the functions shown in FIGS. 39 and 40 may be multiplied by a real number or by adding an arbitrary constant term thereto.

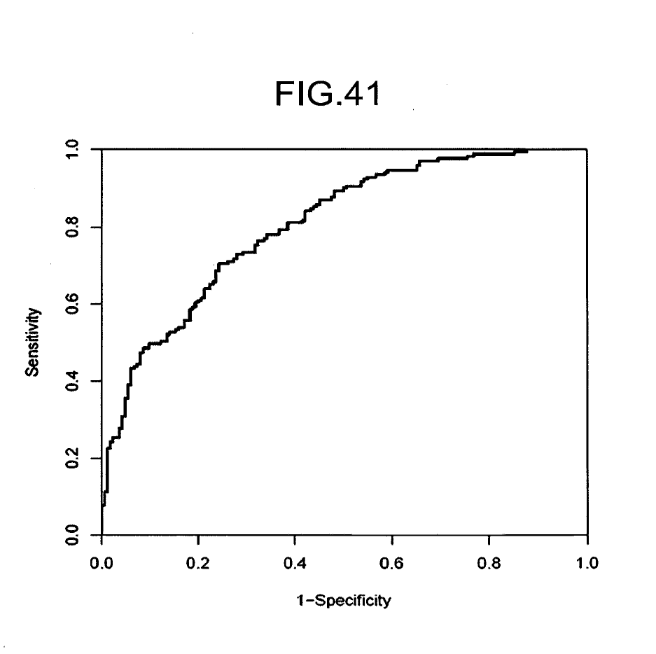

The 2-group discrimination between the healthy group and the non-apparent obesity group using the index formula 6 is evaluated by the area under the ROC curve (see FIG. 41). As a result, an AUC of 0.803±0.024 (in 95% confidence interval, 0.756 to 0.851) is obtained. In addition, the optimum cutoff value of the 2-group discrimination between the healthy group and the non-apparent obesity group using the index formula 6 is calculated with the symptom prevalence of the non-apparent obesity of 50%. As a result, the cutoff value is −0.06, and 70.41% sensitivity, 75.61% specificity, 74.27% positive predictive value, 71.88% negative predictive value, and 73.01% correct diagnosis rate are obtained. From these results, it is found that the index formula 6 is useful, with high diagnostic ability.

### Example 8

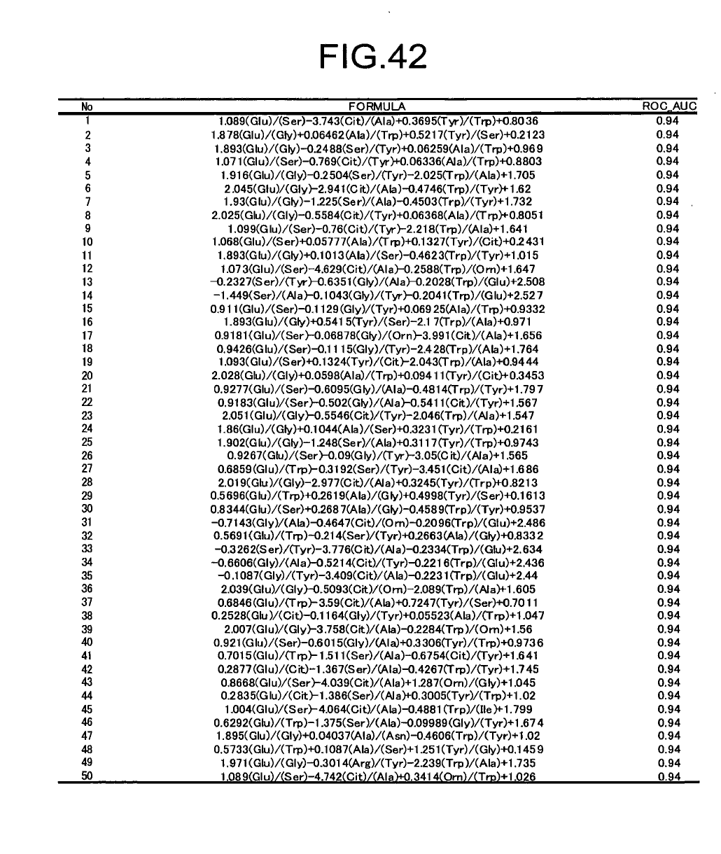

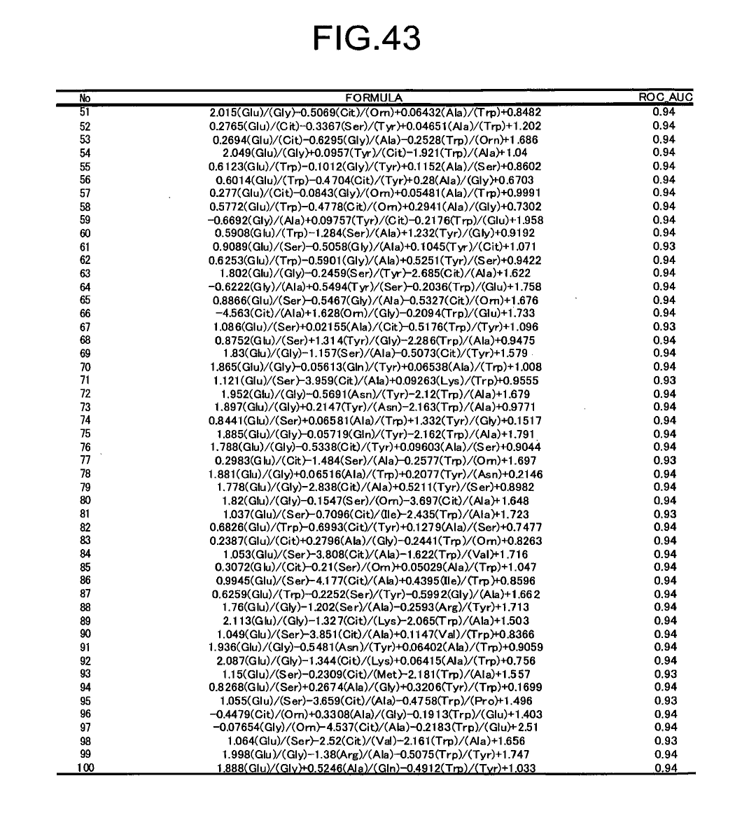

The sample data used in Example 1 is used. Indices which maximize 2-group discriminative ability between the healthy group and the obesity group are earnestly searched for, by using the method described in International publication WO 2004/052191 which is an international application by the present applicant. As a result, index formula 7 is obtained among a plurality of index formulae having equivalent ability. Other than this, a plurality of multivariate discriminants having discriminative ability equivalent to the index formula 7 are obtained. They are shown in FIGS. 42 and 43. The value of each coefficient in the formulae shown in FIGS. 42 and 43 may be multiplied by a real number or by adding an arbitrary constant term thereto.

1.1(Glu)/(Ser)−3.72(Cit)/(Ala)−0.5253(Trp)/(Tyr)+1.704 Index formula 7:

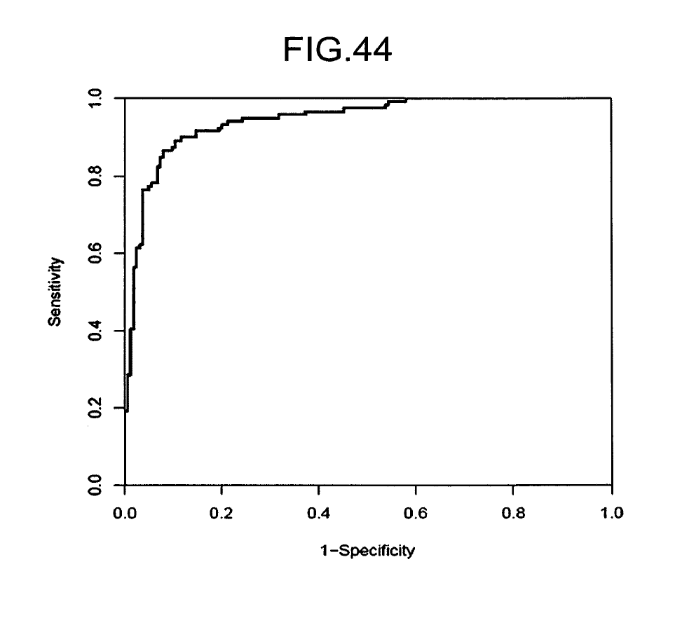

The 2-group discrimination between the healthy group and the obesity group using the index formula 7 is evaluated by the area under the ROC curve (see FIG. 44). As a result, an AUC of 0.945±0.013 (in 95% confidence interval, 0.919 to 0.971) is obtained. In addition, the optimum cutoff value of the 2-group discrimination between the healthy group and the obesity group using the index formula 7 is calculated with the symptom prevalence of the obesity of 42%. As a result, the cutoff value is 1.446, and 86.55% sensitivity, 92.07% specificity, 88.77% positive predictive value, 90.44% negative predictive value, and 89.76% correct diagnosis rate are obtained. From these results, it is found that the index formula 7 is useful, with high diagnostic ability.

### Example 9

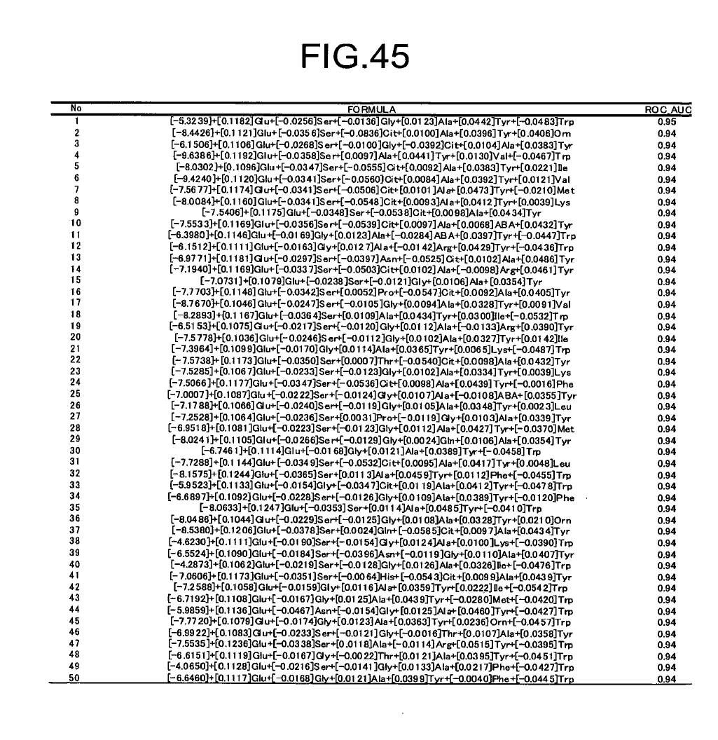

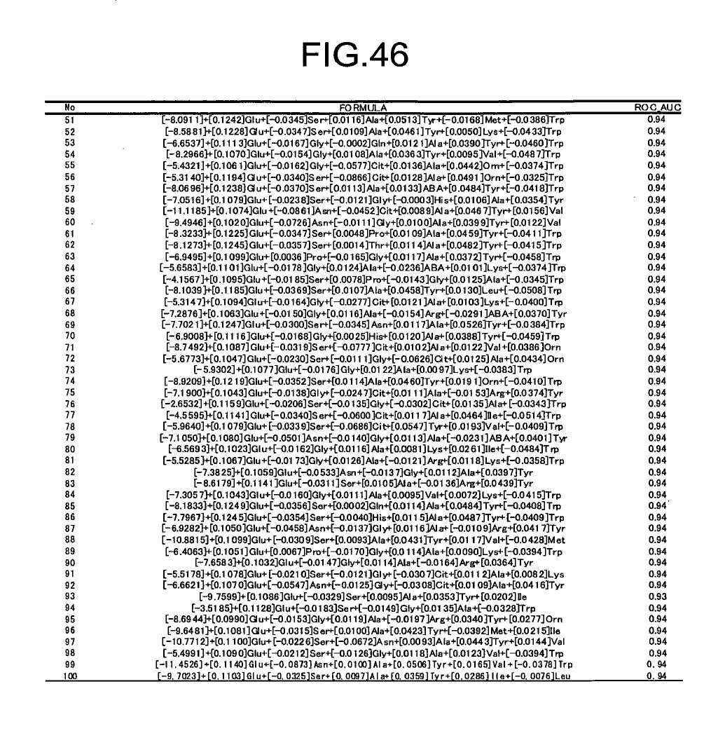

The sample data used in Example 1 is used. Indices which maximize 2-group discriminative ability between the healthy group and the obesity group are searched for, by logistic analysis (explanatory variable coverage method according to the ROC maximum criterion). As a result, as index formula 8, a logistic regression equation having Glu, Ser, Cit, Ala, Tyr, and Trp (the numeral coefficients of the amino acid explanatory variables Glu, Ser, Cit, Ala, Tyr, and Trp, and the constant term are 0.1299, −0.0384, −0.0633, 0.0115, 0.0536, −0.0480, and −5.8449 in order) is obtained. Other than this, a plurality of logistic regression equations having discriminative ability equivalent to the index formula 8 are obtained. They are shown in FIGS. 45 and 46. The value of each coefficient in the equations shown in FIGS. 45 and 46 may be multiplied by a real number.

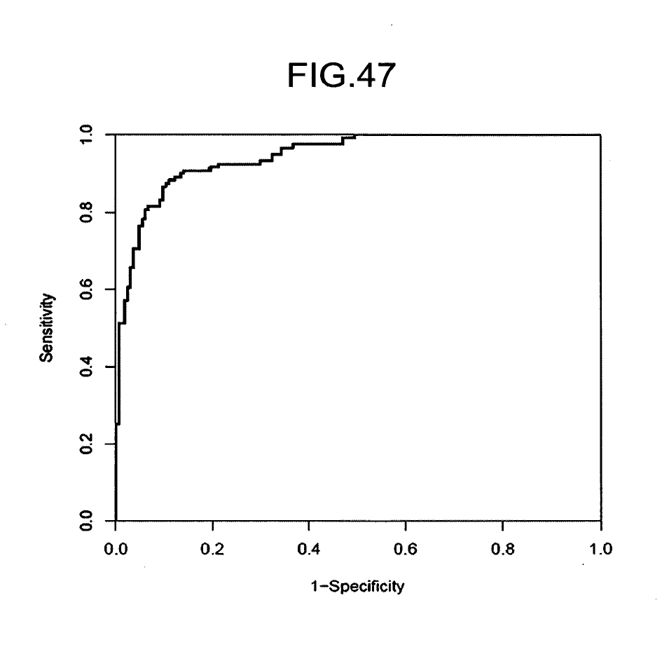

The 2-group discrimination between the healthy group and the obesity group using the index formula 8 is evaluated by the area under the ROC curve (see FIG. 47). As a result, an AUC of 0.945±0.013 (in 95% confidence interval, 0.919 to 0.971) is obtained. In addition, the optimum cutoff value of the 2-group discrimination between the healthy group and the obesity group using the index formula 8 is calculated with the symptom prevalence of the obesity of 42%. As a result, the cutoff value is 0.441, and 86.55% sensitivity, 90.24% specificity, 86.53% positive predictive value, 90.26% negative predictive value, and 88.69% correct diagnosis rate are obtained. From these results, it is found that the index formula 8 is useful, with high diagnostic ability.

### Example 10

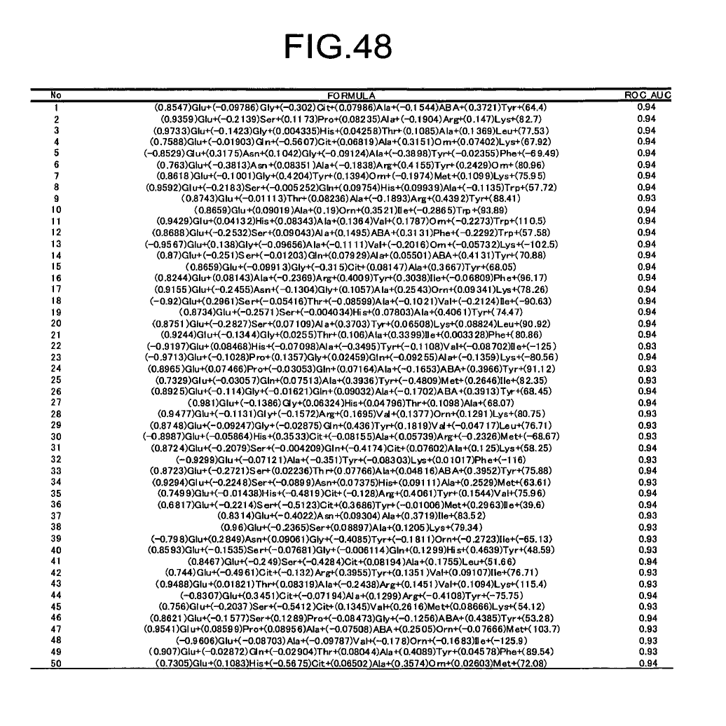

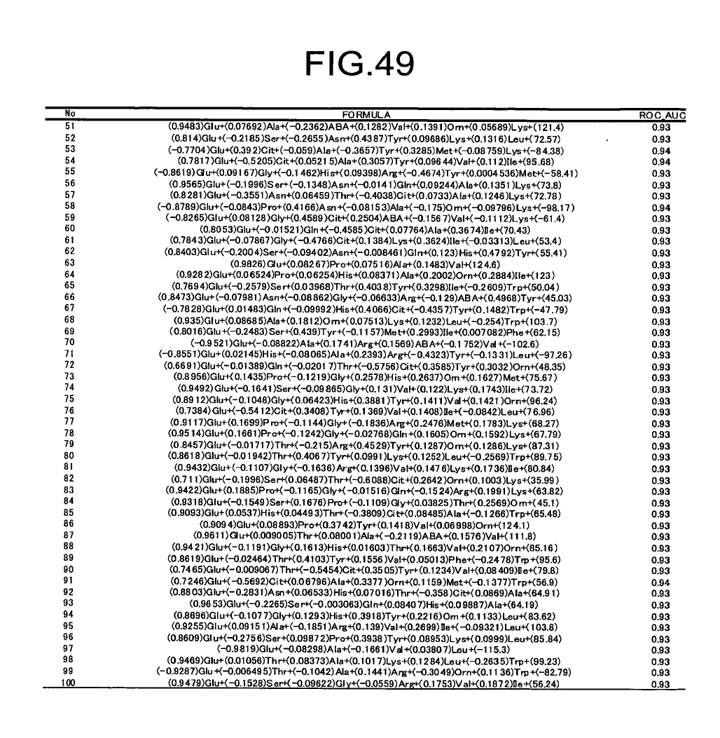

The sample data used in Example 1 is used. Indices which maximize 2-group discriminative ability between the healthy group and the obesity group are searched for, by linear discriminant analysis (explanatory variable coverage method). As a result, as index formula 9, a linear discriminant function having Glu, Thr, Ala, Tyr, Orn, and Lys (the numeral coefficients of the amino acid explanatory variables Glu, Thr, Ala, Tyr, Orn, and Lys, and the constant term are 0.9113, −0.06324, 0.07523, 0.354, 0.1762, 0.05985, and 115.6 in order) is obtained. Other than this, a plurality of linear discriminant functions having discriminative ability equivalent to the index formula 9 are obtained. They are shown in FIGS. 48 and 49. The value of each coefficient in the functions shown in FIGS. 48 and 49 may be multiplied by a real number or by adding an arbitrary constant term thereto.

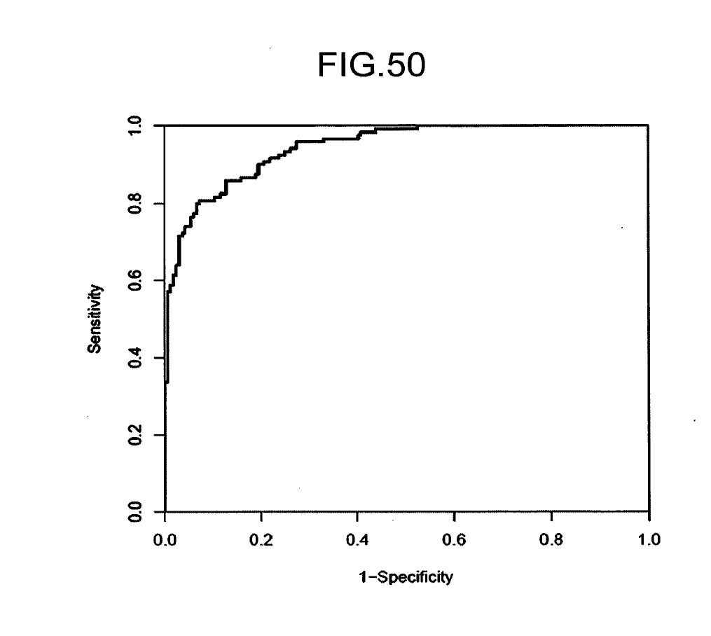

The 2-group discrimination between the healthy group and the obesity group using the index formula 9 is evaluated by the area under the ROC curve (see FIG. 50). As a result, an AUC of 0.943±0.014 (in 95% confidence interval, 0.917 to 0.970) is obtained. In addition, the optimum cutoff value of the 2-group discrimination between the healthy group and the obesity group using the index formula 9 is calculated with the symptom prevalence of the obesity of 42%. As a result, the cutoff value is 0.08, and 85.71% sensitivity, 87.20% specificity, 82.90% positive predictive value, 89.39% negative predictive value, and 86.57% correct diagnosis rate are obtained. From these results, it is found that the index formula 9 is useful, with high diagnostic ability.

### Example 11

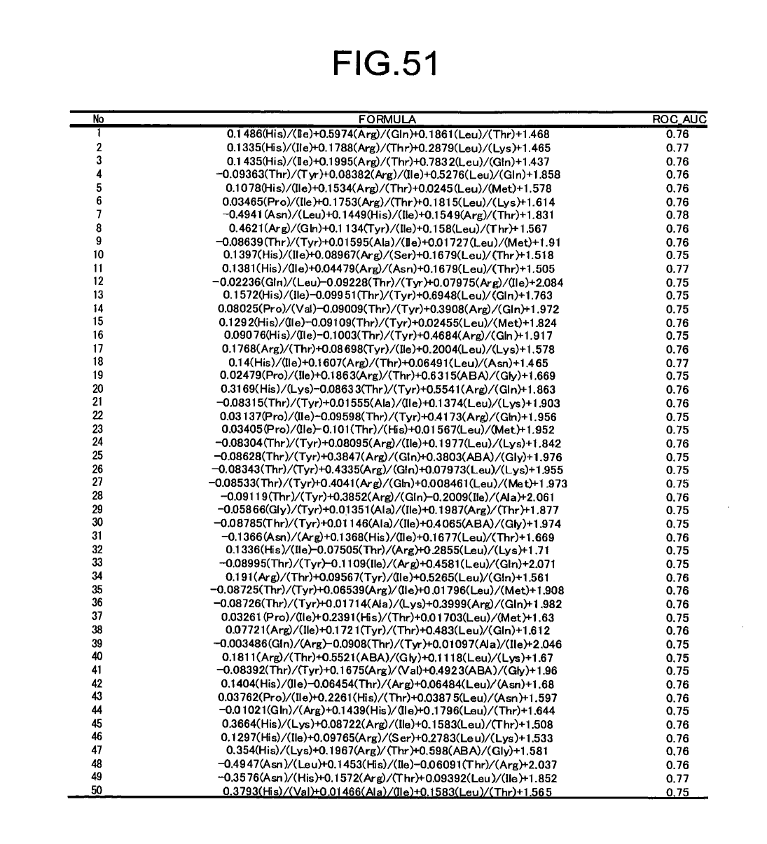

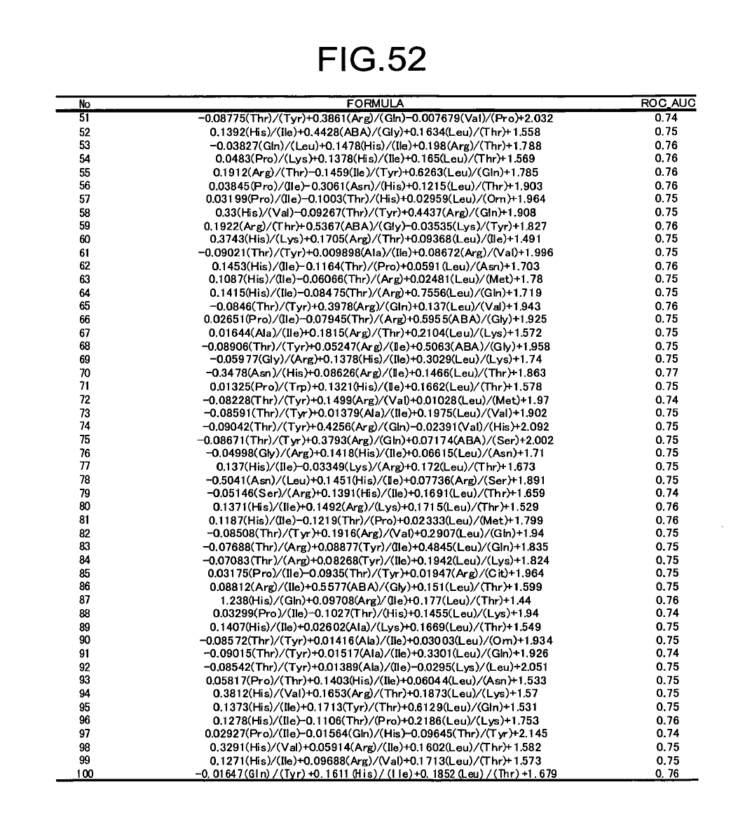

The sample data used in Example 1 is used. Indices which maximize 2-group discriminative ability between the apparent obesity group and the non-apparent obesity group are earnestly searched for, by using the method described in International publication WO 2004/052191 which is an international application by the present applicant. As a result, index formula 4 is obtained among a plurality of index formulae having equivalent ability. Other than this, a plurality of multivariate discriminants having discriminative ability equivalent to the index formula 10 are obtained. They are shown in FIGS. 51 and 52. The value of each coefficient in the formulae shown in FIGS. 51 and 52 may be multiplied by a real number or by adding an arbitrary constant term thereto.

−0.09376(Thr)/(Tyr)+0.0108(Ala)/(Ile)+0.3634(Arg)/(Gln)+1.969 Index formula 10:

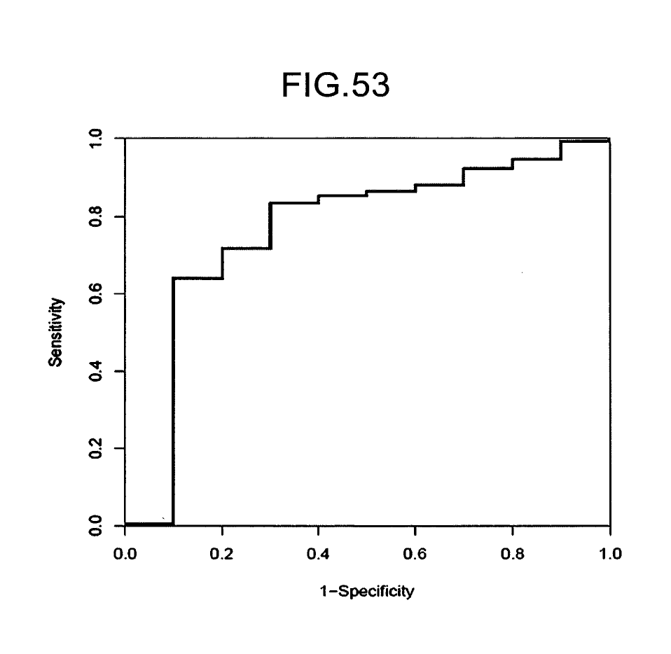

The 2-group discrimination between the apparent obesity group and the non-apparent obesity group using the index formula 10 is evaluated by the area under the ROC curve (see FIG. 53). As a result, an AUC of 0.766±0.090 (in 95% confidence interval, 0.590 to 0.941) is obtained. In addition, the optimum cutoff value of the 2-group discrimination between the apparent obesity group and the non-apparent obesity group using the index formula 10 is calculated with the symptom prevalence of the non-apparent obesity of 6%. As a result, the cutoff value is 1.934, and 71.60% sensitivity, 80.00% specificity, 18.60% positive predictive value, 97.78% negative predictive value, and 79.50% correct diagnosis rate are obtained. From these results, it is found that the index formula 10 is useful, with high diagnostic ability.

### Example 12

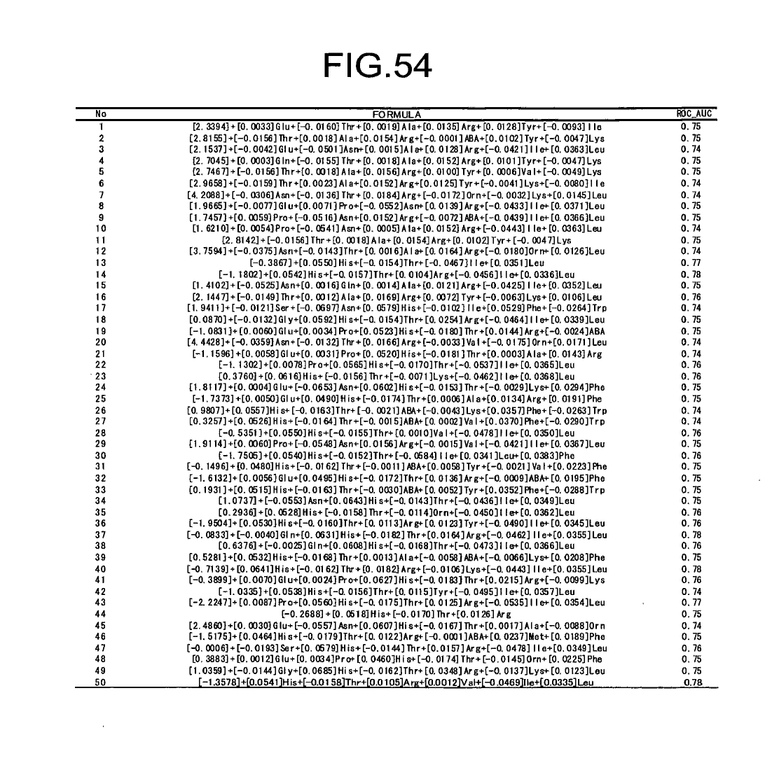

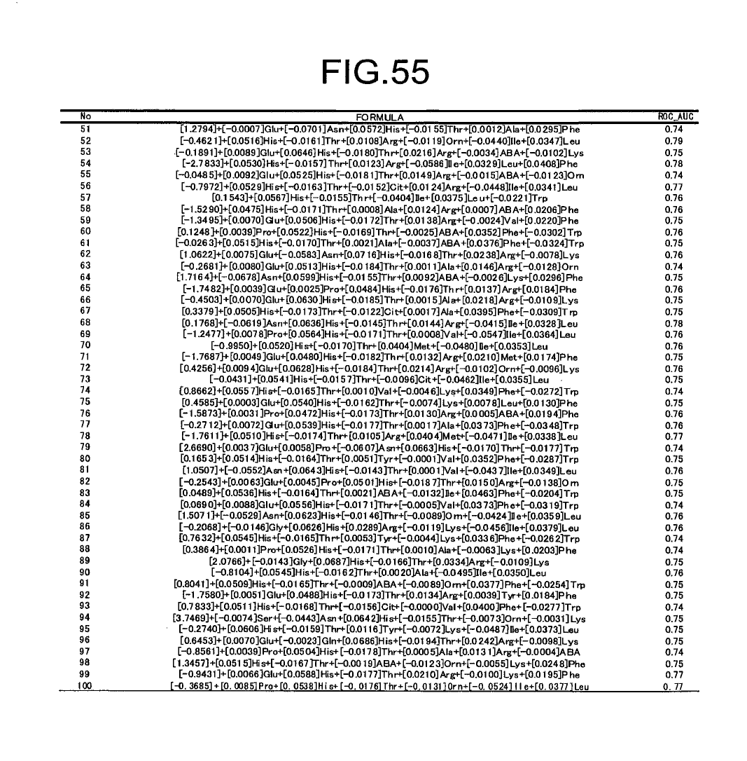

The sample data used in Example 1 is used. Indices which maximize 2-group discriminative ability between the apparent obesity group and the non-apparent obesity group are searched for, by logistic analysis (explanatory variable coverage method according to the ROC maximum criterion). As a result, as index formula 11, a logistic regression equation having Glu, Thr, Ala, Arg, Tyr, and Lys (the numeral coefficients of the amino acid explanatory variables Glu, Thr, Ala, Arg, Tyr, and Lys, and the constant term are 0.0015, −0.0157, 0.0018, 0.0157, 0.0101, −0.0046, and 2.7478 in order) is obtained. Other than this, a plurality of logistic regression equations having discriminative ability equivalent to the index formula 11 are obtained. They are shown in FIGS. 54 and 55. The value of each coefficient in the equations shown in FIGS. 54 and 55 may be multiplied by a real number.

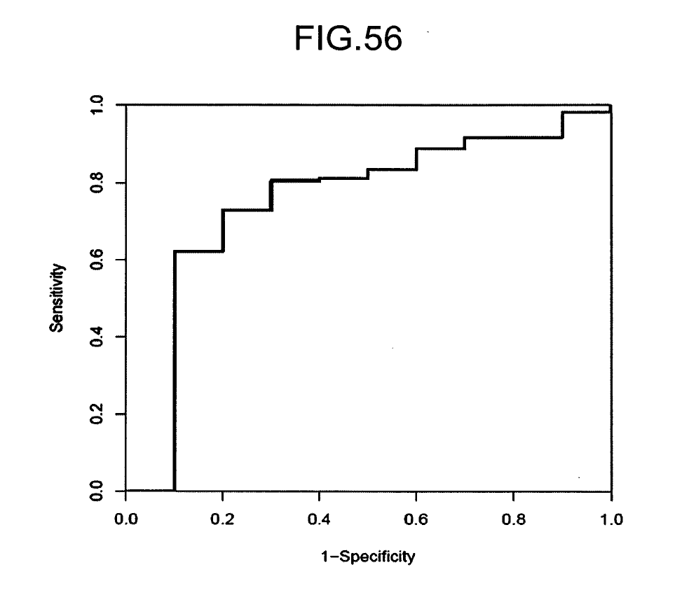

The 2-group discrimination between the apparent obesity group and the non-apparent obesity group using the index formula 11 is evaluated by the area under the ROC curve (see FIG. 56). As a result, an AUC of 0.750±0.091 (in 95% confidence interval, 0.571 to 0.929) is obtained. In addition, the optimum cutoff value of the 2-group discrimination between the apparent obesity group and the non-apparent obesity group using the index formula 11 is calculated with the symptom prevalence of the non-apparent obesity of 6%. As a result, the cutoff value is 0.942, and 72.78% sensitivity, 80.0% specificity, 18.85% positive predictive value, 97.87% negative predictive value, and 79.57% correct diagnosis rate are obtained. From these results, it is found that the index formula 11 is useful, with high diagnostic ability.

### Example 13

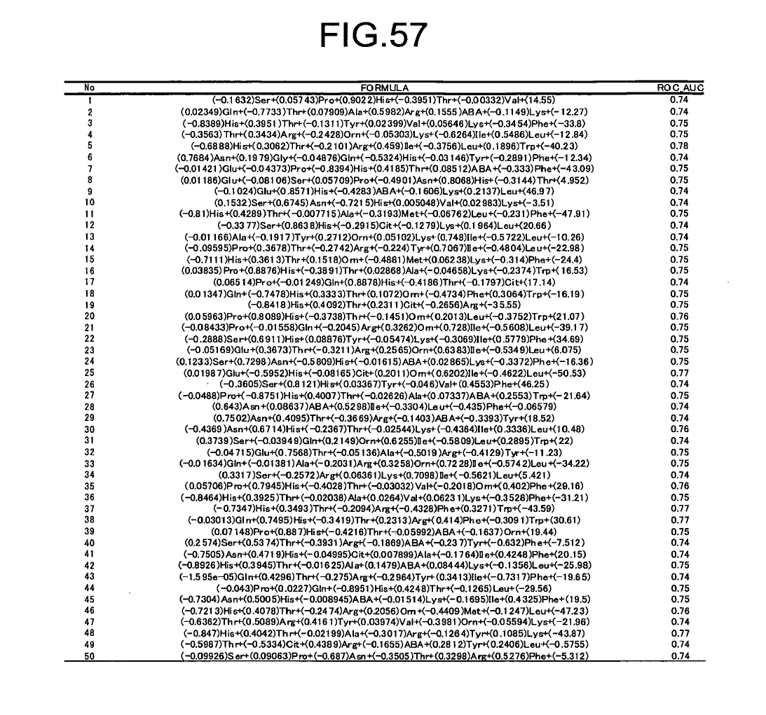

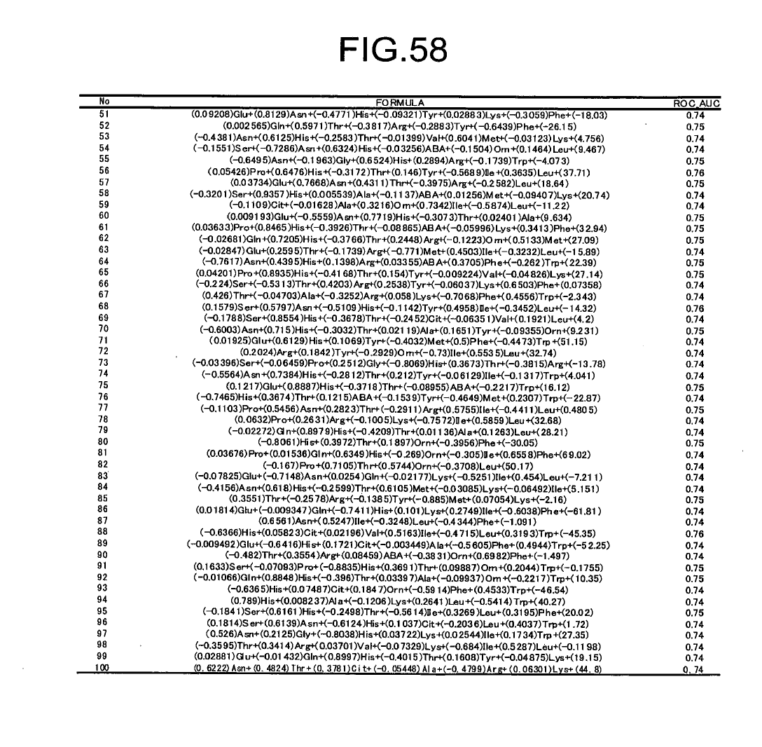

The sample data used in Example 1 is used. Indices which maximize 2-group discriminative ability between the apparent obesity group and the non-apparent obesity group are searched for, by linear discriminant analysis (explanatory variable coverage method). As a result, as index formula 12, a linear discriminant function having His, Thr, Ala, Tyr, Orn, and Phe (the numeral coefficients of the amino acid explanatory variables His, Thr, Ala, Tyr, Orn, and Phe, and the constant term are −0.7968, 0.4249, −0.01413, −0.1258, 0.2072, −0.3544, and −37.77 in order) is obtained. Other than this, a plurality of linear discriminant functions having discriminative ability equivalent to the index formula 12 are obtained. They are shown in FIGS. 57 and 58. The value of each coefficient in the functions shown in FIGS. 57 and 58 may be multiplied by a real number or by adding an arbitrary constant term thereto.

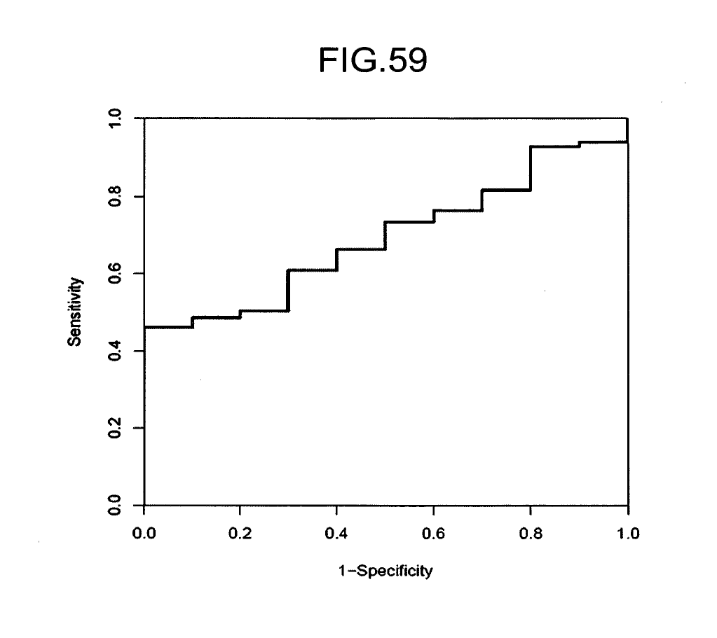

The 2-group discrimination between the apparent obesity group and the non-apparent obesity group using the index formula 12 is evaluated by the area under the ROC curve (see FIG. 59). As a result, an AUC of 0.69±0.095 (in 95% confidence interval, 0.504 to 0.877) is obtained. In addition, the optimum cutoff value of the 2-group discrimination between the apparent obesity group and the non-apparent obesity group using the index formula 12 is calculated with the symptom prevalence of the non-apparent obesity of 6%. As a result, the cutoff value is −0.27, and 60.95% sensitivity, 70.00% specificity, 11.48% positive predictive value, 96.56% negative predictive value, and 69.46% correct diagnosis rate are obtained. From these results, it is found that the index formula 12 is useful, with high diagnostic ability.

### Example 14

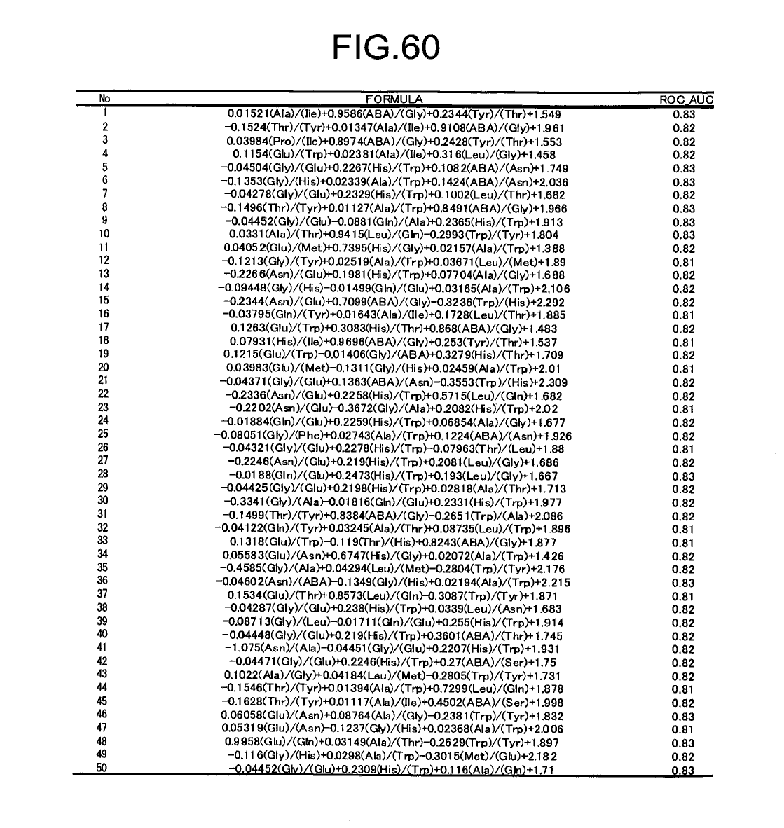

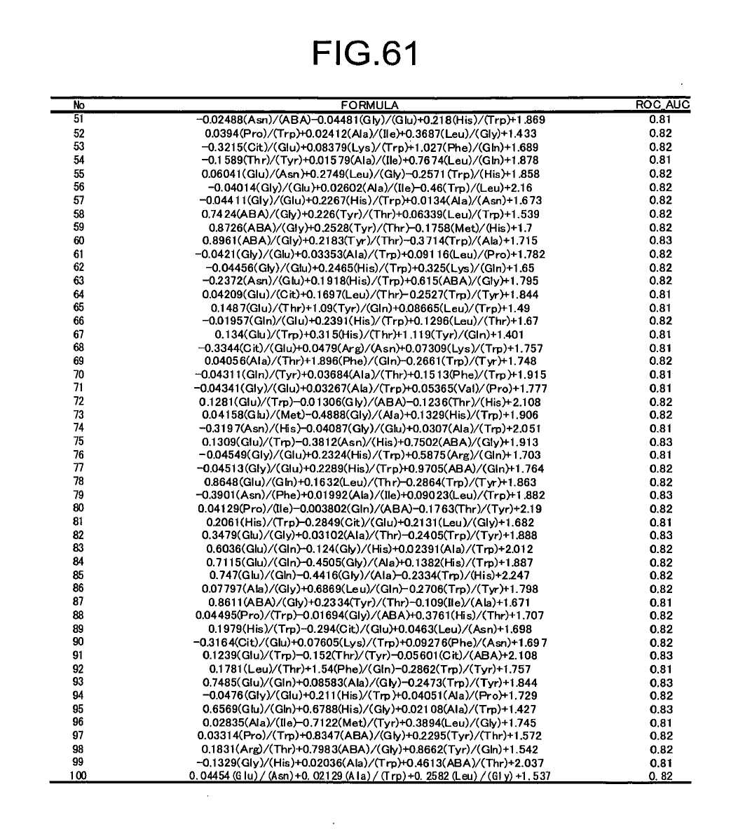

The sample data used in Example 1 is used. Indices which maximize 2-group discriminative ability between the apparent obesity group and the obesity group are earnestly searched for, by using the method described in International publication WO 2004/052191 which is an international application by the present applicant. As a result, index formula 13 is obtained among a plurality of index formulae having equivalent ability. Other than this, a plurality of multivariate discriminants having discriminative ability equivalent to the index formula 13 are obtained. They are shown in FIGS. 60 and 61. The value of each coefficient in the formulae shown in FIGS. 60 and 61 may be multiplied by a real number or by adding an arbitrary constant term thereto.

−0.04311(Gly)/(Glu)+0.2488(His)/(Trp)+0.4275(Leu)/(Gln)+1.669 Index formula 13:

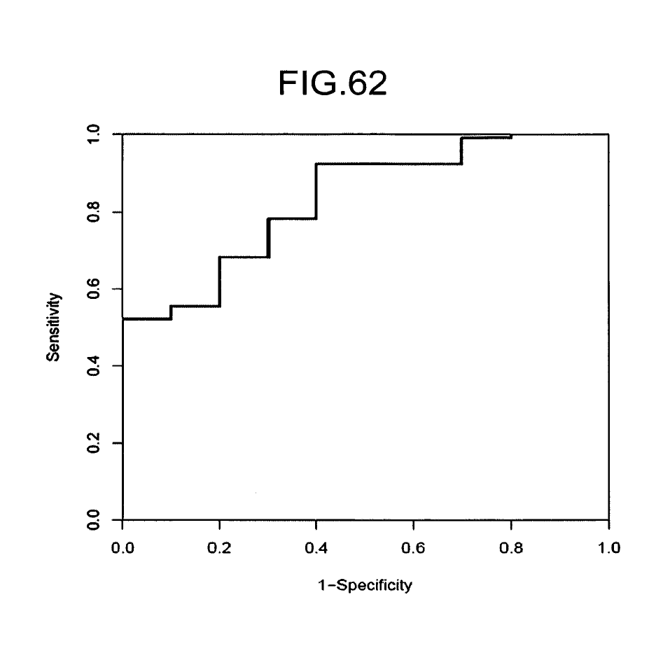

The 2-group discrimination between the apparent obesity group and the obesity group using the index formula 13 is evaluated by the area under the ROC curve (see FIG. 62). As a result, an AUC of 0.830±0.081 (in 95% confidence interval, 0.671 to 0.990) is obtained. In addition, the optimum cutoff value of the 2-group discrimination between the apparent obesity group and the obesity group using the index formula 13 is calculated with the symptom prevalence of the obesity of 8%. As a result, the cutoff value is 1.882, and 78.15% sensitivity, 70.00% specificity, 18.47% positive predictive value, 97.36% negative predictive value, and 70.65% correct diagnosis rate are obtained. From these results, it is found that the index formula 3 is useful, with high diagnostic ability.

### Example 15

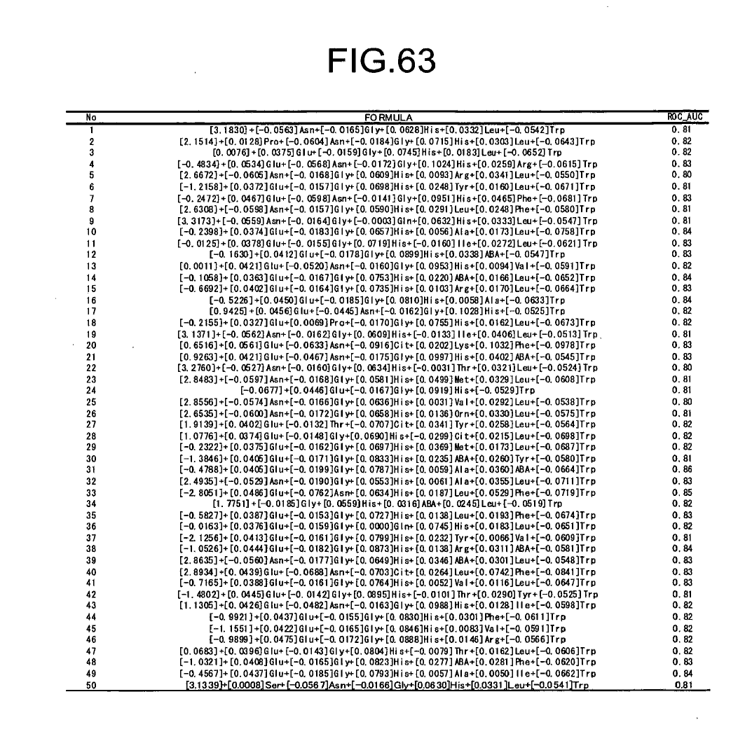

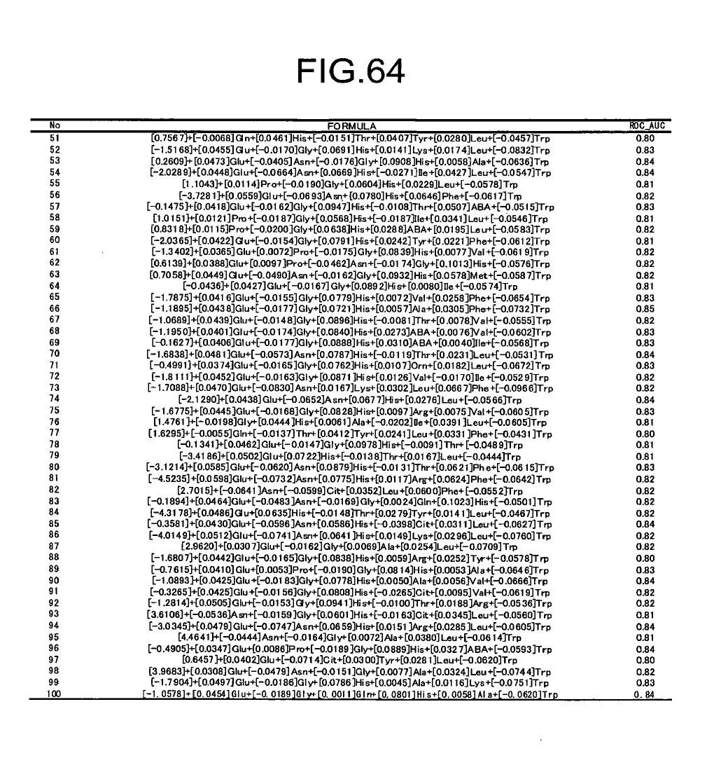

The sample data used in Example 1 is used. Indices which maximize 2-group discriminative ability between the apparent obesity group and the obesity group are searched for, by logistic analysis (explanatory variable coverage method according to the ROC maximum criterion). As a result, as index formula 14, a logistic regression equation having Glu, Asn, Gly, His, Leu, and Trp (the numeral coefficients of the amino acid explanatory variables Glu, Asn, Gly, His, Leu, and Trp, and the constant term are 0.0365, −0.0572, −0.0151, 0.0831, 0.0236, −0.0681, and 1.3616 in order) is obtained. Other than this, a plurality of logistic regression equations having discriminative ability equivalent to the index formula 14 are obtained. They are shown in FIGS. 63 and 64. The value of each coefficient in the equations shown in FIGS. 63 and 64 may be multiplied by a real number.

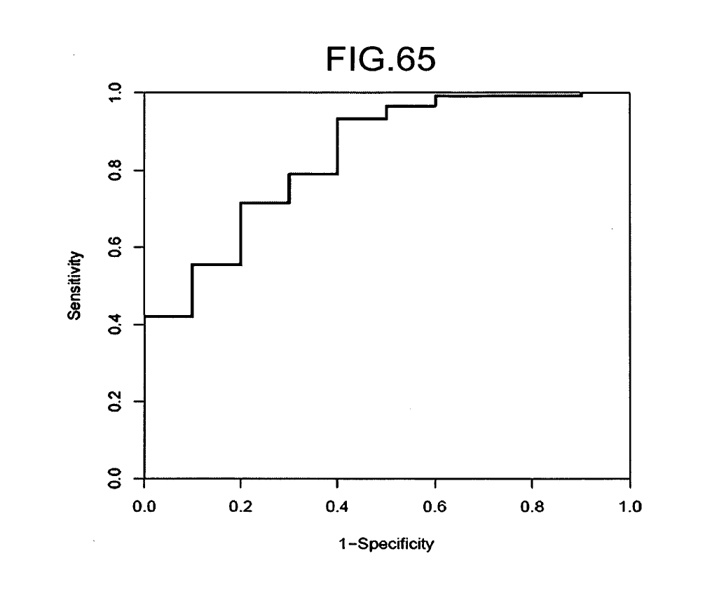

The 2-group discrimination between the apparent obesity group and the obesity group using the index formula 14 is evaluated by the area under the ROC curve (see FIG. 65). As a result, an AUC of 0.835±0.080 (in 95% confidence interval, 0.678 to 0.993) is obtained. In addition, the optimum cutoff value of the 2-group discrimination between the apparent obesity group and the obesity group using the index formula 14 is calculated with the symptom prevalence of the obesity of 8%. As a result, the cutoff value is 0.938, and 71.42% sensitivity, 80.0% specificity, 23.70% positive predictive value, 96.99% negative predictive value, and 79.31% correct diagnosis rate are obtained. From these results, it is found that the index formula 14 is useful, with high diagnostic ability.

### Example 16

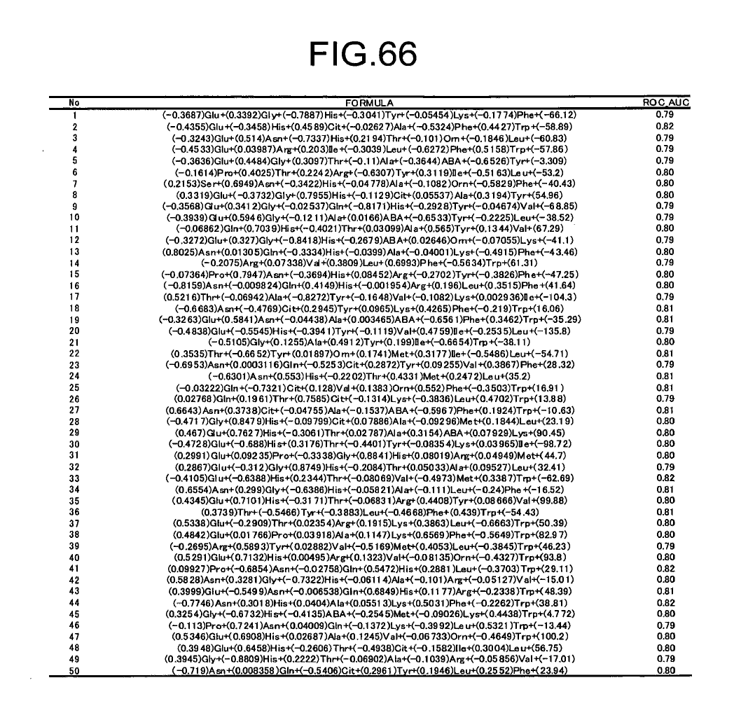

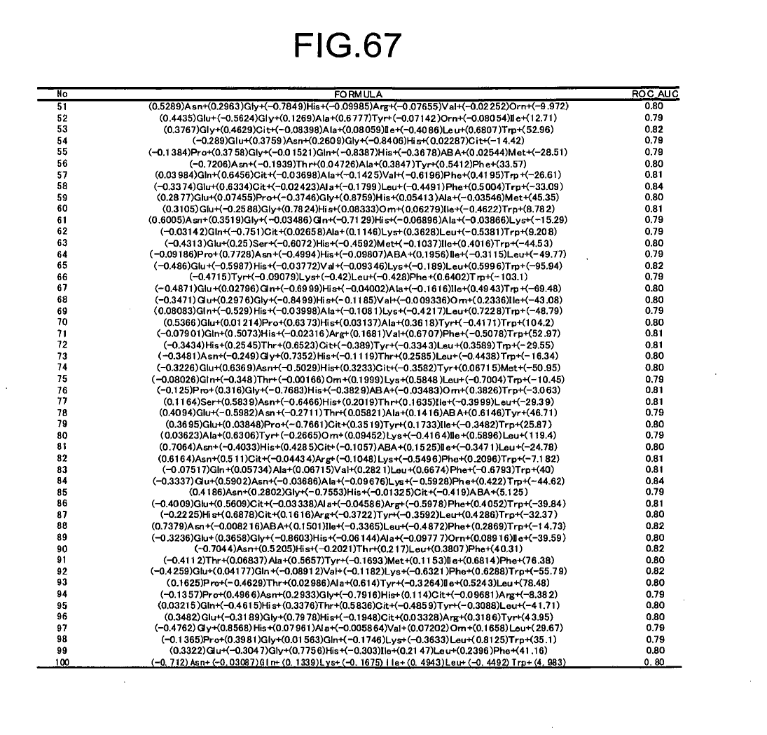

The sample data used in Example 1 is used. Indices which maximize 2-group discriminative ability between the apparent obesity group and the obesity group are searched for, by linear discriminant analysis (explanatory variable coverage method). As a result, as index formula 15, a linear discriminant function having Glu, Gly, His, Ala, and Lys (the numeral coefficients of the amino acid explanatory variables Glu, Gly, His, Ala, and Lys, and the constant term are −0.3357, 0.3859, −0.8555, −0.06068, −0.05278, and −47.92 in order) is obtained. Other than this, a plurality of linear discriminant functions having discriminative ability equivalent to the index formula 15 are obtained. They are shown in FIGS. 66 and 67. The value of each coefficient in the functions shown in FIGS. 66 and 67 may be multiplied by a real number or by adding an arbitrary constant term thereto.

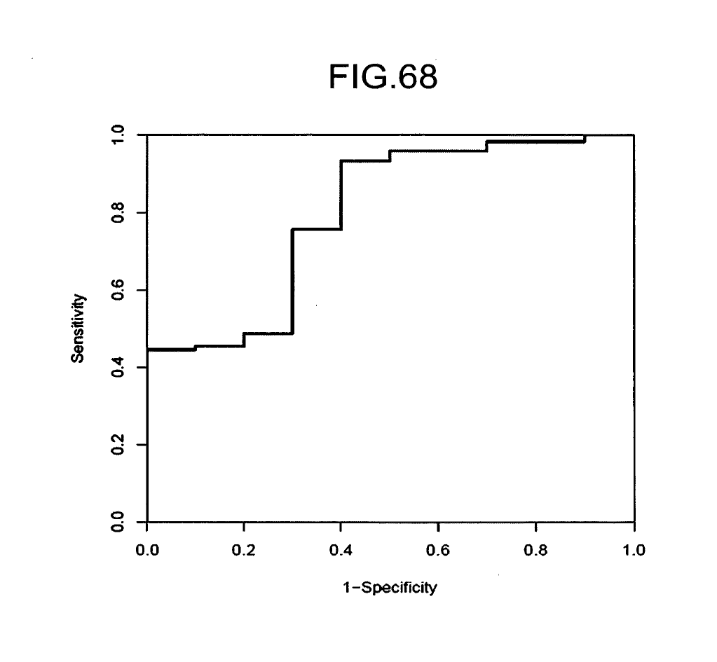

The 2-group discrimination between the apparent obesity group and the obesity group using the index formula 15 is evaluated by the area under the ROC curve (see FIG. 68). As a result, an AUC of 0.796±0.087 (in 95% confidence interval, 0.626 to 0.965) is obtained. In addition, the optimum cutoff value of the 2-group discrimination between the apparent obesity group and the obesity group using the index formula 15 is calculated with the symptom prevalence of the obesity of 8%. As a result, the cutoff value is −0.43, and 75.63% sensitivity, 70.00% specificity, 17.98% positive predictive value, 97.06% negative predictive value, and 70.45% correct diagnosis rate are obtained. From these results, it is found that the index formula 15 is useful, with high diagnostic ability.

### Example 17

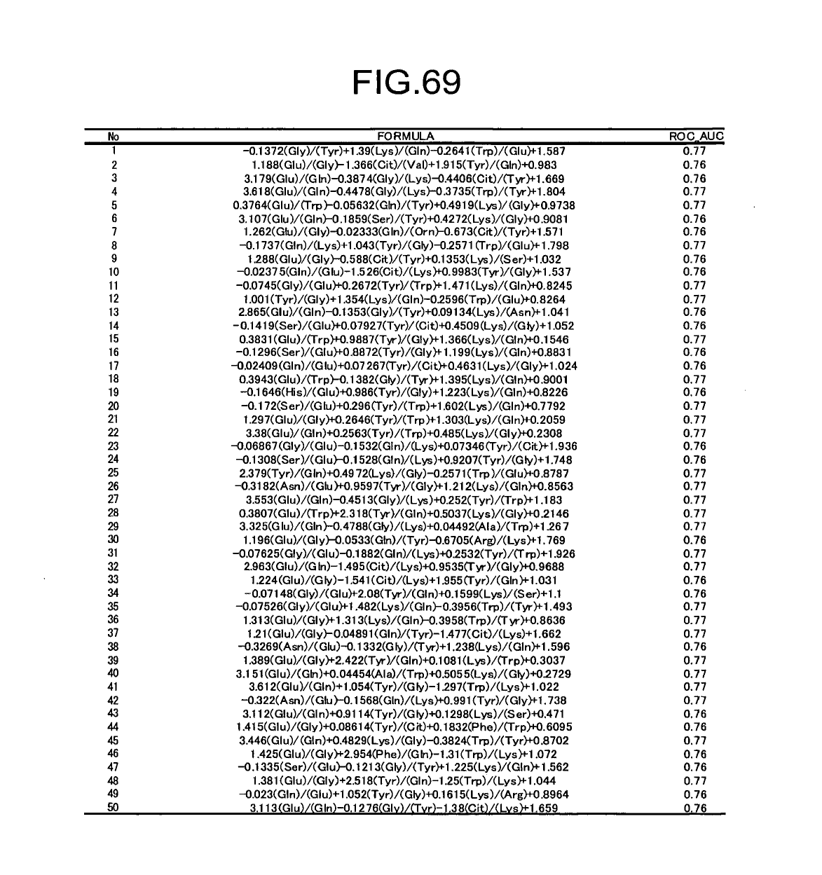

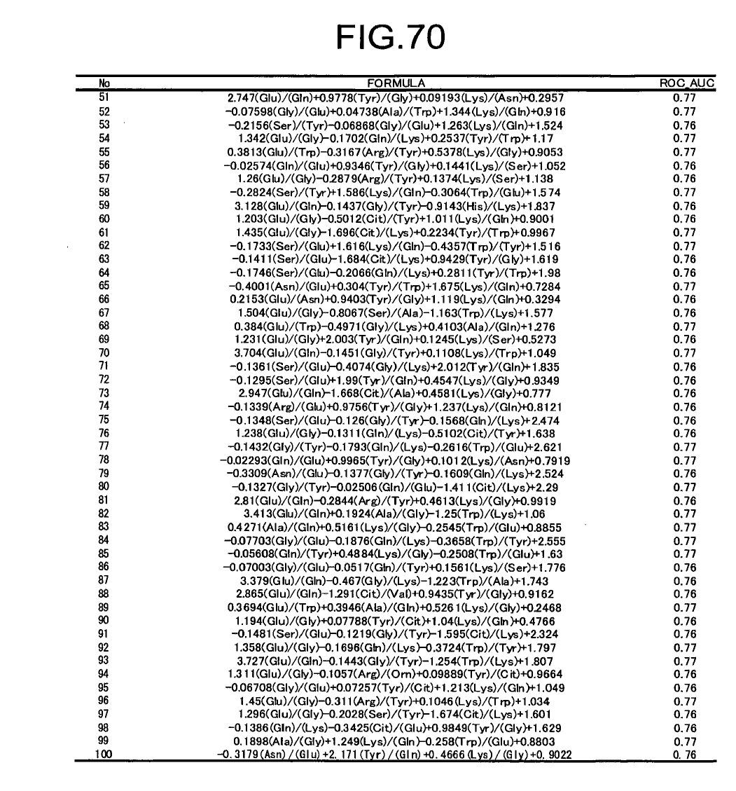

The sample data used in Example 1 is used. Indices which maximize 2-group discriminative ability between the non-apparent obesity group and the obesity group are earnestly searched for, by using the method described in International publication WO 2004/052191 which is an international application by the present applicant. As a result, index formula 16 is obtained among a plurality of index formulae having equivalent ability. Other than this, a plurality of multivariate discriminants having discriminative ability equivalent to the index formula 16 are obtained. They are shown in FIGS. 69 and 70. The value of each coefficient in the formulae shown in FIGS. 69 and 70 may be multiplied by a real number or by adding an arbitrary constant term thereto.

3.588(Glu)/(Gln)+1.041(Tyr)/(Gly)+0.1111(Lys)/(Trp)+0.2534 Index formula 16:

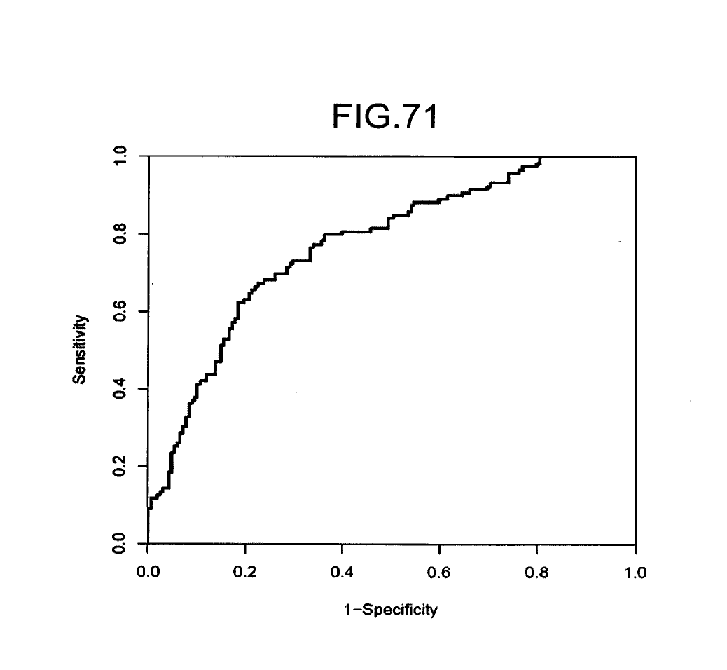

The 2-group discrimination between the non-apparent obesity group and the obesity group using the index formula 16 is evaluated by the area under the ROC curve (see FIG. 71). As a result, an AUC of 0.772±0.027 (in 95% confidence interval, 0.719 to 0.825) is obtained. In addition, the optimum cutoff value of the 2-group discrimination between the non-apparent obesity group and the obesity group using the index formula 16 is calculated with the symptom prevalence of the obesity of 41%. As a result, the cutoff value is 1.403, and 73.11% sensitivity, 70.41% specificity, 63.20% positive predictive value, 79.03% negative predictive value, and 71.52% correct diagnosis rate are obtained. From these results, it is found that the index formula 16 is useful, with high diagnostic ability.

### Example 18

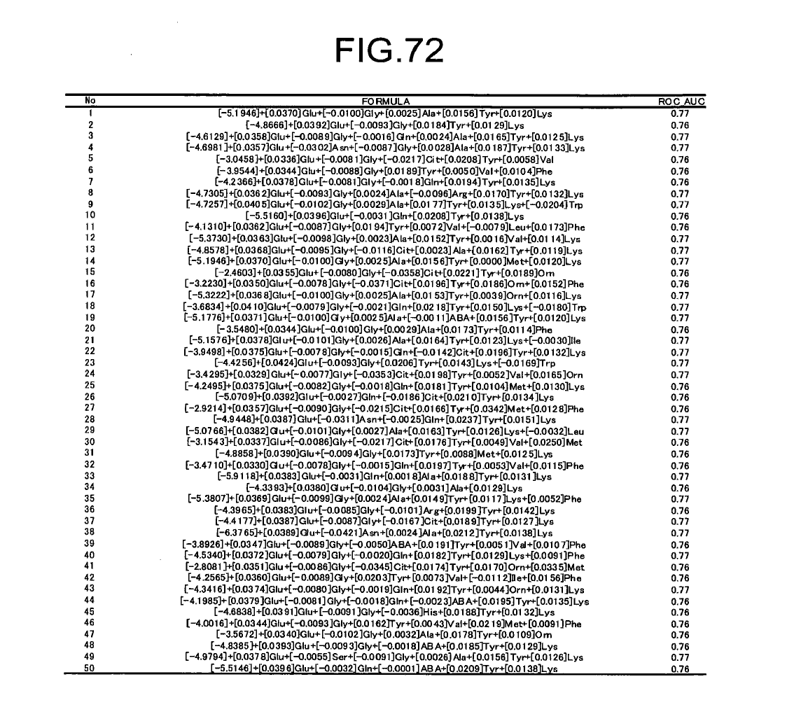

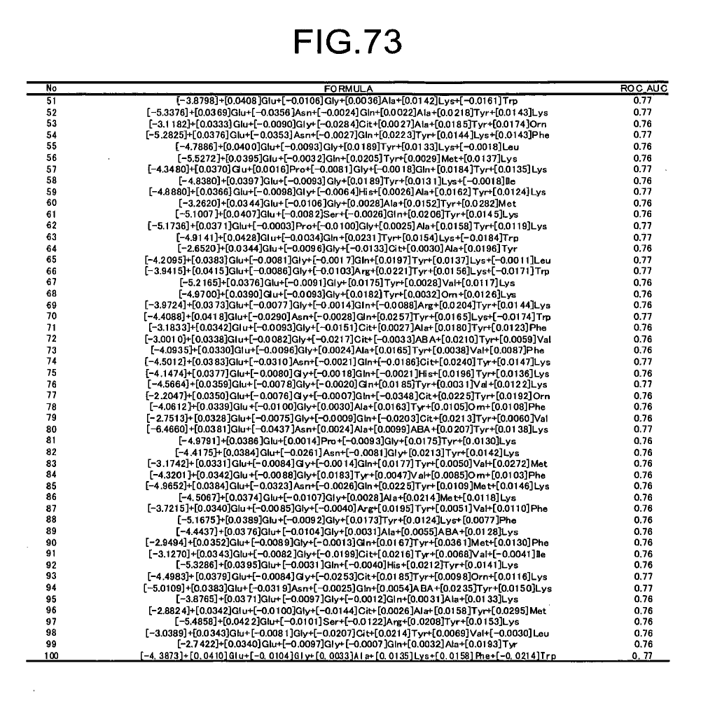

The sample data used in Example 1 is used. Indices which maximize 2-group discriminative ability between the non-apparent obesity group and the obesity group are searched for, by logistic analysis (explanatory variable coverage method according to the ROC maximum criterion). As a result, as index formula 17, a logistic regression equation having Glu, Gly, Cit, Tyr, Val, and Phe (the numeral coefficients of the amino acid explanatory variables Glu, Gly, Cit, Tyr, Val, and Phe, and the constant term are 0.0337, −0.0080, −0.0225, 0.0193, 0.0051, 0.0110, and −3.4665 in order) is obtained. Other than this, a plurality of logistic regression equations having discriminative ability equivalent to the index formula 17 are obtained. They are shown in FIGS. 72 and 73. The value of each coefficient in the equations shown in FIGS. 72 and 73 may be multiplied by a real number.

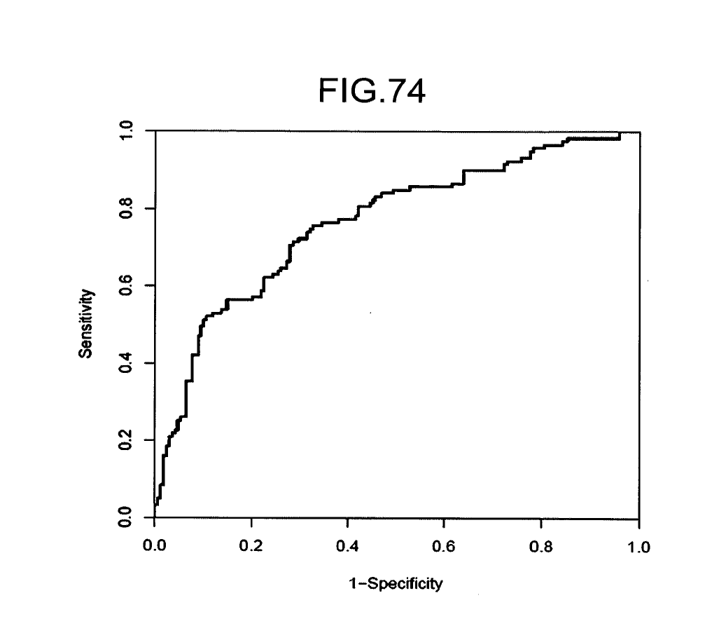

The 2-group discrimination between the non-apparent obesity group and the obesity group using the index formula 17 is evaluated by the area under the ROC curve (see FIG. 74). As a result, an AUC of 0.765±0.027 (in 95% confidence interval, 0.711 to 0.819) is obtained. In addition, the optimum cutoff value of the 2-group discrimination between the non-apparent obesity group and the obesity group using the index formula 17 is calculated with the symptom prevalence of the obesity of 41%. As a result, the cutoff value is 0.423, and 70.59% sensitivity, 72.19% specificity, 63.82% positive predictive value, 77.93% negative predictive value, and 71.53% correct diagnosis rate are obtained. From these results, it is found that the index formula 17 is useful, with high diagnostic ability.

### Example 19

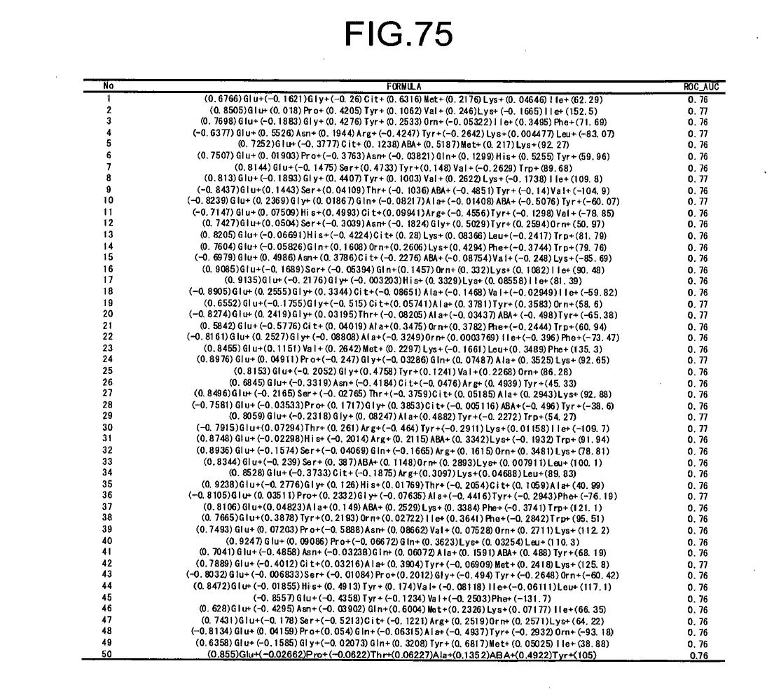

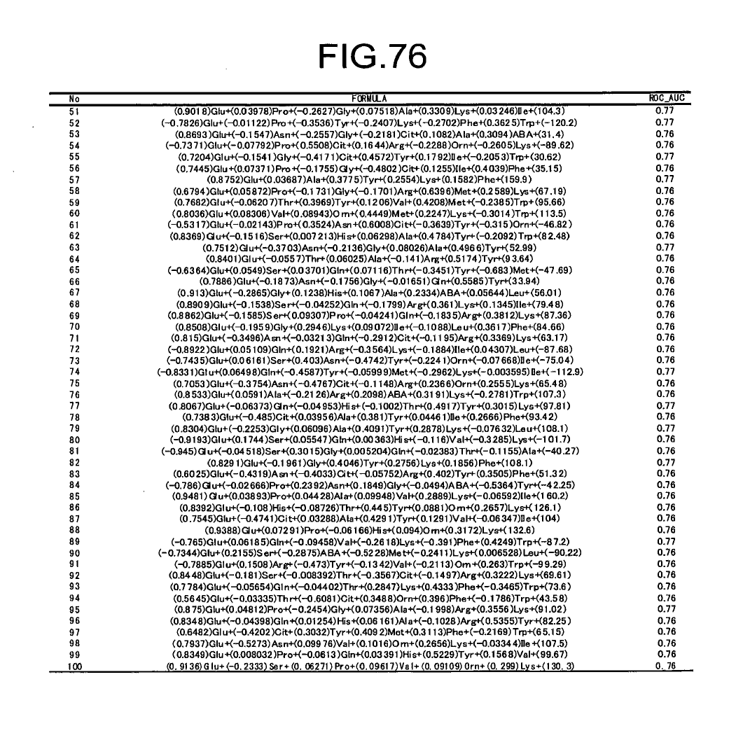

The sample data used in Example 1 is used. Indices which maximize 2-group discriminative ability between the non-apparent obesity group and the obesity group are searched for, by linear discriminant analysis (explanatory variable coverage method). As a result, as index formula 18, a linear discriminant function having Glu, Cit, Tyr, Orn, Met, and Trp (the numeral coefficients of the amino acid explanatory variables Glu, Cit, Tyr, Orn, Met, and Trp, and the constant term are 0.5718, −0.5757, 0.2897, 0.2952, 0.3839, −0.1522, and 56.1 in order) is obtained. Other than this, a plurality of linear discriminant functions having discriminative ability equivalent to the index formula 18 are obtained. They are shown in FIGS. 75 and 76. The value of each coefficient in the functions shown in FIGS. 75 and 76 may be multiplied by a real number or by adding an arbitrary constant term thereto.

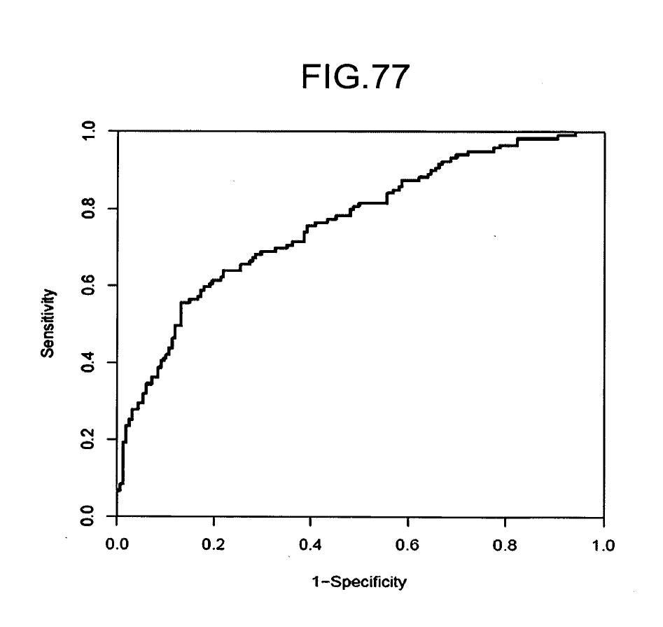

The 2-group discrimination between the non-apparent obesity group and the obesity group using the index formula 18 is evaluated by the area under the ROC curve (see FIG. 77). As a result, an AUC of 0.763±0.028 (in 95% confidence interval, 0.709 to 0.817) is obtained. In addition, the optimum cutoff value of the 2-group discrimination between the non-apparent obesity group and the obesity group using the index formula 18 is calculated with the symptom prevalence of the obesity of 41%. As a result, the cutoff value is 0.05, and 68.07% sensitivity, 71.60% specificity, 62.48% positive predictive value, 76.34% negative predictive value, and 70.15% correct diagnosis rate are obtained. From these results, it is found that the index formula 18 is useful, with high diagnostic ability.

### Example 20

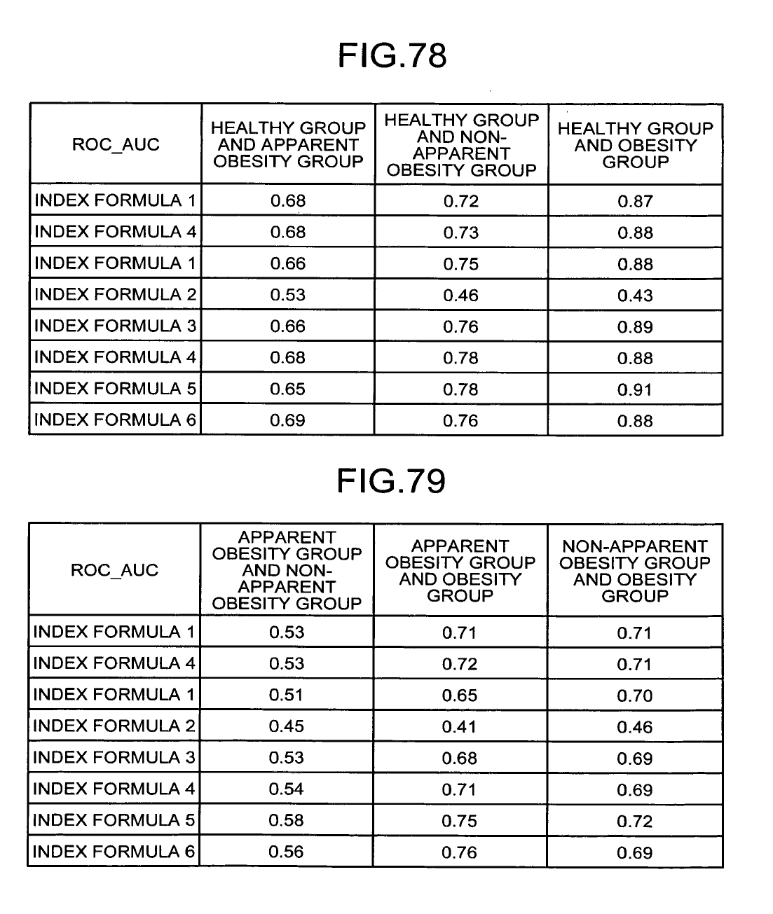

The sample data used in Example 1 is used. As a comparative example of Examples 2 to 19, the 2-group discriminative ability between the healthy group and the apparent obesity group, the healthy group and the non-apparent obesity group, the healthy group and the obesity group, the apparent obesity group and the non-apparent obesity group, the apparent obesity group and the obesity group, and the non-apparent obesity group and the obesity group is verified using index formulae 1 and 4 (upper two index formulae in FIGS. 78 and 79) disclosed in International Publication WO 2008/015929, and index formulae 1, 2, 3, 4, 5, and 6 (lower six index formulae in FIGS. 78 and 79) disclosed in International Publication WO 2009/001862, which are the international applications by the present applicant. As a result, as illustrated in FIGS. 78 and 79, a value larger than the area under the ROC curve obtained by Examples 2 to 19 is not obtained by using any formula for each 2-group discrimination. According to this, it was proved that the multivariate discriminant according to the present invention has higher discriminative ability for the discrimination than the index formula groups disclosed in International Publications WO 2008/015929 and WO 2009/001862, which are the international application by the present applicant.

### Example 21

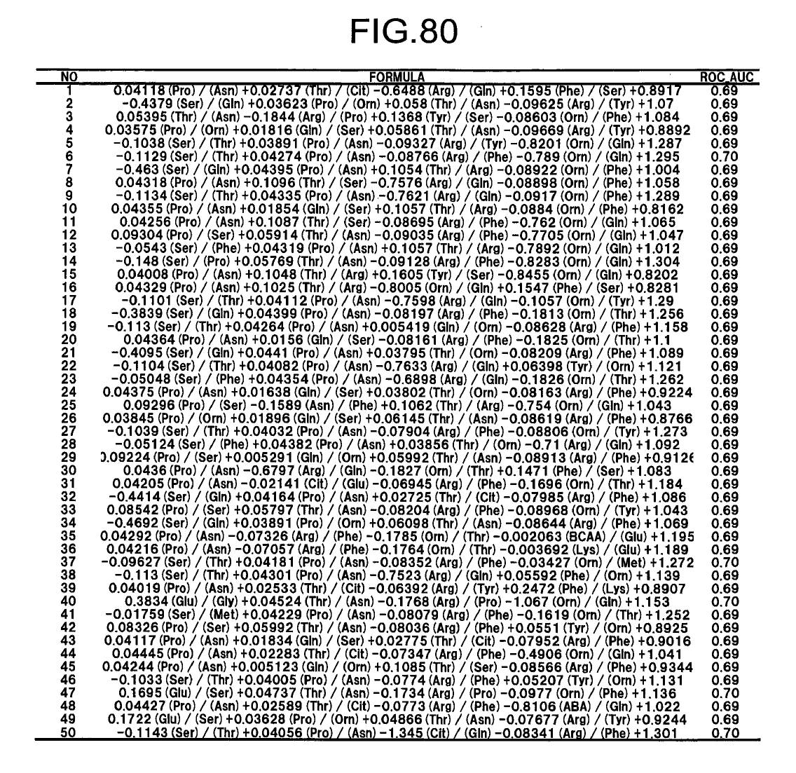

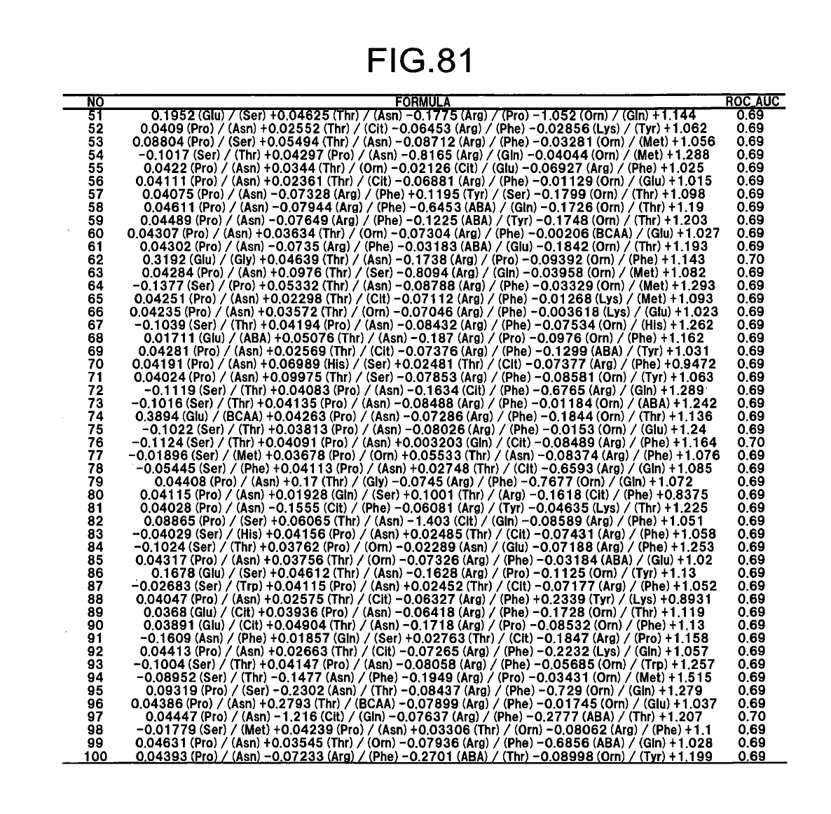

The blood amino acid concentrations are measured by the above-described method of analyzing amino acid from the blood samples of subjects who receive a comprehensive medical examination. The subjects are classified into four groups: a healthy group (BMI<25, VFA (visceral fat area)<100 cm²), an apparent obesity group (BMI≧25, VFA<100 cm²), a non-apparent obesity group (BMI<25, VFA≧100 cm²), and an obesity group (BMI≧25, VFA≧100 cm²). Indices which maximize 2-group discriminative ability between the healthy group and the apparent obesity group are earnestly searched for, according to the ROC maximum criterion, by using the method described in International publication WO 2004/052191 which is an international application by the present applicant. As a result, index formula 19 is obtained among a plurality of index formulae having equivalent ability. Other than this, a plurality of multivariate discriminants having discriminative ability equivalent to the index formula 19 are obtained. They are shown in FIGS. 80 and 81. The value of each coefficient in the formulae shown in FIGS. 80 and 81 may be multiplied by a real number or by adding an arbitrary constant term thereto.

0.08284(Pro/Ser)+0.05648(Thr/Asn)−0.098(Arg/Tyr)−0.8067(Orn/Gln)+1.059 Index formula 19:

### Example 22

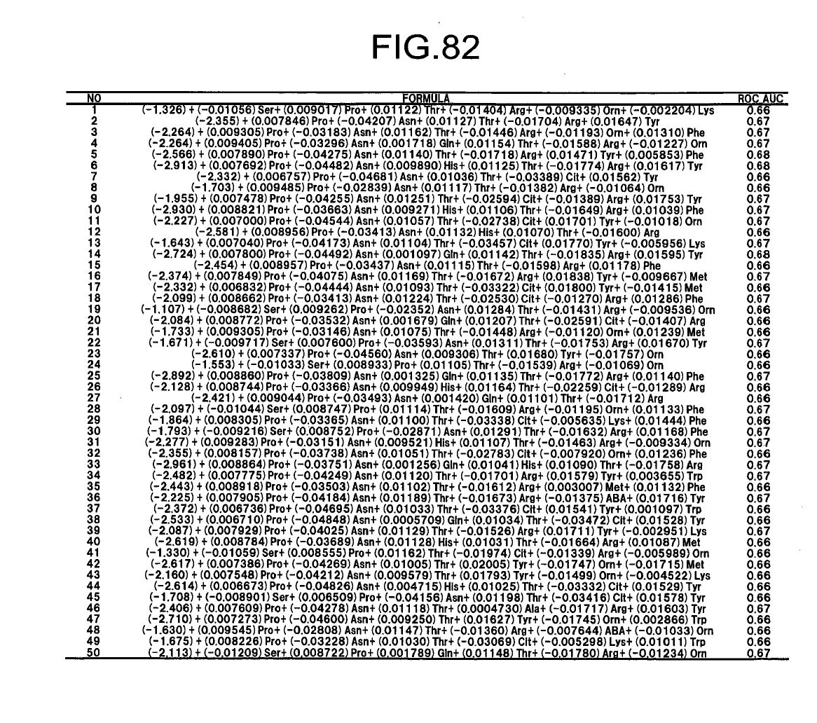

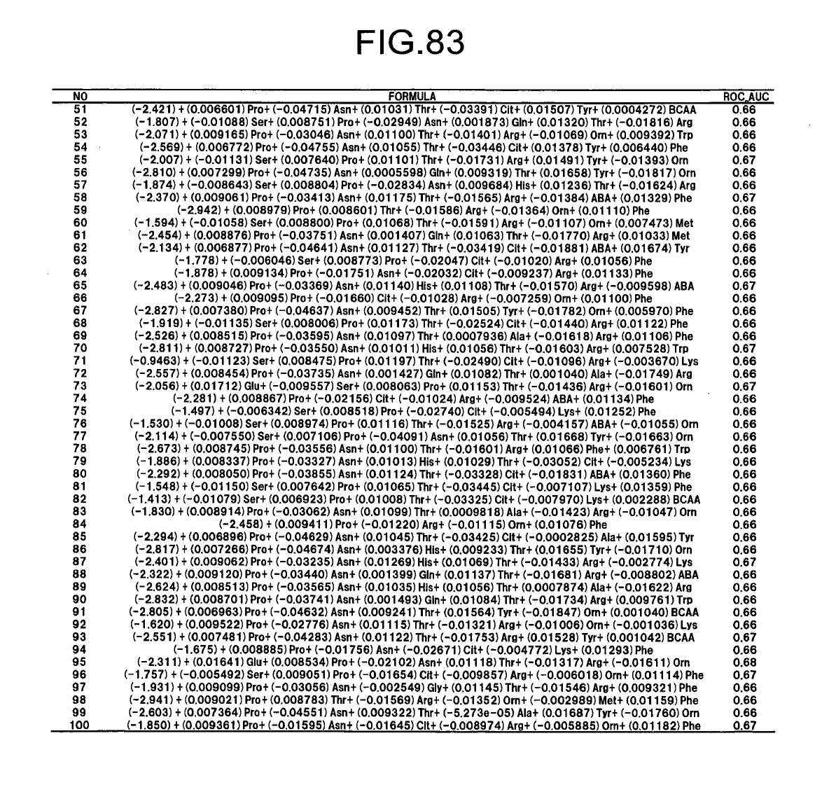

The sample data used in Example 21 is used. Indices which maximize 2-group discriminative ability between the healthy group and the apparent obesity group are searched for, by logistic analysis (explanatory variable coverage method according to the ROC maximum criterion). As a result, as index formula 20, a logistic regression equation described below is obtained. Other than this, a plurality of logistic regression equations having discriminative ability equivalent to the index formula 20 are obtained. They are shown in FIGS. 82 and 83. The value of each coefficient in the equations shown in FIGS. 82 and 83 may be multiplied by a real number.

(−2.084)+(0.008061)Pro+(−0.04049)Asn+(0.01199)Thr+(−0.01557)Arg+(0.01880)Tyr+(−0.01445)Orn Index formula 20:

### Example 23

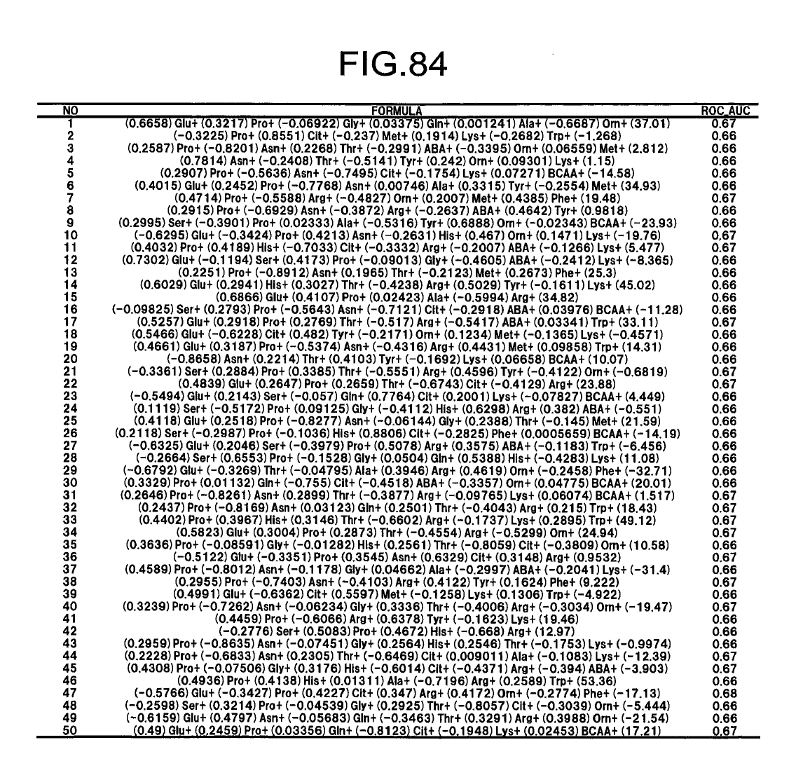

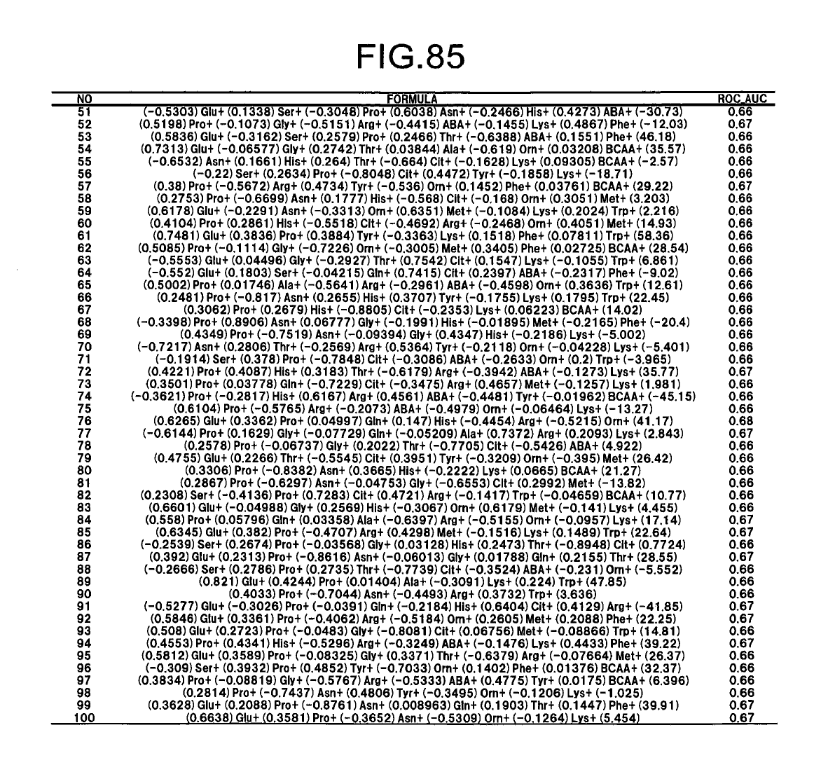

The sample data used in Example 21 is used. Indices which maximize 2-group discriminative ability between the healthy group and the apparent obesity group are searched for, by linear discriminant analysis (explanatory variable coverage method according to the ROC maximum criterion). As a result, as index formula 21, a linear discriminant function described below is obtained (the amino acid explanatory variable “BCAA” in the function represents “Val+Leu+Ile”, the same shall apply hereinafter). Other than this, a plurality of linear discriminant functions having discriminative ability equivalent to the index formula 21 are obtained. They are shown in FIGS. 84 and 85. The value of each coefficient in the functions shown in FIGS. 84 and 85 may be multiplied by a real number or by adding an arbitrary constant term thereto.

(−0.119)Ser+(0.3378)Pro+(−0.7534)Asn+(−0.4598)Orn+(0.3022)Phe+(0.03812)BCAA+(9.616) Index formula 21:

### Example 24

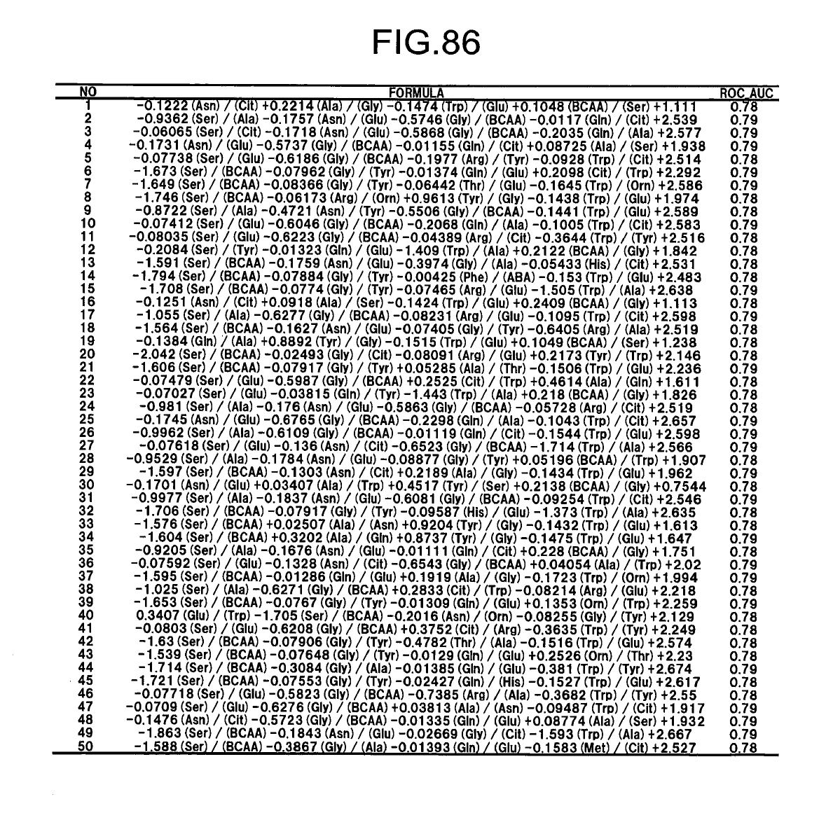

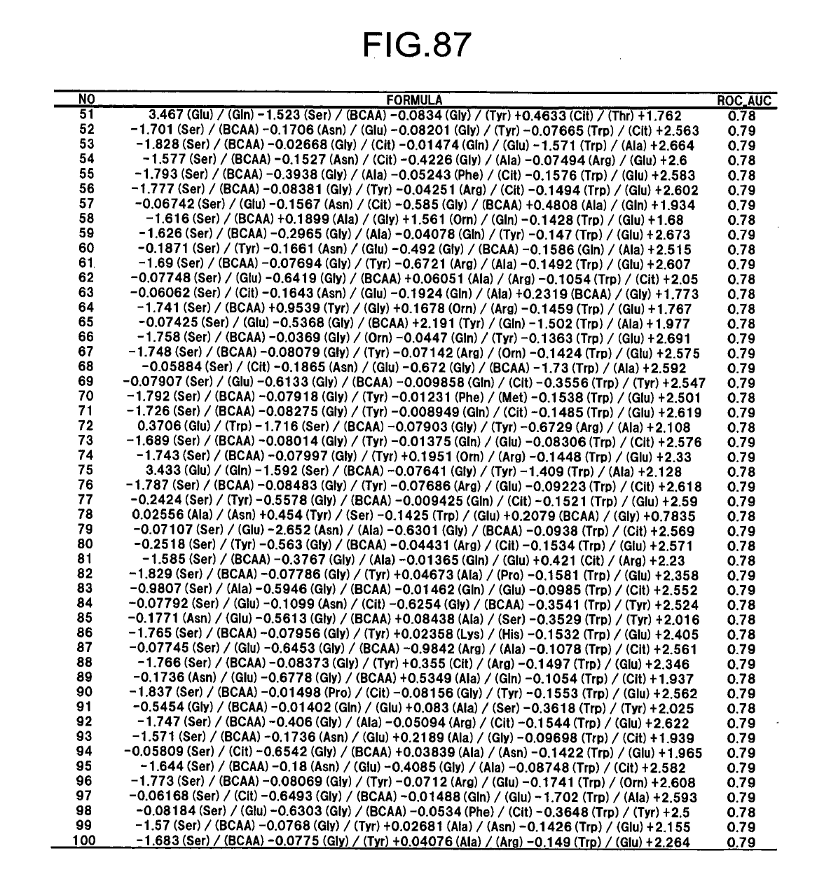

The sample data used in Example 21 is used. Indices which maximize 2-group discriminative ability between the healthy group and the non-apparent obesity group are earnestly searched for, according to the ROC maximum criterion, by using the method described in International publication WO 2004/052191 which is an international application by the present applicant. As a result, index formula 22 is obtained among a plurality of index formulae having equivalent ability. Other than this, a plurality of multivariate discriminants having discriminative ability equivalent to the index formula 22 are obtained. They are shown in FIGS. 86 and 87. The value of each coefficient in the formulae shown in FIGS. 86 and 87 may be multiplied by a real number or by adding an arbitrary constant term thereto.

−0.06266(Ser/Cit)−0.5982(Gly/BCAA)−0.2097(Gln/Ala)−0.07107(Thr/Glu)+2.611 Index formula 22:

### Example 25

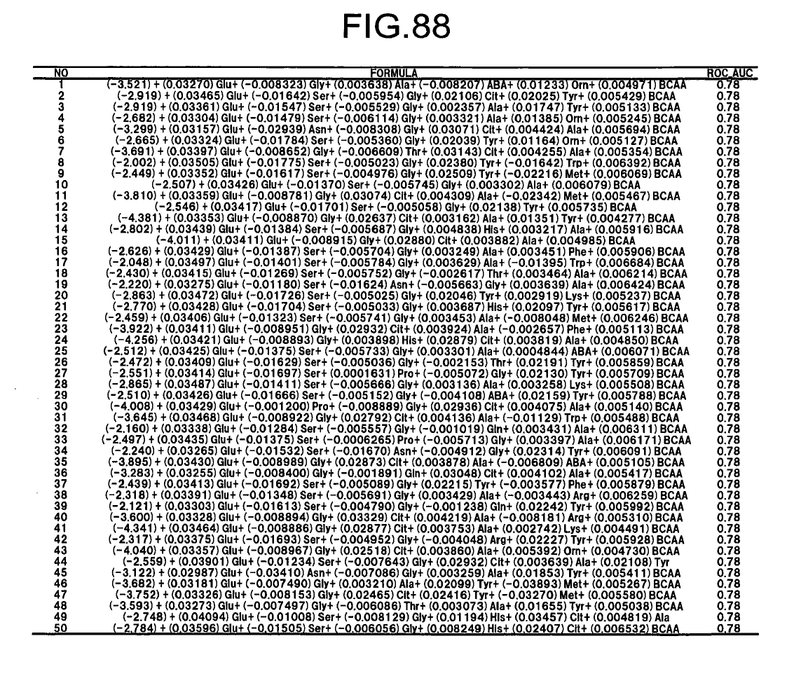

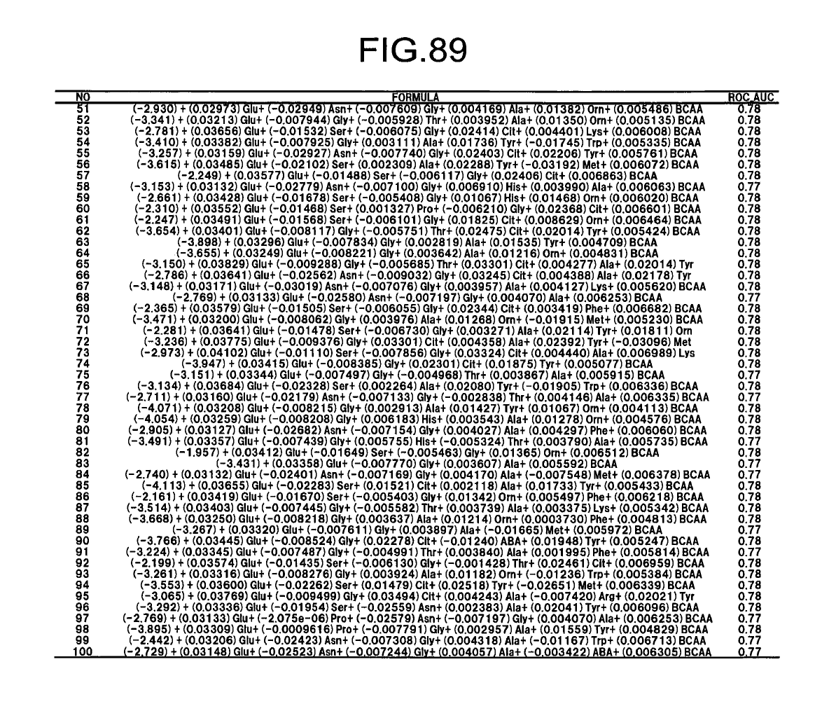

The sample data used in Example 21 is used. Indices which maximize 2-group discriminative ability between the healthy group and the non-apparent obesity group are searched for, by logistic analysis (explanatory variable coverage method according to the ROC maximum criterion). As a result, as index formula 23, a logistic regression equation described below is obtained. Other than this, a plurality of logistic regression equations having discriminative ability equivalent to the index formula 23 are obtained. They are shown in FIGS. 88 and 89. The value of each coefficient in the equations shown in FIGS. 88 and 89 may be multiplied by a real number.

(−3.093)+(0.03470)Glu+(−0.01294)Ser+(−0.006954)Gly+(0.02725)Cit+(0.003579)Ala+(0.005453)BCAA Index formula 23:

### Example 26

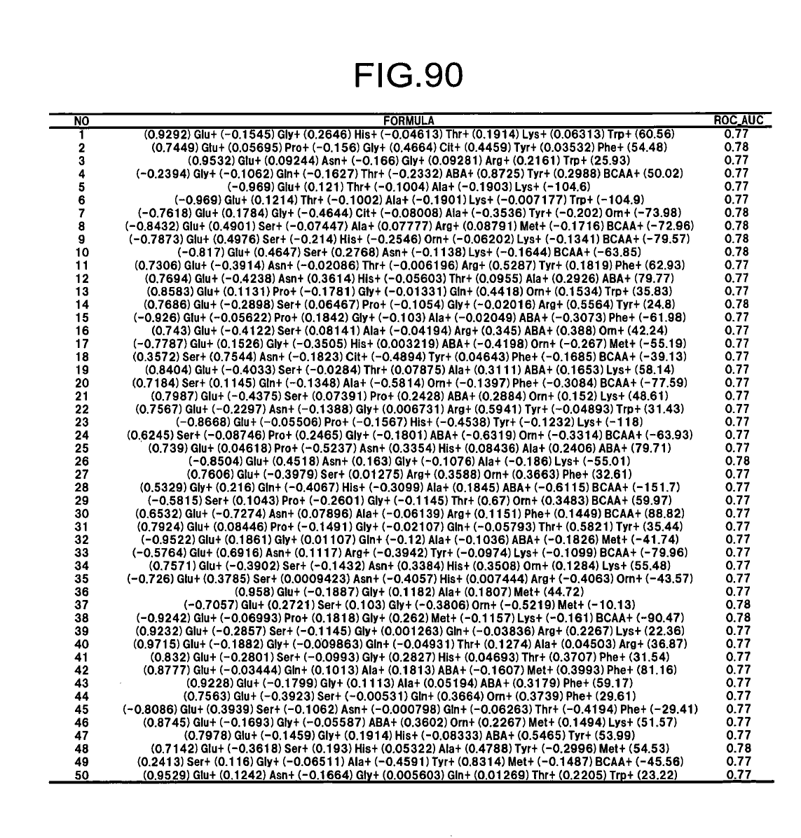

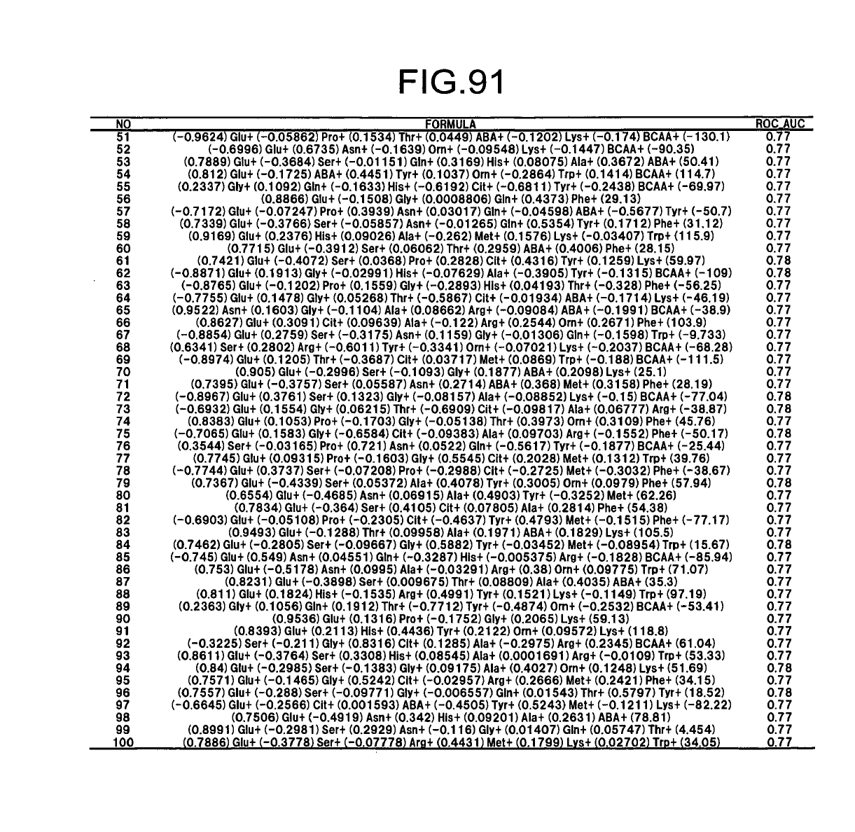

The sample data used in Example 21 is used. Indices which maximize 2-group discriminative ability between the healthy group and the non-apparent obesity group are searched for, by linear discriminant analysis (explanatory variable coverage method according to the ROC maximum criterion). As a result, as index formula 24, a linear discriminant function described below is obtained. Other than this, a plurality of linear discriminant functions having discriminative ability equivalent to the index formula 24 are obtained. They are shown in FIGS. 90 and 91. The value of each coefficient in the functions shown in FIGS. 90 and 91 may be multiplied by a real number or by adding an arbitrary constant term thereto.

(−0.6904)Glu+(−0.1513)His+(0.004091)ABA+(−0.473)Tyr+(0.513)Met+(−0.1166)Lys+(−87.84) Index formula 24:

### Example 27

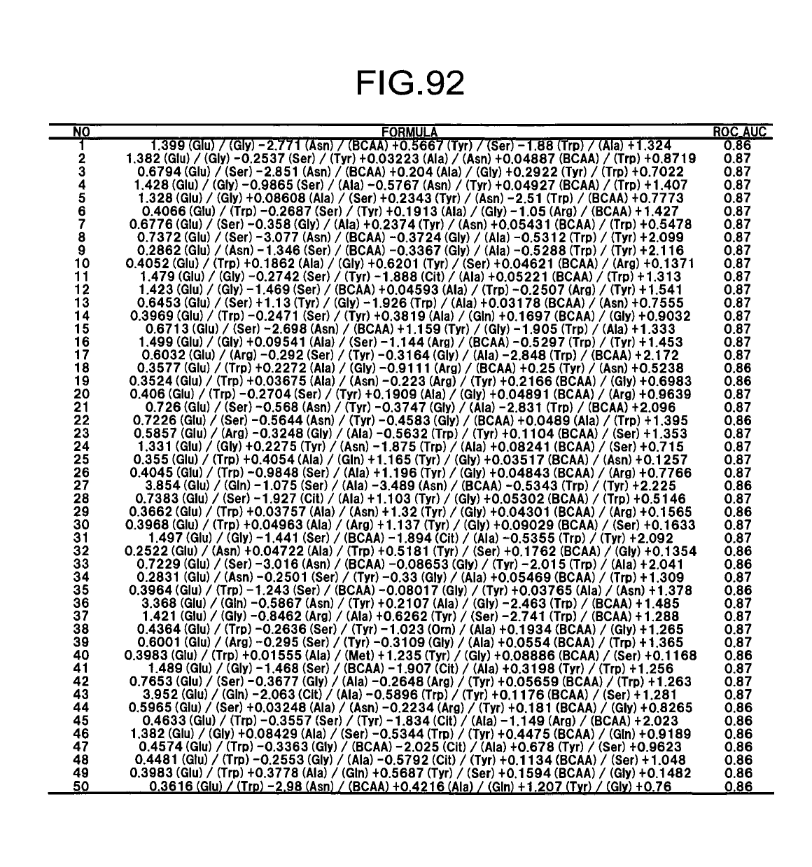

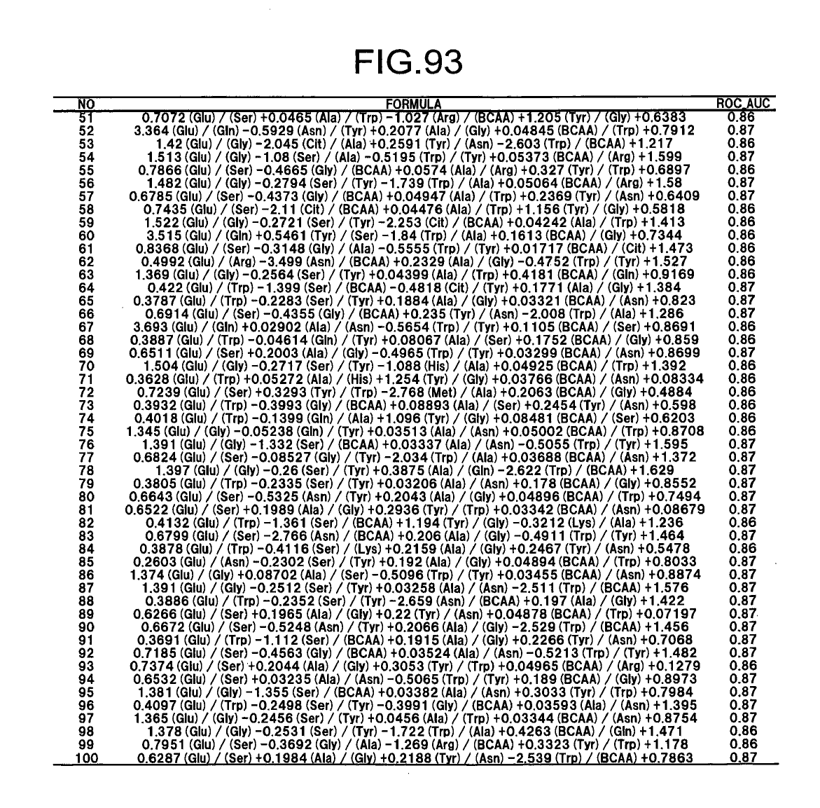

The sample data used in Example 21 is used. Indices which maximize 2-group discriminative ability between the healthy group and the obesity group are earnestly searched for, according to the ROC maximum criterion, by using the method described in International publication WO 2004/052191 which is an international application by the present applicant. As a result, index formula 25 is obtained among a plurality of index formulae having equivalent ability. Other than this, a plurality of multivariate discriminants having discriminative ability equivalent to the index formula 25 are obtained. They are shown in FIGS. 92 and 93. The value of each coefficient in the formulae shown in FIGS. 92 and 93 may be multiplied by a real number or by adding an arbitrary constant term thereto.

1.383(Glu/Gly)−0.9712(Ser/Ala)−0.4993(Trp/Tyr)+0.03613(BCAA/Asn)+1.467 Index formula 25:

### Example 28

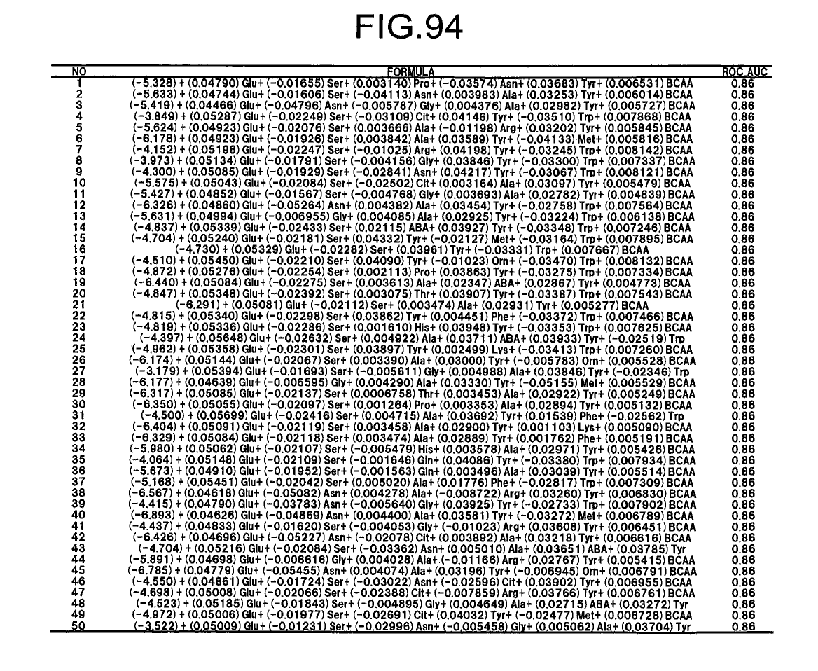

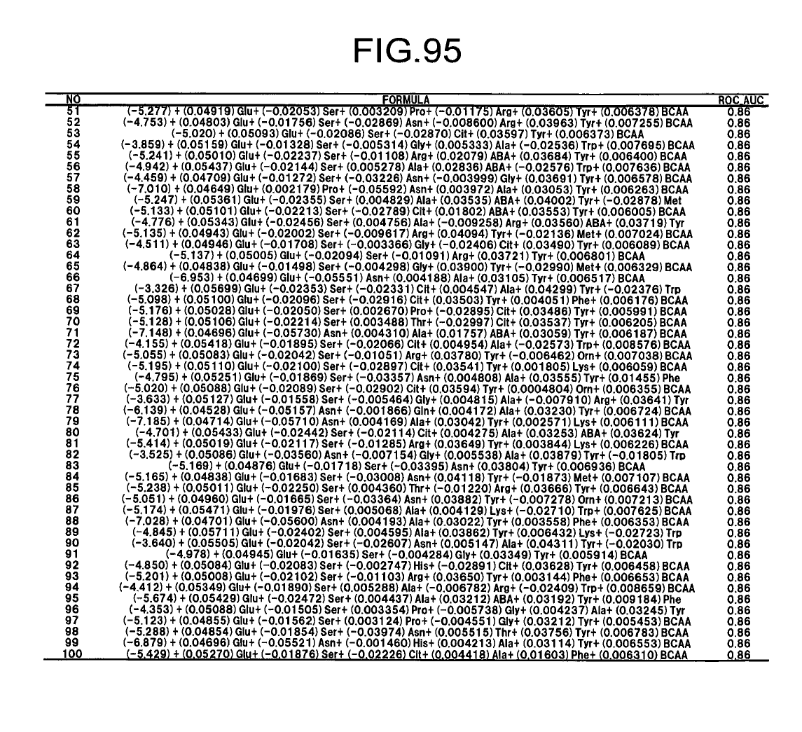

The sample data used in Example 21 is used. Indices which maximize 2-group discriminative ability between the healthy group and the obesity group are searched for, by logistic analysis (explanatory variable coverage method according to the ROC maximum criterion). As a result, as index formula 26, a logistic regression equation described below is obtained. Other than this, a plurality of logistic regression equations having discriminative ability equivalent to the index formula 26 are obtained. They are shown in FIGS. 94 and 95. The value of each coefficient in the equations shown in FIGS. 94 and 95 may be multiplied by a real number.

(−5.188)+(0.05264)Glu+(−0.02294)Ser+(0.003777)Ala+(0.03438)Tyr+(−0.03567)Trp+(0.006689)BCAA Index formula 26:

### Example 29

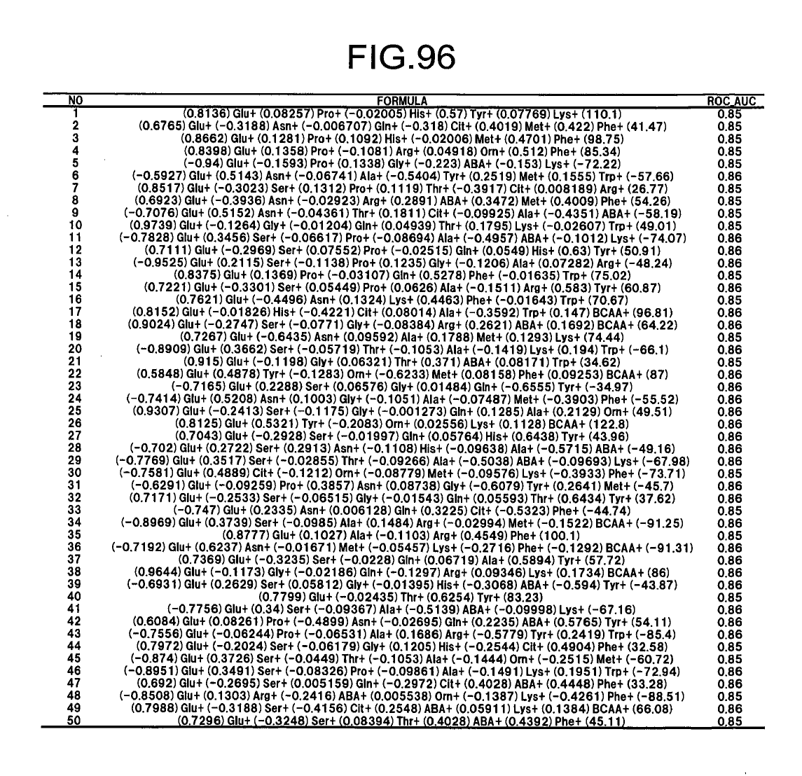

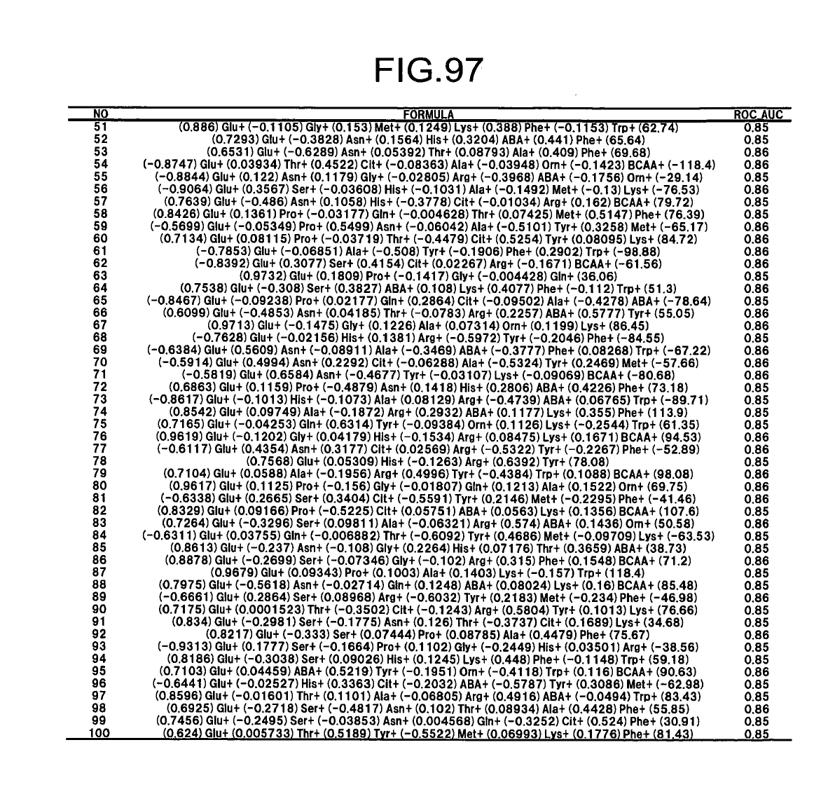

The sample data used in Example 21 is used. Indices which maximize 2-group discriminative ability between the healthy group and the obesity group are searched for, by linear discriminant analysis (explanatory variable coverage method according to the ROC maximum criterion). As a result, as index formula 27, a linear discriminant function described below is obtained. Other than this, a plurality of linear discriminant functions having discriminative ability equivalent to the index formula 27 are obtained. They are shown in FIGS. 96 and 97. The value of each coefficient in the functions shown in FIGS. 96 and 97 may be multiplied by a real number or by adding an arbitrary constant term thereto.

(−0.8287)Glu+(−0.128)Pro+(−0.1247)His+(0.5022)Cit+(−0.1066)Orn+(−0.1333)Lys+(−85.16) Index formula 27:

### Example 30

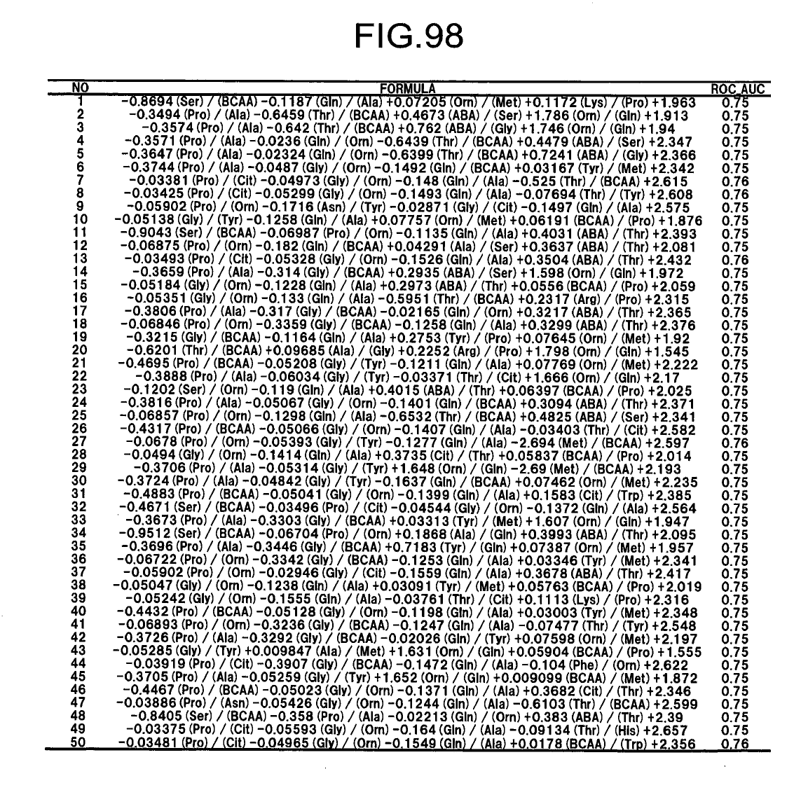

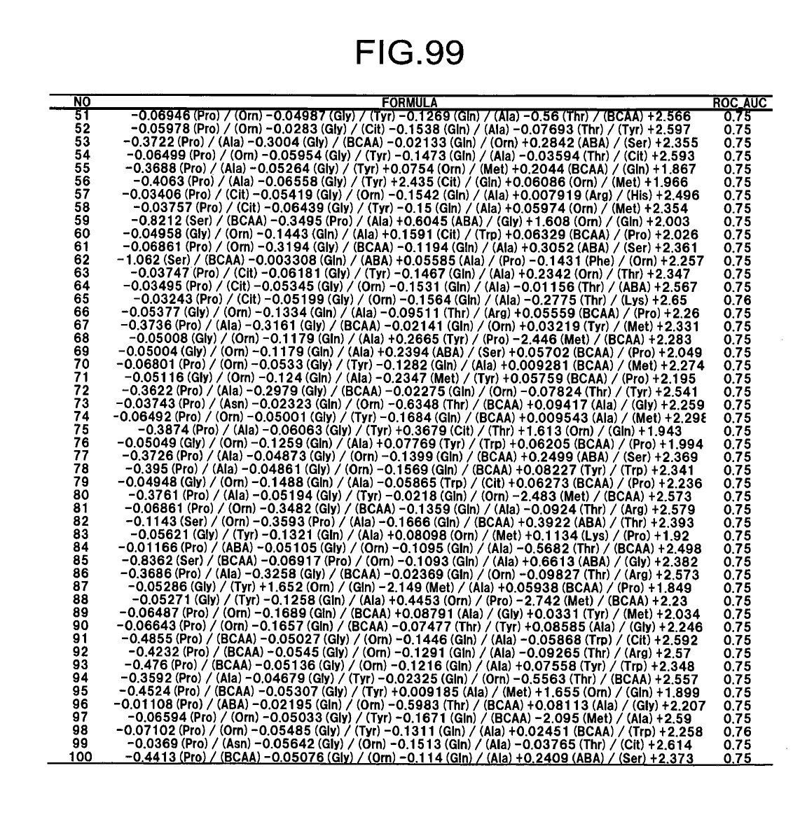

The sample data used in Example 21 is used. Indices which maximize 2-group discriminative ability between the apparent obesity group and the non-apparent obesity group are earnestly searched for, according to the ROC maximum criterion, by using the method described in International publication WO 2004/052191 which is an international application by the present applicant. As a result, index formula 28 is obtained among a plurality of index formulae having equivalent ability. Other than this, a plurality of multivariate discriminants having discriminative ability equivalent to the index formula 28 are obtained. They are shown in FIGS. 98 and 99. The value of each coefficient in the formulae shown in FIGS. 98 and 99 may be multiplied by a real number or by adding an arbitrary constant term thereto.

−0.4309(Pro/BCAA)−0.05254(Gly/Orn)−0.119(Gln/Ala)+0.3006(ABA/Thr)+2.374 Index formula 28:

### Example 31

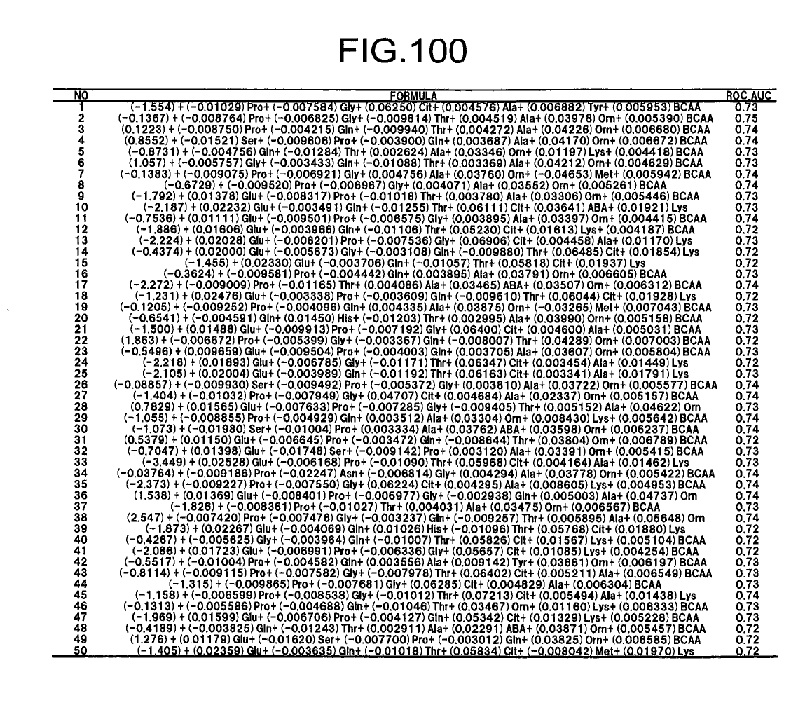

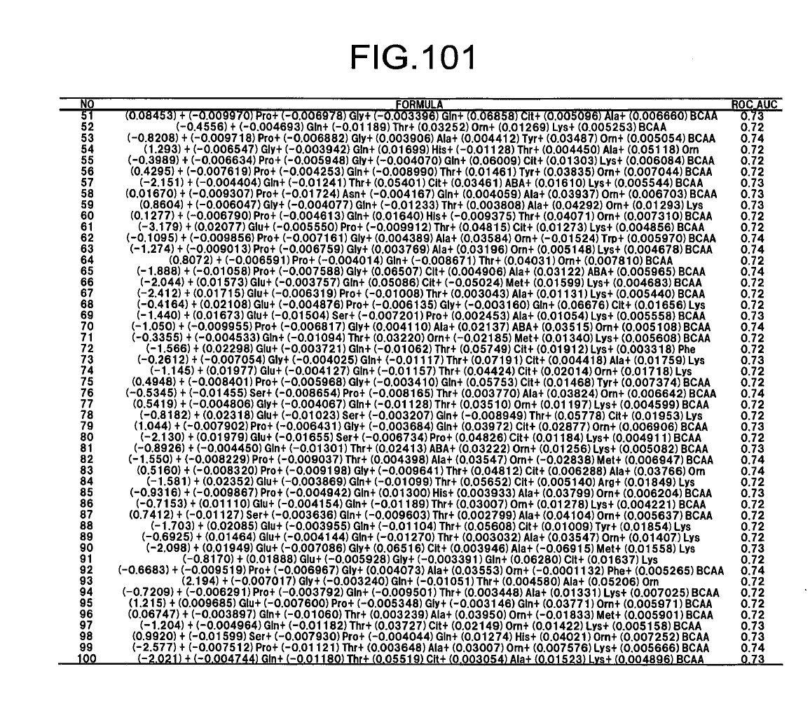

The sample data used in Example 21 is used. Indices which maximize 2-group discriminative ability between the apparent obesity group and the non-apparent obesity group are searched for, by logistic analysis (explanatory variable coverage method according to the ROC maximum criterion). As a result, as index formula 29, a logistic regression equation described below is obtained. Other than this, a plurality of logistic regression equations having discriminative ability equivalent to the index formula 29 are obtained. They are shown in FIGS. 100 and 101. The value of each coefficient in the equations shown in FIGS. 100 and 101 may be multiplied by a real number.

(0.8539)+(−0.009752)Pro+(−0.006173)Gly+(−0.003777)Gln+(0.004300)Ala+(0.04151)Orn+(0.005553)BCAA Index formula 29:

### Example 32

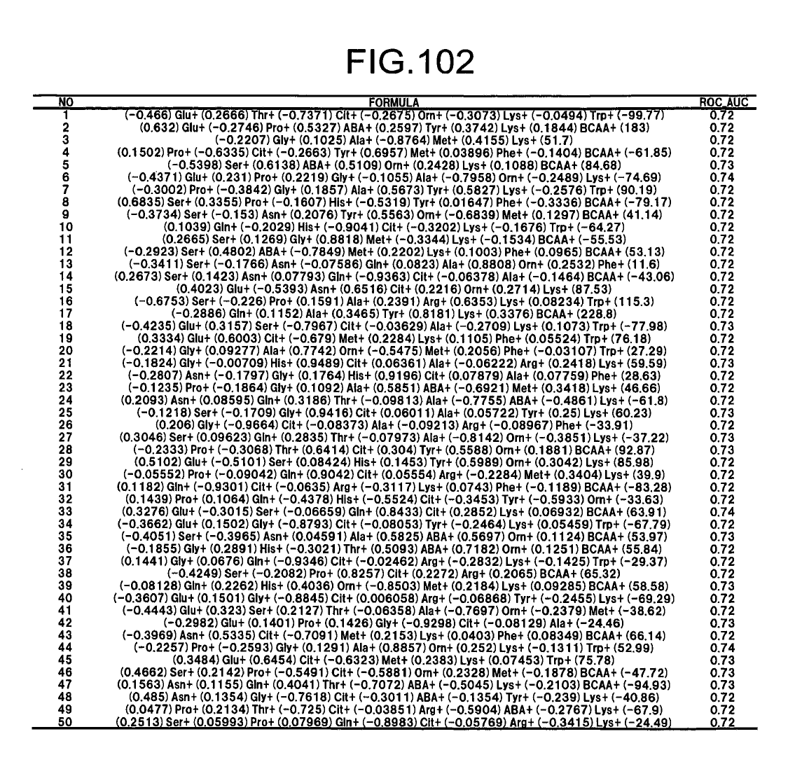

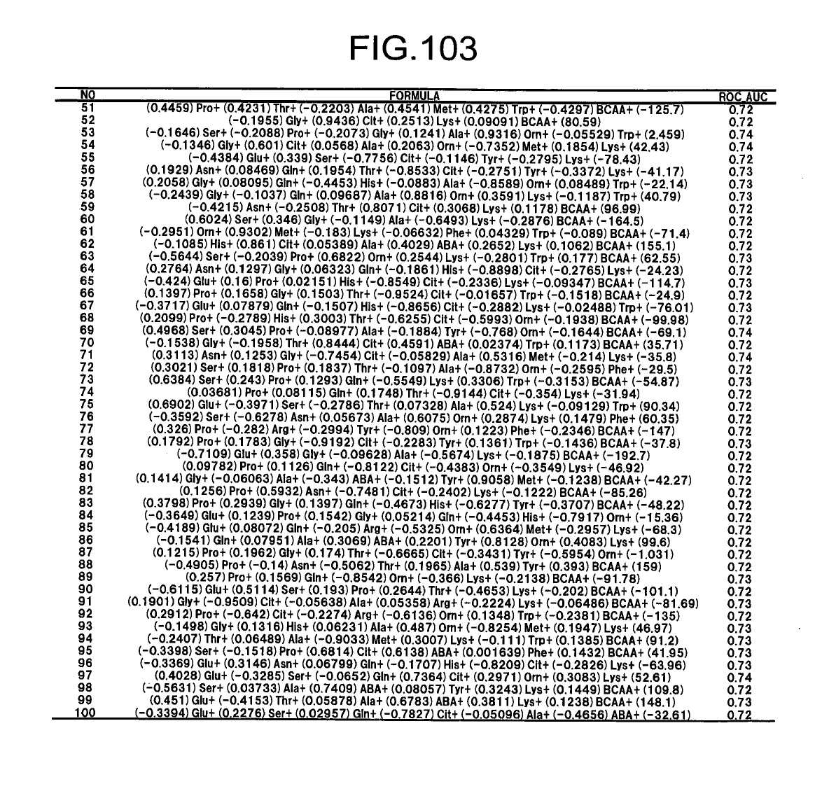

The sample data used in Example 21 is used. Indices which maximize 2-group discriminative ability between the apparent obesity group and the non-apparent obesity group are searched for, by linear discriminant analysis (explanatory variable coverage method according to the ROC maximum criterion). As a result, as index formula 30, a linear discriminant function described below is obtained. Other than this, a plurality of linear discriminant functions having discriminative ability equivalent to the index formula 30 are obtained. They are shown in FIGS. 102 and 103. The value of each coefficient in the functions shown in FIGS. 102 and 103 may be multiplied by a real number or by adding an arbitrary constant term thereto.

(−0.1417)Ser+(−0.0738)Pro+(−0.1559)Gly+(0.9202)Cit+(0.2841)Lys+(0.1505)Phe+(37.55) Index formula 30:

### Example 33

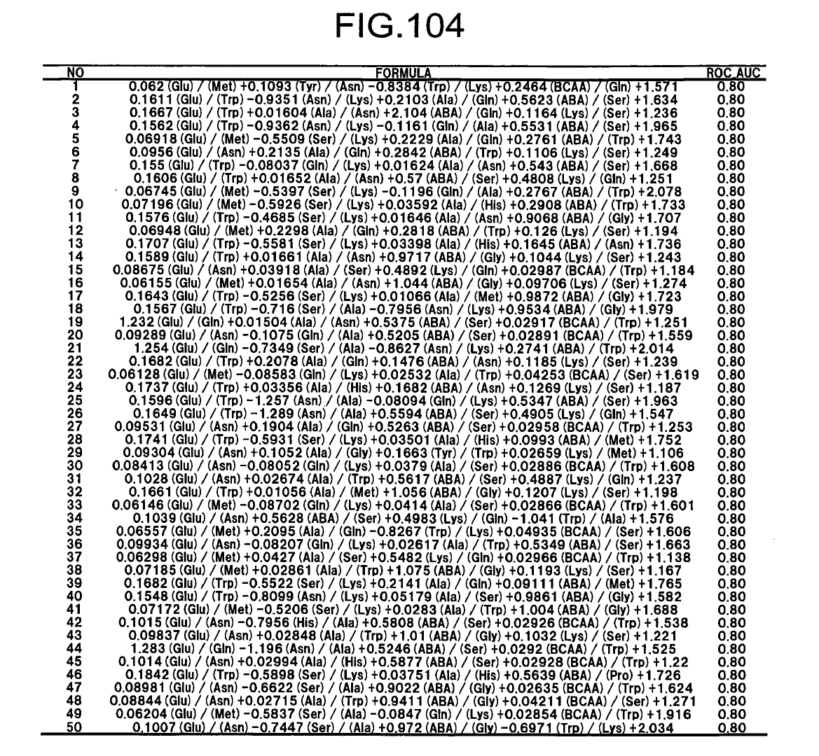

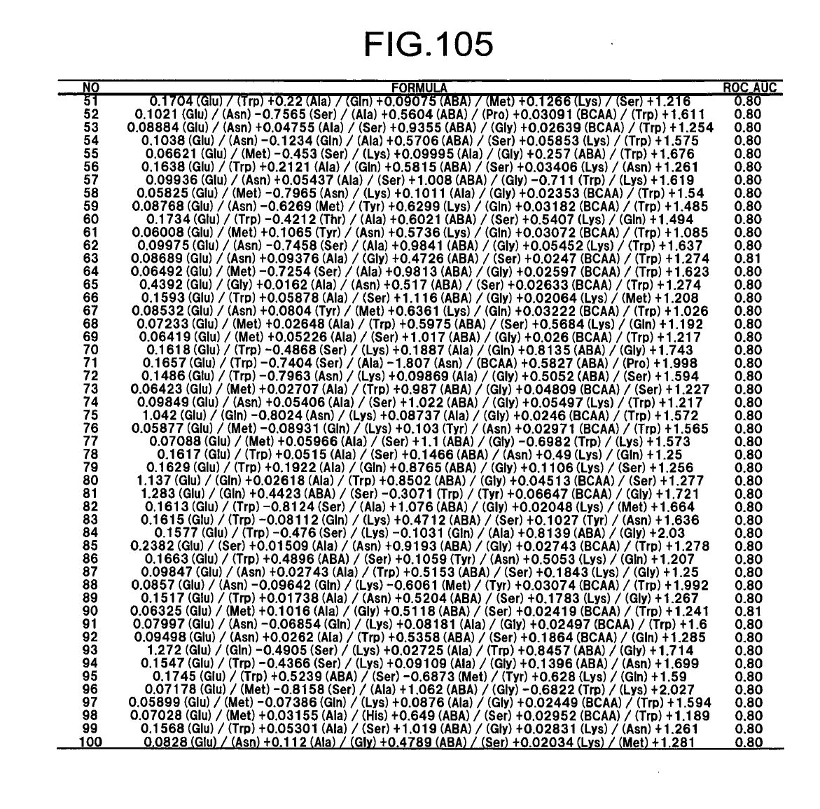

The sample data used in Example 21 is used. Indices which maximize 2-group discriminative ability between the apparent obesity group and the obesity group are earnestly searched for, according to the ROC maximum criterion, by using the method described in International publication WO 2004/052191 which is an international application by the present applicant. As a result, index formula 31 is obtained among a plurality of index formulae having equivalent ability. Other than this, a plurality of multivariate discriminants having discriminative ability equivalent to the index formula 31 are obtained. They are shown in FIGS. 104 and 105. The value of each coefficient in the formulae shown in FIGS. 104 and 105 may be multiplied by a real number or by adding an arbitrary constant term thereto.

0.09865(Glu/Asn)+0.4357(ABA/Ser)+0.4758(Lys/Gln)+0.02968(BC AA/Trp)+1.232 Index formula 31:

### Example 34

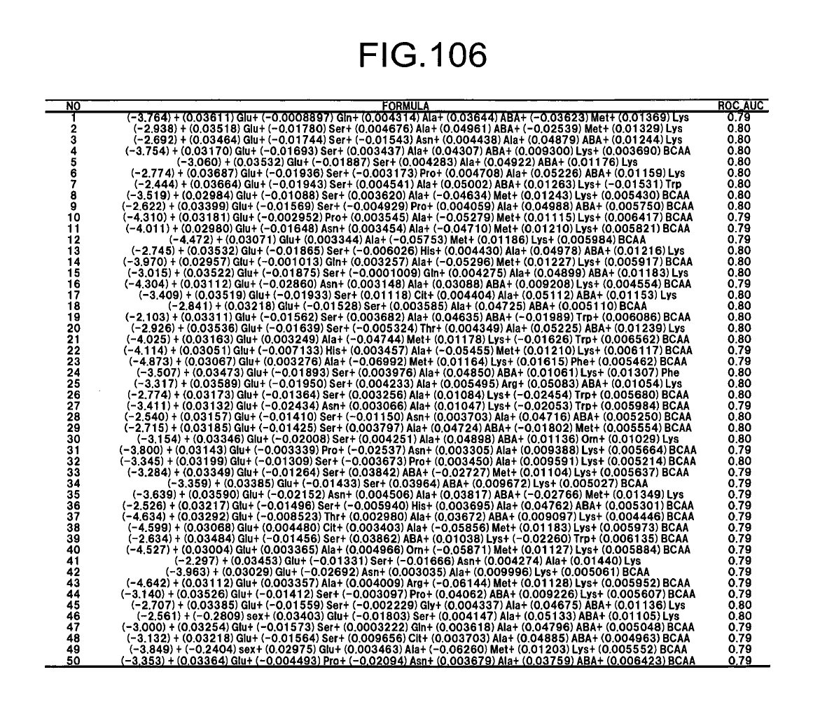

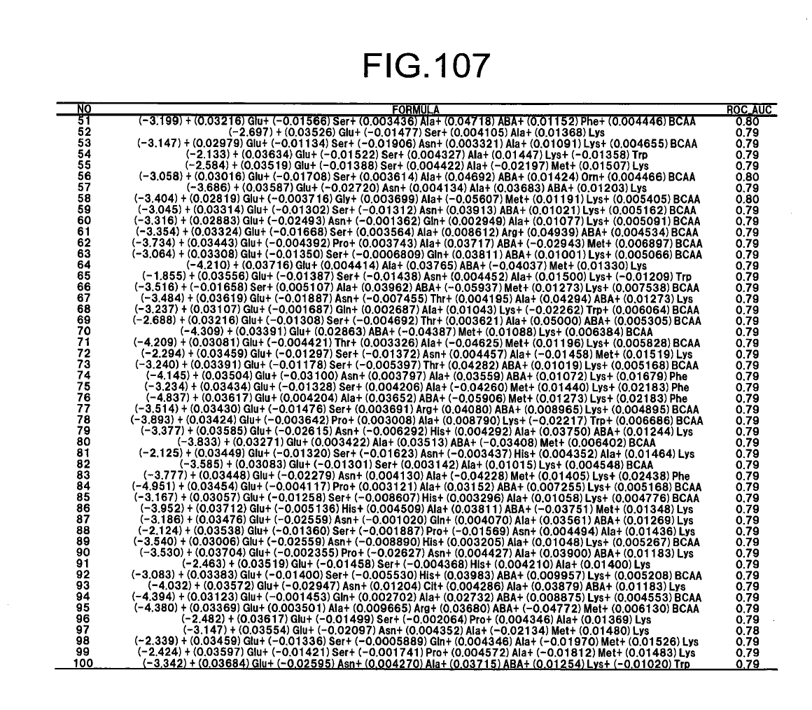

The sample data used in Example 21 is used. Indices which maximize 2-group discriminative ability between the apparent obesity group and the obesity group are searched for, by logistic analysis (explanatory variable coverage method according to the ROC maximum criterion). As a result, as index formula 32, a logistic regression equation described below is obtained. Other than this, a plurality of logistic regression equations having discriminative ability equivalent to the index formula 32 are obtained. They are shown in FIGS. 106 and 107. The value of each coefficient in the equations shown in FIGS. 106 and 107 may be multiplied by a real number.

(−4.831)+(0.03153)Glu+(0.003510)Ala+(0.03078)ABA+(−0.06069)Met+(0.01118)Lys+(0.005459)BCAA Index formula 32:

### Example 35

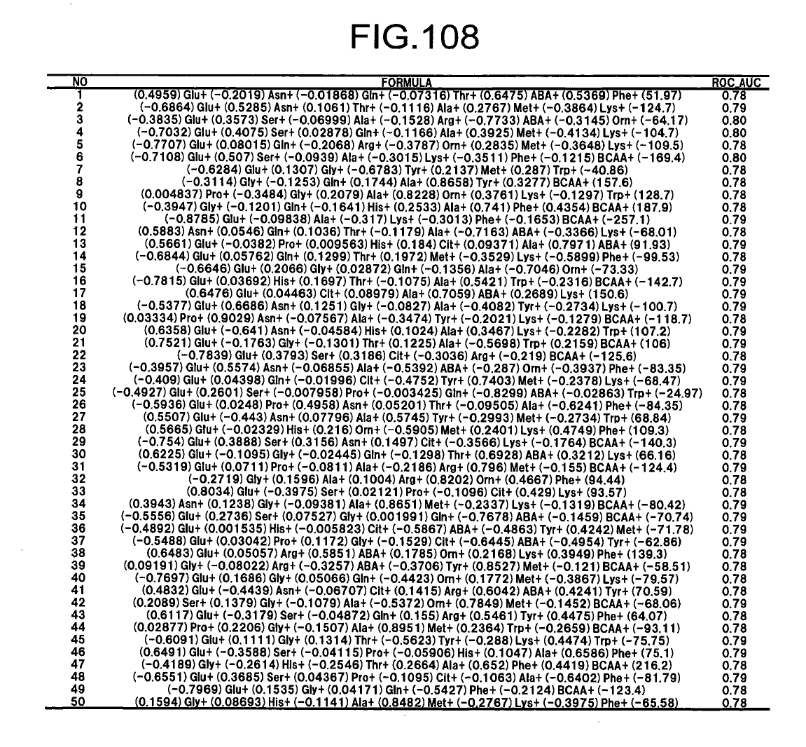

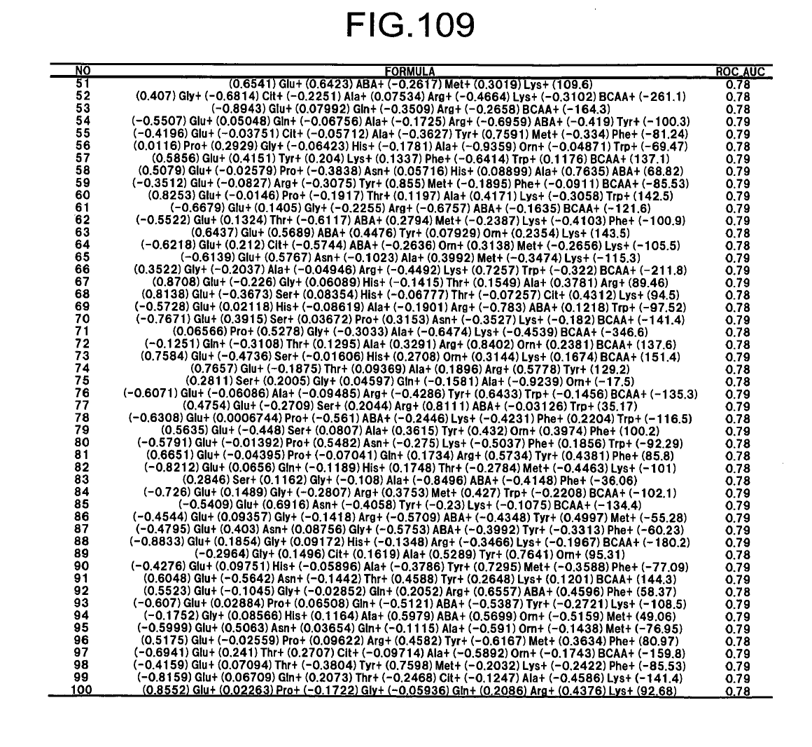

The sample data used in Example 21 is used. Indices which maximize 2-group discriminative ability between the apparent obesity group and the obesity group are searched for, by linear discriminant analysis (explanatory variable coverage method according to the ROC maximum criterion). As a result, as index formula 33, a linear discriminant function described below is obtained. Other than this, a plurality of linear discriminant functions having discriminative ability equivalent to the index formula 33 are obtained. They are shown in FIGS. 108 and 109. The value of each coefficient in the functions shown in FIGS. 108 and 109 may be multiplied by a real number or by adding an arbitrary constant term thereto.

(−0.6047)Glu+(0.2229)Thr+(−0.07818)Ala+(−0.7123)ABA+(−0.2426)Lys+(−0.1109)BCAA+(−161.8) Index formula 33:

### Example 36

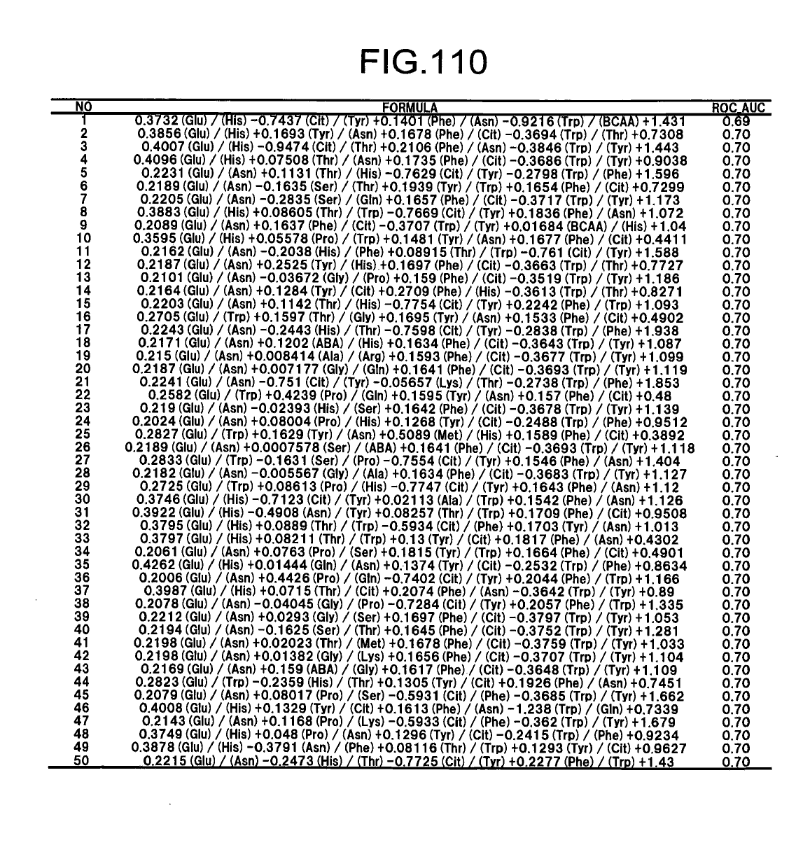

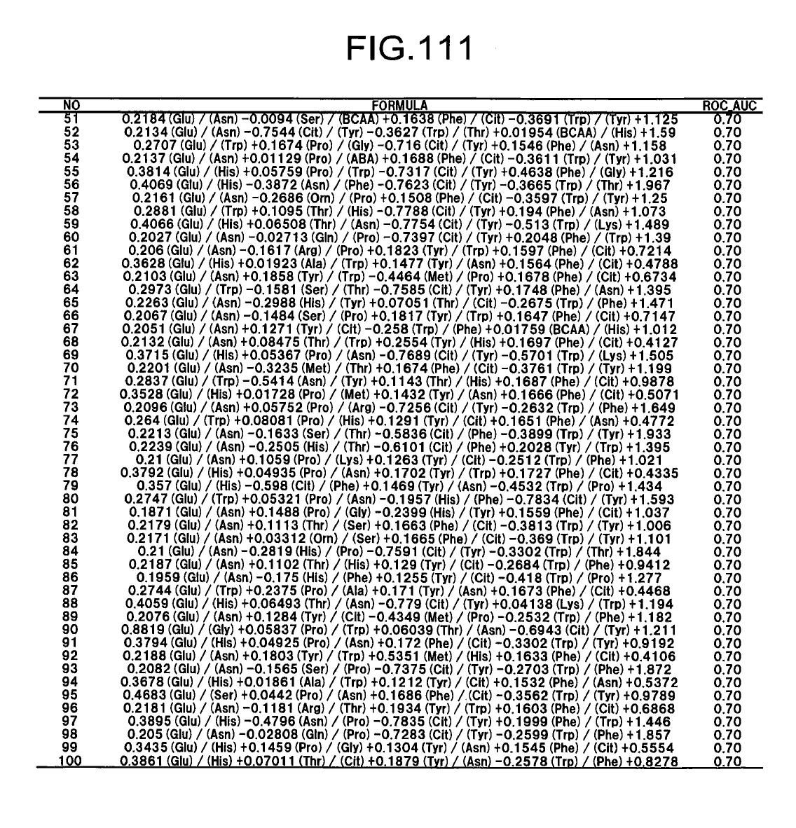

The sample data used in Example 21 is used. Indices which maximize 2-group discriminative ability between the non-apparent obesity group and the obesity group are earnestly searched for, according to the ROC maximum criterion, by using the method described in International publication WO 2004/052191 which is an international application by the present applicant. As a result, index formula 34 is obtained among a plurality of index formulae having equivalent ability. Other than this, a plurality of multivariate discriminants having discriminative ability equivalent to the index formula 34 are obtained. They are shown in FIGS. 110 and 111. The value of each coefficient in the formulae shown in FIGS. 110 and 111 may be multiplied by a real number or by adding an arbitrary constant term thereto.

0.2224(Glu/Asn)−0.2481(His/Thr)+0.1695(Phe/Cit)−0.3708(Trp/Tyr)+1.288 Index formula 34:

### Example 37

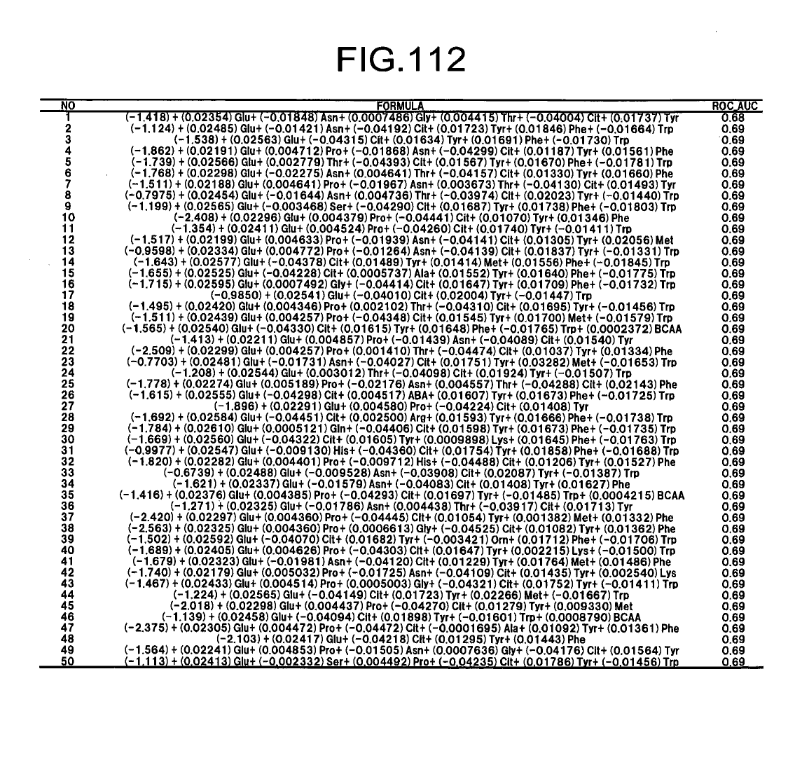

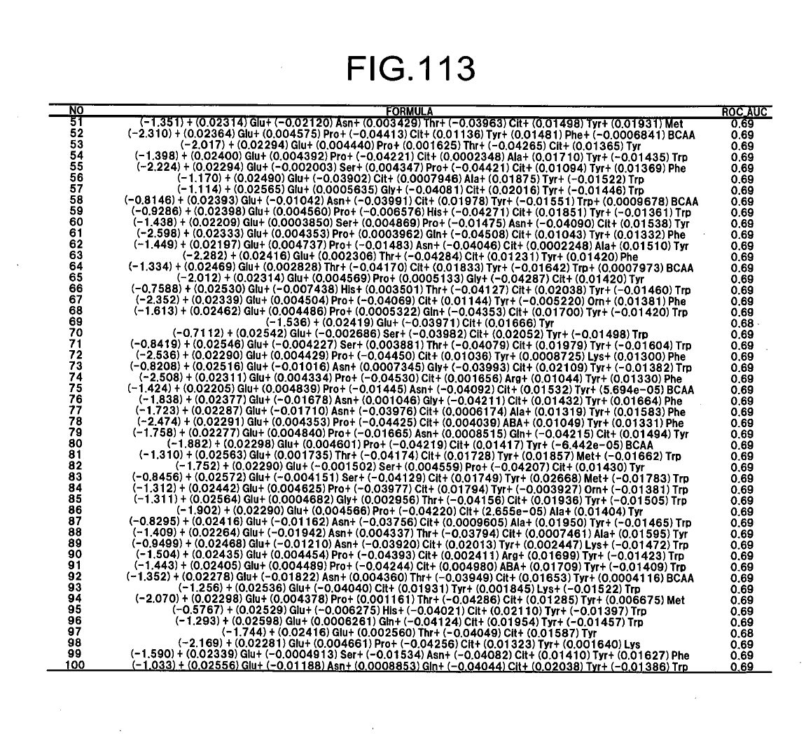

The sample data used in Example 21 is used. Indices which maximize 2-group discriminative ability between the non-apparent obesity group and the obesity group are searched for, by logistic analysis (explanatory variable coverage method according to the ROC maximum criterion). As a result, as index formula 35, a logistic regression equation described below is obtained. Other than this, a plurality of logistic regression equations having discriminative ability equivalent to the index formula 35 are obtained. They are shown in FIGS. 112 and 113. The value of each coefficient in the equations shown in FIGS. 112 and 113 may be multiplied by a real number.

(−1.853)+(0.02439)Glu+(0.004286)Pro+(−0.04532)Cit+(0.01405)Tyr+(0.01594)Phe+(−0.01685)Trp Index formula 35:

### Example 38

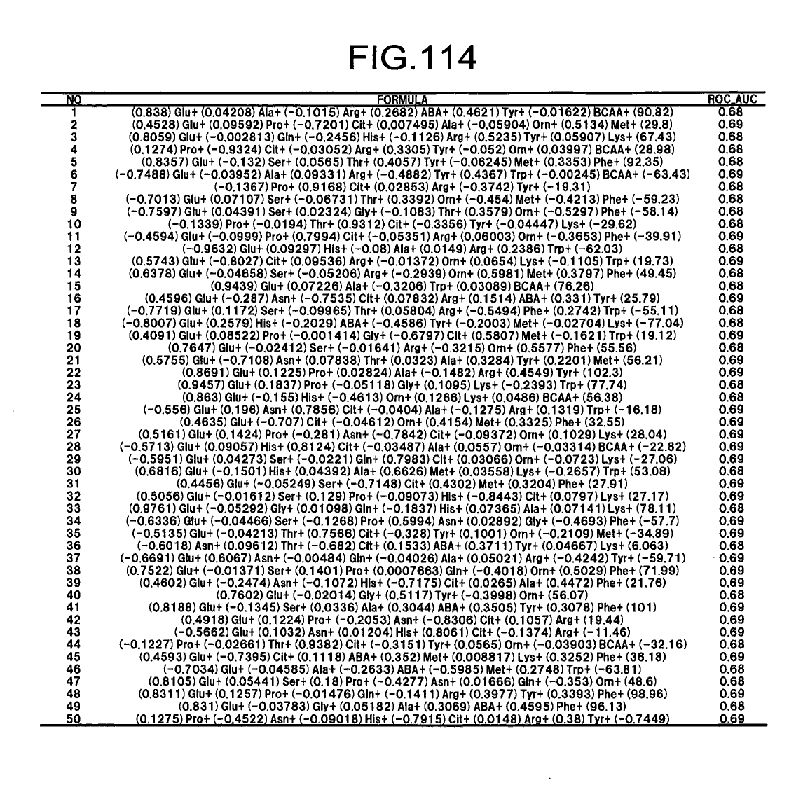

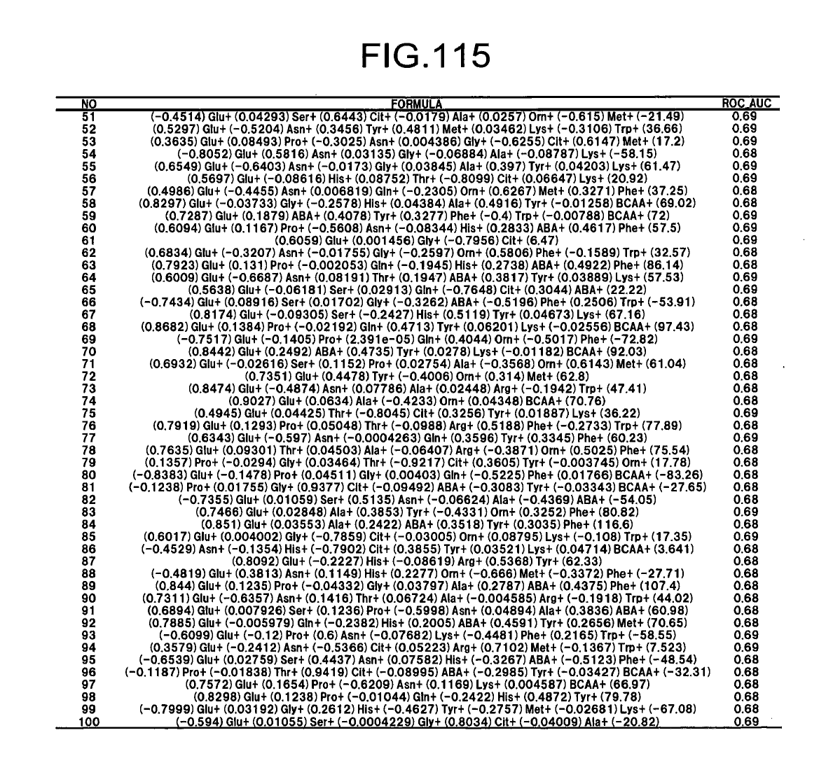

The sample data used in Example 21 is used. Indices which maximize 2-group discriminative ability between the non-apparent obesity group and the obesity group are searched for, by linear discriminant analysis (explanatory variable coverage method according to the ROC maximum criterion). As a result, as index formula 36, a linear discriminant function described below is obtained. Other than this, a plurality of linear discriminant functions having discriminative ability equivalent to the index formula 36 are obtained. They are shown in FIGS. 114 and 115. The value of each coefficient in the functions shown in FIGS. 114 and 115 may be multiplied by a real number or by adding an arbitrary constant term thereto.

(0.7779)Glu+(0.1223)Pro+(−0.2246)His+(0.3704)Met+(0.4384)Phe+(83.09) Index formula 36:

### Example 39

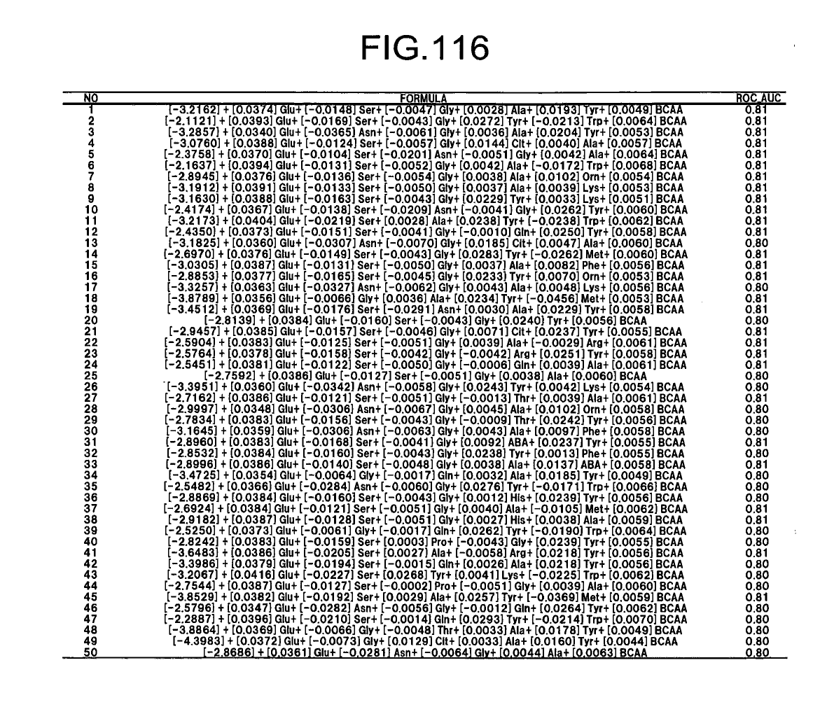

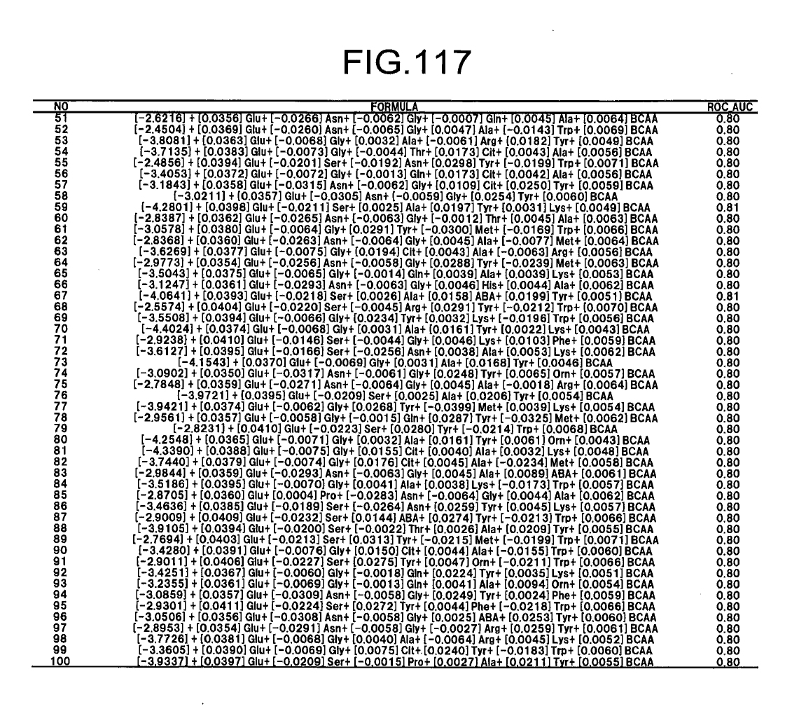

The sample data used in Example 21 is used. Indices which maximize 2-group discriminative ability between “healthy group+apparent obesity group” (healthy group/apparent obesity group) with the VFA less than 100 cm² and “non-apparent obesity group+obesity group” (non-apparent obesity group/obesity group) with the VFA equal to or more than 100 cm² are searched for, by the logistic analysis (explanatory variable coverage method according to the ROC maximum criterion). As a result, as index formula 37, a logistic regression equation having Glu, Gly, Ala, Tyr, Trp, and BCAA (the numerical coefficients of amino acid explanatory variables Glu, Gly, Ala, Tyr, Trp, and BCAA and the constant term are 0.0379, −0.0070, 0.0034, 0.0196, −0.0216, 0.0054, and −3.5250 in order) is obtained. Other than this, a plurality of logistic regression equations having discriminative ability equivalent to the index formula 37 are obtained. They are shown in FIGS. 116 and 117. The value of each coefficient in the equations shown in FIGS. 116 and 117 may be multiplied by a real number.

(−3.5250)+(0.0379)Glu+(−0.0070)Gly+(0.0034)Ala+(0.0196)Tyr+(−0.0216)Trp+(0.0054)BCAA Index formula 37:

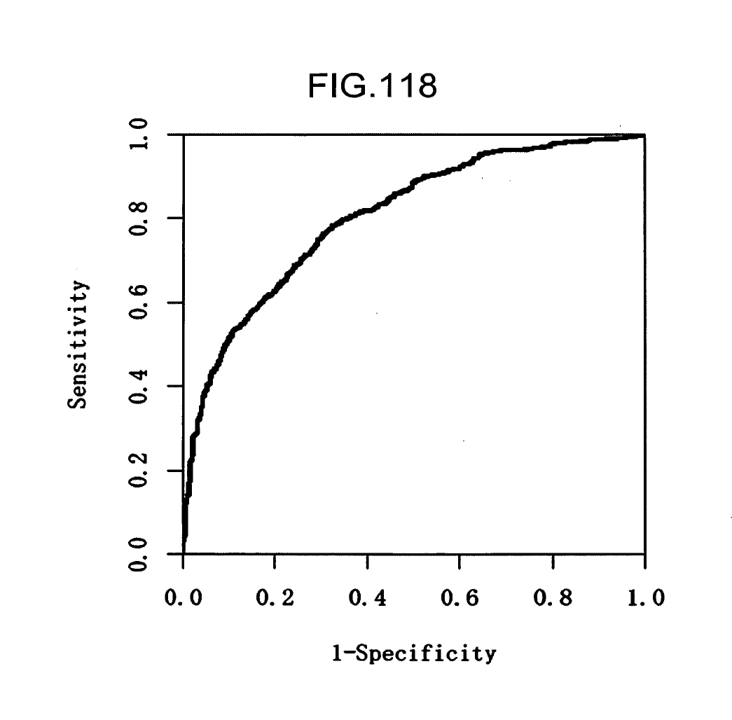

The 2-group discrimination between the healthy group/apparent obesity group and the non-apparent obesity group/obesity group using the index formula 37 is evaluated by the area under the ROC curve (see FIG. 118). As a result, an AUC of 0.807±0.012 (in 95% confidence interval, 0.783 to 0.831) is obtained. In addition, the optimum cutoff value of the 2-group discrimination between the healthy group/apparent obesity group and the non-apparent obesity group/obesity group using the index formula 37 is calculated with the symptom prevalence of the non-apparent obesity/obesity of 60%. As a result, the cutoff value is 0.210, and 76.58% sensitivity, 69.24% specificity, 78.88% positive predictive value, 66.35% negative predictive value, and 73.65% correct diagnosis rate are obtained. From these results, it is found that the index formula 37 is useful, with high diagnostic ability.

### Example 40

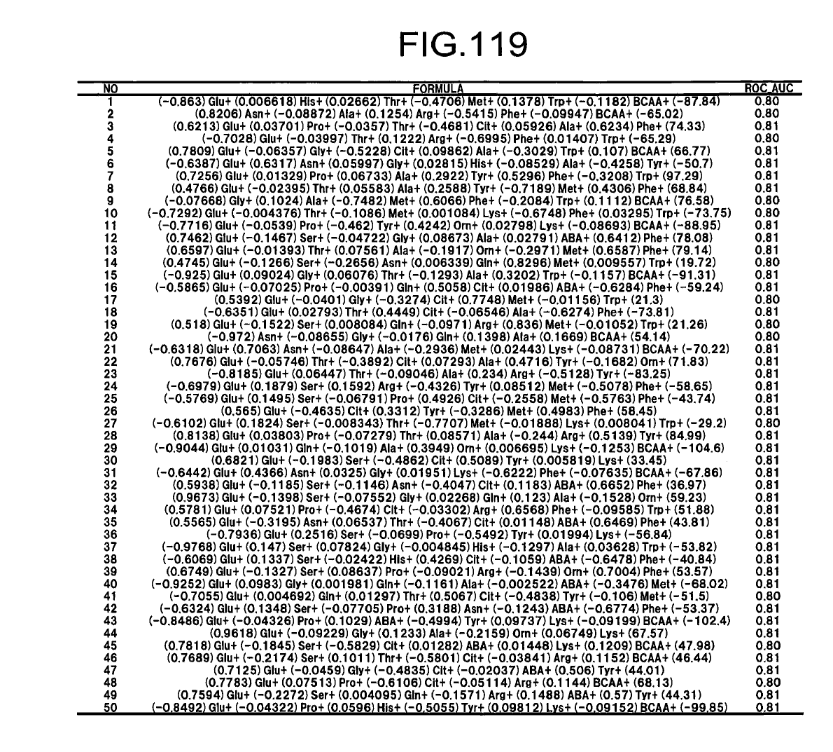

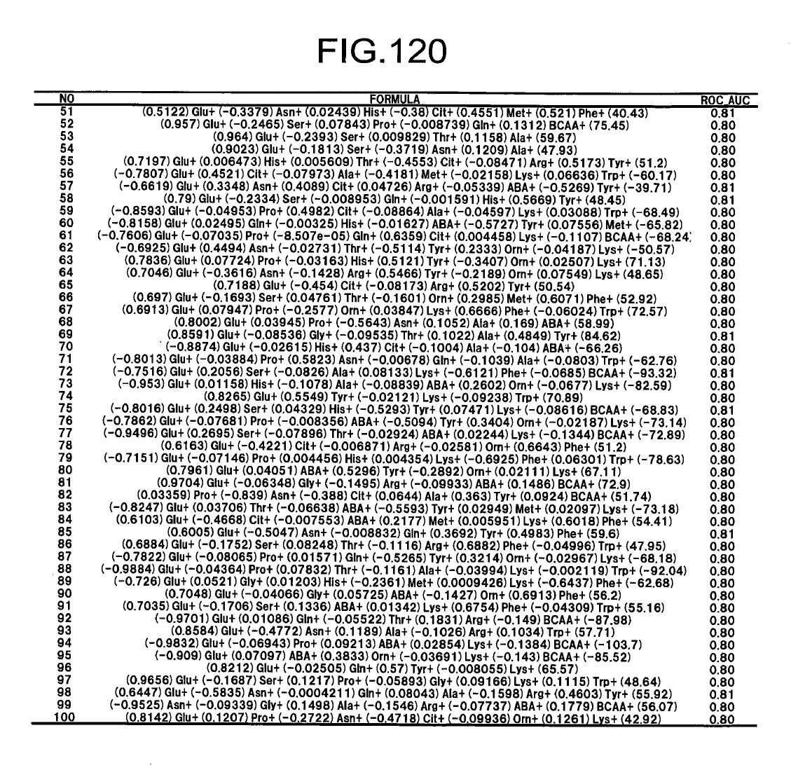

The sample data used in Example 21 is used. Indices which maximize 2-group discriminative ability between the healthy group/apparent obesity group and the non-apparent obesity group/obesity group are searched for, by linear discriminant analysis (explanatory, variable coverage method according to the ROC maximum criterion). As a result, as index formula 38, a linear discriminant function having Glu, Ala, Arg, Tyr, Orn, and BCAA (the numeral coefficients of the amino acid explanatory variables Glu, Ala, Arg, Tyr, Orn, and BCAA, and the constant term are −0.7787, −0.07736, 0.2248, −0.4318, 0.379, −0.08375, and −94.83 in order) is obtained. Other than this, a plurality of linear discriminant functions having discriminative ability equivalent to the index formula 38 are obtained. They are shown in FIGS. 119 and 120. The value of each coefficient in the functions shown in FIGS. 119 and 120 may be multiplied by a real number or by adding an arbitrary constant term thereto.

(−0.7787)Glu+(−0.07736)Ala+(0.2248)Arg+(−0.4318)Tyr+(0.379)Orn+(−0.08375)BCAA+(−94.83) Index formula 38:

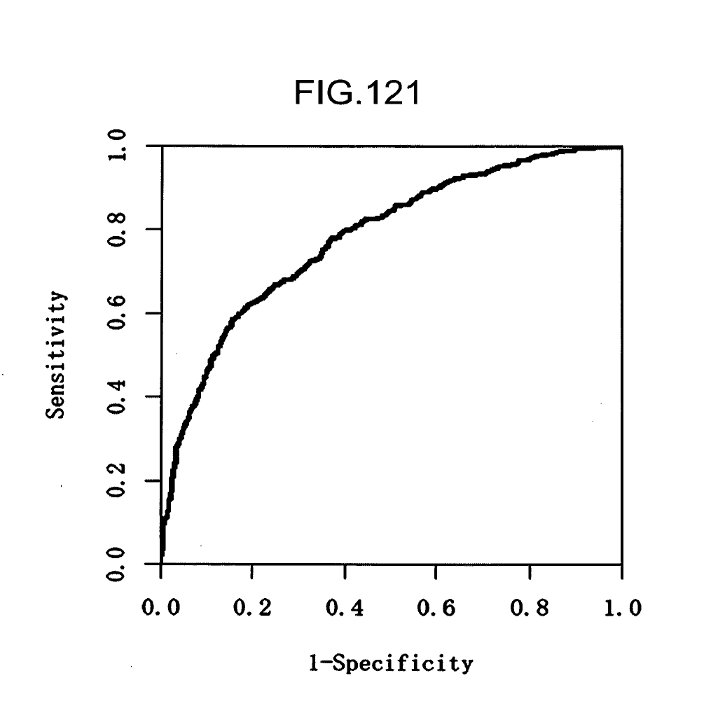

The 2-group discrimination between the healthy group/apparent obesity group and the non-apparent obesity group/obesity group using the index formula 38 is evaluated by the area under the ROC curve (see FIG. 121). As a result, an AUC of 0.782±0.013 (in 95% confidence interval, 0.757 to 0.807) is obtained. In addition, the optimum cutoff value of the 2-group discrimination between the healthy group/apparent obesity group and the non-apparent obesity group/obesity group using the index formula 38 is calculated with the symptom prevalence of the non-apparent obesity/obesity of 60%. As a result, the cutoff value is −185, and 70.01% sensitivity, 70.10% specificity, 77.84% positive predictive value, 60.91% negative predictive value, and 70.05% correct diagnosis rate are obtained. From these results, it is found that the index formula 38 is useful, with high diagnostic ability.

### Example 41

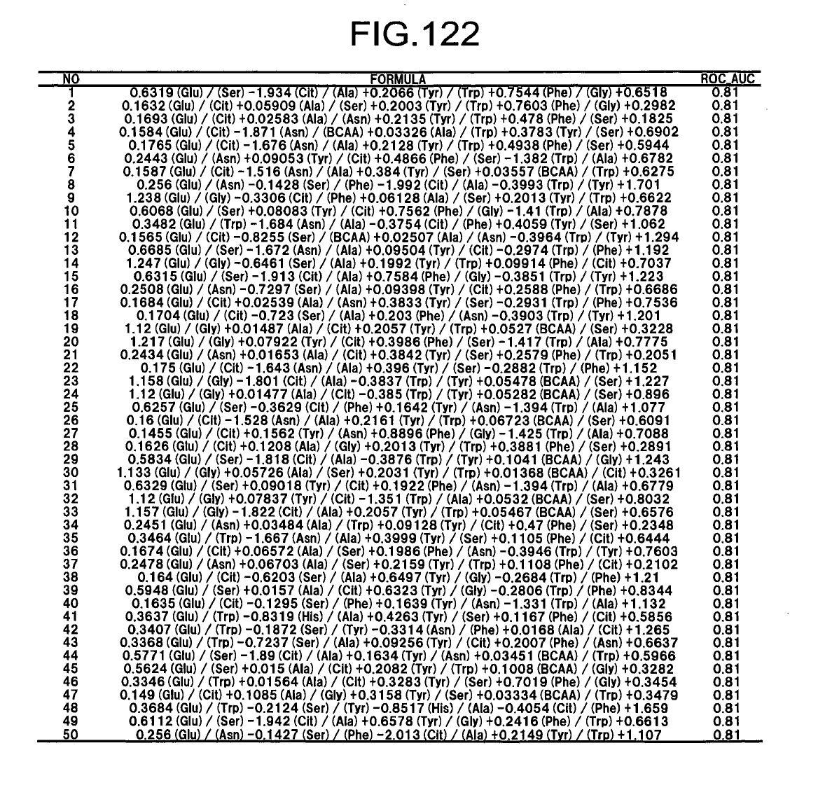

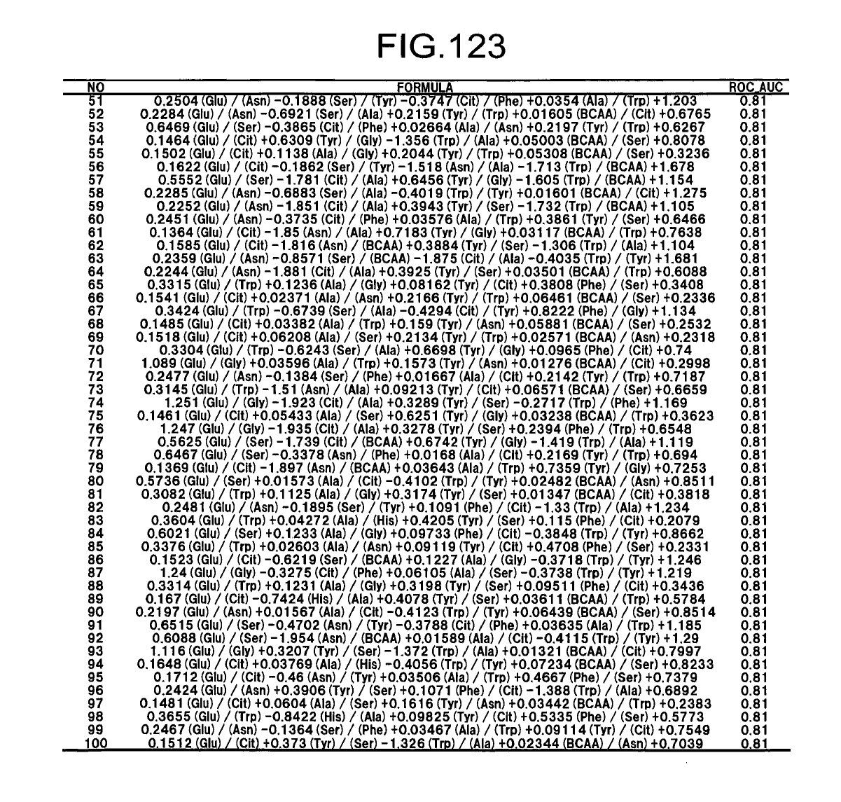

The sample data used in Example 21 is used. Indices which maximize 2-group discriminative ability between the healthy group/apparent obesity group and the non-apparent obesity group/obesity group are earnestly searched for, by using the method described in International publication WO 2004/052191 which is an international application by the present applicant. As a result, index formula 39 is obtained among a plurality of index formulae having equivalent ability. Other than this, a plurality of multivariate discriminants having discriminative ability equivalent to the index formula 39 are obtained. They are shown in FIGS. 122 and 123. The value of each coefficient in the formulae shown in FIGS. 122 and 123 may be multiplied by a real number or by adding an arbitrary constant term thereto.

0.2541(Glu/Asn)−0.7493(Ser/Ala)−0.3896(Cit/Phe)+0.2152(Tyr/Trp)+1.102 Index formula 39:

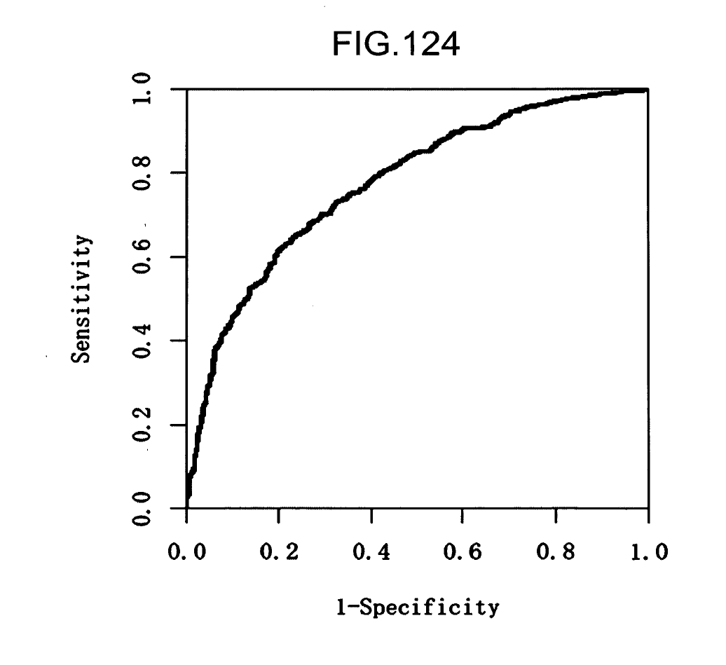

The 2-group discrimination between the healthy group/apparent obesity group and the non-apparent obesity group/obesity group using the index formula 39 is evaluated by the area under the ROC curve (see FIG. 124). As a result, an AUC of 0.776±0.013 (in 95% confidence interval, 0.750 to 0.801) is obtained. In addition, the optimum cutoff value of the 2-group discrimination between the healthy group/apparent obesity group and the non-apparent obesity group/obesity group using the index formula 39 is calculated with the symptom prevalence of the non-apparent obesity/obesity of 60%. As a result, the cutoff value is 1.207, and 70.24% sensitivity, 70.10% specificity, 77.90% positive predictive value, 61.10% negative predictive value, and 70.19% correct diagnosis rate are obtained. From these results, it is found that the index formula 39 is useful, with high diagnostic ability.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A method of evaluating obesity, comprising:
an obtaining step of obtaining amino acid concentration data on a concentration value of an amino acid in blood collected from a subject to be evaluated; and
a concentration value criterion evaluating step of evaluating a state of at least one of an apparent obesity, a non-apparent obesity, and an obesity that are defined by BMI (Body Mass Index) and VFA (Visceral Fat Area) in the subject, based on the concentration value of at least one of Glu, Ser, Pro, Gly, Ala, Cys2, Tyr, Val, Orn, Met, Lys, Ile, Leu, Phe, and Trp contained in the amino acid concentration data of the subject obtained at the obtaining step.

2. The method of evaluating obesity according to claim 1, wherein the concentration value criterion evaluating step further includes a concentration value criterion discriminating step of discriminating between a healthy state defined by the BMI and the VFA and the apparent obesity, between the healthy state and the non-apparent obesity, between the healthy state and the obesity, between the apparent obesity and the non-apparent obesity, between the apparent obesity and the obesity, between the non-apparent obesity and the obesity, or between the healthy state or the apparent obesity and the non-apparent obesity or the obesity in the subject, based on the concentration value of at least one of Glu, Ser, Pro, Gly, Ala, Cys2, Tyr, Val, Orn, Met, Lys, Ile, Leu, Phe, and Trp contained in the amino acid concentration data of the subject obtained at the obtaining step.

3. The method of evaluating obesity according to claim 1, wherein the concentration value criterion evaluating step further includes:
a discriminant value calculating step of calculating a discriminant value that is a value of a multivariate discriminant with a concentration of the amino acid as an explanatory variable, based on both (i) the concentration value of at least one of Glu, Ser, Pro, Gly, Ala, Cys2, Tyr, Val, Orn, Met, Lys, Ile, Leu, Phe, and Trp contained in the amino acid concentration data of the subject obtained at the obtaining step and (ii) the previously established multivariate discriminant; and
a discriminant value criterion evaluating step of evaluating the state of at least one of the apparent obesity, the non-apparent obesity, and the obesity in the subject based on the discriminant value calculated at the discriminant value calculating step, and
wherein the multivariate discriminant contains at least one of Glu, Ser, Pro, Gly, Ala, Cys2, Tyr, Val, Orn, Met, Lys, Ile, Leu, Phe, and Trp as the explanatory variable.

4. The method of evaluating obesity according to claim 3, wherein the discriminant value criterion evaluating step further includes a discriminant value criterion discriminating step of discriminating between a healthy state defined by the BMI and the VFA and the apparent obesity, between the healthy state and the non-apparent obesity, between the healthy state and the obesity, between the apparent obesity and the non-apparent obesity, between the apparent obesity and the obesity, between the non-apparent obesity and the obesity, or between the healthy state or the apparent obesity and the non-apparent obesity or the obesity in the subject, based on the discriminant value calculated at the discriminant value calculating step.

5. The method of evaluating obesity according to claim 4, wherein the multivariate discriminant is any one of a fractional expression, the sum of a plurality of the fractional expressions, a logistic regression equation, a linear discriminant, a multiple regression equation, a discriminant prepared by a support vector machine, a discriminant prepared by a Mahalanobis' generalized distance method, a discriminant prepared by canonical discriminant analysis, and a discriminant prepared by a decision tree.

6. The method of evaluating obesity according to claim 5, wherein when discriminating between the healthy state and the apparent obesity at the discriminant value criterion discriminating step, the multivariate discriminant is a formula 1, a formula 2, the logistic regression equation with Glu, Thr, and Phe as the explanatory variables, the logistic regression equation with Pro, Asn, Thr, Arg, Tyr, and Orn as the explanatory variables, the linear discriminant with His, Thr, Val, Orn, and Trp as the explanatory variables, or the linear discriminant with Ser, Pro, Asn, Orn, Phe, Val, Leu, and Ile as the explanatory variables:
a₁(Glu/Gly)+b₁(His/Ile)+c₁(Thr/Phe)+d₁ (formula 1)
a₂(Pro/Ser)+b₂(Thr/Asn)+c₂(Arg/Tyr)+d₂(Orn/Gln)+e₂ (formula 2)
wherein in the formula 1, a₁, b₁, and c₁ are arbitrary non-zero real numbers and d₁ is an arbitrary real number and in the formula 2, a₂, b₂, c₂, and d₂ are arbitrary non-zero real numbers and e₂ is an arbitrary real number.

7. The method of evaluating obesity according to claim 5, wherein when discriminating between the healthy state and the non-apparent obesity at the discriminant value criterion discriminating step, the multivariate discriminant is a formula 3, a formula 4, the logistic regression equation with Glu, Ser, Ala, Orn, Leu, and Trp as the explanatory variables, the logistic regression equation with Glu, Ser, Gly, Cit, Ala, Val, Leu, and Ile as the explanatory variables, the linear discriminant with Glu, Ser, His, Thr, Lys, and Phe as the explanatory variables, or the linear discriminant with Glu, His, ABA, Tyr, Met, and Lys as the explanatory variables:
a₃(Ser/Ala)+b₃(Gly/Tyr)+c₃(Trp/Glu)+d₃ (formula 3)
a₄(Ser/Cit)+b₄(Gly/(Val+Leu+Ile))+c₄(Gln/Ala)+d₄(Thr/Glu)+e₄ (formula 4)
wherein in the formula 3, a₃, b₃, and c₃ are arbitrary non-zero real numbers and d₃ is an arbitrary real number and in the formula 4, a₄, b₄, c₄, and d₄ are arbitrary non-zero real numbers and e₄ is an arbitrary real number.

8. The method of evaluating obesity according to claim 5, wherein when discriminating between the healthy state and the obesity at the discriminant value criterion discriminating step, the multivariate discriminant is a formula 5, a formula 6, the logistic regression equation with Glu, Ser, Cit, Ala, Tyr, and Trp as the explanatory variables, the logistic regression equation with Glu, Ser, Ala, Tyr, Trp, Val, Leu, and Ile as the explanatory variables, the linear discriminant with Glu, Thr, Ala, Tyr, Orn, and Lys as the explanatory variables, or the linear discriminant with Glu, Pro, His, Cit, Orn, and Lys as the explanatory variables:
a₅(Glu/Ser)+b₅(Cit/Ala)+c₅(Trp/Tyr)+d₅ (formula 5)
a₆(Glu/Gly)+b₆(Ser/Ala)+c₆(Trp/Tyr)+d₆((Val+Leu+Ile)/Asn)+e₆ (formula 6)
wherein in the formula 5, a₅, b₅, and c₅ are arbitrary non-zero real numbers and d₅ is an arbitrary real number and in the formula 6, a₆, b₆, c₆, and d₆ are arbitrary non-zero real numbers and e₆ is an arbitrary real number.

9. The method of evaluating obesity according to claim 5, wherein when discriminating between the apparent obesity and the non-apparent obesity at the discriminant value criterion discriminating step, the multivariate discriminant is a formula 7, a formula 8, the logistic regression equation with Glu, Thr, Ala, Arg, Tyr, and Lys as the explanatory variables, the logistic regression equation with Pro, Gly, Gln, Ala, Orn, Val, Leu, and Ile as the explanatory variables, the linear discriminant with His, Thr, Ala, Tyr, Orn, and Phe as the explanatory variables, or the linear discriminant with Ser, Pro, Gly, Cit, Lys, and Phe as the explanatory variables:
a₇(Thr/Tyr)+b₇(Ala/Ile)+c₇(Arg/Gln)+d₇ (formula 7)
a₈(Pro/(Val+Leu+Ile))+b₈(Gly/Orn)+c₈(Gln/Ala)+d₈(ABA/Thr)+e₈ (formula 8)
wherein in the formula 7, a₇, b₇, and c₇ are arbitrary non-zero real numbers and d₇ is an arbitrary real number and in the formula 8, a₈, b₈, c₈, and d₈ are arbitrary non-zero real numbers and e₈ is an arbitrary real number.

10. The method of evaluating obesity according to claim 5, wherein when discriminating between the apparent obesity and the obesity at the discriminant value criterion discriminating step, the multivariate discriminant is a formula 9, a formula 10, the logistic regression equation with Glu, Asn, Gly, His, Leu, and Trp as the explanatory variables, the logistic regression equation with Glu, Ala, ABA, Met, Lys, Val, Leu, and Ile as the explanatory variables, the linear discriminant with Glu, Gly, His, Ala, and Lys as the explanatory variables, or the linear discriminant with Glu, Thr, Ala, ABA, Lys, Val, Leu, and Ile as the explanatory variables:
a₉(Gly/Glu)+b₉(His/Trp)+c₉(Leu/Gln)+d₉ (formula 9)
a₁₀(Glu/Asn)+b₁₀(ABA/Ser)+c₁₀(Lys/Gln)+d₁₀((Val+Leu+Ile)/Trp))+e₁₀ (formula 10)
wherein in the formula 9, a₉, b₉, and c₉ are arbitrary non-zero real numbers and d₉ is an arbitrary real number and in the formula 10, a₁₀, b₁₀, c₁₀, and d₁₀ are arbitrary non-zero real numbers and e₁₀ is an arbitrary real number.

11. The method of evaluating obesity according to claim 5, wherein when discriminating between the non-apparent obesity and the obesity at the discriminant value criterion discriminating step, the multivariate discriminant is a formula 11, a formula 12, the logistic regression equation with Glu, Gly, Cit, Tyr, Val, and Phe as the explanatory variables, the logistic regression equation with Glu, Pro, Cit, Tyr, Phe, and Trp as the explanatory variables, the linear discriminant with Glu, Cit, Tyr, Orn, Met, and Trp as the explanatory variables, or the linear discriminant with Glu, Pro, His, Met, and Phe as the explanatory variables:
a₁₁(Glu/Gln)+b₁₁(Tyr/Gly)+c₁₁(Lys/Trp)+d₁₁ (formula 11)
a₁₂(Glu/Asn)+b₁₂(His/Thr)+c₁₂(Phe/Cit)+d₁₂(Trp/Tyr)+e₁₂ (formula 12)
wherein in the formula 11, a₁₁, b₁₁, and c₁₁ are arbitrary non-zero real numbers and d₁₁ is an arbitrary real number and in the formula 12, a₁₂, b₁₂, c₁₂, and d₁₂ are arbitrary non-zero real numbers and e₁₂ is an arbitrary real number.

12. The method of evaluating obesity according to claim 5, wherein when discriminating between the healthy state or the apparent obesity and the non-apparent obesity or the obesity at the discriminant value criterion discriminating step, the multivariate discriminant is a formula 13, the logistic regression equation with Glu, Gly, Ala, Tyr, Trp, Val, Leu, and Ile as the explanatory variables, or the linear discriminant with Glu, Ala, Arg, Tyr, Orn, Val, Leu, and Ile as the explanatory variables:
a₁₃(Glu/Asn)+b₁₃(Ser/Ala)+c₁₃(Cit/Phe)+d₁₃(Tyr/Trp)+e₁₃ (formula 13)
wherein in the formula 13, a₁₃, b₁₃, c₁₃, and d₁₃ are arbitrary non-zero real numbers and e₁₃ is an arbitrary real number.

13. An obesity-evaluating apparatus comprising a control unit and a memory unit to evaluate a state of at least one of an apparent obesity, a non-apparent obesity, and an obesity that are defined by BMI (Body Mass Index) and VFA (Visceral Fat Area) in a subject to be evaluated, wherein the control unit includes:
a discriminant value-calculating unit that calculates a discriminant value that is a value of a multivariate discriminant with a concentration of an amino acid as an explanatory variable, based on both (i) a concentration value of at least one of Glu, Ser, Pro, Gly, Ala, Cys2, Tyr, Val, Orn, Met, Lys, Ile, Leu, Phe, and Trp contained in previously obtained amino acid concentration data of the subject on the concentration value of the amino acid and (ii) the multivariate discriminant stored in the memory unit; and
a discriminant value criterion-evaluating unit that evaluates the state of at least one of the apparent obesity, the non-apparent obesity, and the obesity in the subject based on the discriminant value calculated by the discriminant value-calculating unit, and
wherein the multivariate discriminant contains at least one of Glu, Ser, Pro, Gly, Ala, Cys2, Tyr, Val, Orn, Met, Lys, Ile, Leu, Phe, and Trp as the explanatory variable.

14. An obesity-evaluating method of evaluating a state of at least one of an apparent obesity, a non-apparent obesity, and an obesity that are defined by BMI (Body Mass Index) and VFA (Visceral Fat Area) in a subject to be evaluated, which method is carried out with an information processing apparatus including a control unit and a memory unit, the method comprising:
(I) a discriminant value calculating step of calculating a discriminant value that is a value of a multivariate discriminant with a concentration of an amino acid as an explanatory variable, based on both (i) a concentration value of at least one of Glu, Ser, Pro, Gly, Ala, Cys2, Tyr, Val, Orn, Met, Lys, Ile, Leu, Phe, and Trp contained in previously obtained amino acid concentration data of the subject on the concentration value of the amino acid and (ii) the multivariate discriminant stored in the memory unit; and
(II) a discriminant value criterion evaluating step of evaluating the state of at least one of the apparent obesity, the non-apparent obesity, and the obesity in the subject based on the discriminant value calculated at the discriminant value calculating step, and
wherein the multivariate discriminant contains at least one of Glu, Ser, Pro, Gly, Ala, Cys2, Tyr, Val, Orn, Met, Lys, Ile, Leu, Phe, and Trp as the explanatory variable, and the steps (I) and (II) are executed by the control unit.

15. An obesity-evaluating system comprising an obesity-evaluating apparatus including a control unit and a memory unit to evaluate a state of at least one of an apparent obesity, a non-apparent obesity, and an obesity that are defined by BMI (Body Mass Index) and VFA (Visceral Fat Area) in a subject to be evaluated and an information communication terminal apparatus that provides amino acid concentration data of the subject on a concentration value of an amino acid that are connected to each other communicatively via a network, wherein
the information communication terminal apparatus includes:
an amino acid concentration data-sending unit that transmits the amino acid concentration data of the subject to the obesity-evaluating apparatus; and
an evaluation result-receiving unit that receives an evaluation result of the subject on the state of at least one of the apparent obesity, the non-apparent obesity, and the obesity transmitted from the obesity-evaluating apparatus, and
the control unit of the obesity-evaluating apparatus includes:
an amino acid concentration data-receiving unit that receives the amino acid concentration data of the subject transmitted from the information communication terminal apparatus;
a discriminant value-calculating unit that calculates a discriminant value that is a value of a multivariate discriminant with a concentration of the amino acid as an explanatory variable, based on both (i) the concentration value of at least one of Glu, Ser, Pro, Gly, Ala, Cys2, Tyr, Val, Orn, Met, Lys, Ile, Leu, Phe, and Trp contained in the amino acid concentration data of the subject received by the amino acid concentration data-receiving unit and (ii) the multivariate discriminant stored in the memory unit;
a discriminant value criterion-evaluating unit that evaluates the state of at least one of the apparent obesity, the non-apparent obesity, and the obesity in the subject based on the discriminant value calculated by the discriminant value-calculating unit; and
an evaluation result-sending unit that transmits the evaluation result of the subject obtained by the discriminant value criterion-evaluating unit to the information communication terminal apparatus, and
wherein the multivariate discriminant contains at least one of Glu, Ser, Pro, Gly, Ala, Cys2, Tyr, Val, Orn, Met, Lys, Ile, Leu, Phe, and Trp as the explanatory variable.

16. An obesity-evaluating program product having a non-transitory computer readable medium including programmed instructions for making an information processing apparatus including a control unit and a memory unit execute a method of evaluating a state of at least one of an apparent obesity, a non-apparent obesity, and an obesity that are defined by BMI (Body Mass Index) and VFA (Visceral Fat Area) in a subject to be evaluated, the method comprising:
(I) a discriminant value calculating step of calculating a discriminant value that is a value of a multivariate discriminant with a concentration of an amino acid as an explanatory variable, based on both (i) a concentration value of at least one of Glu, Ser, Pro, Gly, Ala, Cys2, Tyr, Val, Orn, Met, Lys, Ile, Leu, Phe, and Trp contained in previously obtained amino acid concentration data of the subject on the concentration value of the amino acid and (ii) the multivariate discriminant stored in the memory unit; and
(II) a discriminant value criterion evaluating step of evaluating the state of at least one of the apparent obesity, the non-apparent obesity, and the obesity in the subject based on the discriminant value calculated at the discriminant value calculating step, and
wherein the multivariate discriminant contains at least one of Glu, Ser, Pro, Gly, Ala, Cys2, Tyr, Val, Orn, Met, Lys, Ile, Leu, Phe, and Trp as the explanatory variable, and the steps (I) and (II) are executed by the control unit.

17. A non-transitory computer-readable recording medium, comprising the obesity-evaluating program product according to claim 16 recorded thereon.

18. An information communication terminal apparatus that provides amino acid concentration data of a subject to be evaluated on a concentration value of an amino acid, being communicatively via a network to an obesity-evaluating apparatus including a control unit and a memory unit to evaluate a state of at least one of an apparent obesity, a non-apparent obesity, and an obesity that are defined by BMI (Body Mass Index) and VFA (Visceral Fat Area) in the subject, comprising:
an amino acid concentration data-sending unit that transmits the amino acid concentration data of the subject to the obesity-evaluating apparatus; and
an evaluation result-receiving unit that receives the evaluation result of the subject on the state of at least one of the apparent obesity, the non-apparent obesity, and the obesity transmitted from the obesity-evaluating apparatus, and
wherein the evaluation result is the result of (I) receiving the amino acid concentration data of the subject transmitted from the information communication terminal apparatus, (II) calculating a discriminant value that is a value of a multivariate discriminant with a concentration of the amino acid as an explanatory variable, based on both (i) the concentration value of at least one of Glu, Ser, Pro, Gly, Ala, Cys2, Tyr, Val, Orn, Met, Lys, Ile, Leu, Phe, and Trp contained in the received amino acid concentration data of the subject and (ii) the multivariate discriminant stored in the memory unit, and (III) evaluating the state of at least one of the apparent obesity, the non-apparent obesity, and the obesity in the subject based on the calculated discriminant value, and
wherein the multivariate discriminant contains at least one of Glu, Ser, Pro, Gly, Ala, Cys2, Tyr, Val, Orn, Met, Lys, Ile, Leu, Phe, and Trp as the explanatory variable.

19. An obesity-evaluating apparatus comprising a control unit and a memory unit to evaluate a state of at least one of an apparent obesity, a non-apparent obesity, and an obesity that are defined by BMI (Body Mass Index) and VFA (Visceral Fat Area) in a subject to be evaluated, being communicatively via a network to an information communication terminal apparatus that provides amino acid concentration data of the subject on a concentration value of an amino acid,
wherein the control unit includes:
an amino acid concentration data-receiving unit that receives the amino acid concentration data of the subject transmitted from the information communication terminal apparatus;
a discriminant value-calculating unit that calculates a discriminant value that is a value of a multivariate discriminant with a concentration of the amino acid as an explanatory variable, based on both (i) the concentration value of at least one of Glu, Ser, Pro, Gly, Ala, Cys2, Tyr, Val, Orn, Met, Lys, Ile, Leu, Phe, and Trp contained in the amino acid concentration data of the subject received by the amino acid concentration data-receiving unit and (ii) the multivariate discriminant stored in the memory unit;
a discriminant value criterion-evaluating unit that evaluates the state of at least one of the apparent obesity, the non-apparent obesity, and the obesity in the subject based on the discriminant value calculated by the discriminant value-calculating unit; and
an evaluation result-sending unit that transmits the evaluation result of the subject obtained by the discriminant value criterion-evaluating unit to the information communication terminal apparatus, and
wherein the multivariate discriminant contains at least one of Glu, Ser, Pro, Gly, Ala, Cys2, Tyr, Val, Orn, Met, Lys, Ile, Leu, Phe, and Trp as the explanatory variable.
